(19) United States
(12) Patent Application Publication
(10) Pub. No.: US 2025/0141820 A1
(43) Pub. Date: May 1, 2025

(54) METHODS AND SYSTEMS FOR AI-FACILITATED CONVERSATIONS AMONG SYNCHRONOUS AND ASYNCHRONOUS HUMAN PARTICIPANTS

(71) Applicant: Unanimous A. I., Inc., Arlington, VA (US)

(72) Inventors: Louis B. Rosenberg, San Luis Obispo, CA (US); Gregg Willcox, Seattle, WA (US); Hans Schumann, San Francisco, CA (US)

(21) Appl. No.: 19/007,215

(22) Filed: Dec. 31, 2024

Related U.S. Application Data
(63) Continuation-in-part of application No. 18/887,029, filed on Sep. 16, 2024.
Application No. 18/887,029 is a continuation-in-part of application No. 18/588,851, filed on Feb. 27, 2024, now Pat. No. 12,166,735.
Application No. 18/588,851 is a continuation of application No. 18/240,286, filed on Aug. 30, 2023, now Pat. No. 11,949,638.
Application No. 18/887,029 is a continuation-in-part of application No. 18/367,089, filed on Sep. 12, 2023, now Pat. No. 12,190,294.
Application No. 18/367,089 is a continuation-in-part of application No. 18/240,286, filed on Aug. 30, 2023, now Pat. No. 11,949,638.
(60) Provisional application No. 63/557,706, filed on Feb. 26, 2024.
(60) Provisional application No. 63/599,467, filed on Nov. 15, 2023.
(60) Provisional application No. 63/600,669, filed on Nov. 18, 2023.
(60) Provisional application No. 63/449,986, filed on Mar. 4, 2023.
(60) Provisional application No. 63/449,986, filed on Mar. 4, 2023.
(60) Provisional application No. 63/451,614, filed on Mar. 12, 2023.
(60) Provisional application No. 63/456,483, filed on Apr. 1, 2023.

(51) Int. Cl. H04L 51/046; H04L 51/04; H04L 51/216; H04L 51/56

(52) U.S. Cl. CPC H04L 51/046; H04L 51/04; H04L 51/216; H04L 51/56

(57) ABSTRACT

The present disclosure describes systems and methods for asynchronous conversational deliberation among a population of human participants. In some aspects, a collaboration server is connected to a memory containing a representation of conversational content that was previously captured from prior human participants, the representation associated with each prior participant including at least one stored idea, insight, view, or assertion expressed by that prior participant and at least one associated numerical measure of sentiment, conviction, confidence, or support. According to some embodiments, an asynchronous conversational process is enabled in which each of a plurality of new human participants engages in real-time dialog with a Conversational Surrogate Agent displayed by their associated computing device, each Conversational Surrogate Agent configured to express to at least one new participant, at least one stored idea, insight, view, or assertion associated with at least one prior participant.

### CROSS-REFERENCE TO RELATED APPLICATION

This application claims the benefit of U.S. Provisional Application No. 63/557,706 filed Feb. 26, 2024, for METHOD AND SYSTEM FOR COLLECTIVE SUPERINTELLIGENCE WITH SELECTABLE LEVELS OF SYNCHRONY, which is incorporated in its entirety herein by reference.

This application is a continuation-in-part of U.S. patent application Ser. No. 18/887,029 filed Sep. 16, 2024, for METHODS AND SYSTEMS FOR ENBALING LARGE-SCALE CONVERSATIONAL DELIBERATIONS AMONG HUMAN GROUPS AND AI-POWERED CONVERSATIONAL AGENTS, which claims the benefit of U.S. Provisional Application No. 63/599,467 filed Nov. 15, 2023, for METHOD AND SYSTEM FOR HYBRID COLLECTIVE SUPERINTELLIGENCE and U.S. Provisional Application No. 63/600,669 filed Nov. 18, 2023, for METHOD AND SYSTEM FOR HYBRID COLLECTIVE SUPERINTELLIGENCE WITH PRELOADED CONTEXTUAL CONTENT AND REAL-TIME SCOUT AGENTS, all of which are incorporated in their entirety herein by reference.

This application is a continuation-in-part of U.S. patent application Ser. No. 18/887,029 filed Sep. 16, 2024, for METHODS AND SYSTEMS FOR ENBALING LARGE-SCALE CONVERSATIONAL DELIBERATIONS AMONG HUMAN GROUPS AND AI-POWERED CONVERSATIONAL AGENTS, which is a continuation-in-part of U.S. patent application Ser. No. 18/588,851 filed Feb. 27, 2024, for METHODS AND SYSTEMS FOR ENABLING CONVERSATIONAL DELIBERATION ACROSS LARGE NETWORKED POPULATIONS, now U.S. Pat. No. 12,166,735, issued on Dec. 10, 2024, which is a continuation of U.S. patent application Ser. No. 18/240,286, filed Aug. 30, 2023, for METHODS AND SYSTEMS FOR HYPERCHAT CONVERSATIONS AMONG LARGE NETWORKED POPULATIONS WITH COLLECTIVE INTELLIGENCE AMPLIFICATION, now U.S. Pat. No. 11,949,638, issued on Apr. 2, 2024, which claims the benefit of U.S. Provisional Application No. 63/449,986, filed Mar. 4, 2023, for METHOD AND SYSTEM FOR “HYPERCHAT” CONVERSATIONS AMONG LARGE NETWORKED POPULATIONS WITH COLLECTIVE INTELLIGENCE AMPLIFICATION, which are incorporated in their entirety herein by reference.

This application is a continuation-in-part of U.S. patent application Ser. No. 18/887,029 filed Sep. 16, 2024, for METHODS AND SYSTEMS FOR ENBALING LARGE-SCALE CONVERSATIONAL DELIBERATIONS AMONG HUMAN GROUPS AND AI-POWERED CONVERSATIONAL AGENTS, which is a continuation-in-part of U.S. patent application Ser. No. 18/367,089 filed Sep. 12, 2023, for METHODS AND SYSTEMS FOR HYPERCHAT AND HYPERVIDEO CONVERSATIONS ACROSS NETWORKED HUMAN POPULATIONS WITH COLLECTIVE INTELLIGENCE AMPLIFICATION, which claims the benefit of U.S. Provisional Application No. 63/449,986, filed Mar. 4, 2023, for METHOD AND SYSTEM FOR “HYPERCHAT” CONVERSATIONS AMONG LARGE NETWORKED POPULATIONS WITH COLLECTIVE INTELLIGENCE AMPLIFICATION, U.S. Provisional Application No. 63/451,614, filed Mar. 12, 2023, for METHOD AND SYSTEM FOR HYPERCHAT CONVERSATIONS ACROSS NETWORKED HUMAN POPULATIONS WITH COLLECTIVE INTELLIGENCE AMPLIFICATION, and U.S. Provisional Application No. 63/456,483, filed Apr. 1, 2023, for METHOD AND SYSTEM FOR HYPERCHAT AND HYPERVIDEO CONVERSATIONS AMONG NETWORKED HUMAN POPULATIONS WITH COLLECTIVE INTELLIGENCE AMPLIFICATION, all of which are incorporated in their entirety herein by reference.

This application is a continuation-in-part of U.S. patent application Ser. No. 18/887,029 filed Sep. 16, 2024, for METHODS AND SYSTEMS FOR ENBALING LARGE-SCALE CONVERSATIONAL DELIBERATIONS AMONG HUMAN GROUPS AND AI-POWERED CONVERSATIONAL AGENTS, which is a continuation-in-part of U.S. patent application Ser. No. 18/367,089 filed Sep. 12, 2023, for METHODS AND SYSTEMS FOR HYPERCHAT AND HYPERVIDEO CONVERSATIONS ACROSS NETWORKED HUMAN POPULATIONS WITH COLLECTIVE INTELLIGENCE AMPLIFICATION, which is a continuation-in-part of U.S. patent application Ser. No. 18/240,286, filed Aug. 30, 2023, for METHODS AND SYSTEMS FOR HYPERCHAT CONVERSATIONS AMONG LARGE NETWORKED POPULATIONS WITH COLLECTIVE INTELLIGENCE AMPLIFICATION, now U.S. Pat. No. 11,949,638, issued on Apr. 2, 2024, which claims the benefit of U.S. Provisional Application No. 63/449,986, filed Mar. 4, 2023, for METHOD AND SYSTEM FOR “HYPERCHAT” CONVERSATIONS AMONG LARGE NETWORKED POPULATIONS WITH COLLECTIVE INTELLIGENCE AMPLIFICATION, which are incorporated in their entirety herein by reference.

U.S. Pat. No. 10,551,999 filed on Oct. 28, 2015, U.S. Pat. No. 10,817,158 filed on Dec. 21, 2018, U.S. Pat. No. 11,360,656 filed on Sep. 17, 2020, and U.S. application Ser. No. 17/744,464 filed on May 13, 2022, the contents of are incorporated by reference herein in their entirety.

### BACKGROUND

### 1. Technical Field

The present description relates generally to computer mediated collaboration, and more specifically to computer mediated collaboration via real-time distributed conversations over computer networks.

### 2. Discussion of the Related Art

Whether interactive human dialog is enabled through text, video, or VR, these tools are often used to enable networked teams and other distributed groups to hold real-time interactive coherent conversation, for example, deliberative conversations, debating issues and reaching decisions, setting priorities, or otherwise collaborating in real-time.

In some aspects, real-time conversations become much less effective as the number of participants increases. Whether conducted through text, voice, video, or VR, it is very difficult to hold a coherent interactive conversation among groups that are larger than 12 to 15 people with some experts suggesting the ideal group size for interactive coherent conversation is 5 to 7 people. This has created a barrier to harnessing the collective intelligence of large groups through real-time interactive coherent conversation.

### SUMMARY

The present disclosure describes systems and methods for enabling real-time conversational dialog (i.e., via text, voice, and video chats) among a large population of networked individuals, while facilitating convergence on groupwise decisions, insights, and solutions. Embodiments of the disclosure include dividing a large user population into a plurality of smaller subgroups that are each sized to enable enhanced information transfer among subgroups that supports fast and effective convergence on optimized solutions for amplifying collective intelligence. An embodiment of the disclosure enables flexibility for the collective intelligence system based on selectable modes of operation. In some cases, synchronous, semi-synchronous, and asynchronous modes of operation may be based on the relative timing of participation among the population of human contributors to the collective intelligence system.

An apparatus, system, and method for large-scale conversational deliberation and amplified collective intelligence are described. One or more aspects of the apparatus, system, and method include a plurality of networked subgroups of users, each subgroup configured for real-time conversational deliberation among its members; a conversational surrogate agent associated with each subgroup, each configured to observe the real-time conversational deliberation among members of its subgroup, pass insights to and receive insights from other conversational surrogate agents associated with other subgroups, and conversationally express insights received from other subgroups to the members of its own subgroup as natural first person dialog; and a conversational contributor agent associated with each subgroup, each configured to participate in local conversation of that subgroup by offering answers, insights, opinions, or factual information that is independently AI generated rather than being derived based on conversational content of human users in other subgroups.

An apparatus, system, and method for large-scale conversational deliberation and amplified collective intelligence are described. One or more aspects of the apparatus, system, and method include a communication structure that divides a large population of users into a plurality of unique subgroups, each configured for real-time conversational deliberation among its members; a conversational surrogate agent assigned to each subgroup, each configured to observe real-time dialog among its members, distill salient insights, pass insights to one or more other subgroups, and conversationally express insights received from other subgroups to members of its own subgroup as natural first person dialog; and one or more conversational contributor agents placed into a plurality of the subgroups of humans, each configured to participate in local conversations of its subgroup independently of observations of other rooms, by suggesting answers or offering insights, opinions, and/or factual information that is primarily AI generated.

An apparatus, system, and method for large-scale conversational deliberation and amplified collective intelligence are described. One or more aspects of the apparatus, system, and method include a communication structure that divides a large population of users into a plurality of unique subgroups, each configured for real-time conversational deliberation among its members; a conversational surrogate agent assigned to each subgroup, each configured to observe real-time conversational deliberation among its members, distill salient insights, pass insights to one or more other subgroups, and conversationally express insights received from other subgroups to members of its own subgroup as natural first person dialog; and a scout agent assigned to a subgroup, each configured to search for and acquire factual information for use in the real-time conversational deliberation in that subgroup and express that factual information to the members of that subgroup in real-time.

A method, apparatus, non-transitory computer readable medium, and system for large-scale conversational deliberation and amplified collective intelligence are described. One or more aspects of the method, apparatus, non-transitory computer readable medium, and system include dividing a large population of users into a plurality of networked subgroups, each configured for real-time conversational deliberation among its members; associating a conversational surrogate agent with each subgroup, each configured to observe the real-time conversational c deliberation among members of its subgroup; passing insights from the conversational surrogate agent of one subgroup to other conversational surrogate agents of other subgroups, and receiving insights from the other conversational surrogate agents of other subgroups; conversationally expressing insights received from other subgroups to the members of a subgroup as natural first person dialog using the conversational surrogate agent associated with that subgroup; and associating a conversational contributor agent with each subgroup, each configured to participate in local conversation of that subgroup by offering answers, insights, opinions, or factual information that is independently AI generated rather than being derived based on conversational content of human users in other subgroups.

A method, apparatus, non-transitory computer readable medium, and system for large-scale conversational deliberation and amplified collective intelligence are described. One or more aspects of the method, apparatus, non-transitory computer readable medium, and system include dividing a large population of users into a plurality of configured for real-time unique subgroups, each conversational deliberation among its members; assigning a conversational surrogate agent to each subgroup, each configured to observe real-time dialog among its members, distill salient insights, pass insights to one or more subgroups, and conversationally express insights received from other subgroups to members of its own subgroup as natural first person dialog; and placing one or more conversational contributor agents into a plurality of the subgroups of humans, each configured to participate in local conversations of its subgroup independently of observations of other rooms, by suggesting answers or offering insights, opinions, and/or factual information that is primarily AI generated.

A method, apparatus, non-transitory computer readable medium, and system for large-scale conversational deliberation and amplified collective intelligence are described. One or more aspects of the method, apparatus, non-transitory computer readable medium, and system include dividing a large population of users into a plurality of unique subgroups, each configured for real-time conversational deliberation among its members; assigning a conversational surrogate agent to each subgroup, each configured to observe real-time dialog among its members, distill salient insights, pass insights to one or more other subgroups, and conversationally express insights received from other subgroups to members of its own subgroup as natural first person dialog; and assigning a scout agent to each subgroup, each configured to search for and acquire factual information for use in the real-time conversational deliberation in that subgroup and express that factual information conversationally to members of that subgroup in real-time.

A method, apparatus, non-transitory computer readable medium, and system for asynchronous conversational deliberation among a population of human participants are described. One or more aspects of the method, apparatus, non-transitory computer readable medium, and system include providing a collaboration server connected to a memory containing a representation of conversational content that was previously captured from a plurality of prior human participants, the representation associated with each prior participant including at least one stored idea, insight, view, or assertion expressed by that prior participant and at least one associated numerical measure of sentiment, conviction, confidence, or support; running an asynchronous conversation application on each of a plurality of networked computing devices, each computing device in communication with the collaboration server and each computing device associated with one of a plurality of new human participants; and enabling an asynchronous conversational process in which each of the plurality of new human participants engages in real-time dialog with a Conversational Surrogate Agent displayed by their associated computing device, each Conversational Surrogate configured to express to at least one new participant, at least one stored idea, insight, view, or assertion associated with at least one prior participant.

An apparatus, system, and method for asynchronous conversational deliberation among a population of human participants are described. One or more aspects of the apparatus, system, and method include a collaboration server connected to a memory, the memory containing a representation of conversational content previously captured from a plurality of prior human participants, the representation associated with each prior participant including at least one stored idea, insight, view, or assertion expressed by that prior participant and at least one associated numerical measure of sentiment, conviction, confidence, or support; a plurality of networked computing devices, each computing device in communication with the collaboration server and associated with one of a plurality of new human participants, each computing device running an asynchronous conversation application; and a plurality of Conversational Surrogate Agents, each displayed by an associated computing device, each Conversational Surrogate Agent configured to engage in real-time dialog with at least one new human participant and to express at least one stored idea, insight, view, or assertion associated with at least one prior participant.

An apparatus, system, and method for facilitating collective superintelligence among a large population of networked users each belonging to at least one of a plurality of subgroups are described. One or more aspects method include a of the apparatus, system, and conversational surrogate agent (AI agent) assigned to each subgroup, wherein the AI agent is configured to: observe and distill insights from the conversation among the users of its assigned subgroup, assess numerical measures of conviction, confidence, and sentiment associated with each insight, store the observed insights and associated numerical measures in a memory, pass the observed insights and associated numerical measures having been stored to another AI agent, receive insights and associated numerical measures from the other AI agent, express, through conversational dialog, received insights from the other AI agents assigned subgroup using first-person language modulated based on the strength of the numerical measures; a central server configured to coordinate asynchronous transmission and reception of insights among the AI agents based on predefined heuristics, wherein the heuristics determine insights are to be transmitted from a subgroup, and which subgroups are to receive the transmitted insights; and a feedback mechanism enabling users within a subgroup to provide conversational responses to received insights, wherein the responses are aggregated and used to modulate the strength of the language used by the AI agents in passing insights.

A method, apparatus, non-transitory computer readable medium, and system for facilitating collective superintelligence among a large population of networked users each belonging to at least one of a plurality of subgroups are described. One or more aspects of the method, apparatus, non-transitory computer readable medium, and system include assigning a conversational surrogate agent (AI agent) to each subgroup; observing and distilling insights from the conversation among the users of each assigned subgroup using the AI agent; assessing numerical measures of confidence, conviction, and sentiment associated with each insight using the AI agent; storing the observed insights and associated numerical measures in a memory; passing the observed insights and associated numerical measures having been stored to another AI agent; receiving insights and associated numerical measures from the other AI agent; expressing, through conversational dialog, received insights from the other AI agent's assigned subgroup using first-person language modulated based on the strength of the numerical measures; coordinating asynchronous transmission and reception of insights among the subgroups using a central server based on predefined heuristics, wherein the heuristics determine which insights are to be transmitted from a subgroup, and which subgroups are to receive the transmitted insights; and enabling users within a subgroup to provide responses to received insights through a conversational feedback mechanism, wherein the responses are aggregated and used to modulate the strength of the language used by the AI agent in passing insights.

### BRIEF DESCRIPTION OF THE DRAWINGS

FIG. 1 shows an example of a collaboration system according to aspects of the present disclosure.

FIG. 2 shows an example of a collaboration process according to aspects of the present disclosure.

FIGS. 3 through 4 show examples of a HyperChat process according to aspects of the present disclosure.

FIGS. 5 through 6 show examples of an interaction process according to aspects of the present disclosure.

FIG. 7 shows an example of a flowchart for computer mediated collaboration according to aspects of the present disclosure.

FIGS. 8 through 9 show examples of a video based HyperChat process according to aspects of the present disclosure.

FIG. 10 shows an example of a collaboration server according to aspects of the present disclosure.

FIG. 11 shows an example of a computing device according to aspects of the present disclosure.

FIGS. 12 through 18 show examples of methods for computer mediated collaboration according to aspects of the present disclosure.

FIG. 19 shows an example of a system for real-time analysis, and insight communication, conversation extraction according to aspects of the present disclosure.

FIGS. 20 through 24 show examples of a network architecture according to aspects of the present disclosure.

FIG. 25 shows an example of a system according to aspects of the present disclosure.

FIG. 26 shows an example of a system of an embodied large-scale personified collective intelligence according to aspects of the present disclosure.

FIGS. 27 through 29 show examples of a network architecture according to aspects of the present disclosure.

FIGS. 30-32 show example methods for large-scale conversational deliberation and amplified collective intelligence, according to aspects of the present disclosure.

FIG. 33 shows an example of a method for asynchronous conversational deliberation among a population of human participants, according to aspects of the present disclosure.

FIGS. 34 through 35 show examples of methods for facilitating collective superintelligence among a large population of networked users, according to aspects of the present disclosure.

### DETAILED DESCRIPTION

Networking technologies enable groups of distributed individuals to hold real-time conversations online through text chat, voice chat, video chat, or virtual reality (VR) chat.

In the field of Collective Intelligence, research has shown that more accurate decisions, priorities, insights, and forecasts can be generated by aggregating the input of very large groups.

However, there is a significant need for inventive interactive solutions can that enable real-time deliberative conversations among large groups of networked users via text, voice, video, or virtual avatars. For example, enabling large groups (e.g., such as groups as large as 50, 500, and 5000 distributed users) to engage in coherent and meaningful deliberative conversations would have significant collaborative benefits for large human teams and organizations, including the ability to amplify their collective intelligence.

The present disclosure describes systems and methods for enabling conversational dialog (i.e., via text, voice, and video chats) among a large population of networked individuals, while facilitating convergence on groupwise decisions, insights, and solutions. Embodiments of the disclosure are configured to perform emerging forms of language-based communication that include dividing a large user population into a plurality of smaller subgroups to enable coherent conversations among each of the plurality of users in parallel with other subgroups. In some cases, an artificial intelligence agent enables exchange of conversational content among different subgroups to facilitate the propagation of conversational content across the population which enables generation of valuable insights across the subgroups.

One or more embodiments of the present disclosure include systems (e.g., computational architectures) that enable information to propagate efficiently across large groups, as well as enable subgroups to use the insights from other subgroups as well as reliable external resources. For example, an artificial intelligence agent may be configured to participate in the HyperChat process by offering insights or suggestions to the conversation at defined time intervals. Additionally, an embodiment of the present disclosure is configured to customize and/or define the AI agent such that the AI agent is able to scientifically and/or factually support insights related to the topic being discussed in the conversation.

Conventional computer networking technologies enable groups of distributed individuals to hold conversations online through text chat, voice chat, video chat, or in 3D immersive meeting environments via avatars that convey voice information and provide facial expression information and body gestural information. Accordingly, such environments are increasingly prevalent methods for distributed groups to meet in real-time and hold conversations. This enables teams to debate issues, reach decisions, make plans, or converge on solutions. In some cases, such real-time communication technologies may be used for conversations among small, distributed groups. However, real-time communication becomes increasingly difficult as the number of users/participants increases.

In some cases, holding a real-time conversation (through text, voice, video, or immersive avatar) among groups that are large (e.g., larger than 4 to 7 people) is difficult and the discussion degrades rapidly as the group size increases further (e.g., groups with more than 10 to 12 people). Moreover, in cases of asynchronous communications, existing methods are unable to transmit insights from one group to another. Therefore, there is a need to enable distributed conversations among large groups of networked users via text, voice, video, or immersive avatars. For example, embodiments of the present disclosure enable large groups (i.e., comprising 200, 2000, 20,000 or even distributed 2,000,000 users) to engage in conversational interactions that can lead to a unified and coherent result. Additionally, embodiments describe systems and methods that may be able to engage such large populations to harness and amplify the combined collective intelligence.

In some cases, it may be challenging to extend such systems to voice or video chat among sub-groups. For instance, according to the present disclosure, in case of voice and video implementations, handling of timing aspects is possible (and important) as there may be multiple people talking at the same time (e.g., because the people are divided into subgroups and a small number of people share a sub-group). Thus, the present disclosure describes a method using a memory and AI agents that may be employed to exchange conversational information among subgroups.

Embodiments of the present disclosure can be deployed across a wide range of networked conversational environments (e.g., from text chatrooms (deployed using textual dialog), to video conference rooms (deployed using verbal dialog and live video), to immersive “metaverse” conference rooms (deployed using verbal dialog and simulated avatars), etc.

One or more embodiments of the present disclosure are configured to enhance information transfer among subgroups to support faster and more effective convergence on optimized solutions that amplify collective intelligence. In some cases, a method is provided based on which a large population of users can hold a single unified conversation via a communication structure that divides the population into a plurality of small subgroups.

For example, a small subgroup is well suited for coherent deliberative conversation (such as a subgroup with less than 8 people). Each of the subgroups are assigned to an artificial agent (i.e., an artificial intelligence (AI) agent) that observes the real-time dialog among human users within the subgroup and injects insights to the subgroup at time intervals that may be determined based on the accuracy and supportability of the injection. The AI agents are Conversational Contributor Agents that are based on a large language model (LLM) and may have a unique profile based on the topic of the conversation. Additionally, in some cases, the Conversational Contributor Agents may be configured to advocate or oppose a particular position which enables an instigation of a wide range of reactions among the human users as a means of assessing the support for or resistance to the particular position.

According to an embodiment, an additional AI agent may be assigned in a subgroup that may be configured to monitor the conversation of the subgroup. The additional AI agents are Scout Agents that may be able to provide additional reference information to the subgroup in case the conversation drifts to a topic that may have not been foreseen at the beginning of the HyperChat process. In some cases, the Scout Agent may be configured to use additional external resources (e.g., the Internet) to acquire information for use in the subgroup. In some cases, the Scout Agent may transmit the acquired information to the Conversational Contributor Agent that may be configured to conversationally inject the contextual information received from the Scout Agent into the discussion.

Accordingly, by including a Conversational Contributor Agent to each subgroup of the plurality of subgroups, embodiments of the present disclosure are able to enhance incorporation of AI generated informational content into the conversation among the human participants. Additionally, embodiments of the present disclosure are able to identify the incorporated content that are accepted by the subgroup based on computing a statistical value. In some cases, the content that is satisfactorily accepted by a subgroup may be transmitted to other subgroups resulting in further increase in the intelligence of the overall system.

An embodiment of the present disclosure is configured to further enhance the flexibility of operation of the HyperChat system. In some examples, a human moderator or an administrator may be configured to select a mode of operation when coordinating sessions among human users. In some cases, the HyperChat system may be operated in selectable modes of operation, i.e., synchronous mode, semi-synchronous mode, and asynchronous mode. For example, in case of the synchronous mode, embodiments may enable participation of the human users to the HyperChat process at substantially the same time. For example, in case of the semi-synchronous mode, embodiments may enable participation of the human users to the HyperChat process in a sequential series of batches while developing the ideas of each subgroup based on exchange of informational content between subgroups. For example, in case of the asynchronous mode, embodiments may enable participation of the human users with the AI agents that may provide the insights captured from other users.

The following description is not to be taken in a limiting sense, but is made merely for the purpose of describing the general principles of exemplary embodiments. The scope of the invention should be determined with reference to the claims.

The terms “Surrogates”, “Surrogate Agents”, and “Conversational Surrogate Agents” refer to the same entity and have been used interchangeably throughout the specification. Additionally, the terms “Subgroup”, “Group”, and “ChatRoom” refer to the same entity and have been used interchangeably throughout the specification. The terms “Global Observer Agent”, “Global Agent”, “Global Conversational Agent”, “Conversational Observer Agent”, and “Observer Agent” refer to the same entity and have been used interchangeably throughout the specification.

Reference throughout this specification to “one embodiment,” “an embodiment,” or similar language means that a particular feature, structure, or characteristic described in connection with the embodiment is included in at least one embodiment of the present description. Thus, appearances of the phrases “in one embodiment,” “in an embodiment,” and similar language throughout this specification may, but do not necessarily, all refer to the same embodiment.

Furthermore, the described features, structures, or characteristics of the description may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the description. One skilled in the relevant art will recognize, however, that the teachings of the present description can be practiced without one or more of the specific details, or with other methods, components, materials, and so forth. In other instances, well-known structures, materials, or operations are not shown or described in detail to avoid obscuring aspects of the description.

### A Collaboration System

As disclosed herein, the HyperChat system may enable a large population of distributed users to engage in real-time textual, audio, or video conversations. According to some aspects of the present disclosure, individual users may engage with a small number of other participants (e.g., referred to herein as a sub-group), thereby enabling coherent and in manageable conversations online environments. Moreover, aspects of the present disclosure enable exchange of conversational information between subgroups using AI agents (e.g., and thus may propagate conversational information efficiently across the population). Accordingly, members of individual subgroups can benefit from the knowledge, wisdom, insights, and intuitions of other sub-groups and the entire population is enabled to gradually converge on collaborative insights that leverage the collective intelligence of the large population. Additionally, methods and systems are disclosed for discussing the divergent viewpoints that are surfaced globally (i.e., insights of the entire population), thereby presenting the most divisive narratives to subgroups to foster global discussion around key points of disagreement.

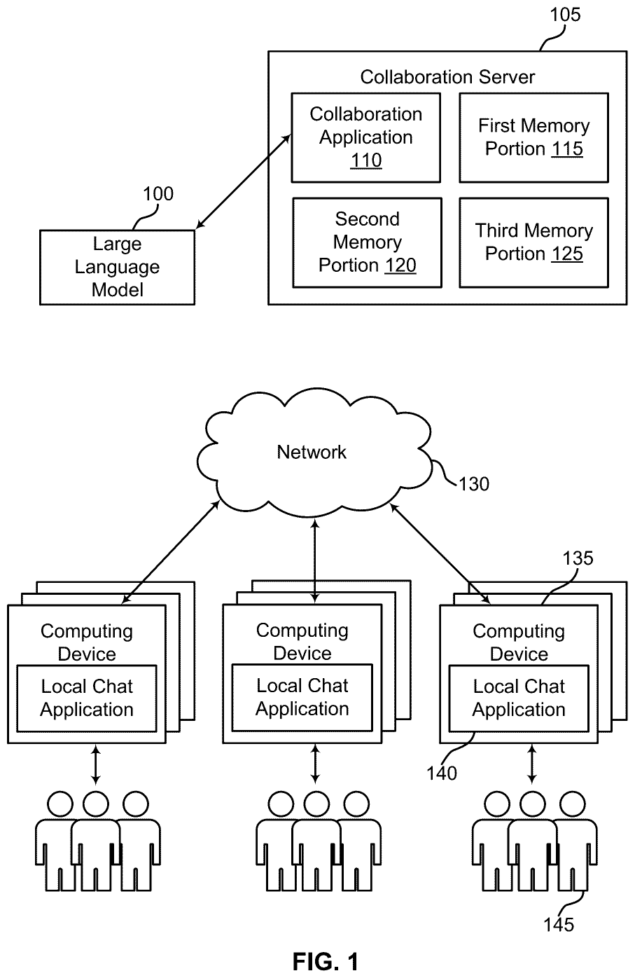

FIG. 1 shows an example of a collaboration system according to aspects of the present disclosure. The example shown includes large language model 100, collaboration server 105, network 130, a plurality of computing devices 135, and a plurality of individual users 145.

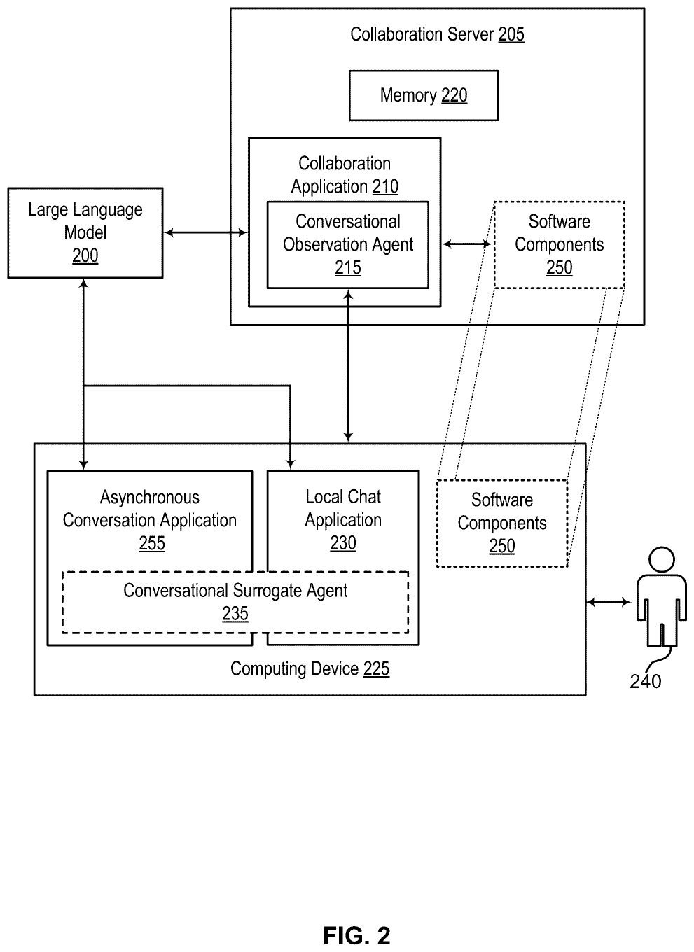

In an example, a large group of users 145 enter the collaboration system. In the example shown in FIG. 1, nine users may enter the system. However, embodiments are not limited thereto, and large groups of users (e.g., 100 users, 500 users, 5000 users, etc.) may enter the system. In some examples, the collaboration server 105 divides 100 users into sub-groups (e.g., 20 sub-groups of 5 users each for 100 users). User 145 is an example of, or includes aspects of, the corresponding element described with reference to FIGS. 2-6.

In some examples, each user 145 may experience a traditional chat room with four other users 145. The user 145 sees the names of the four other users 145 in the sub-group. The collaboration server 105 mediates a conversation with the five users and ensures that the users see the comments from each other. Thus, each user participates in a real-time conversation with the remaining four users in the chat room (i.e., sub-group). According to the example, the collaboration server 105 performs the process in parallel with the 19 other sub-groups. However, the users 145 are not able to see the conversations happening in the 19 other chat rooms.

According to some aspects, collaboration server 105 performs a collaboration application 110, i.e., the collaboration server 105 uses collaboration application 110 for communication with the set of the networked computing devices 135, and each computing device 135 is associated with one member of the population of human participants (e.g., a user 145). Additionally, the collaboration server 105 defines a set of sub-groups of the population of human participants.

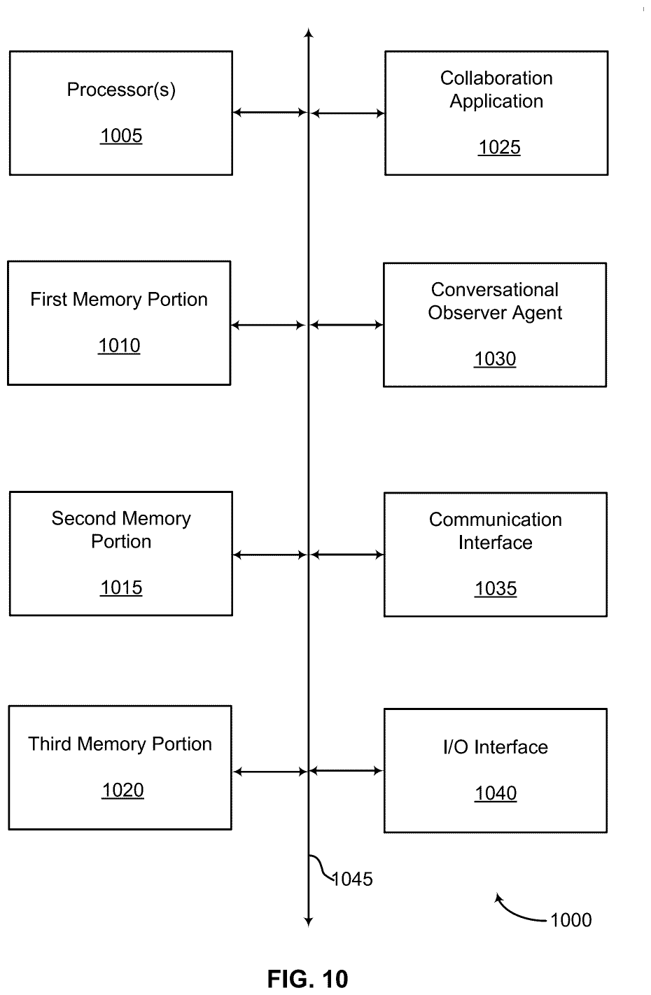

In some cases, the collaboration server 105 keeps track of the chat conversations separately in a memory. The memory in the collaboration server 105 includes a first memory portion 115, a second memory portion 120, and a third memory portion 125. First memory portion 115, second memory portion 120, and third memory portion 125 are examples of, or include aspects of, the corresponding element described with reference to FIG. 10.

Collaboration server 105 keeps track of the chat conversations separately so that the chat conversations can be separated from each other. The collaboration server 105 periodically sends chunks of each separate chat conversation to a Large Language Model 100 (LLM, for example, ChatGPT from OpenAI) via an Application Programming Interface (API) for processing and receives a summary from the LLM 100 that is associated with the particular sub-group. The collaboration server 105 keeps track of each conversation (via the software observer agent) and generates summaries using the LLM (via API calls).

Collaboration server 105 provides one or more functions to users 145 linked by way of one or more of the various networks 130. In some cases, the collaboration server 105 includes a single microprocessor board, which includes a microprocessor responsible for controlling aspects of the collaboration server 105. In some cases, a collaboration server 105 uses a microprocessor and protocols to exchange data with other devices/users 145 on one or more of the networks 130 via hypertext transfer protocol (HTTP), and simple mail transfer protocol (SMTP), although other protocols such as file transfer protocol (FTP), and simple network 130 management protocol (SNMP) may also be used. In some cases, a collaboration server 105 is configured to send and receive hypertext markup language (HTML) formatted files (e.g., for displaying web pages). In various embodiments, a collaboration server 105 comprises a general purpose computing device 135, a personal computer, a laptop computer, a mainframe computer, a super computer, or any other suitable processing apparatus.

In some examples, collaboration application 110 (e.g., and/or large language model 100) may implement natural language processing (NLP) techniques. NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks 130 or statistical models which make soft, probabilistic decisions based on attaching real-valued weights to input features. These models can express the relative probability of multiple answers.

In some examples, large language model 100 (e.g., and/or implementation of large language model 100 via collaboration application 110) may be an example of, or implement aspects of, a neural processing unit (NPU). A NPU is a microprocessor that specializes in the acceleration of machine learning algorithms. For example, an NPU may operate on predictive models such as artificial neural networks 130 (ANNs) or random forests (RFs). In some cases, an NPU is designed in a way that makes it unsuitable for general purpose computing such as that performed by a Central Processing Unit (CPU). Additionally, or alternatively, the software support for an NPU may not be developed for general purpose computing. Large language model 100 is an example of, or includes aspects of, the corresponding element described with reference to FIG. 2.

According to some aspects, large language model 100 processes the first conversational summary, the second conversational summary, and the third conversational summary using the large language model 100 to generate a global conversational summary expressed in conversational form. In some examples, large language model 100 sends the global conversational summary expressed in conversational form to each of the members of the first sub-group, the second sub-group, and the third sub-group. In some examples, large language model 100 may include aspects of an artificial neural network 130 (ANN). Large language model 100 is an example of, or includes aspects of, the corresponding element described with reference to FIG. 2.

An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some examples, a computing device 135 is a personal computer, laptop computer, mainframe computer, palmtop computer, personal assistant, mobile device, or any other suitable processing apparatus. Computing device 135 is an example of, or includes aspects of, the corresponding element described with reference to FIGS. 2, 5, and 11. In certain aspects, computing device 135 includes local chat application 140. According to some aspects, a local chat application 140 is provided on each networked computing device 135.

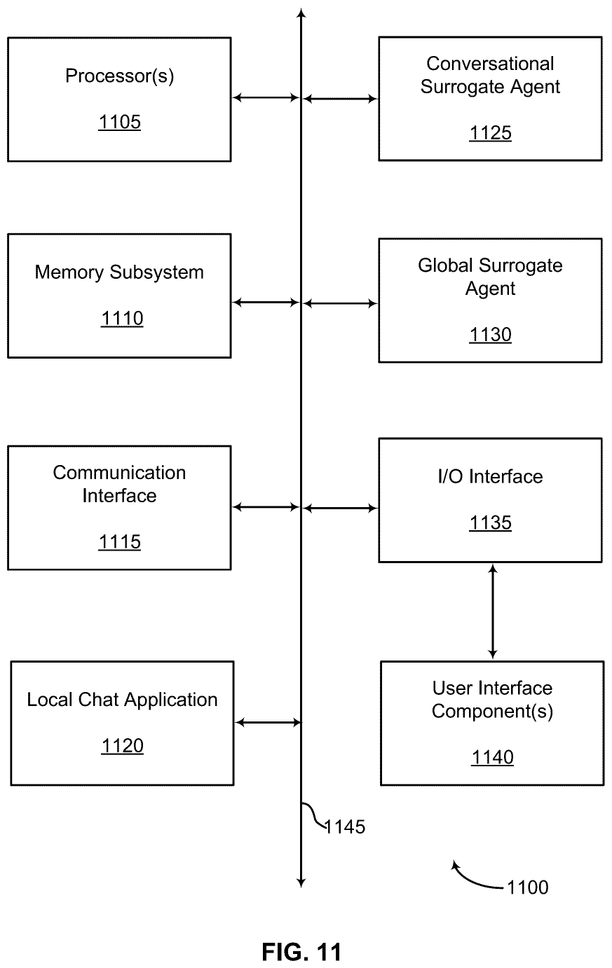

The local chat application 140 may be configured for displaying a conversational prompt received from the collaboration server 105 (via network 130 and computing device 135), and for enabling real-time chat communication of a user with other users in a sub-group assigned by the collaboration server 105, the real-time chat communication including sending chat input collected from the one user associated with the networked computing device 135 and other users of the assigned sub-group. Local chat application 140 is an example of, or includes aspects of, the corresponding element described with reference to FIGS. 2 and 11.

Network 130 facilitates the transfer of information between computing device 135 and collaboration server 105. Network 130 may be referred to as a “cloud”. Network 130 (e.g., cloud) is a computer network configured to provide on-demand availability of computer system resources, such as data storage and computing power. In some examples, the network 130 provides resources without active management by the user 145. The term network 130 (e.g., or cloud) is sometimes used to describe data centers available to many users 145 over the Internet. Some large networks 130 have functions distributed over multiple locations from central servers. A server is designated an edge server if it has a direct or close connection to a user 145. In some cases, a network 130 (e.g., or cloud) is limited to a single organization. In other examples, the network 130 (e.g., or cloud) is available to many organizations. In one example, a network 130 includes a multi-layer communications network 130 comprising multiple edge routers and core routers. In another example, a network 130 is based on a local collection of switches in a single physical location.

According to some aspects, network architecture 130 provides a collaboration server 105 connected to a memory containing a representation of conversational content that was previously captured from a set of prior human participants, the representation associated with each prior participant including at least one stored idea, insight, view, or assertion expressed by that prior participant and at least one associated numerical measure of sentiment, conviction, confidence, or support. Network architecture 130 is an example of, or includes aspects of, the corresponding element described with reference to FIGS. 2, 19-24, and 27-29.

In some aspects, one or more components of FIG. 1 (e.g., collaboration server 105, network 130, computing device 135, etc.) may implement or include a database to perform one or more of the operations and functions described herein. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user 145 interacts with database controller. In other cases, database controller may operate automatically without user 145 interaction.

FIG. 2 shows an example of a collaboration process according to aspects of the present disclosure. The example shown includes large language model 200, collaboration server 205, computing device 225, user 240, and software components 250.

In some cases, large language models (LLMs) (e.g., such as LLM 200 in the example of FIG. 2) are artificial intelligence systems, for example, trained on vast amounts of text data to understand and generate human-like text. The models may utilize deep learning techniques to analyze and generate coherent and contextually relevant responses to text inputs. Large language models have a wide range of applications, including natural language understanding, text generation, translation, summarization, etc.

In some cases, LLM 200 is able to identify unique chat messages within complex blocks of dialog while assessing or identifying responses that refer to a particular point. In some cases, LLM 200 can capture the flow of the conversation (e.g., the speakers, content of the conversation, other speakers who disagreed, agreed, or argued, etc.) from the block dialog. In some cases, LLM 200 can provide the conversational context, e.g., blocks of dialog that capture the order and timing in which the chat responses flow.

In some aspects, LLM 200 is configured to generate the dialog used to express a stored idea, insight, view, or assertion based on the at least one stored numerical measure of sentiment, conviction, confidence, or support. In some aspects, the at least one numerical measure of sentiment, conviction, confidence, or support is generated at least in part by a large language model that assesses dialog expressed by at least one of the set of new participants. In some aspects, the at least one numerical measure of sentiment, conviction, confidence, or support is generated at least in part based on a facial expression or vocal inflection of the at least one new participant. Large language model 200 is an example of, or includes aspects of, the corresponding element described with reference to FIGS. 1, 26, 27, and 29.

According to some aspects, collaboration server 205 runs a collaboration application 210, and the collaboration server 205 is in communication with the set of the networked computing devices 225 (e.g., where each computing device 225 is associated with one member of the population of human participants, the collaboration server 205 defining a set of sub-groups the of population of human participants).

In some aspects, the representation of conversational content associated with each of a set of prior participants references at least one solution to a problem presented to each participant and at least one reason in support or opposition of the solution.

According to some aspects, collaboration server 205 is connected to a memory, the memory containing a representation of conversational content previously captured from a plurality of prior human participants, the representation associated with each prior participant including at least one stored idea, insight, view, or assertion expressed by that prior participant and at least one associated numerical measure of sentiment, conviction, confidence, or support. In some aspects, the collaboration server 205 is further configured to periodically update the representation of conversational content based on new inputs from the set of new human participants. In some aspects, the collaboration server 205 is further configured to analyze the conversational content to identify emerging trends or consensus among the human participants. In some aspects, the collaboration server 205 is further configured to facilitate the exchange of conversational content between different subgroups of new human participants. In some aspects, the collaboration server 205 is further configured to generate reports or visualizations based on aggregated conversational content and the associated numerical measures of sentiment, conviction, confidence, or support.

Collaboration server 205 is an example of, or includes aspects of, the corresponding element described with reference to FIGS. 1, 10, and 27. In certain aspects, collaboration server 205 includes collaboration application 210 and memory 220.

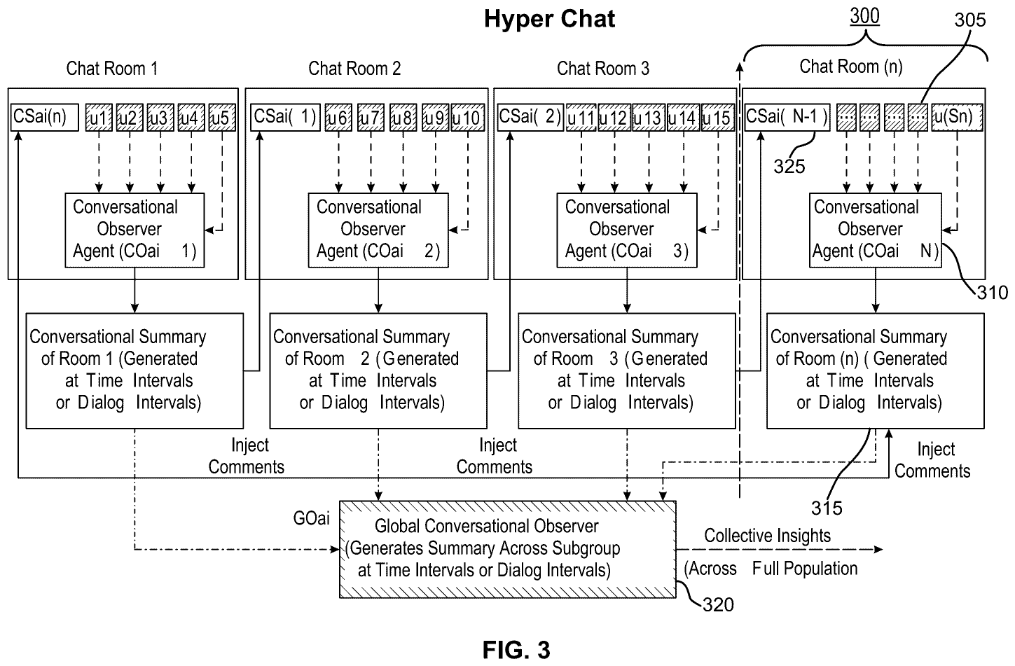

In certain aspects, collaboration application 210 includes conversational observation agent 215. In certain aspects, collaboration application 210 includes (e.g., or implements) software components 250. In some cases, conversational observation agent 215 is an AI-based model that observes the real-time conversational content within one or more of the sub-groups and passes a representation of the information between the sub-groups to not lose the benefit of the broad knowledge and insight across the full population. In some cases, conversational observation agent 215 keeps track of each conversation separately and sends chat conversation chunks (via an API) to LLM 200 for processing (e.g., summarization). Collaboration application 210 is an example of, or includes aspects of, the corresponding element described with reference to FIGS. 1 and 10. Conversational observation agent 215 is an example of, or includes aspects of, the corresponding element described with reference to FIGS. 3, 4, 6, 9, and 10.

Examples of memory 220 (e.g., first memory portion, second memory portion, third memory portion as described in FIG. 1) may include random access memory 220 (RAM), read-only memory 220 (ROM), or a hard disk. Examples of memory 220 devices include solid state memory and a hard disk drive. In some examples, memory 220 (e.g., first memory portion, second memory portion, third memory portion) is used to store computer-readable, computer-executable software including instructions that, when executed, cause a processor to perform various functions described herein. In some cases, the memory 220 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory 220 store information in the form of a logical state.

According to some aspects, computing device 225 runs an asynchronous conversation application 255 on each of a set of networked computing devices 225, each computing device 225 in communication with the collaboration server 205 and each computing device 225 is associated with one of a set of new human participants. In some aspects, the set of networked computing devices 225 running an asynchronous conversation application 255 may not all be connected to the collaboration server 205 at the same time.

According to some aspects, computing device 225 is in communication with the collaboration server 205 and associated with one of a plurality of new human participants, each computing device 225 running an asynchronous conversation application 255.

In some aspects, each networked computing device 225 includes a user interface that displays a summary of the most relevant insights and associated numerical measures to the users 240 within the subgroup.

In some aspects, each networked computing device 225 includes a user interface that displays a summary of the most relevant insights and associated numerical measures to the users within the subgroup.

Computing device 225 is a networked computing device that facilitates the transfer of information between local chat application 230 and collaboration server 205.

Computing device 225 is an example of, or includes aspects of, the corresponding element described with reference to FIGS. 1, 5, 11, 19, 25-27, and 29. In certain aspects, computing device 225 includes local chat application 230.

According to some aspects, local chat application 230 is provided on each networked computing device 225, the local chat application 230 may be configured for displaying a conversational prompt received from the collaboration server 205, and for enabling real-time chat communication with other members of a sub-group assigned by the collaboration server 205, the real-time chat communication including sending chat input collected from the one member associated with the networked computing device 225 to other members of the assigned sub-group. Local chat application 230 is an example of, or includes aspects of, the corresponding element described with reference to FIGS. 1 and 11. In certain aspects, local chat application 230 includes conversational surrogate agent 235. In certain aspects, local chat application 230 includes (e.g., or implements) software components 250.

In some aspects, conversational surrogate agent 235 is a simulated (i.e., artificial, fake, etc.) user in each sub-group that conversationally expresses a representation of the information contained in the summary from a different sub-group.

In some aspects, the Conversational Surrogate Agent 235 expresses dialog that is generated at least in part by a Large Language Model 200 provided with at least one stored idea, insight, view, or assertion associated with at least one prior participant. In some aspects, the Conversational Surrogate Agent 235 expresses the dialog in the first person to the at least one new participant. In some aspects, the at least one idea, insight, view, or assertion expressed to the at least one new participant is selected from a set of stored ideas, insights, views, or assertions by an intelligent heuristic process, the intelligent process configured to challenge the at least one new participant with conversational content that has not yet been discussed by the at least one new participant during the dialog.

In some aspects, the Conversational Surrogate Agent 235 is configured to modulate its simulated emotion when expressing a stored idea, insight, view, or assertion based on a stored numerical measure of sentiment, conviction, confidence, or support. In some aspects, the simulated emotion includes a vocal inflection. In some aspects, the simulated emotion includes facial expression. In some aspects, the Conversational Surrogate Agent 235 is displayed as an animated avatar on the computing device 225. In some aspects, the at least one stored idea, insight, view, or assertion that is associated with at least one prior participant is an aggregation across a set of prior participants and represents a collective intelligence. In some aspects, the aggregation is a weighted aggregation based at least on part on a set of stored numerical measures of sentiment, conviction, confidence, or support.

In some aspects, each of the set of different Conversational Surrogate Agents 235 is represented by a different animated graphical avatar on the associated computing device 225. In some aspects, each of the Conversational Surrogate Agents 235 is also configured to express conversationally to at least one new participant, at least one stored idea, insight, view, or assertion captured and stored from at least one other new participant.

According to some aspects, conversational surrogate agent 235 comprises a set of Conversational Surrogate Agents, each displayed by an associated computing device 225, each Conversational Surrogate Agent 235 configured to engage in real-time dialog with at least one new human participant and to express at least one stored idea, insight, view, or assertion associated with at least one prior participant. In some aspects, each Conversational Surrogate Agent 235 is further configured to adapt its dialog based on the real-time sentiment, conviction, confidence, or support expressed by the new human participant. In some aspects, each Conversational Surrogate Agent 235 is further configured to provide contextual information or statistical information related to the stored ideas, insights, views, or assertions.

According to some aspects, conversational surrogate agent 235 is an AI agent assigned to each subgroup, wherein the AI agent is configured to: observe and distill insights from the conversation among the users 240 of its assigned measures of conviction, subgroup, assess numerical confidence, and sentiment associated with each insight, store the observed insights and associated numerical measures in a memory, pass the observed insights and associated numerical measures having been stored to another AI agent, receive insights and associated numerical measures from the other AI agent, express, through conversational dialog, received insights from the other AI agents assigned subgroup using first-person language modulated based on the strength of the numerical measures.

In some aspects, each AI agent is further configured to adapt its dialog based on real-time sentiment analysis of the users' responses within its assigned subgroup. In some aspects, each AI agent is further configured to provide contextual information or statistical information related to the observed insights. In some aspects, each AI Agent is further configured to express received insights using multimedia elements such as text, audio, and video to enhance user 240 engagement.

According to some aspects, conversational surrogate agent 235 observes and distills insights from the conversation among the users 240 of each assigned subgroup using the AI agent. In some examples, conversational surrogate agent 235 assesses numerical measures of conviction, confidence, and sentiment associated with each insight using the agent. AI In some examples, conversational surrogate agent 235 stores the observed insights and associated numerical measures in a memory. In some examples, conversational surrogate agent 235 passes the observed insights and associated numerical measures having been stored to another AI agent. In some examples, conversational surrogate agent 235 receives insights and associated numerical measures from the other AI agent. In some examples, conversational surrogate agent 235 expresses, through conversational dialog, received insights from the other AI agent's assigned subgroup using first-person language modulated based on the strength of the numerical measures.

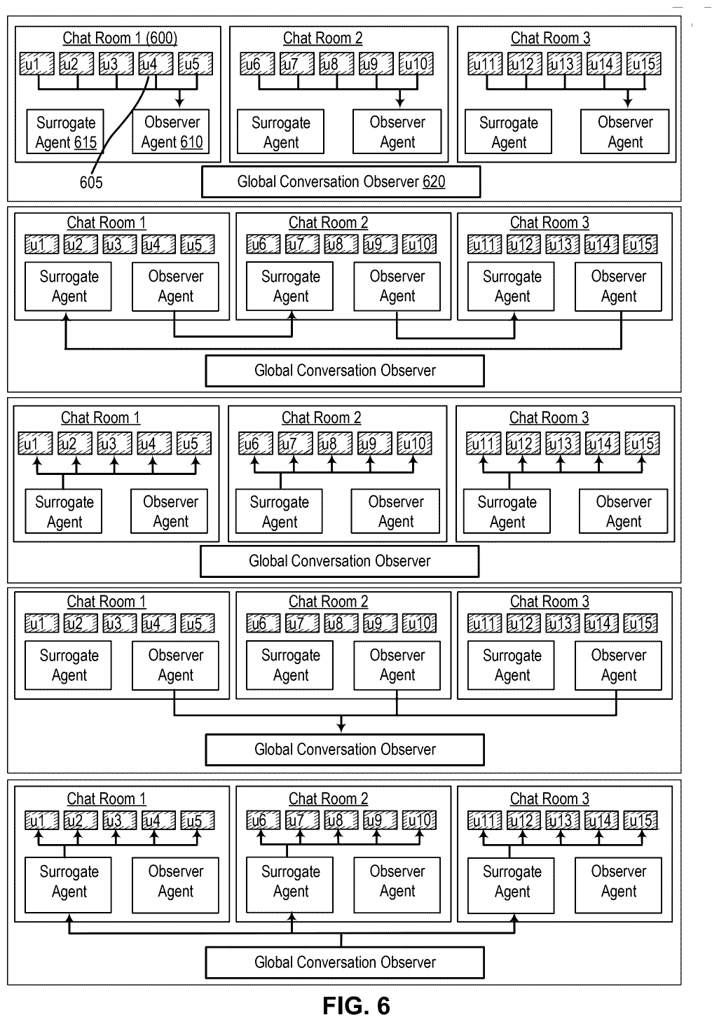

In some aspects, each AI Agent is further configured to adapt its dialog based on real-time sentiment analysis of the users' responses within its assigned subgroup. In some aspects, each AI agent is further configured to provide contextual information or statistical information related to the observed insights. Conversational surrogate agent 235 is an example of, or includes aspects of, the corresponding element described with reference to FIGS. 6, 8, 9, 11, and 34-35.

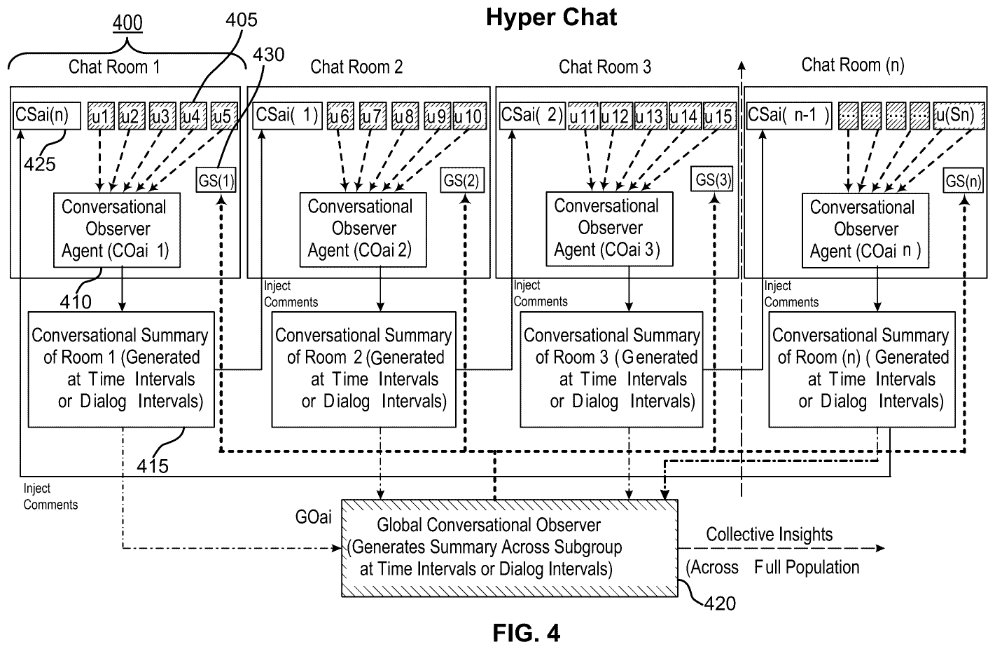

In certain aspects, local chat application 230 includes a conversational instigator agent and a global surrogate agent. In some aspects, conversational instigator agent is a fake user in each sub-group that is designed to stoke conversation within subgroups in which members are not being sufficiently detailed in their rationale for the supported positions. In some aspects, a global surrogate agent is a fake user in each sub-group that selectively represents the views, arguments, and narratives that have been observed across the full population during a recent time period (e.g., custom tailor representation for the subgroup based on the subgroup's interactive dialog among members). Conversational instigator agent and Global surrogate agent are examples of, or include aspects of, the corresponding element described with reference to FIG. 4.

As described herein, software components 250 may be executed by the collaboration server 205 and the local chat application 230 for enabling operations and functions described herein, through communication between the collaboration application 210 (running on the collaboration server 205) and the local chat applications 230 running on each of the plurality of networked computing devices 225. For instance, collaboration server 205 and computing device 225 may include software components 225 that perform one or more of the operations and functions described herein. Generally, software components may include software executed via collaboration server 205, software components may include software executed via computing device 225, and/or software executed via both collaboration server 205 and computing device 225. In some aspects, collaboration application 210 and local chat application 230 may each be examples of software components 250. Generally, software components 250 may be executed to enable methods 1200-1800 described in more detail herein.

For instance, software components 250 enable, through communication between the collaboration application 210 running on the collaboration server 205 and the local chat applications 230 running on each of the set of networked computing devices 225, the following steps: (a) sending the conversational prompt to the set of networked computing devices 225, the conversational prompt including a question to be collaboratively discussed by the population of human participants, (b) presenting, substantially simultaneously, representation of the conversational prompt to each member of the population of human participants on a display of the computing device 225 associated with that member, (c) dividing the population of human participants into a first sub-group consisting of a first unique portion of the population, a second sub-group consisting of a second unique portion of the population, and a third sub-group consisting of a third unique portion of the population, where the first unique portion consists of a first set of members of the population of human participants, the second unique portion consists of a second set of members of the population of human participants and the third unique portion consists of a third set of members of the population of human participants, (d) collecting and storing a first conversational dialogue in a first memory portion at the collaboration server 205 from members of the population of human participants in the first sub-group during an interval via a user 240 interface on the computing device 225 associated with each member of the population of human participants in the first sub-group, (e) collecting and storing a second conversational dialogue in a second memory portion at the collaboration server 205 from members of the population of human participants in the second sub-group during the interval via a user 240 interface on the computing device 225 associated with each member of the population of human participants in the second sub-group, (f) collecting and storing a third conversational dialogue in a third memory portion at the collaboration server 205 from members of the population of human participants in the third sub-group during the interval via a user 240 interface on the computing device 225 associated with each member of the population of human participants in the third sub-group, (g) processing the first conversational dialogue at the collaboration server 205 using a large language model 200 to identify and express a first conversational argument in conversational form, where the identifying of the first conversational argument includes identifying at least one viewpoint, position or claim in the first conversational dialogue supported by evidence or reasoning, (h) processing the second conversational dialogue at the collaboration server 205 using the large language model 200 to identify and express a second conversational argument in conversational form, where the identifying of the second conversational argument includes identifying at least one viewpoint, position or claim in the second conversational dialogue supported by evidence or reasoning, (i) processing the third conversational dialogue at the collaboration server 205 using the large language model 200 to identify and third express conversational argument a in conversational form, where the identifying of the third conversational argument includes identifying at least one viewpoint, position or claim in the third conversational dialogue supported by evidence or reasoning, (j) sending the first conversational argument expressed in conversational form to each of the members of a first different sub-group, where the first different sub-group is not the first sub-group, (k) sending the second conversational argument expressed in conversational form to each of the members of a second different sub-group, where the second different sub-group is not the second sub-group, (l) sending the third conversational argument expressed in conversational form to each of the members of a third different sub-group, where the third different sub-group is not the third sub-group, and (m) repeating steps (d) through (l) at least one time. Note—in many preferred embodiments, step (c), which involves dividing the population into a plurality of subgroups can be performed before steps (a) and (b).

In some examples, software components 250 send, in step (j), the first conversational argument expressed in conversational form to each of the members of a first different sub-group expressed in first person as if the first conversational argument were coming from a member of the first different sub-group of the population of human participants. In some examples, software components 250 send, in step (k), the second conversational argument expressed in conversational form to each of the members of a second different sub-group expressed in first person as if the second conversational argument were coming from a member of the second different sub-group of the population of human participants. In some examples, software components 250 send, in step (l), the third conversational argument expressed in conversational form to each of the members of a third different sub-group expressed in first person as if the third conversational argument were coming from a member of the third different sub-group of the population of human participants. In some such embodiment, the additional simulated member is assigned a unique username that appears similarly in the Local Chat Application as the usernames of the human members of the sub-group. In this way, the users within a sub-group are made to feel like they are holding a natural real-time conversation among participants in their sub-group, that subset including a simulated member that express in the first person, unique points that represents conversational information captured from another sub-group. With every sub-group having such a simulated member, information propagates smoothly across the population, linking all the subgroups into a single unified conversation. In some examples, software components 250 process, in step (n), the first conversational argument, the second conversational argument, and the third conversational argument using the large language model 200 to generate a global conversational argument expressed in conversational form. In some examples, software components 250 sends, in step (o), the global conversational argument expressed in conversational form to each of the members of the first sub-group, the second sub-group, and the third sub-group. In some aspects, a final global conversational argument is generated by weighting more recent ones of the global conversational arguments more heavily than less recent ones of the global conversational arguments. In some aspects, the first conversational dialogue, the second conversational dialogue and the third conversational dialogue each include a set of ordered chat messages including text. In some aspects, the first conversational dialogue, the second conversational dialogue and the third conversational dialogue each further include a respective member identifier for the member of the population of human participants who entered each chat message. In some aspects, the first conversational dialogue, the second conversational dialogue and the third conversational dialogue each further includes a respective timestamp identifier for a time of day when each chat message is entered. In some aspects, the processing the first conversational dialogue in step (g) further includes determining a respective response target indicator for each chat message entered by the first sub-group, where the respective response target indicator provides an indication of a prior chat message to which each chat message is responding; the processing the second conversational dialogue in step (h) further includes determining a respective response target indicator for each chat message entered by the second sub-group, where the respective response target indicator provides an indication of a prior chat message to which each chat message is responding; and the processing the third conversational dialogue in step (i) further includes determining a respective response target indicator for each chat message entered by the third sub-group, where the respective response target indicator provides an indication of a prior chat message to which each chat message is responding. In some aspects, the processing the first conversational dialogue in step (g) further includes determining a respective sentiment indicator for each chat message entered by the first sub-group, where the respective sentiment indicator provides an indication of whether each chat message is in agreement or disagreement with prior chat messages; the processing the second conversational dialogue in step (h) further includes determining a respective sentiment indicator for each chat message entered by the second sub-group, where the respective sentiment indicator provides an indication of whether each chat message is in agreement or disagreement with prior chat messages; and the processing the third conversational dialogue in step (i) further includes determining a respective sentiment indicator for each chat message entered by the third sub-group, where the respective sentiment indicator provides an indication of whether each chat message is in agreement or disagreement with prior chat messages. In some aspects, the processing the first conversational dialogue in step (g) further includes determining a respective conviction indicator for each chat message entered by the first sub-group, where the respective conviction indicator provides an indication of conviction for each chat message; the processing the second conversational dialogue in step (h) further includes determining a respective conviction indicator for each chat message entered by the second sub-group, where the respective conviction indicator provides an indication of conviction for each chat message; and the processing the third conversational dialogue in step (i) further includes determining a respective conviction indicator for each chat message entered by the third sub-group, where the respective conviction indicator provides an indication of conviction each chat message is in the expressions of the chat message. In some aspects, the first unique portion of the population (i.e., a first sub-group) consists of no more than ten members of the population of human participants, the second unique portion consists of no more than ten members of the population of human participants, and the third unique portion consists of no more than ten members of the population of human participants. In some aspects, the first conversational dialogue includes chat messages including voice. In some aspects, the voice includes words spoken, and at least one spoken language component selected from the group of spoken language components consisting of tone, pitch, rhythm, volume and pauses. Such spoken language components are common ways in which emotional value can be assessed or indicated in vocal inflection. In some aspects, the first conversational dialogue includes chat messages including video. In some aspects, the video includes words spoken, and at least one language component selected from the group of language components consisting of tone, pitch, rhythm, volume, pauses, facial expressions, gestures, and body language. In some aspects, each of the repeating steps occurs after expiration of an interval. In some aspects, the interval is a time interval. In some aspects, the interval is a number of conversational interactions. In some aspects, the first different sub-group is the second sub-group, and the second different sub-group is the third sub-group. In some aspects, the first different sub-group is a first randomly selected sub-group, the second different sub-group is a second randomly selected sub-group, and the third different sub-group is a third randomly selected sub-group, where the first randomly selected sub-group, the second randomly selected sub-group and the third randomly selected sub-group are not the same sub-group. In some examples, software components 250 process, in step (g), the first conversational dialogue at the collaboration server 205 using the large language model 200 to identify and express the first conversational argument in conversational form, where the identifying of the first conversational argument includes identifying at least one viewpoint, position or claim in the first conversational dialogue supported by evidence or reasoning, where the first conversational argument is not identified in the first different sub-group. In some examples, software components 250 process, in step (h), the second conversational dialogue at the collaboration server 205 using the large language model 200 to identify and express the second conversational argument in conversational form, where the identifying of the second conversational argument includes identifying at least one viewpoint, position or claim in the second conversational dialogue supported by evidence or reasoning, where the second conversational argument is not identified in the second different sub-group. In some examples, software components 250 process, in step (i), the third conversational dialogue at the collaboration server 205 using the large language model 200 to identify and express the third conversational argument in conversational form, where the identifying of the third conversational argument includes identifying at least one viewpoint, position or claim in the third conversational dialogue supported by evidence or reasoning, where the third conversational argument is not identified in the third different sub-group.

According to some aspects, software components 250 send, in step (a), the conversational prompt to the set of networked computing devices 225, the conversational prompt including a question to be collaboratively discussed by the population of human participants. In some examples, software components 250 present, in step (b), substantially simultaneously, a representation of the conversational prompt to each member of the population of human participants on a display of the computing device 225 associated with that member. In some examples, software components 250 divide, in step (c), the population of human participants into a first sub-group consisting of a first unique portion of the population, a second sub-group consisting of a second unique portion of the population, and a third sub-group consisting of a third unique portion of the population, where the first unique portion consists of a first set of members of the population of human participants, the second unique portion consists of a second set of members of the population of human participants and the third unique portion consists of a third set of members of the population of human participants, including dividing the population of human participants as a function of user 240 initial responses to the conversational prompt. In some examples, software components 250 collects and stores, in step (d), a first conversational dialogue in a first memory portion at the collaboration server 205 from members of the population of human participants in the first sub-group during an interval via a user 240 interface on the computing device 225 associated with each member of the population of human participants in the first sub-group. In some examples, software components 250 collect and store, in step (e), a second conversational dialogue in a second memory portion at the collaboration server 205 from members of the population of human participants in the second sub-group during the interval via a user 240 interface on the computing device 225 associated with each member of the population of human participants in the second sub-group. In some examples, software components 250 collect and store, in step (f), a third conversational dialogue in a third memory portion at the collaboration server 205 from members of the population of human participants in the third sub-group during the interval via a user 240 interface on the computing device 225 associated with each member of the population of human participants in the third sub-group. In some examples, software components 250 process, in step (g), the first conversational dialogue at the collaboration server 205 using a large language model 200 to express a first conversational summary in conversational form. In some examples, software components 250 process, in step (h), the second conversational dialogue at the collaboration server 205 using the large language model 200 to express a second conversational summary in conversational form. In some examples, software components 250 in process, step (i), the third conversational dialogue at the collaboration server 205 using the large language model 200 to express a third conversational summary in conversational form. In some examples, software components 250 send, in step (j), the first conversational summary expressed in conversational form to each of the members of a first different sub-group, where the first different sub-group is not the first sub-group. In some examples, software components 250 send, in step (k), the second conversational summary expressed in conversational form to each of the members of a second different sub-group, where the second different sub-group is not the second sub-group. In some examples, software components 250 send, in step (l), the third conversational summary expressed in conversational form to each of the members of a third different sub-group, where the third different sub-group is not the third sub-group. In some examples, software components 250 repeat, in step (m), steps (d) through (l) at least one time. In some examples, software components 250 send, in step (j), the first conversational summary expressed in conversational form to each of the members of a first different sub-group expressed in first person as if the first conversational summary were coming from an additional member (simulated) of the first different sub-group of the population of human participants. In some examples, software components 250 send, in step (k), the second conversational summary expressed in conversational form to each of the members of a second different sub-group expressed in first person as if the as if the second conversational summary were coming from an additional member (simulated) of the second different sub-group of the population of human participants. In some examples, software components 250 send, in step (l), the third conversational summary expressed in conversational form to each of the members of a third different sub-group expressed in first person as if the third conversational summary were coming from an additional member (simulated) of the third different sub-group of the population of human participants. In some examples, software components 250 process, in step (n), the first conversational summary, the second conversational summary, and the third conversational summary using the large language model 200 to generate a global conversational summary expressed in conversational form. In some examples, software components 250 send, in step (o), the global conversational summary expressed in conversational form to each of the members of the first sub-group, the second sub-group, and the third sub-group. In some aspects, a final global conversational summary is generated by weighting more recent ones of the global conversational summaries more heavily than less recent ones of the global conversational summaries. In some aspects, the dividing the population of human participants, in step (c), includes: assessing the initial responses to determine the most supported user 240 perspectives and dividing the population to distribute the most supported user 240 perspectives amongst the first sub-group, the second sub-group and the third sub-group. In some examples, software components 250 presents, substantially simultaneously, in step (b), a representation of the conversational prompt to each member of the population of human participants on a display of the computing device 225 associated with that member, where the presenting further includes providing a set of alternatives, options or controls for initially responding to the conversational prompt. In some aspects, the dividing the population of human participants, in step (c), includes: assessing the initial responses to determine the most supported user 240 perspectives and dividing the population to group users 240 having the first most supported user 240 perspective together in the first sub-group, users 240 having the second most supported user 240 perspective together in the second sub-group, and users 240 having the third most supported user 240 perspective together in the third sub-group.

According to some aspects, software components 250 monitor, in step (n), the first conversational dialogue for a first viewpoint, position or claim not supported by first reasoning or evidence. In some examples, software components 250 send, in step (o), in response to monitoring the first conversational dialogue, a first conversational question to the first sub-group requesting first reasoning or evidence in support of the first viewpoint, position or claim. In some examples, software components 250 monitor, in step (p), the second conversational dialogue for a second viewpoint, position or claim not supported by second reasoning or evidence. In some examples, software components 250 send, in step (q), in response to monitoring the second conversational dialogue, a second conversational question to the second sub-group requesting second reasoning or evidence in support of the second viewpoint, position or claim. In some examples, software components 250 monitor, in step (r), the third conversational dialogue for a third viewpoint, position or claim not supported by third reasoning or evidence. In some examples, software components 250 send, in step(s), in response to monitoring the third conversational dialogue, a third conversational question to the third sub-group requesting third reasoning or evidence in support of the third viewpoint, position or claim.

According to some aspects, software components 250 monitor, in step (n), the first conversational dialogue for a first viewpoint, position or claim supported by first reasoning or evidence. In some examples, software components 250 send, in step (o), in response to monitoring the first conversational dialogue, a first conversational challenge to the first sub-group questioning the first reasoning or evidence in support of the first viewpoint, position or claim. In some examples, software components 250 monitor, in step (p), the second conversational dialogue for a second viewpoint, position or claim supported by second reasoning or evidence. In some examples, software components 250 send, in step (q), in response to monitoring the second conversational dialogue, a second conversational challenge to the second sub-group questioning second reasoning or evidence in support of the second viewpoint, position or claim. In some examples, software components 250 monitor, in step (r), the third conversational dialogue for a third viewpoint, position or claim supported by third reasoning or evidence. In some examples, software components 250 send, in step(s), in response to monitoring the third conversational dialogue, a third conversational challenge to the third sub-group questioning third reasoning or evidence in support of the third viewpoint, position or claim. In some examples, software components 250 send, in step (o), the first conversational challenge to the first sub-group questioning the first reasoning or evidence in support of the first viewpoint, position, or claim, where the questioning the first reasoning or evidence includes a viewpoint, position, or claim collected from the second different sub-group or the third different sub-group.

According to some aspects, software components 250 process, in step (n), the first conversational summary, the second conversational summary, and the third conversational summary using the large language model 200 to generate a list of positions, reasons, themes or concerns from across the first sub-group, the second sub-group, and the third sub-group. In some examples, software components 250 display, in step (o), to the human moderator using the collaboration server 205 the list of positions, reasons, themes or concerns from across the first sub-group, the second sub-group, and the third sub-group. In some examples, software components 250 receive, in step (p), a selection of at least one of the positions, reasons, themes or concerns from the human moderator via the collaboration server 205. In some examples, software components 250 generate, in step (q), a global conversational summary expressed in conversational form as a function of the selection of the at least one of the positions, reasons, themes or concerns. In some aspects, the providing the local moderation application on at least one networked computing device 225, the local moderation application configured to allow the human moderator to observe the first conversational dialogue, the second conversational dialogue, and the third conversational dialogue. In some aspects, the providing the local moderation application on at least one networked computing device 225, the local moderation application configured to allow the human moderator to selectively and collectively send communications to members of the first sub-group, send communications to members of the second sub-group, and send communications to members of the third sub-group. In some examples, software components 250 sends, in step (r), the global conversational summary expressed in conversational form to each of the members of the first sub-group, the second sub-group, and the third sub-group.

According to some aspects, software components 250 process, in step (g), the first conversational dialogue at the collaboration server 205 using a large language model 200 to express a first summary conversational in conversational form. In some examples, software components 250 process, in step (h), the second conversational dialogue at the collaboration server 205 using the large language model 200 to express a second conversational summary in conversational form. In some examples, software components 250 process, in step (i), the third conversational dialogue at the collaboration server 205 using the large language model 200 to express a third conversational summary in conversational form. In some examples, software components 250 send, in step (j), the first conversational summary expressed in conversational form to each of the members of a first different sub-group, where the first different sub-group is not the first sub-group. In some examples, software components 250 send, in step (k), the second conversational summary expressed in conversational form to each of the members of a second different sub-group, where the second different sub-group is not the second sub-group. In some examples, software components 250 send, in step (l), the third conversational summary expressed in conversational form to each of the members of a third different sub-group, where the third different sub-group is not the third sub-group. In some examples, software components 250 repeat, in step (m), steps (d) through (l) at least one time. In some examples, software components 250 process, in step (n), the first conversational summary, the second conversational summary, and the third conversational summary using the large language model 200 to generate a global conversational summary expressed in conversational form. In some examples, software components 250 process, in step (n), the first conversational summary, the second conversational summary, and the third conversational summary using the large language model 200 to generate a first global conversational summary expressed in conversational form, where the first global conversational summary is tailored to the first sub-group, generate a second global conversational summary, where the second global conversational summary is tailored to the second sub-group, and generate a third global conversational summary, where the third global conversational summary is tailored to the third sub-group. In some examples, software components 250 send, in step (o), the first global conversational summary expressed in conversational form to each of the members of the first sub-group, send the second global conversational summary expressed in conversational form to the each of the members of the second sub-group, and send the third global conversational summary expressed in conversational form to each of the members of the third sub-group. In some examples, software components 250 process, in step (n), the first conversational summary, the second conversational summary, and the third conversational summary using the large language model 200 to generate a first global conversational summary expressed in conversational form, where the first global conversational summary is tailored to the first sub-group by including a viewpoint, position, or claim not expressed in the first sub-group, generate a second global conversational summary, where the second global conversational summary is tailored to the second sub-group by including a viewpoint, position, or claim not expressed in the second sub-group, and generate a third global conversational summary, where the third global conversational summary is tailored to the third sub-group by including a viewpoint, position, or claim not expressed in the third sub-group. In some examples, software components 250 process, in step (n), the first conversational summary, the second conversational summary, and the third conversational summary using the large language model 200 to generate a first global conversational summary expressed in conversational form, where the first global conversational summary is tailored to the first sub-group by including a viewpoint, position, or claim not expressed in the first sub-group, where the viewpoint, position, or claim not expressed in the first sub-group is collected from the first different subgroup, where the second global conversational summary is tailored to the second sub-group by including a viewpoint, position, or claim not expressed in the second sub-group, where the viewpoint, position, or claim not expressed in the second sub-group is collected from the second different subgroup, where the third global conversational summary is tailored to the third sub-group by including a viewpoint, position, or claim not expressed in the third sub-group, where the viewpoint, position, or claim not expressed in the third sub-group is collected from the third different subgroup.

According to some aspects, software components 250 send, in step (a), the conversational prompt to the set of networked computing devices 225, the conversational prompt including a question to be collaboratively discussed by the population of human participants. In some examples, software components 250 present, in step (b), substantially simultaneously, a representation of the conversational prompt to each member of the population of human participants on a display of the computing device 225 associated with that member. In some examples, software components 250 divide, in step (c), the population of human participants into a first sub-group consisting of a first unique portion of the population, a second sub-group consisting of a second unique portion of the population, and a third sub-group consisting of a third unique portion of the population, where the first unique portion consists of a first set of members of the population of human participants, the second unique portion consists of a second set of members of the population of human participants and the third unique portion consists of a third set of members of the population of human participants. In some examples, software components 250 collect and store, in step (d), a first conversational dialogue in a first memory 220 portion at the collaboration server 205 from members of the population of human participants in the first sub-group during an interval via a user 240 interface on the computing device 225 associated with each member of the population of human participants in the first sub-group, where the first conversational dialogue includes chat messages including a first segment of video including at least one member of the first sub-group. In some examples, software components 250 collect and store, in step (e), a second conversational dialogue in a second memory 220 portion at the collaboration server 205 from members of the population of human participants in the second sub-group during the interval via a user 240 interface on the computing device 225 associated with each member of the population of human participants in the second sub-group, where the first conversational dialogue includes chat messages including a second segment of video including at least one member of the second sub-group. In some examples, software components 250 collect and store, in step (f), a third conversational dialogue in a third memory 220 portion at the collaboration server 205 from members of the population of human participants in the third sub-group during the interval via a user 240 interface on the computing device 225 associated with each member of the population of human participants in the third sub-group, where the first conversational dialogue includes chat messages including a second segment of video including at least one member of the third sub-group. In some examples, software components 250 process, in step (g), the first conversational dialogue at the collaboration server 205 using a large language model 200 to express a first conversational summary in conversational form. In some examples, software components 250 process, in step (h), the second conversational dialogue at the collaboration server 205 using the large language model 200 to express a second conversational summary in conversational form. In some examples, software components 250 process, in step (i), the third conversational dialogue at the collaboration server 205 using the large language model 200 to express a third conversational summary in conversational form. In some examples, software components 250 send, in step (j), the first conversational summary expressed in conversational form to each of the members of a first different sub-group, where the first different sub-group is not the first sub-group. In some examples, software components 250 send, in step (k), the second conversational summary expressed in conversational form to each of the members of a second different sub-group, where the second different sub-group is not the second sub-group. In some examples, software components 250 send, in step (l), the third conversational summary expressed in conversational form to each of the members of a third different sub-group, where the third different sub-group is not the third sub-group. In some examples, software components 250 repeat, in step (m), steps (d) through (l) at least one time. In some examples, software components 250 sends, in step (j), the first conversational summary expressed in conversational form to each of the members of a first different sub-group expressed in first person as if the first conversational summary were coming from an additional member (simulated) of the first different sub-group of the population of human participants. In some examples, software components 250 send, in step (k), the second conversational summary expressed in conversational form to each of the members of a second different sub-group expressed in first person as if the as if the second conversational summary were coming from an additional member (simulated) of the second different sub-group of the population of human participants. In some examples, software components 250 send, in step (l), the third conversational summary expressed in conversational form to each of the members of a third different sub-group expressed in first person as if the third conversational summary were coming from an additional member (simulated) of the third different sub-group of the population of human participants. In some examples, software components 250 send, in step (j), the first conversational summary expressed in conversational form to each of the members of a first different sub-group expressed in first person as if the first conversational summary were coming from an additional member (simulated) of the first different sub-group of the population of human participants, including sending the first conversational summary in a first video segment including a graphical character representation expressing the first conversational summary through movement and voice. In some examples, software components 250 send, in step (k), the second conversational summary expressed in conversational form to each of the members of a second different sub-group expressed in first person as if the as if the second conversational summary were coming from an additional member (simulated) of the second different sub-group of the population of human participants, including sending the second conversational summary in a second video segment including a graphical character representation expressing the second conversational summary through movement and voice. In some examples, software components 250 send, in step (l), the third conversational summary expressed in conversational form to each of the members of a third different sub-group expressed in first person as if the third conversational summary were coming from an additional member (simulated) of the third different sub-group of the population of human participants, including sending the second conversational summary in a second video segment including a graphical character representation expressing the second conversational summary through movement and voice. In some examples, software components 250 send, in step (j), the first conversational summary expressed in conversational form to each of the members of a first additional different sub-group. In some examples, software components 250 send, in step (k), the second conversational summary expressed in conversational form to each of the members of a second additional different sub-group. In some examples, software components 250 send, in step (l), the third conversational summary expressed in conversational form to each of the members of a third additional different sub-group. In some examples, software components 250 process, in step (g), the first conversational dialogue at the collaboration server 205 using a large language model conversational 200 to express a first summary in conversational form, where the first conversational summary includes a first graphical representation of a first artificial agent. In some examples, software components 250 process, in step (h), the second conversational dialogue at the collaboration server 205 using the large language model 200 to express a second conversational summary in conversational form, where the second conversational summary includes a second graphical representation of a second artificial agent. In some examples, software components 250 process, in step (i), the third conversational dialogue at the collaboration server 205 using the large language model 200 to express a third conversational summary in conversational form, where the third conversational summary includes a third graphical representation of a third artificial agent.

According to some aspects, asynchronous conversation application 255 enables an asynchronous conversational process in which each of the set of new human participants engages in real-time dialog with a Conversational Surrogate Agent 235 displayed by their associated computing device 210, each Conversational Surrogate Agent 235 configured to express to at least one new participant, at least one stored idea, insight, view, or assertion associated with at least one prior participant. In some aspects, the asynchronous conversation process enables a selected set of new participants to communicate through real-time dialog with each other while also engaging in dialog with the same Conversational Surrogate Agent 235. In some aspects, the asynchronous conversational process is configured to enable at least one new participant to engage in real-time dialog with a set of different Conversational Surrogate Agents 235 on their associated computing device 225, each of the different Conversational Surrogate Agents 235 configured to conversationally represent a different perspective stored within the memory and associated with different prior human participants.

In some aspects, the asynchronous conversation application 255 includes a user interface that displays a summary of the most relevant stored ideas, insights, views, or assertions to the new human participant. In some aspects, a set of the subgroups are engaged asynchronously over sequential time periods.

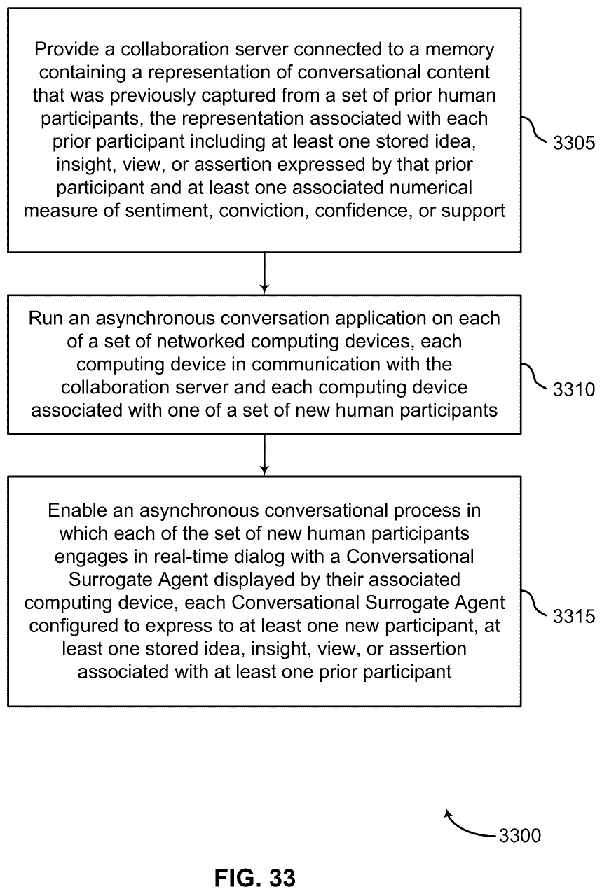

Asynchronous conversation application 255 is an example of, or includes aspects of, the corresponding element described with reference to FIG. 33.

Accordingly, various methods, systems, and apparatuses for asynchronous conversational deliberation among a population of human participants are described. For instance, one or more aspects of FIG. 2 may be implemented to perform one or more operations described with reference to FIGS. 33-35.

In one example, collaboration server 205 may be connected to a memory 220 containing a representation of conversational content that was previously captured from a plurality of prior human participants (e.g., such as user 240), the representation associated with each prior participant including at least one stored idea, insight, view, or assertion expressed by that prior participant and at least one associated numerical measure of sentiment, conviction, confidence, or support. An asynchronous conversation application 255 may be run on each of a plurality of networked computing devices 225, each computing device 225 in communication with the collaboration server 205 and each computing device 225 associated with one of a plurality of new human participants 240. An asynchronous conversational process may be enabled in which each of the plurality of new human participants engages in real-time dialog with a Conversational Surrogate Agent 235 displayed by their associated computing device 225, each Conversational Surrogate Agent 235 configured to express to at least one new participant, at least one stored idea, insight, view, or assertion associated with at least one prior participant.

### A HyperChat Process

Embodiments of the present disclosure include a collaboration server that can divide a large group of people into small sub-groups. In some examples, the server can divide a large population (72 people) into 12 sub-groups of 6 people each, thereby enabling each sub-group's users to chat among themselves. The server can inject conversational prompts into the sub-groups in parallel such that the members are talking about the same issue, topic or question. At various intervals, the server captures blocks of dialog from each sub-group, sends it to a Large Language Model (LLM) via an API that summarizes and analyzes the blocks (using an Observer Agent for each sub-group), and then sends a representation of the summaries into other sub-groups. In some cases, the server expresses the summary blocks as first person dialogue that is part of the naturally flowing conversation (e.g., using a surrogate agent for each sub-group). Accordingly, the server enables 72 people to hold a real-time conversation on the same topic while providing for each person to be part of a small sub-group that can communicate conveniently and simultaneously has conversational information passed between sub-groups in the form of the summarized blocks of dialogue. Hence, conversational content propagates across the large population (i.e., each of the sub-groups) that provides for the large population to converge on conversational conclusions.

A global conversational summary is optionally generated after the sub-groups hold parallel conversations for some time with informational summaries passed between sub-groups. A representation of the global conversational summary is optionally injected into the sub-groups via the surrogate AI agent associated with that sub-group. As a consequence of the propagation of local conversational content across sub-groups and the optional injection of global conversational content into all sub-groups, the large population is enabled to hold a single unified deliberative conversation and converge over time towards unified conclusions or sentiments. With respect to global conversational summaries, when the server detects convergence in conclusions or sentiments (using, for example, the LLM via an API), the server can send the dialogue blocks that are stored for each of the parallel rooms to the Large Language Model and, using API calls, ask the LLM for processing. The processing includes generating a conversational summary across sub-groups, including an indication of the central points made among sub-groups, especially points that have strong support across sub-groups and arguments raised. In some cases, the processing assesses the strength of the sentiments associated with the points made and arguments raised. The global conversational summary is generated as a block of conversation expressed from the perspective of an observer who is watching each of the sub-groups. The global conversational summary can be expressed from the perspective of a global surrogate that expresses the summary inside each sub-group to inform the users of the outcome of the parallel conversations in other sub-groups, i.e., the conclusions of the large population (or a sub-population divided into sub-groups).

In some embodiments, the system provides a global summary to a human moderator that the moderator sees at any time during the process. Accordingly, the moderator is provided with an overall view of the discussions in the sub-groups during the process.

In some embodiments, the system summarizes the discussion of the entire population and injects the representation into different subgroups as an interactive first-person dialog. The first-person dialog may be crafted to provide a summary of a central theme observed across groups and instigate discussion and elaboration, thereby encouraging the subgroup to discuss the issue among themselves and build a consensus. The consensus is built across the entire population by guiding subgroups towards central themes and providing for the opportunity to explore, elaborate, or reject the globally observed premise.

In other embodiments, the globally injected summary and query for elaboration could be based not on a common theme observed globally but based on an uncommon theme observed globally (i.e., a divergent viewpoint). By directing one or more subgroups to brainstorm and/or debate divergent viewpoints that are surfaced globally (i.e., but not in high frequency among subgroups), the method effectively ensures that many subgroups consider the divergent viewpoint and potentially reject, accept, modify, or qualify the divergent viewpoint.

FIG. 3 shows an example of a HyperChat process according to aspects of the present disclosure. The example shown includes chat room 300, conversational dialogue 315, and global conversation observer 320.

According to the exemplary HyperChat process shown in FIG. 3, a plurality of chat rooms 300 (n) include 5 users each. The number of users is used for instructional purposes. However, most implementations of HyperChat can employ different populations of users in each chat room. In preferred embodiments, the full population (p) is divided into a sufficient number of chat rooms (n) such that the number of users in each room is appropriately sized for coherent deliberative real-time conversations. According to some experts, the ideal size for human groups to hold deliberative conversations ranges from 4 to 7 users, with significant degradation occurring in group sizes over 10 users. Thus, the collaboration server of the present embodiment can be configured in software to automatically divide a full population (p) of users into a sufficient number of sub-groups and associated chat rooms (n) so as to ensure the deliberating sup-groups fall within a target size range such as 4 to 7 users or to ensure the sub-group size does not go above a defined threshold size such as 10 users.

The users in the full population (p) are each using a computer (desktop, laptop, tablet, phone, etc., . . . ) running a HyperChat application to interact with the HyperChat server over a communication network in a client-server architecture. In the case of HyperChat, the client application enables users to interact with other users through real-time dialog via text chat and/or voice chat and/or video chat and/or avatar-based VR chat.

As shown in FIG. 3, the HyperChat system divides the population of users into smaller subgroups referred to herein as chat room 300 which can be text-based, voice-based, video-based and/or avatar-based. The term “room” is a structural matter and does not imply the sub-groups need to be in an environment that looks, feels, or is called a room. In some cases, the rooms are defined by the fact that a member of a given room can communicate conversationally in real-time with other members of the room by exchanging real-time text and/or by exchanging real-time voice and/or by exchanging real-time video and/or by exchanging real-time information that represents avatars associated with the respective users. Chat room 300 is an example of, or includes aspects of, the corresponding element described with reference to FIGS. 4-6, 8, and 9.

In certain aspects, chat room 300 includes user 305, conversational observation agent 310, and conversational surrogate agent 325. As an example shown in FIG. 3, there are ‘n’ sub-groups labeled Chat Room 1, Chat Room 2, Chat Room 3, and up to Chat Room (n) respectively. The (n) sub-groups or chat rooms each have five users assigned to them (for illustration purposes, as the number of users in each su b-group may vary). According to the example, Sub-Group 1 has users (u1) to (u5), Sub-Group 2 has users (u6) to (u10), Sub-Group 3 has users (u11) to (u15), which would continue in this pattern up to Sub-Group (n) which has users up to (u(p)). User 305 is an example of, or includes aspects of, the corresponding element described with reference to FIGS. 1, 2, 4-6, 8, and 9.

Additionally, each sub-group is assigned an AI Agent (i.e., conversational observer agent 310) that monitors that real-time dialog among the users of that subgroup. The real-time AI monitor can be implemented using an API to interface with a Foundational Model such as GPT-3 or ChatGPT from OpenAI or LaMDA from Google or from another provider of a Large Language Model system. Conversational observer agent 310 monitors the conversational interactions among the users of that sub-group and generates informational summaries 315 that assess, compress, and represent the informational content expressed by one or more users of the group (and optionally the conviction levels associated with different elements of informational content expressed by one or more users of the group). The informational summaries 315 are generated at various intervals, which can be based on elapsed time (e.g., at three minute intervals) or can be based on conversational interactions (for example, after a certain number of individuals speak via text or voice in that room).

In case of both, a time-based interval or a conversational-content-based interval, conversational observer agent 310 extracts a set of key points expressed by members of the group, summarizing the points in a compressed manner (using LLM), optionally assigning a conviction level to each of the points made based on the level of agreement (or disagreement) among participants and/or the level of conviction expressed in the language used by participants and/or the level of conviction inferred from facial expressions, vocal inflections, body posture and/or body gestures of participants (in embodiments that use microphones, cameras or other sensors to capture that information). The conversational observer agent 310 then transfers the summary to other modules in the system (e.g., global conversational observer 320 and conversational surrogate agent 325). Conversational observation agent 310 is an example of, or includes aspects of, the corresponding element described with reference to FIGS. 2, 4, 6, 9, and 10. Global conversational observer 320 is an example of, or includes aspects of, the corresponding element described with reference to FIGS. 4-6, and 9.

Conversational surrogate agent 325 in each of the chat rooms receives informational summaries or conversational dialog 315 from one or more conversational observer agents 310 and expresses the conversational dialog in first person to users 305 of each subgroup during real-time conversations. According to the example shown in FIG. 3, CSai (N−1) 325 is a conversational surrogate agent that receives conversational dialog from Subgroup (n−1) (i.e., based on the real-time conversations among humans in Chat Room (n−1)) and expresses a representation of the conversational dialog in natural language form (text and/or voice and/or expressive avatar) to users of another subgroup. For example, CSai (N−1) 325 is assigned to sub-group (n) (i.e., Chat room (n)) which indicates that it receives conversational dialog 315 from sub-group (n−1) and express a representation of the conversational dialog (in natural language) to the users of subgroup (n). Conversational dialogue 315 is an example of, or includes aspects of, the corresponding element described with reference to FIG. 4. Hereinafter, conversational dialog may be referred to as informational summary and the two terms may be used interchangeably.

Additionally, FIG. 3 indicates that conversational surrogate agent (CSai-2) receives an informational summary from sub-group 2 and expresses a representation of the summary (as natural language) to the users of sub-group 3. Likewise, conversational surrogate agent CSai (l) receives informational summaries from sub-group 1 and expresses a representation of those summaries (as natural language) to the users of sub-group 2. In this way, subgroups shown in FIG. 3 may receive informational summaries from at least one other sub-group. This ensures informational propagation across the population (e.g., the full population) (p)) of users and individual participants may communicate directly (i.e., hold direct conversations) with few (e.g., 4) other individuals.

Here, ‘n’ can be extended to any number of users, for example 1000 users could be broken into 200 subgroups, each with 5 users, enabling coherent and meaningful conversations within subgroups with a manageable number of participants while also enabling natural and efficient propagation of conversational information between subgroups, thereby providing for knowledge, wisdom, insights, and intuition to propagate from subgroup to subgroup and ultimately across the full population.

Accordingly, a large population (for example 1000 networked users) can engage in a single conversation such that each participant feels like they are communicating with a small subgroup of other users, and yet informational content is shared between subgroups.

The content that is shared between subgroups is injected by the conversational surrogate agent 325 as conversational content presented as text chat from a surrogate member of the group or voice chat from a surrogate member of the group or video chat from a simulated video of a human expressing verbal content or VR-based Avatar Chat from a 3D simulated avatar of a human expressing verbal content.

Conversational surrogate agent 325 can be identified as an AI agent that expresses a summary of the views, opinions, perspectives, and insights from another subgroup. For example, the CSai agent in a given room, can express verbally—“I am here to represent another group of participants. Over the last three minutes, they expressed the following points for consideration.” In some cases, the CSai expresses summarized points generated by conversational observer agent 310.

Additionally, conversational observer agent 310 may generate summarized points at regular time intervals or intervals related to dialogue flow. For example, if a three-minute interval is used, the conversational observer agent generates a conversational dialogue 315 of the key points expressed in a given room over the previous three minutes. It would then pass the conversational dialogue 315 to a conversational surrogate agent 325 associated with a different subgroup. The surrogate agent may be designed to wait for a pause in the conversation in the subgroup (i.e., buffer the content for a short period of time) and then inject the conversational dialogue 315. The summary, for example, can be textually or verbally conveyed as—“Over the last three minutes, the participants in Subgroup 22 expressed that Global Warming is likely to create generational resentment as younger generations blame older generations for not having taken action sooner. A counterpoint was raised that younger generations have not shown sufficient urgency themselves.”

In a more natural implementation, the conversational surrogate agent may be designed to speak in the first person, representing the views of a subgroup the way an individual human might. In this case, the same informational summary quoted in the paragraph above could be verbalized by the conversational surrogate agent as follows—“Having listened to some other users, I would argue Global Warming is likely to create generational resentment as younger generations blame older generations for not acting sooner. On the other hand, we must also consider that younger generations have not shown sufficient urgency themselves.”

“First person” in English refers to the use of pronouns such as “I,” “me,” “we,” and “us,” which allows the speaker or writer, e.g., the conversational surrogate, to express thoughts, feelings, experiences, and opinions directly. When a sentence or a piece of writing is in the first person, it is written from the perspective of the person speaking or writing. An example of a sentence written in the first person is “I believe that the outcome of the Super Bowl is significantly dependent upon the Chief's quarterback Mahomes, who has been inconsistent in recent weeks.”

In an even more natural implementation, the conversational surrogate agent might not identify that it is summarizing the views of another subgroup, but simply offer opinions as if it was a human member of the subgroup—“It's also important to consider that Global Warming is likely to create generational resentment as younger generations blame older generations for not acting sooner. On the other hand, we must also consider that younger generations have not shown sufficient urgency themselves.”

In the three examples, a block of informational content is generated by one subgroup, summarized to extract the key points, and then expressed into another subgroup. This provides for information propagation such that the receiving subgroup can consider the points in an ongoing conversation. The points may be discounted, adopted, or modified by the receiving subgroup. Since such information transfer is happening in each subgroup parallelly, a substantial amount of information transfer occurs.

As shown in FIG. 3, the amplification of collective intelligence (across the full population) can be overseen by a third artificial agent, i.e., global conversational observer agent (GOai) 320. Global conversational observer 320 takes informational summaries as input from each of the conversational observer agents 310 (which include an extraction of key points and optionally include confidence and conviction assessments associated with each of the key points) across a plurality of the subgroups and produces a global informational summary at various intervals, i.e., based on elapsed time (e.g., based on five minute elapsed time and/or five minute intervals) or can be based on conversational interactions (for example, after a certain amount of dialogue has been generated across groups).

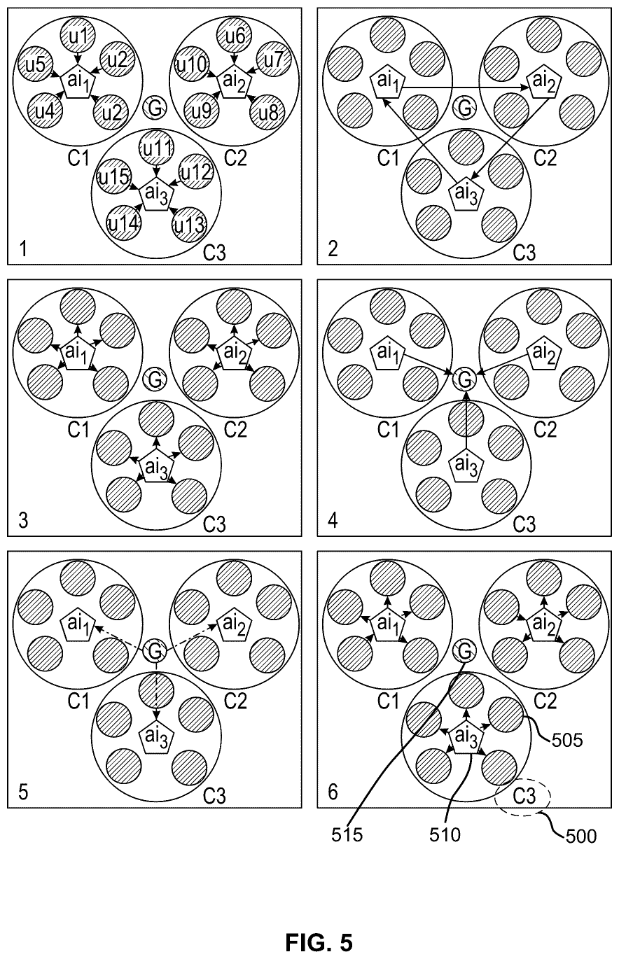

In case of each, a time-based interval or a conversational content-based interval, global conversational observer 320 extracts a set of key points expressed across subgroups, summarizes the points in a compressed manner, optionally assigning a conviction level to each of the points made based on the conviction identified within particular subgroups and/or based on the level of agreement across subgroups. Global conversational observer 320 documents and stores informational summaries 315 at regular intervals, thereby documenting a record of the changing sentiments of the full population over time and is also designed to output a final summary at the end of the conversation based on some or all of the stored global records. In some embodiments, when generating an updated or a Final Conversation Summary, the global conversational observer 320 weights the informational summaries 315 generated towards the end of the conversation substantially higher than those generated at the beginning of the conversation, as is generally assumed each group (and the networked of groups) gradually converges on the collective insights over time. Global conversational observer 320 is an example of, or includes aspects of, the corresponding element described with reference to FIGS. 4 and 5.

According to an exemplary embodiment, the collaborative system may be implemented among 800 people ((p)=800) to forecast the team that will win the Super Bowl next week. The conversational prompt in the example can be as follows-“The Kansas City Chiefs are scheduled to play the Philadelphia Eagles in the Super Bowl this Sunday. Who is going to win the game and why? Please discuss.”

The prompt is entered by a moderator and is distributed by the HyperChat server (e.g., collaboration server as described with reference to FIGS. 1-2) to each of the HyperChat clients over communication networks (e.g., 800 users on the networked computing device described in FIGS. 1-2). The local HyperChat client application (e.g., local chat application described in FIGS. 1-2) that is running on the computer associated with each user displays the conversational prompt to the user. Thus, the prompt is sent from the collaboration server to 800 computing devices (e.g., desktops, laptops, phones, tablets, or other suitable devices with processing, input, and display capabilities). The prompt is shown to 800 users by the computing device associated with each user. The prompt can be displayed as text or as verbal content using a simulated voice. In some cases, the prompt can be provided by a visual representation of a human moderator (i.e., either a simulated flat video image or a 3D avatar). Thus, the 800 users who participate in the collaborative discussion and forecasting effort each receive the prompt: “The Kansas City Chiefs are scheduled to play the Philadelphia Eagles in the Super Bowl this Sunday. Who is going to win the game and why? Please discuss.” In preferred embodiments, this happens at substantially the same time coordinated by the server, thus ensuring that all participants (across the plurality of sub-groups) kick off the discussion together.

The HyperChat server (i.e., collaboration server as described in FIGS. 1-2) performs a computational task that divides the 800 users into 80 subgroups (i.e., n=80) of 10 users each. The 80 subgroups can be considered as “Chat Room 1”, “Chat Room 2”, to “Chat Room 80”. Thus, each of the 800 users are uniquely assigned to one of the 80 chat rooms. In some cases, the chat rooms can appear to the user as traditional text chat rooms in which each user is represented by a unique username in text with 10 such unique usernames in each room. In some cases, the chat rooms can appear to the user as a video conference call (e.g., Zoom) in which each user is represented by a webcam video feed with 10 video feeds in each room. The chat rooms can appear to the user as a 3D virtual conference room (e.g., Horizon Workroom) in which each of the 10 users appear as 3D avatars sitting around a virtual conference table to hold a conversation. The creation and display of AI-powered avatars with real-time voice and animated facial features (generated from text) can be enabled using off-the-shelf software modules with API interaction from companies such as Heygen and Synthesia.

Accordingly, the HyperChat server creates 80 unique conversational spaces and assigns 10 unique users to each of the spaces and enables the 10 users in each space to hold a real-time conversation with the other users in the space. Each of the users are aware that the topic to be discussed, as injected into the rooms by the HyperChat Server, is “The Kansas City Chiefs are scheduled to play the Philadelphia Eagles in the Super Bowl this Sunday. Who is going to win the game and why? Please discuss.”

According to some embodiments, a timer appears in each room, giving each subgroup six minutes to discuss the issue, surfacing the perspectives and opinions of various members of each group. As the users engage in real-time dialog (by text, voice, video, and/or 3D avatar), the conversational observer agent associated with each room monitors the dialogue. At one-minute intervals during the six minute discussion, the conversational observer agent associated with each room may be configured to automatically generate an informational summary for that room for that one-minute interval. In some embodiments, the informational summary can refer to storing the one-minute interval of dialogue (e.g., either captured as text directly or converted to text through known speech to text methods) and then sending the one minute of text to a foundational AI model (e.g., ChatGPT) via an API with a request that the Large Language Model summarize the one minute of text, extracting the most important points and ordering the points from most important to least important based on the conviction of the subgroup with regard to each point. Conviction may be assessed based on the strength of the sentiment assessing each point by individual members and/or based on the level of agreement among members on each point. The ChatGPT engine produces an informational summary for each conversational observer agent (i.e., an informational summary for each group. Note—in this example, this process of generating the conversational summary of the one-minute interval of conversation would happen multiple times during the full six-minute discussion.)

Each time a conversational summary is generated for a sub-group by an observer agent, a representation of the informational content is then sent to a conversational surrogate agent in another room. As shown in FIG. 3, each room is associated with another room in a ring structure where the conversational observer agent of the last room in the list is associated with a conversational surrogate agent associated with the first room. While a ring structure is a viable way to have information propagate across all rooms, other network structures are possible for connecting conversational observer agent from one room to conversational surrogate agent in other rooms. In some examples, the network structures can include a ring structure with jumper cables across the ring to drive faster propagation of information. The network structure can also include randomized connections and/or small world connections.

Assuming the ring network structure shown in FIG. 3, at the end of each one-minute interval, an informational summary about the prior one minute of conversation held in Chat Room 1 will be injected into Chat Room 2 (via a conversational surrogate agent). At substantially the same time, an informational summary about the prior one-minute conversation held in Chat Room 2 will be injected into Chat Room 3 (via a conversational surrogate agent). The same thing happens between Chat Rooms 3 and 4, to the remaining pairs of rooms until an informational summary about the conversation held in Chat Room 80 will be injected into Chat Room 1 (via a conversational surrogate agent).

Accordingly, each chat room is exposed to a conversational summary from another chat room. And this repeats over time, for multiple intervals, thereby enabling conversations in parallel chat rooms to remain independent but coordinated over time by the novel use of information propagation.

For example, a conversational surrogate agent in Chat Room 22 may express the informational summary received from Chat Room 21 as follows-“Having listened to another group of users, I would argue that the Kansas City Chiefs are more likely to win the Super Bowl because they have a more reliable quarterback, a superior defense, and have better special teams. On the other hand, recent injuries to the Chiefs could mean they don't play up to their full capacity while the Eagles are healthier all around. Still, considering all the issues the Chiefs are more likely to win.”

The human participants in Chat Room 22 are thus exposed to the above information, either via text (in case of a text-based implementation) or by live voice (in case of a voice chat, chat, or avatar-based video implementation). A similar process is performed in each room, i.e., with different information summaries.

In parallel to each of the informational summaries being injected into an associated subgroups for consideration by the user of the subgroup, the informational summaries for the 80 subgroups are routed to the global conversational observer agent which summarizes the key points across the 80 subgroups and assesses conviction and/or confidence based on the level of agreement among subgroups. For example, if 65 of the 80 subgroups were leaning towards the Chiefs as the likely Super Bowl winner, a higher conviction score would be assigned to that sentiment as compared to a situation where, for example, as few as 45 of the 80 subgroups were leaning towards the Chiefs as the likely Superbowl Winner.

Additionally, when the users receive the informational summary from another room into their room, an optional updated prompt may be sent to each room and displayed, asking the members of each group to have an additional conversational period in light of the updated prompt, thus continuing the discussion in consideration of their prior discussion and the information received from another subgroup and the updated prompt. Int this example, the second conversational period can be another six-minute period. However, in practice the system may be configured to provide a slightly shorter time period. For example, a four-minute timer is generated in each subgroup.

In some cases, the users engage in real-time dialogue (by text, voice, video, and/or 3D avatar) for the allocated time period (e.g., four minutes). At the end of four minutes, the conversational observer agent associated with each room is tasked with generating a new informational summary for the room for the prior four minutes using similar techniques. In some embodiments, the summary includes the prior six-minute time period, but is weighted less in importance. In some cases, conviction may be assessed based on the strength of the sentiment assessing each point by individual members and/or based on the level of agreement among members on each point. Additionally, agreement of sentiments in the second time period with the first time period may also be used as an indication of higher conviction.

The informational summary from each conversational observer agent is then sent to a conversational surrogate agent in another room. Assuming the ring network structure shown in FIG. 3, an informational summary about the prior four-minute conversation held in Chat Room 1 is injected into Chat Room 2 (via a conversational surrogate agent). At substantially the same time, an informational summary about the prior four-minute conversation held in Chat Room 2 is injected into Chat Room 3 (via a conversational surrogate agent). The same process is performed between Chat Rooms 3 and 4, till the 79 pairs of rooms, etc. until an informational summary about the conversation held in Chat Room 80 is injected into Chat Room 1 (via a conversational surrogate agent). Accordingly, each chat room is exposed to a second conversational summary from another chat room.

Regardless of the specific time periods used as the interval for conversational summaries, each room is generally exposed to multiple conversational summaries over the duration of a conversation. In the simplest case of a first time period and a second time period, it is important to clarify that in the second time period, each room is exposed to a second conversational summary from the second time period reflecting the sentiments of the same subgroup it received a summary from in the first time period. In other embodiments, the order of the ring structure can be randomized between time periods, such that in the second time period, each of the 80 different subgroups is associated with a different subgroup than it was associated with in the first time period. In some cases, such randomization increases the informational propagation across the population.

In case of a same network structure or an updated network structure used between time periods, the users consider the informational summary in the room and then continue the conversation about who will win the super bowl for the allocated four-minute period. At the end of the four-minute period, the process may repeat with another round (e.g., for another time period, for example of two minutes, with another optionally updated prompt). In some cases, the process can conclude if the group has sufficiently converged on a collective intelligence prediction, solution, or insight.

At the end of various conversational intervals (by elapsed time or by elapsed content), the Collaboration Server can be configured to optionally route the informational summaries for that interval to the global conversational observer agent which summarizes the key points across the (n) subgroups and assesses conviction and/or confidence based on the level of agreement among subgroups to assess if the group has sufficiently converged. For example, the Collaboration Server can be configured to assess if the level of agreement across subgroups is above a threshold metric. If so, the process is considered to reach a conversational consensus. Conversely, if the level of agreement across subgroups has not reached a threshold metric, the process may demand (e.g., and include) further deliberation. In this way, the Collaboration Server can intelligently guide the population to continue deliberation until a threshold level of agreement is reached, at which point the Collaboration Server ends the deliberation.

In case of further deliberation, an additional time period is automatically provided and the subgroups are tasked with considering the latest informational summary from another group along with their own conversations and discuss the issues further. In the case of the threshold being met, the Conversation Server can optionally send a Final Global Conversational Summary to all the sub-groups, informing all participants of the final consensus reached.

Accordingly, embodiments of the present disclosure include a HyperChat process with multiple rounds. Before the rounds start, the population is split into a set of (n) subgroups, each with (u) users. In some cases, before the rounds start, a network structure is established that identifies the method of feeding information between subgroups. As shown in FIG. 3, a ring structure is used such that each subgroup is numbered from 1 to N and wherein an informational summary from each subgroup X is generated by a Conversational Observer Agent (e.g., a using Foundational Al model such as ChatGPT) and is fed into subgroup X+1 and expressed conversationally within that subgroup by a Conversational Surrogate Agent (e.g., using a Foundational Al model such as ChatGPT). The Informational Summary of Subgroup N is fed back to the beginning of the list, injected into Subgroup 1 because this is a ring structure. In addition, at the end of each round the Global Conversational Observer Agent generates an Informational Summary across subgroups N. Rounds repeat one after another, stopping when the Informational Summary across subgroups N has reached a sufficient threshold of agreement and/or conviction in an outcome. In some embodiments, a threshold number (e.g., a maximum number) of rounds is defined, and if the group reaches the threshold number of rounds (e.g., the maximum number of rounds) without reaching sufficient threshold of agreement and/or conviction, an output is delivered along with an indication that the group could not find sufficient consensus.

In some embodiments, the informational summary fed into each subgroup is based on a progressively larger number of subgroups. For example, in the first round, each subgroup gets an informational summary based on the dialog in one other subgroup. In the second round, each subgroup gets an informational summary based on the dialog within two subgroups. In the third round, each subgroup gets an informational summary based on the dialog within four subgroups. In this way, the system helps drive the population towards increasing consensus.

In some embodiments, there are no discrete rounds but instead a continuously flowing process in which subgroups continuously receive Informational Summaries from other subgroups, e.g., based on new points being made within the other subgroup (i.e., not based on time periods).

According to some embodiments, the Conversational Surrogate agents selectively insert arguments into the subgroup based on arguments provided in other subgroups (based on the information received using the Conversational Observer agents). For example, the arguments may be counterpoints to the subgroup's arguments based on counterpoints identified by other Conversational Observers, or the arguments may be new arguments that were not considered in the subgroup that were identified by other Conversational Observers watching other subgroups.

In some cases, a functionality is defined to enable selective argument insertion by a Conversational Surrogate agent that receives conversational summary information from a subgroup X and inserts selective arguments into its associated subgroup Y. For example, a specialized Conversational Surrogate associated with subgroup Y performs additional functions. In some examples, the functions may include monitoring the conversation within subgroup Y and identifying the distinct arguments made by users during deliberation, maintaining a listing of the distinct arguments made in subgroup y, optionally ordered by assessed importance of the arguments to the conversing group, and when receiving a conversational summary from a Conversational Observer agent of subgroup X, comparing the arguments made in the conversational summary from subgroup X with the arguments that have already been made by participants in subgroup Y, identifying any arguments made in the conversational summary from subgroup x that were not already made by participants in the dialog within subgroup Y. Additionally, the functions may include expressing to the participants of subgroup Y as dialog via text or voice, one or more arguments extracted from the conversational summary from subgroup x that was identified as having not already been raised within subgroup x.

The present disclosure describes systems and methods that can enable large, networked groups to engage in real-time conversations with informational flow throughout the population without the drawbacks of individuals needing to communicate directly within unmanageable group sizes. Accordingly, multiple individuals (thousands or even millions) can engage in a unified conversation that aims to converge upon a singular prediction, decision, evaluation, forecast, assessment, diagnosis, or recommendation while leveraging the full population and the associated inherent collective intelligence.

FIG. 4 shows an example of a HyperChat process according to aspects of the present disclosure. The example shown includes chat room 400, conversational dialogue 415, and global conversation observer 420. The HyperChat process of FIG. 4 is substantially the same as described with reference to FIG. 3 and hence repeated descriptions are omitted for brevity.

Chat room 400 is an example of, or includes aspects of, the corresponding element described with reference to FIGS. 3, 5, 6, 8, and 9. In certain aspects, chat room 400 includes user 405, conversational observation agent 410, conversational surrogate agent 425, and global surrogate agent 430.

As shown with reference to FIG. 4, a Global Surrogate Agent (GS) 430 can be added to each subgroup to selectively represent the views, arguments, and narratives that have been observed across the full population during a recent time period. For example, GS (n) in FIG. 4 represents the Global Surrogate agent present in chat room n. The Global Surrogate agent 430 in each room (n) is configured to impart conversational content (as text, voice, video, and/or 3D avatar) into a single subgroup (chat room) based on the Global Conversational Summary generated by the Global Conversational Observer 420 (as described with reference to FIG. 3). The views represented by each GS (n) agent 430 into each subgroup (n) may be identical. Global surrogate agent 430 is an example of, or includes aspects of, the corresponding element described with reference to FIG. 11. Global conversation observer 420 is an example of, or includes aspects of, the corresponding element described with reference to FIGS. 3, 5, 6, and 9.

In some embodiments, the views represented by each GS (n) agent 430 into each subgroup (n) can be custom tailored for the subgroup based on the subgroup's interactive dialog (among users 405), as analyzed by the subgroup's Conversational Observer (i.e., conversational observation agent 410) and/or can be based on the analysis of pre-session data that is optionally collected from participants and used in the formation of subgroups. User 405 is an example of, or includes aspects of, the corresponding element described with reference to FIGS. 1-3, 5, 6, 8, and 9. Conversational observation agent 410 is an example of, or includes aspects of, the corresponding element described with reference to FIGS. 2, 3, 6, 9, and 10.

For example, a GS agent 430 may summarize the population's discussion and inject a representation of the summary as interactive dialog into subgroups. For example, considering the Super Bowl prediction, the GS agent may be configured to inject a summary into subgroups and ask for elaboration based on a central theme that was observed. For example, the analysis across subgroups (by the Global Conversational Observer Agent) may indicate that most groups agree the outcome of the Super Bowl depends on whether the Chief's quarterback Mahomes, who has been playing hot and cold, plays well on Super Bowl day. Based on the observed theme, the injected dialog by the GS agent may be—“I've been watching the conversation across the many subgroups and a common theme has appeared. It seems many groups believe that the outcome of the Super Bowl is significantly dependent upon the Chief's quarterback Mahomes, who has been inconsistent in recent weeks. What could affect Mahomes' performance this Sunday and do we think Mahomes is likely to have a good day?”. Such a first-person dialog may be crafted (e.g., via ChatGPT API) to provide a summary of a central theme observed across groups and then ask for discussion and elaboration, thereby encouraging the subgroup to discuss the issue. Accordingly, a consensus is built across the entire population by guiding subgroups towards central themes and providing for the opportunity to explore, elaborate, or reject the globally observed premise.

In some embodiments, the phrasing of the dialog from the GS agent may be crafted from the perspective of an ordinary member of the subgroup, not highlighting the fact that the agent is an artificial observer. For example, the dialog above could be phrased as “I was thinking, the outcome of the Super Bowl is significantly dependent upon the Chief's quarterback Mahomes, who has been inconsistent in recent weeks. What could affect Mahomes' performance this Sunday and do we think Mahomes is likely to have a good day?” This phrasing expresses the same content, but optionally presents it in a more natural conversational manner.

In some embodiments, the globally injected summary and query for elaboration could be based not on a common theme observed globally but based on an uncommon theme observed globally (i.e., a divergent viewpoint). By directing one or more subgroups to brainstorm and/or debate divergent viewpoints that are surfaced globally (i.e., but not in high frequency among subgroups), this software mediated method can be configured to ensures that many subgroups consider the divergent viewpoint and potentially reject, accept, modify, or qualify the divergent viewpoint. This has the potential to amplify the collective intelligence of the group, by propagating infrequent viewpoints and conversationally evoking levels of conviction in favor of, or against, those viewpoints for use in analysis. In an embodiment, the Global Surrogate Agents present the most divisive narratives to subgroups to foster global discussion around key points of disagreement.

One or more embodiments of the present disclosure further include a method for challenging the views and/or biases of individual subgroups based on the creation of a Conversational Instigator Agent that is designed to intelligently stoke conversation within subgroups in which members are not being sufficiently detailed in expressing the rationale for the supported positions or rejected positions. In such cases, a Conversational Instigator Agent can be configured to monitor and process the conversational dialog within a subgroup and identify when positions are expressed (for example, the Chiefs will win the Super Bowl) without expressing detailed reasons for supporting that position. In some cases, when the Conversational Instigator Agent identifies a position that is not associated with one or more reasons for the position, it can inject a question aimed at the human member who expressed the unsupported position. For example, “But why do you think the Chiefs will win?” In other cases, it can inject a question aimed at the subgroup as a whole. For example, “But why do we think the Chiefs will win?”

In addition, the Conversational Instigator Agent can be configured to challenge the expressed reasons that support a particular position or reject a particular position. For example, a human member may express that the Chiefs will win the Super Bowl “because they have a better offense.” The Conversational Instigator Agent can be configured to identify the expressed position (i.e., the Chiefs will win) and identify the supporting reason (i.e., they have a better offense) and can be further configured to challenge the reason by injecting a follow-up question, “But why do you think they have a better offense?”. Such a challenge then instigates one or more human members in the subgroup to surface reasons that support the position that the Chiefs have a better offense, which further supports the position that the Chiefs will win the Super Bowl. In some embodiments, the Conversational Instigator Agent is designed to probe for details using specific phraseology, for example, responding to unsupported or weakly supported positions by asking “But why do you support” the position, or asking “Can you elaborate” on the position. Such phraseologies provide an automated method for the Al agents to stoke the conversation and evoke additional detail in a very natural and flowing way. Accordingly, the users do not feel the conversation has been interrupted, stalled, mediated, or manipulated.

According to some embodiments, one or more designated human moderators are enabled to interface with the Global Conversational Agent and directly observe a breakdown of the most common positions, reasons, themes, or concerns raised across subgroups and provide input to the system to help guide the population-wide conversation. In some cases, the Human Moderator can indicate (through a standard user interface) that certain positions, reasons, themes, or concerns be overweighted when shared among or across subgroups. This can be achieved, for example, by enabling the Human Moderator to view a displayed listing of expressed reasons and the associated level of support for each, within a subgroup and/or across subgroups and clicking on one or more to be overweighted. In other cases, the Human Moderator can indicate that certain positions, reasons, themes, or concerns be underweighted when shared among or across subgroups. For example, Human Moderators are enabled to indicate that certain positions, reasons, themes, concerns be barred from sharing among and across mitigate subgroups, for example to offensive or inappropriate content, inaccurate information, or threads that are deemed off-topic. In this way, the Human Moderator can provide real-time input that influences the automated sharing of content by the Conversational Instigator Agent, either increasing or decreasing the amount of sharing of certain positions, reasons, themes, or concerns among subgroups.

The loudest person in a room can greatly sway the other participants in that room. In some cases, such effects may be attenuated using small rooms, thereby containing the impact of the loudest person to a small subset of the full participants, and only passing information between the rooms that gain support from multiple participants in that room. In some embodiments, for example, each room may include only three users and information only gets propagated if a majority (i.e., two users) express support for that piece of information. In other embodiments, different threshold levels of support may be used other than majority. In this way, the system may attenuate the impact of a single loud user in a given room, requiring a threshold support level to propagate their impact beyond that room.

FIG. 5 shows an example of an interaction process according to aspects of the present disclosure. The example shown includes chat room 500 and global conversation observer 515.

Chat room 500 is an example of, or includes aspects of, the corresponding element described with reference to FIGS. 3, 4, 6, 8, and 9. In certain aspects, chat room 500 includes user 505 and computing device 510. User 505 is an example of, or includes aspects of, the corresponding element described with reference to FIGS. 1-4, 6, 8, and 9.

In certain aspects, computing device 510 may include a conversational observer agent and a conversational surrogate agent. Computing device 510 is an example of, or includes aspects of, the corresponding element described with reference to FIGS. 1, 2, and 11. Conversational observer agent and conversational surrogate agent are examples of, or includes aspects of, the corresponding elements described with reference to FIGS. 1, 2, 3, 6, and 11. Global conversation observer 515 is an example of, or includes aspects of, the corresponding element described with reference to FIGS. 3, 4, 6, and 9.

As an example shown in FIG. 5, the interactive process for a collaboration system is shown as a 6 step process (indicated by numbers 1-6). For example, in a first step (indicated in 1), users u1 to u15 in chat rooms C1, C2, and C3 perform parallel chat conversations that are captured by AI-based computing device 510 represented as ai1, ai2, and ai3 in chat rooms C1, C2, and C3 respectively. Details regarding the functions of the computing device are provided in FIGS. 1-4.

Each computing device 510 uses a LLM to generate an informational summary of the conversation of the chat rooms C1, C2, and C3. A representation of the informational summary thus generated is sent to the conversational agent of the next chat room in a ring structure as the second step (indicated in 2). For example, the computing device ai1 of chat room C1 sends the summary of chat room C1 to the computing device a2 of chat room C2. Similarly, the computing device ai2 of chat room C2 sends the summary of chat room C2 to the computing device ai3 of chat room C3 and the computing device ai3 of chat room C3 sends the summary of chat room C3 to the computing device ai1 of chat room C1. Further details regarding transferring the summary to other chat rooms is provided with reference to FIG. 3.

Each computing device 510 of a chat room shares the informational summary received from the other chat room to the users of the respective chat room (as a third step indicated by 3). As an example shown in FIG. 5, the computing device ai1 of chat room C1 shares the summary of chat room C3 with the users of chat room C1. Similarly, the computing device ai2 of chat room C2 shares the summary of chat room C1 with the users of chat room C2 and the computing device ai3 of chat room C3 shares the summary of chat room C2 with the users of chat room C3. Further description regarding this step is provided with reference to FIG. 3.

Steps 1, 2 and 3 may optionally repeat a number of times, enabling users to hold deliberative conversations in the three parallel chat rooms for multiple intervals after which conversational information propagates across rooms as shown.

In step four, the Computing device 510 corresponding to each chat room sends the informational summary to global conversation observer (G) 515 (fourth step indicated by 4). The global conversation observer 515 generates a global conversation summary after the each of the chat rooms hold parallel conversations for some time while incorporating content from the informational summaries passed between chat rooms. For example, the global conversation summary is generated based on the informational summaries from each chat room over one or more conversational intervals.

In the fifth and sixth steps (indicated in 5 and 6), the global conversation summary is provided to computing device 510 of each chat room C1, C2, and C3, which in turn share the global conversation summary with the users in the chat room. Details regarding this step are provided with reference to FIG. 3.

FIG. 6 shows an example of an interaction process according to aspects of the present disclosure. The example shown includes chat room 600 and global conversation observer 620.

Chat room 600 is an example of, or includes aspects of, the corresponding element described with reference to FIGS. 3-5, 8, and 9. In certain aspects, chat room 600 includes user 605, conversational observer agent 610, and conversational surrogate agent 615. User 605 is an example of, or includes aspects of, the corresponding element described with reference to FIGS. 1-5, 8, and 9.

Conversational observer agent 610 is an example of, or includes aspects of, the corresponding element described with reference to FIGS. 2-4, 9, and 10. Conversational surrogate agent 615 is an example of, or includes aspects of, the corresponding element described with reference to FIGS. 2-4, 8, 9, and 11. Global conversation observer 620 is an example of, or includes aspects of, the corresponding element described with reference to FIGS. 3-5, and 9.

FIG. 6 shows an interaction process for collaborative conversations as a 5-step process. In the first step, a large population engages in a single conversation such that each participant is associated with one of a plurality of small subgroups of users and is enabled to directly communicate with the other users in that unique subgroup of users. Conversational observer agent 610 (e.g., conversational observer agent as described with reference to FIGS. 1-3) keeps track of the conversation among each subgroup and generates summaries using the LLM (as described with reference to FIGS. 1-3).

In the second step, the collaboration server (described with reference to FIGS. 1-2) uses the conversational observer agent to coordinate information exchange between the separate chat rooms (i.e., between the separate conversations happening in parallel among separate subgroups). The information exchange is performed when the conversational observer agent generates a conversational representation of the summary (e.g., using LLM) for a given chat room of a given sub-group and sends the summary representation to conversational surrogate agent 615 of another chat room for another sub-group.

In some cases, conversational observer agent 610 may generate summarized points to be sent at regular time intervals or intervals related to dialogue flow. The content that is shared between subgroups is injected by the conversational surrogate agent 615 (in the third step) as conversational content and presented as text chat or voice chat or video chat from a simulated video to the users of the respective sub-group by a surrogate member (i.e., conversational surrogate agent 615) of the group. Accordingly, a block of informational content is generated by one subgroup, summarized to extract the key points, and then expressed into another subgroup.

In a third step, the plurality of subgroups continue their parallel deliberative conversations, now with the benefits of the informational content received in the second step. In this way, the participants in each subgroup can consider, accept, reject or otherwise discuss ideas and information from another subgroup, thereby enabling conversational content to gradually propagate across the full population in a thoughtful and proactive manner.

In preferred embodiments, the second and third steps are repeated multiple times (at intervals) enabling information to continually propagate across subgroups during the real-time conversation. By enabling local real-time conversations in small deliberative subgroups, while simultaneously enabling real-time conversational content to propagate across the subgroups, the collective intelligence is amplified as the full population is enabled to converge on unified solutions.

According to some embodiments, in a fourth step, a global conversation observer 620 takes as input, the informational summaries that were generated by each of the conversational observer agents 610, and processes that information which includes an extraction of key points across a plurality of the subgroups and produces a global informational summary.

Global conversational observer 620 documents and stores informational summaries at regular intervals, thereby documenting a record of the changing sentiments of the full population and outputs a final summary at the end of the conversation based on the stored global records. Global conversational observer 620, in a fifth step, provides the final summary to each surrogate agent 615, which in turn provides the final summary to each user in the collaborative system. In this way, all participants are made aware of the solution or consensus reached across the full population of participants.

In some embodiments, a global surrogate agent is provided in each subgroup to selectively represent the views, arguments, and narratives that have been observed across the entire population. In some embodiments, the views represented by each global surrogate agent into each subgroup (n) can be custom tailored for the subgroup based on the subgroup's interaction. For example, a global surrogate agent may summarize the population's discussion and inject a representation of the summary as interactive dialog into subgroups.

### Dynamic Grouping

One or more embodiments of the present disclosure include a method for engineering subgroups to have deliberate bias. Accordingly, in some embodiments of the present invention, the discussion prompt is sent (by the central server) to the population of users before the initial subgroups are defined. The users provide a response to the initial prompt via text, voice, video, and/or avatar interface that is sent to the central server. In some embodiments, the user can provide an initial response in a graphical user interface that provides a set of alternatives, options, or other graphically accessed controls (including a graphic swarm interface or graphical slider interface as disclosed in the aforementioned patent applications incorporated by reference herein). The responses from the population are then routed to a Global Pre-Conversation Observer Agent that performs a rapid assessment. In some embodiments, the assessment is a classification process performed by an LLM on the set of initial responses, determining a set of Most Supported User Perspectives based on the frequency of expressed answers from within the population.

Using the classifications, a Subgroup Formation Agent is defined to subdivide the population into a set of small subgroups, i.e., to evenly distribute the frequency of Most Supported User Perspectives (as expressed by users) across the subgroups.

For example, a group of 1000 users may be engaged in a HyperChat session. An initial prompt is sent to the full population of users by the centralized server. In some examples, the initial conversational prompt may be—“What team is going to win the Super Bowl next year and why?”

Each user u(n) of the 1000 users provides a textual or verbal response to the local computer, the responses routed to the central server as described with reference to FIGS. 3-4. The Global Pre-Conversation Observer Agent then performs a Classification Process, identifying a set of most supported answers to the prompt. In some examples, the most supported answers are a set of teams that the 1000 users most commonly believe will win the Super Bowl Next year. The most supported set may be the following seven teams—“Chiefs, 49ers, Cowboys, Eagles, Patriots, Rams, Packers,”

The Subgroup Formation Agent then divides the population into subgroups, working to create the distribution (e.g., the maximum distribution) of user perspectives across subgroups, such that each subgroup comprises a diverse set of perspectives (i.e., avoid having some groups overweighted by users who prefer the chiefs while other groups are overweighted by users who prefer the Eagles). Accordingly, subgroups being formed are not biased towards a particular team, and may have a healthy debate for and against the various teams.

In some embodiments, a distribution of bias is deliberately engineered across subgroups by algorithms running on the central server to have a statistical sampling of groups that lean towards certain beliefs, outcomes, or demographics. Accordingly, the system can collect and evaluate the different views that emerge from demographically biased groups and assess the reaction of the biased groups when Conversational Surrogate Agents that represent groups with alternative biases inject comments into that group.

An embodiment includes collection of preliminary data from each individual entering the HyperChat system (prior to assignment to subgroups) to create “bias engineered subgroups” on the central server. The data may be collected with a pre-session inquiry via survey, poll, questionnaire, text interview, verbal interview, a swarm interface, or another known tool. Using the collected pre-session data, users are allocated into groups based on demographic characteristics and/or expressed leanings. In some embodiments, users with similar characteristics in the pre-session data are grouped together to create a set of similar groups (e.g., maximally similar groups). In some embodiments, a blend of biased groups is created with some groups containing more diverse perspectives than others.

The HyperChat system begins collecting the discussion from each subgroup once the biased subgroups are created. After the first round (before Conversational Surrogate agents inject sentiments into groups), the Global Observer agent can be configured to assess what narratives (i.e., reasons, counterarguments, prevailing methods of thought) are most common in each subgroup that is biased in specific ways and the degree to which the biases and demographics impact the narratives that emerge. For example, subgroups that are composed of more Kansas City Chiefs fans might express different rationale for Super Bowl outcomes than subgroups that are composed of fewer Chiefs fans or may be less likely to highlight the recent performance of the Chiefs quarterback to justify the likelihood of the Chiefs winning the Super Bowl next year. The Global Observer agent quantifies and collates the differences to generate a single report describing the differences at a high level. Then, the Conversation Surrogate agents can be configured to inject views from groups with specific biases into groups with alternate biases, provide for the group to deliberate when confronted with alternate viewpoints, and measure the degree to which the alternate views influence the discussion in each subgroup. Accordingly, the HyperChat system can be algorithmically designed to increase (e.g., and/or maximize) the sharing of opposing views across subgroups that lean in different directions.

In an alternate embodiment, the Ring Structure that defines information flow between subgroups is changed between rounds, such that most subgroups receive informational summaries from different subgroups in each round. Accordingly, information flow is increased. In some embodiments, the Ring Structure can be replaced by a randomized network structure or a small world network structure. In some embodiments, users are shuffled between rounds with some users being moved to other subgroups by the HyperSwarm server.

### HyperChat for Rounded and Roundless Structures

One or more embodiments of the present disclosure are structured in formalized “rounds” that are defined by the passage of a certain amount of time or other quantifiable metrics. Thus, rounds can be synchronous across subgroups (i.e., rounds start and end at substantially the same time across subgroups), rounds can be asynchronous across subgroups (i.e., rounds start and end independently of the round timing in other subgroups), and rounds can be invisible to users within each subgroup (i.e., rounds may be tracked by the central server to mediate when a block of conversational information is injected into a given subgroup, but the participants in that subgroup may perceive the event as nothing more than an artificial agent injecting a natural comment into the conversation in the subgroup).

For example, a system can be structured with 200 subgroups (n=1 to n=200) of 10 participants each for a total population of 2000 individuals (u=1 to u=1000). A particular first subgroup (n=78) may be observed by a Conversational Observer Agent (COai 78) process and linked to a second subgroup (n=89) for passage of conversational information via Conversational Summary Agent (CSai 89). When a certain threshold of back-and-forth dialog exceeds in the first subgroup, as determined by process (COai 78), a summary is generated and passed to process (CSai 89) which then expresses the summary, as a first person interjection (as text, voice, video, and or avatar) to the members of the second subgroup (in a ring structure of 200 subgroups). The members of Subgroup 89 that hear and/or see the expression of the summary from Subgroup 78 may perceive the summary as an organic injection into the conversation (i.e., not necessarily as part of a formalized round structured by the central server).

In some examples, a first group of participants may be asked to discuss a number of issues related to NBA basketball in a text-based chat environment. After a certain amount of time, the chat dialog is sent (for example, API-based by an automated process) to a LLM model that summarizes the dialog that had elapsed during the time period, extracting the important points while avoiding unnecessary information. The summary is then passed to the LLM (for example, by API-based automated process) to convert it into a first person expression and to inject the expression into another chat group. A dialog produced by the LLM model (e.g., ChatGPT) may be:

“I observed a group of sports fans discussing the Lakers vs. Grizzlies game, where the absence of Ja Morant was a common reason why they picked the Lakers to win. They also discussed the Eastern conference finals contenders, with the Milwaukee Bucks being the most supported choice due to their consistency and balanced team. Some expressed confidence in the Bucks, while others had conflicting views due to recent losses and player absences. The Boston Celtics and Philadelphia 76ers were also mentioned as potential contenders, but doubts were raised over their consistency and playoff performance.”

Accordingly, members of the second group can read a summary of conversational information, including central arguments, from a first subgroup. In some cases, the expression is in the first person and thus feels like a natural part of the conversation in the second subgroup.

### A Collaboration Process

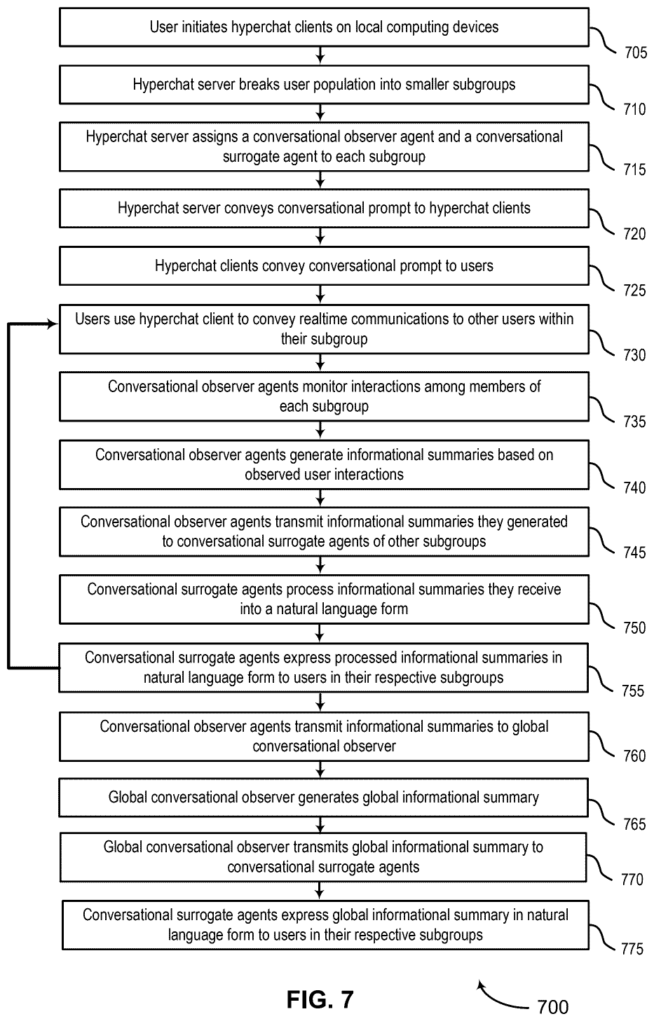

FIG. 7 shows an example of a flowchart for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system users initiate HyperChat clients (i.e., local chat application) on local computing devices. In some cases, the operations of this step refer to, or may be performed by, the user as described with reference to FIGS. 1-5.

At operation 710, the system breaks user population into smaller subgroups. In some cases, the operations of this step refer to, or may be performed by, the HyperChat server. According to some embodiments, the HyperChat server may be a collaboration server (described with reference to FIGS. 1-3).

At operation 715, the system assigns a conversational observer agent and a conversational surrogate agent to each subgroup. In some cases, the operations of this step refer to, or may be performed by, the HyperChat server or collaboration server as described with reference to FIGS. 1-3. In some cases, the observer agent and the surrogate agent are performed by the same software process and may be considered a single dual-purpose AI agent.

At operation 720, the system conveys conversational prompt to HyperChat clients. In some cases, the operations of this step refer to, or may be performed by, the HyperChat server or collaboration server as described with reference to FIGS. 1-3.

At operation 725, the system conveys conversational prompt to users within each subgroup. In some cases, the operations of this step refer to, or may be performed by, the HyperChat server or collaboration server as described with reference to FIGS. 1-3. In some embodiments the system expresses the prompt using different wording or style in different subgroups depending on the configuration of the surrogate agent with respect to that subgroup.

At operation 730, the system uses HyperChat client to convey real time communications to and from other users within their subgroup. In many preferred embodiments, this real-time communication is routed through the collaboration server, which mediates message passage among members of each subgroup via the hyperchat client. In some cases, the operations of this step refer to, or may be performed by, the user as described with reference to FIGS. 1-5.

At operation 735, the system monitors interactions among members of each subgroup. In some cases, the operations of this step refer to, or may be performed by, the conversational observer agent as described with reference to FIGS. 1-5.

At operation 740, the system generates informational summaries based on observed user interactions. In some cases, the operations of this step refer to, or may be performed by, the conversational observer agent as described with reference to FIGS. 1-5.

At operation 745, the system transmits informational summaries they generated to conversational surrogate agents of other subgroups. In some cases, the operations of this step refer to, or may be performed by, the conversational observer agent as described with reference to FIGS. 1-5.

At operation 750, the system processes informational summaries they receive into a natural language form. In some cases, the operations of this step refer to, or may be performed by, the conversational surrogate agent as described with reference to FIGS. 1-5.

At operation 755, the system expresses processed informational summaries in natural language form to users in their respective subgroups. In some cases, the operations of this step refer to, or may be performed by, the conversational surrogate agent as described with reference to FIGS. 1-5.

At operation 755, the process optionally repeats by jumping back to operation 730, thus enabling the members within each subgroup to continue their real-time dialog, their deliberations now influenced by the conversational content that was injected into their room. In this way, steps 730 to 755 can be performed at repeated intervals during which subgroups deliberate, their conversations are observed, processed, and summarized, and a representation of the summary is passed into other groups. The number of iterations can be pre-planned in software, or can be based on pre-defined time limits, or can be dependent on the level of conversational agreement within or across subgroups. In all cases, the system will eventually cease repeating steps 730 to 755.

At operation 760, the system transmits informational summaries to global conversational observer. In some cases, the operations of this step refer to, or may be performed by, the conversational observer agent as described with reference to FIGS. 1-5. According to some embodiments, operation 760 is performed after operations 730 to 755 are performed parallelly for a certain time.

At operation 765, the system generates global informational summary. In some cases, the operations of this step refer to, or may be performed by, the global conversational observer as described with reference to FIGS. 1-5.

At operation 770, the system transmits global informational summary to conversational surrogate agents. In some cases, the operations of this step refer to, or may be performed by, the global conversational observer as described with reference to FIGS. 1-5.

At operation 775, the system expresses global informational summary in natural language form to users in their respective subgroups. In some cases, the operations of this step refer to, or may be performed by, the conversational surrogate agent as described with reference to FIGS. 1-5.

In some embodiments, the process at 775 optionally jumps back to operation 730, thus enabling the members within each subgroup to continue their real-time dialog, their deliberations now influenced by the global information summary that was injected into their room. The number of iterations (jumping back to 730) can be pre-planned in software, or can be based on pre-defined time limits, or can be dependent on the level of conversational agreement within or across subgroups.

In all examples, the system will eventually cease jumping back to operation 730. At that point, the system expresses a final global informational summary in natural language form to the users in their respective subgroups.

### Video HyperChat Process

Video conferencing is a special case for the HyperChat technology since it is very challenging for groups of networked users above a certain size (i.e., number of users) to hold a coherent and flowing conversation that converges on meaningful decisions, predictions, insights, prioritization, assessments or other group-wise conversational outcomes. In some examples, when groups are larger than 12 to 15 participants in a video conferencing setting, it is increasingly difficult to hold a true group-wise conversation. In some cases, video conferencing for large groups may be used for one-to-many presentations and Q&A sessions (however, such presentations and sessions are not true conversations).

Current video conferencing systems are not equipped to enable large groups to hold conversations while enabling the amplification of the collective intelligence. Embodiments of the present disclosure describe systems and methods for video conferencing that are equipped to enable large groups to hold conversations while enabling the amplification of collective intelligence and significant new capabilities.

Embodiments of the present disclosure can be deployed across a wide range of networked conversational environment (e.g., text chatrooms (deployed using textual dialog), video conference rooms (deployed using verbal dialog and live video), immersive “metaverse” conference rooms (deployed using verbal dialog and simulated avatars), etc.). One or more embodiments include a video conferencing HyperChat process.

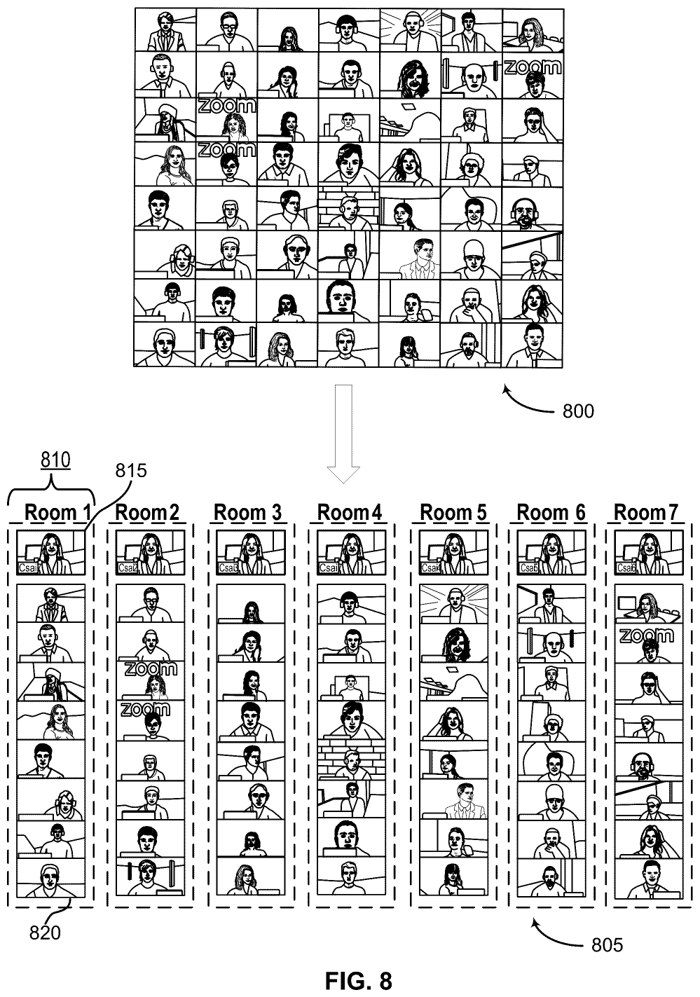

FIG. 8 shows an example of a video based HyperChat process according to aspects of the present disclosure. The example shown includes conventional video conferencing environment 800 with 56 real-time human participants who are communicating through video chat. For convenience we refer to this environment as “chat room” 800 despite the fact that the communication is primarily video based. Similarly, FIG. 8 also includes video based chat room 810.

Chat room 810 is an example of, or includes aspects of, the corresponding element described with reference to FIGS. 3-6, and 9. In certain aspects, chat room 810 includes conversational surrogate agent 815 and user 820. Conversational surrogate agent 815 is an example of, or includes aspects of, the corresponding element described with reference to FIGS. 2, 6, 9, and 11. User 820 is an example of, or includes aspects of, the corresponding element described with reference to FIGS. 1-6, and 9.

Referring to FIG. 8, a conventional video conferencing application 800 (i.e., Zoom) is being used by 56 networked human members in a single conversational room. As shown, the number of users is high, making it challenging (i.e., nearly impossible) for members to clearly identify users in the room or enable a meaningful groupwise conversation. Due to the high number of human members, it may be very difficult for a single individual to have much of an opportunity to speak. In fact, communication research shows that deliberative conversations degrade substantially with group sizes greater than 5 to 7 members, as turn-taking dynamics collapse and participation per users drop greatly. In case a meeting is scheduled for an hour, on an average, a conversation of 56 members would enable few individuals to speak for more than one minute on average. Such a situation/setting is not conducive to user contribution and does not provide for a healthy back and forth among participants on issues of consequence. Accordingly, there is no mechanism to leverage the ability of large groups to amplify the collective intelligence of the networked participants through real-time deliberative conversation.

Referring again to FIG. 8, a structure and method for a hyper video chat 805 is shown for the example of 56 networked human users 820, according to embodiments of the present disclosure. As shown, the 56 users are split into 7 separable sub-rooms (i.e., Room 1 to Room 7) each populated by 8 participants. In each sub-room, the participants can see and hear the other 7 participants in the room which is a size that is convenient for meaningful human conversations that can reach groupwise decisions, assessments, prioritizations, evaluations, rating, rankings, and other groupwise outcomes.

The example shows 8 participants per room. However, embodiments are not limited thereto and fewer or greater number of participants within reason can be used. The example shows equal numbers of participants per sub-room. However, embodiments are not limited thereto, and other embodiments can (e.g., use, implement, etc.) varying numbers of participants per sub-room. As shown in hyper video chat 805 is a Conversational Surrogate Agent (CSai) 815 that is uniquely assigned, maintained, and deployed for use in each of the parallel rooms.

The CSai agent 815 is shown in this example at the top of each column of video feeds and is a real-time graphical representation of an artificial agent that emulates what a human user may look like in the video box of the video conferencing system. In some cases, technologies enable simulated video of artificial human characters that can naturally verbalize dialog and depict natural facial expressions and vocal inflections. For example, the “Digital Human Video Generator” technology from Delaware company D-ID is an example technology module that can be used for creating real-time animated artificial characters. Other technologies are available from other companies.

Using APIs from large language models such as ChatGPT, unique and natural dialog can be generated for the Conversational Surrogate Agent in each sub-room which is conveyed verbally to the other members of the room through simulated video of a human speaker, thereby enabling the injection of content from other sub-rooms in a natural and flowing method that does not significantly disrupt the conversational flow in each sub-room. One or more exemplary embodiments evaluate hyper-chat and indicate that conversational flow is maintained.

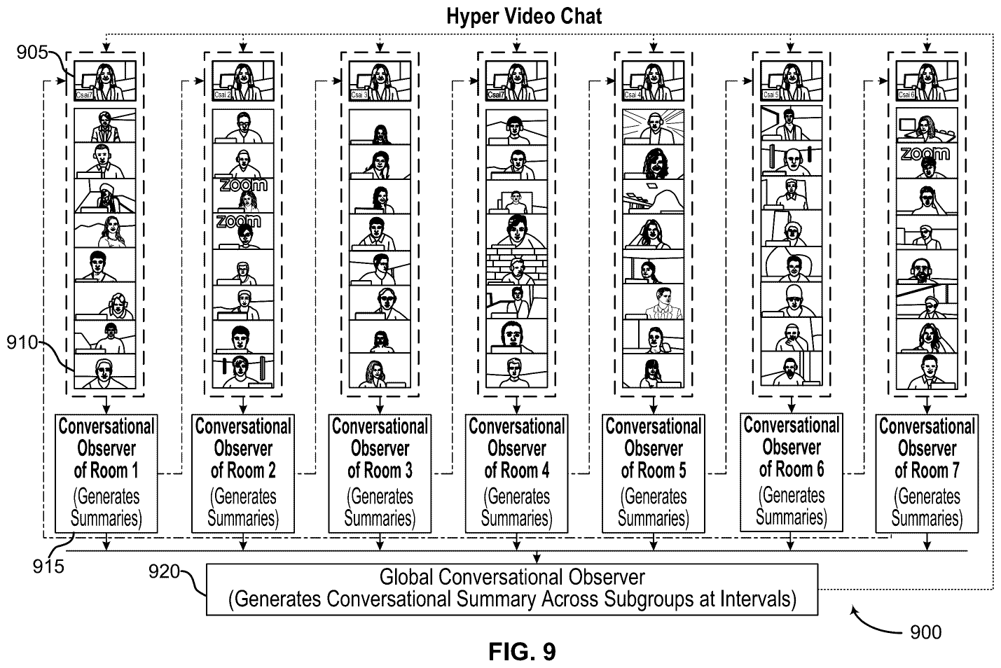

FIG. 9 shows an example of a video based HyperChat process according to aspects of the present disclosure. The example shown includes room chat 900 and global conversation observer 920.

Chat room 900 is an example of, or includes aspects of, the corresponding element described with reference to FIGS. 3-6, and 8. In certain aspects, chat room 900 includes conversational surrogate agent 905, user 910, and conversational observation agent 915. Conversational surrogate agent 905 is an example of, or includes aspects of, the corresponding element described with reference to FIGS. 2, 6, 8, and 11. User 910 is an example of, or includes aspects of, the corresponding element described with reference to FIGS. 1-6, and 8. Conversational observation agent 915 is an example of, or includes aspects of, the corresponding element described with reference to FIGS. 2-4, 6, and 10. Global conversation observer 920 is an example of, or includes aspects of, the corresponding element described with reference to FIGS. 3-6.

FIG. 9 shows mapping of a plurality of information pathways (e.g., pathways shown with reference to FIGS. 3-4). As shown in FIG. 9, there are two critical processes that involve Large Language Models accessed in real-time by API. In some cases, a process (performed by a Conversational Observer Agent 915) monitors the conversation in each sub-room (either by text or voice chat) and generates conversational summaries at various intervals. In some cases, a process injects conversational summaries from one sub-room into one or more other sub-rooms, thereby propagating conversational information across the large population.

As shown in FIG. 9, the human dialog generated within each sub-room is captured in real-time (or near real-time), stored for periods of time, converted to text, and intermittently input to an LLM engine via an API process. The LLM is directed to perform assessments and/or summarizations of the captured dialog as described with reference to FIGS. 3-4. In some cases, the LLM can be directed to summarize the interval of dialog, indicating the most significant points made and the conviction (or lack thereof) expressed by the sub-group in each of the significant points made. In some cases, the Conversational Summary generated in each sub-room is fed to the Conversational Surrogate Agent 905 in an alternate sub-room to enable the Hyper Video process with information propagation. Accordingly, the human participants are enabled to engage in real-time conversation within the respective sub-rooms and to receive (via a simulated human surrogate 905) critical points that were expressed among the participants (users 910) in another sub-room.

The process is conducted among some, many, or each of the subgroups at regular intervals, thereby propagating information in a highly efficient manner. In some examples, sub-rooms are arranged in a ring network structure as shown in FIG. 9. Each sub-room is monitored by a single observer agent 915 which provides informational summaries to a single alternate sub-room at intervals and each sub-room is populated with a single Conversational Surrogate Agent 905 that receives information summaries from a single alternate-subgroup at certain intervals.

One or more exemplary embodiments of the disclosure evaluate the HyperChat text process and enable significant information propagation. According to some embodiments, alternate network structures (i.e., other than a ring structure) can be used. Additionally, embodiments may enable multiple Conversational Surrogate Agents in each sub-room, each of may which optionally represent informational summaries from other alternate sub-rooms. Or, in other embodiments, a single Conversational Surrogate Agent given sub-room may optionally represent informational summaries from multiple alternative sub-rooms. The representations can be conveyed as a first-person dialog.

Networking structures other than a ring network become increasingly valuable at larger and larger group sizes. For example, an implementation in which 2000 users engage in a single real-time conversation may involve connecting 400 sub-groups of 5 members each according to the methods of the present invention. In such an embodiment, a small world network or other efficient topology may be more effective at propagating information across the population.

Referring again to FIG. 9, an optional Global Observer Agent 920 is enabled by an LLM engine and is configured to receive conversational summaries (via API calls) from two or more of the Conversational Observer Agents 915. The Global Observer Agent 920 receives conversational summaries from the active sub-rooms (Sub-room 1 to Sub-room 7) and assesses and summarizes the salient points made across sub-groups at various intervals. For example, the Global Observer Agent 920 may assess and summarize the key points made across the seven sub-rooms shown at regular time intervals, estimating the relative conviction expressed across sub-groups on various points made.

As shown in FIG. 9, the Global Observer Agent 920 can inject the assessments and summaries performed at various intervals back into each sub-room (i.e., to each sub-group of participants) via the simulated video Conversation Surrogate Agent 905 in the sub-room. Accordingly, the groups can receive global information (i.e., with key points from each group). According to embodiments described herein, the injection of global summary information into sub-groups occurs less frequently than the injection of local information from other sub-groups and occurs later in the conversational process. That is, the process enabled herein is an interactive system in which the entire population gradually converges on solutions. Thus, in some aspects, more time may elapse for global sentiments to converge than local sentiments within individual sub-rooms (i.e., among sub-groups).

In some embodiments, the subgroups receive the same global summary injected into the sub-room via the Conversational Surrogate Agent 905 within the room. In some embodiments, the Global Observer Agent 920 is configured to inject customized summaries into each of the sub-rooms based on a comparison between the global summary made and the individual summary made for across groups particular groups. In some embodiments, the comparison may be performed to determine if the local sub-group has not sufficiently considered significant points raised across the set of sub-groups. For example, if most subgroups identified an important issue for consideration in a given groupwise conversation but one or more other sub-groups failed to discuss that important issue, the Global Observer Agent 920 can be configured to inject a summary of such an important issue.

As described, the injection of a summary can be presented in the first person. For example, if sub-group number 1 (i.e., the users holding a conversation in sub-room 1) fail to mention a certain issue that may impact the outcome, a decision, or forecast being discussed, but other sub-groups (i.e., sub-rooms 2 through 7) discuss the issue as significant, the Global Observer Agent identifies the fact by comparing the global summary with each local summary, and in response injects a representation of the certain issue into room 1.

In some embodiments, the representation is presented in the first person by the Conversational Surrogate Agent 905 in sub-room 1, for example with dialog such as—“I've been watching the conversation in all of the other rooms, and I noticed that they have raised an issue of importance that has not come up in our room.” The Conversational Surrogate Agent 905 will then describe the issue of importance as summarized across rooms. Accordingly, information propagation is enabled across the population while providing for subgroup 1 to continue the naturally flowing conversation. For example, subgroup 1 may consider the provided information but not necessarily agree or accept the issues raised.

In some embodiments, the phrasing of the dialog from the Conversational Surrogate Agent 905 may be crafted from the perspective of an ordinary member of the sub-room, not explicitly highlighting the fact that the agent is an artificial observer. For example, the dialog above could be phrased as “I was thinking, there's an issue of importance that we have not discussed yet in our room. The Conversational Surrogate Agent 905 will then describe the issue of importance as summarized across rooms as if it was their own first-person contribution to the conversation. This can enable a more natural and flowing dialog.

The video conferencing architecture (e.g., as described with reference to FIGS. 8-9) can be deployed using either the round-based methods or roundless methods. The present disclosure describes systems and methods for text-based conversations that can be applied to voice-based conversations deployed using video chat or avatar chat. Accordingly, large populations can be enabled to be split into a network of interconnected real-time subgroups that converge in conversational synchrony on collaborative solutions. In addition, the methods for amplifying collective intelligence are applicable to the video chat examples of FIGS. 8-9.

In some cases, the video-based solutions can be deployed with an additional sentiment analysis layer that assesses the level of conviction of each user's verbal statements based on the inflection in the voice, the facial expressions, and/or the hand and body gestures that correlate with verbal statements during the conversation. The sentiment analysis can be used to supplement the assessment of either confidence and/or conviction in the conversational points expressed by individual members and can be used in the assessment of overall confidence and conviction within subgroups and across subgroups. When sentiment analysis is used, embodiments described herein may employ anonymity filters to protect the privacy of individual participants.

FIG. 10 shows an example of a collaboration server 1000 according to aspects of the present disclosure. In certain aspects, collaboration server 1000 includes processor(s) 1005, first memory portion 1010, second memory portion 1015, third memory portion 1020, collaboration application 1025, conversational observer agent 1030, communication interface 1035, I/O interface 1040, and channel 1045.

Collaboration server 1000 is an example of, or includes aspects of, the corresponding element described with reference to FIGS. 1-3. In some embodiments, collaboration server 1000 includes one or more processors 1105 that can execute instructions stored in first memory portion 1010, second memory portion 1015, and third memory portion 1020 to provide a collaboration server running a collaboration application, the collaboration server in communication with the plurality of the networked computing devices, each computing device associated with one member of the population of human participants, the collaboration server defining a plurality of sub-groups of the population of human participants; provide a local chat application on each networked computing device, the local chat application configured for displaying a conversational prompt received from the collaboration server, and for enabling real-time chat communication with other members of a sub-group assigned by the collaboration server, said real-time chat communication including sending chat input collected from the one member associated with the networked computing device to other members of the assigned sub-group; and enable through communication between the collaboration application running on the collaboration server and the local chat applications running on each of the plurality of networked computing devices.

According to some aspects, collaboration server 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof.) In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, transmission processing.

According to some aspects, each of first memory portion 1010, second memory portion 1015, and third memory portion 1020 include one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, collaboration application 1025 enables users to interact with other users through real-time dialog via text chat and/or voice chat and/or video chat and/or avatar-based VR chat. In some cases, collaboration application 1025 running on the device associated with each user displays the conversational prompt to the user. In some cases, collaboration application 1025 is stored in the memory (e.g., one of first memory portion 1010, second memory portion 1015, or third memory portion 1020) and is executed by one or more processors 1005.

According to some aspects, conversational observer agent 1030 is an AI-based agent that extracts conversational content from a sub-group, sends the content to a LLM to generate a summary, and shares the generated summary with each user on the collaboration server 1000. In some cases, conversational observer agent 1030 is stored in the memory (e.g., one of first memory portion 1010, second memory portion 1015, or third memory portion 1020) and is executed by one or more processors 1005.

According to some aspects, communication interface 1035 operates at a boundary between communicating entities (such as collaboration server 1000, one or more user devices, a cloud, and one or more databases) and channel 1045 and can record and process communications. In some cases, communication interface 1035 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1040 is controlled by an I/O controller to manage input and output signals for collaboration server 1000. In some cases, I/O interface 1040 manages peripherals not integrated into collaboration server 1000. In some cases, I/O interface 1040 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1040 or via hardware components controlled by the I/O controller.

FIG. 11 shows an example of a computing device 1100 according to aspects of the present disclosure. In certain aspects, computing device 1100 includes processor(s) 1105, memory subsystem 1110, communication interface 1115, local chat application 1120, conversational surrogate agent 1125, global surrogate agent 1130, I/O interface 1135, user interface component 1140, and channel 1145.

In some aspects, computing device 1100 is an example of, or includes aspects of, the corresponding element described with reference to FIGS. 1, 2, 5, and 6. In some embodiments, computing device 1100 includes one or more processors 1105 that can execute instructions stored in memory subsystem 1110.

According to some aspects, computing device 1100 includes one or more processors 1105. Processor(s) 1105 is an example of, or includes aspects of, the corresponding element described with reference to FIG. 10.

According to some aspects, memory subsystem 1110 includes one or more memory devices. Memory subsystem 1110 is an example of, or includes aspects of, the memory and memory portions described with reference to FIGS. 1-2 and 10.

According to some aspects, communication interface 1115 operates at a boundary between communicating entities (such as computing device 1100, one or more user devices, a cloud, and one or more databases) and channel 1145 and can record and process communications. Communication interface 1115 is an example of, or includes aspects of, the corresponding element described with reference to FIG. 10.

According to some aspects, local chat application 1120 provides for a real-time conversation between the one user of a sub-group and the plurality of other members assigned to the same sub-group. Local chat application 1120 is an example of, or includes aspects of, the corresponding element described with reference to FIGS. 1 and 2. In some cases, local chat application 1120 is stored in the memory subsystem 1110 and is executed by the one or more processors 1105.

According to some aspects, conversational surrogate agent 1125 conversationally expresses a representation of the information contained in the summary from a different room. Conversational surrogate agent 1125 is an example of, or includes aspects of, the corresponding element described with reference to FIGS. 2-4. In some cases, conversational surrogate agent 1125 is stored in the memory subsystem 1110 and is executed by the one or more processors 1105.

According to some aspects, global surrogate agent 1130 selectively represents the views, arguments, and narratives that have been observed across the entire population. Global surrogate agent 1130 is an example of, or includes aspects of, the corresponding element described with reference to FIGS. 2-4. In some cases, global surrogate agent 1130 is stored in the memory subsystem 1110 and is executed by the one or more processors 1105.

According to some aspects, I/O interface 1135 is controlled by an I/O controller to manage input and output signals for computing device 1100. I/O interface 1130 is an example of, or includes aspects of, the corresponding element described with reference to FIG. 10.

According to some aspects, user interface component(s) 1140 enable a user to interact with computing device 1100. In some cases, user interface component(s) 1140 include an audio device, such as an external speaker system, an external display device such as a display screen, an input device (e.g., a remote control device interfaced with a user interface directly or through the I/O controller), or a combination thereof. In some cases, user interface component(s) 1135 include a GUI.

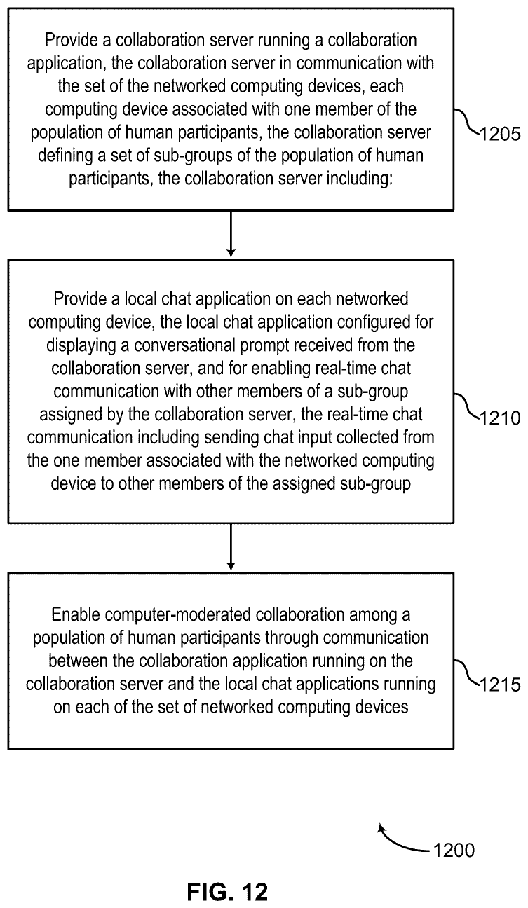

FIG. 12 shows an example of a method 1200 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system provides a collaboration server running a collaboration application, the collaboration server in communication with the set of the devices, networked computing each computing device associated with one member of the population of human participants, the collaboration server defining a set of sub-groups of the population of human participants, the collaboration server including: In some cases, the operations of this step refer to, or may be performed by, a collaboration server as described with reference to FIGS. 1, 2, and 10.

At operation 1210, the system provides a local chat application on each networked computing device, the local chat application configured for displaying a conversational prompt received from the collaboration server, and for enabling real-time chat communication with other members of a sub-group assigned by the collaboration server, the real-time chat communication including sending chat input collected from the one member associated with the networked computing device to other members of the assigned sub-group. In some cases, the operations of this step refer to, or may be performed by, a local chat application as described with reference to FIGS. 1, 2, and 11.

At operation 1215, the system enables computer-moderated collaboration among a population of human participants through communication between the collaboration application running on the collaboration server and the local chat applications running on each of the set of networked computing devices. For instance, at operation 1215 the system enables various steps through the communication between collaboration application running on the collaboration server and the local chat applications running on each of the set of networked computing devices (e.g., the enabled steps including one or more operations described with reference to methods 1300-1800). In some cases, the operations of this step refer to, or may be performed by, software components as described with reference to FIG. 2.

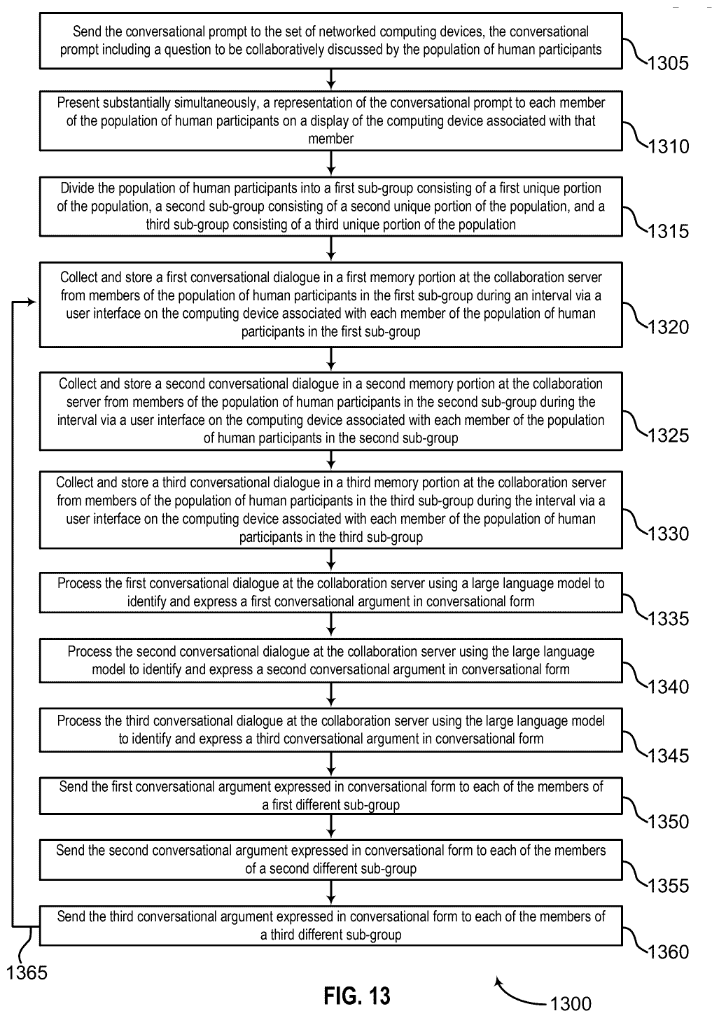

FIG. 13 shows an example of a series of operations for a method 1300 for computer mediated collaboration according to aspects of the present disclosure. Variations of the present example may include performing the series of operations in a different order than the order in which the series of operations is presented here. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305 (e.g., at step a), the system sends the conversational prompt to the set of networked computing devices, the conversational prompt including a question, issue or topic to be collaboratively discussed by the population of human participants. In some cases, the operations of this step refer to, or may be performed by, software components as described with reference to FIG. 2. In some cases, the conversational prompt could be entered into the system by a designated human moderator in advance or in real-time.

At operation 1310 (e.g., at step b), the system presents, substantially simultaneously, a representation of the conversational prompt to each member of the population of human participants on a display of the computing device associated with that member. In some cases, the operations of this step refer to, or may be performed by, software components as described with reference to FIG. 2. In some embodiments the prompt is displayed textually. In other embodiments, the prompt is expressed verbally by a conversational agent.

At operation 1315 (e.g., at step c), the system divides the population of human participants into a first sub-group consisting of a first unique portion of the population, a second sub-group consisting of a second unique portion of the population, and a third sub-group consisting of a third unique portion of the population, where the first unique portion consists of a first set of members of the population of human participants, the second unique portion consists of a second set of members of the population of human participants and the third unique portion consists of a third set of members of the population of human participants. In some cases, the operations of this step refer to, or may be performed by, software components as described with reference to FIG. 2. Note, operation 1315 can be performed before operations 1305 and 1310. In some embodiments, the sub-groups are formed before some or all of the prior steps. In many embodiments, additional sub-groups (i.e., more than three) are formed following the same method.

At operation 1320 (e.g., at step d), the system collects and stores a first conversational dialogue in a first memory portion at the collaboration server from members of the population of human participants in the first sub-group during an interval via a user interface on the computing device associated with each member of the population of human participants in the first sub-group. In some cases, the operations of this step refer to, or may be performed by, software components as described with reference to FIG. 2.

At operation 1325 (e.g., at step e), the system collects and stores a second conversational dialogue in a second memory portion at the collaboration server from members of the population of human participants in the second sub-group during the interval via a user interface on the computing device associated with each member of the population of human participants in the second sub-group. In some cases, the operations of this step refer to, or may be performed by, software components as described with reference to FIG. 2.

At operation 1330 (e.g., at step f), the system collects and stores a third conversational dialogue in a third memory portion at the collaboration server from members of the population of human participants in the third sub-group during the interval via a user interface on the computing device associated with each member of the population of human participants in the third sub-group. In some cases, the operations of this step refer to, or may be performed by, software components as described with reference to FIG. 2.

For other embodiments, for example those in which more than three sub-groups are created, additional steps similar to 1320, 1325, and 1330 are performed on the conversational dialog associated with each of the additional sub-groups, collecting and storing dialog in additional memories.

At operation 1335 (e.g., at step g), the system processes the first conversational dialogue at the collaboration server using a large language model to identify and express a first conversational argument in conversational form, where the identifying of the first conversational argument includes identifying at least one assertion, viewpoint, position or claim in the first conversational dialogue supported by evidence or reasoning, expressed or implied. In some cases, the operations of this step refer to, or may be performed by, software components as described with reference to FIG. 2.

At operation 1340 (e.g., at step h), the system processes the second conversational dialogue at the collaboration server using the large language model to identify and express a second conversational argument in conversational form, where the identifying of the second conversational argument includes identifying at least one assertion, viewpoint, position or claim in the second conversational dialogue supported by evidence or reasoning, expressed or implied. In some cases, the operations of this step refer to, or may be performed by, software components as described with reference to FIG. 2.

At operation 1345 (e.g., at step i), the system processes the third conversational dialogue at the collaboration server using the large language model to identify and express a third conversational argument in conversational form, where the identifying of the third conversational argument includes identifying at least one assertion, viewpoint, position or claim in the third conversational dialogue supported by evidence or reasoning, expressed or implied. In some cases, the operations of this step refer to, or may be performed by, software components as described with reference to FIG. 2.

For other embodiments, for example those in which more than three sub-groups are created, additional steps similar to 1335, 1340, and 1345 are performed on the conversational dialog associated with each of the additional sub-groups.

At operation 1350 (e.g., at step j), the system sends the first conversational argument to be expressed in conversational form (via text or voice) to each of the members of a first different sub-group, where the first different sub-group is not the first sub-group. In some cases, the operations of this step refer to, or may be performed by, software components as described with reference to FIG. 2.

At operation 1355 (e.g., at step k), the system sends the second conversational argument to be expressed in conversational form (via text or voice) to each of the members of a second different sub-group, where the second different sub-group is not the second sub-group. In some cases, the operations of this step refer to, or may be performed by, software components as described with reference to FIG. 2.

At operation 1360 (e.g., at step l), the system sends the third conversational argument to be expressed in conversational form (via text or voice) to each of the members of a third different sub-group, where the third different sub-group is not the third sub-group. In some cases, the operations of this step refer to, or may be performed by, software components as described with reference to FIG. 2.

For other embodiments, for example those in which more than three sub-groups are created, additional steps are performed that are similar to 1350, 1355, and 1360 in order to send additional conversational arguments from each of the additional sub-groups to be expressed in conversational form in other different sub-groups.

At operation 1365 (e.g., at step m), the system repeats operations 1320-1360 (e.g., steps (d) through (l)) at least one time. In some cases, the operations of this step refer to, or may be performed by, software components as described with reference to FIG. 2.

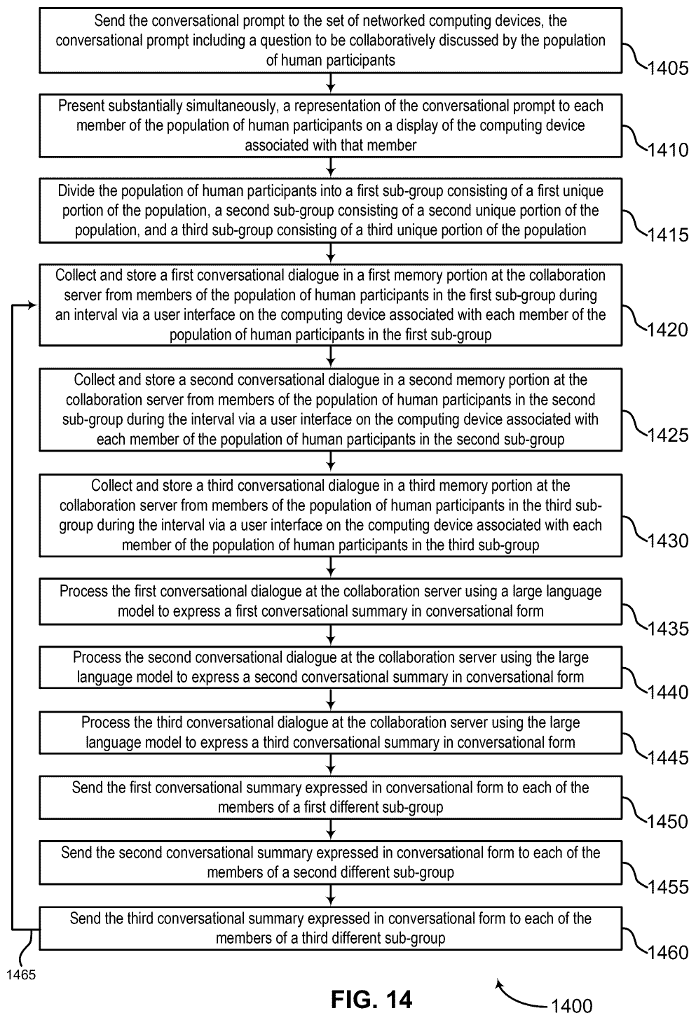

FIG. 14 shows an example of a method 1400 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1405 (e.g., in step a), the system sends the conversational prompt to the set of networked computing devices, the conversational prompt including a question to be collaboratively discussed by the population of human participants. In some cases, the operations of this step refer to, or may be performed by, software components as described with reference to FIG. 2. In some cases, the conversational prompt could be entered into the system by a designated human moderator in advance or in real-time.

At operation 1410 (e.g., in step b), the system presents, substantially simultaneously, a representation of the conversational prompt to each member of the population of human participants on a display of the computing device associated with that member. In some cases, the operations of this step refer to, or may be performed by, software components as described with reference to FIG. 2. In some embodiments the prompt is displayed textually. In other embodiments, the prompt is expressed verbally by a conversational agent.

At operation 1415 (e.g., in step c), the system divides the population of human participants into a first sub-group consisting of a first unique portion of the population, a second sub-group consisting of a second unique portion of the population, and a third sub-group consisting of a third unique portion of the population, where the first unique portion consists of a first set of members of the population of human participants, the second unique portion consists of a second set of members of the population of human participants and the third unique portion consists of a third set of members of the population of human participants, including dividing the population of human participants as a function of user initial responses to the conversational prompt. In some cases, the operations of this step refer to, or may be performed by, software components as described with reference to FIG. 2. In some embodiments, the sub-groups are formed before some or all of the prior steps. In many embodiments, additional sub-groups (i.e., more than three) are formed following the same method.

At operation 1420 (e.g., in step d), the system collects and stores a first conversational dialogue in a first memory portion at the collaboration server from members of the population of human participants in the first sub-group during an interval via a user interface on the computing device associated with each member of the population of human participants in the first sub-group. In some cases, the operations of this step refer to, or may be performed by, software components as described with reference to FIG. 2.

At operation 1425 (e.g., in step e), the system collects and stores a second conversational dialogue in a second memory portion at the collaboration server from members of the population of human participants in the second sub-group during the interval via a user interface on the computing device associated with each member of the population of human participants in the second sub-group. In some cases, the operations of this step refer to, or may be performed by, software components as described with reference to FIG. 2.

At operation 1430 (e.g., in step f), the system collects and stores a third conversational dialogue in a third memory portion at the collaboration server from members of the population of human participants in the third sub-group during the interval via a user interface on the computing device associated with each member of the population of human participants in the third sub-group. In some cases, the operations of this step refer to, or may be performed by, software components as described with reference to FIG. 2.

For other embodiments, for example, those in which more than three sub-groups are created, additional steps similar to 1420, 1425, and 1430 are performed on the conversational dialog associated with each of the additional sub-groups, collecting and storing dialog in additional memories.

At operation 1435 (e.g., in step g), the system processes the first conversational dialogue at the collaboration server using a large language model to express a first conversational summary in conversational form. In some cases, the operations of this step refer to, or may be performed by, software components as described with reference to FIG. 2.

At operation 1440 (e.g., in step h), the system processes the second conversational dialogue at the collaboration server using the large language model to express a second conversational summary in conversational form. In some cases, the operations of this step refer to, or may be performed by, software components as described with reference to FIG. 2.

At operation 1445 (e.g., in step i), the system processes the third conversational dialogue at the collaboration server using the large language model to express a third conversational summary in conversational form. In some cases, the operations of this step refer to, or may be performed by, software components as described with reference to FIG. 2.

For other embodiments, for example, those in which more than three sub-groups are created, additional steps similar to 1435, 1440, and 1445 are performed on the conversational dialog associated with each of the additional sub-groups.

At operation 1450 (e.g., in step j), the system sends the first conversational summary to be expressed in conversational form (via text or voice) to each of the members of a first different sub-group, where the first different sub-group is not the first sub-group. In some cases, the operations of this step refer to, or may be performed by, software components as described with reference to FIG. 2.

At operation 1455 (e.g., in step k), the system sends the second conversational summary to be expressed in conversational form (via text or voice) to each of the members of a second different sub-group, where the second different sub-group is not the second sub-group. In some cases, the operations of this step refer to, or may be performed by, software components as described with reference to FIG. 2.

At operation 1460 (e.g., in step l), the system sends the third conversational summary to be expressed in conversational form (via text or voice) to each of the members of a third different sub-group, where the third different sub-group is not the third sub-group. In some cases, the operations of this step refer to, or may be performed by, software components as described with reference to FIG. 2.

For other embodiments, for example, those in which more than three sub-groups are created, additional steps are performed that are similar to 1450, 1455, and 1460 in order to send additional conversational summaries from each of the additional sub-groups to be expressed in conversational form in other different sub-groups.

At operation 1465 (e.g., in step m), the system repeats operations 1420-1460 (e.g., steps (d) through (l)) at least one time. In some cases, the operations of this step refer to, or may be performed by, software components as described with reference to FIG. 2.

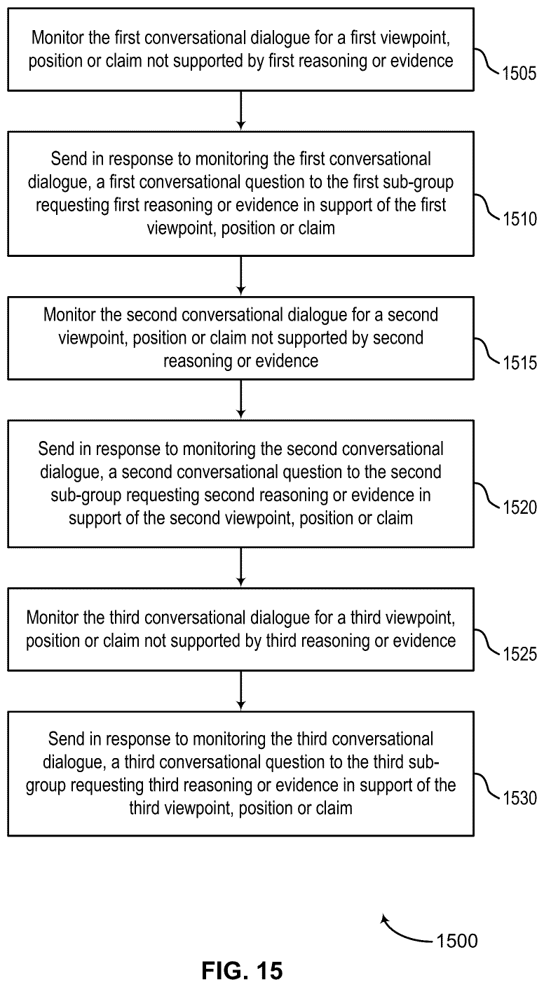

FIG. 15 shows an example of a method 1500 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1505 (e.g., in step n), the system monitors the first conversational dialogue for a first assertion, viewpoint, position or claim not supported by first reasoning or evidence. In some cases, the operations of this step refer to, or may be performed by, software components as described with reference to FIG. 2.

At operation 1510 (e.g., in step o), the system sends, in response to monitoring the first conversational dialogue, a first conversational question to the first sub-group requesting first reasoning or evidence in support of the first assertion, viewpoint, position or claim. In some cases, the operations of this step refer to, or may be performed by, software components as described with reference to FIG. 2.

At operation 1515 (e.g., in step p), the system monitors the second conversational dialogue for a second assertion, viewpoint, position or claim not supported by second reasoning or evidence. In some cases, the operations of this step refer to, or may be performed by, software components as described with reference to FIG. 2.

At operation 1520 (e.g., in step q), the system sends in response to monitoring the second conversational dialogue, a second conversational question to the second sub-group requesting second reasoning or evidence in support of the second assertion, viewpoint, position or claim. In some cases, the operations of this step refer to, or may be performed by, software components as described with reference to FIG. 2.

At operation 1525 (e.g., in step r), the system monitors the third conversational dialogue for a third assertion, viewpoint, position or claim not supported by third reasoning or evidence. In some cases, the operations of this step refer to, or may be performed by, software components as described with reference to FIG. 2.

At operation 1530 (e.g., in step s), the system sends in response to monitoring the third conversational dialogue, a third conversational question to the third sub-group requesting third reasoning or evidence in support of the third assertion, viewpoint, position or claim. In some cases, the operations of this step refer to, or may be performed by, software components as described with reference to FIG. 2.

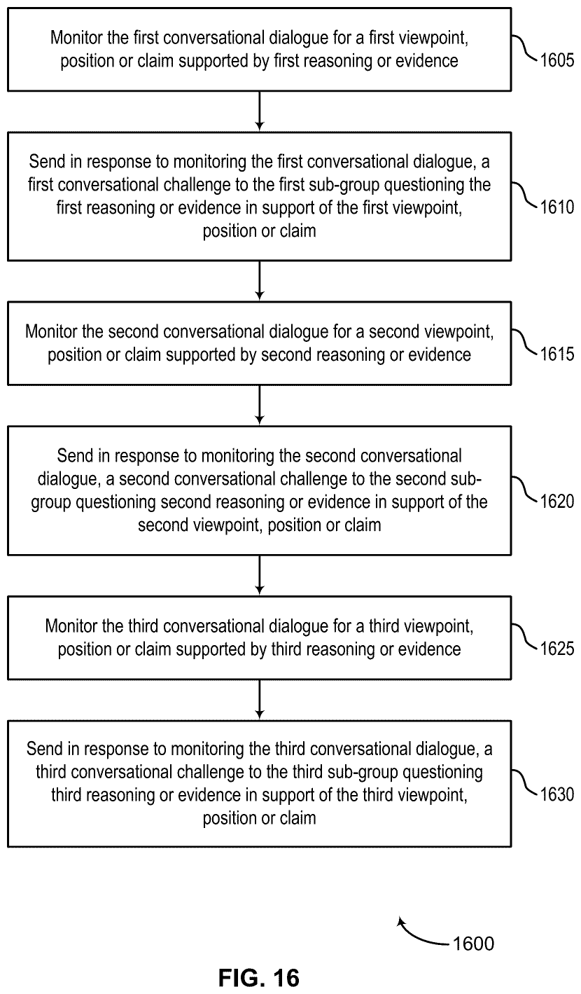

FIG. 16 shows an example of a method 1600 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1605 (e.g., in step n), the system monitors the first conversational dialogue for a first assertion, viewpoint, position or claim supported by first reasoning or evidence. In some cases, the operations of this step refer to, or may be performed by, software components as described with reference to FIG. 2.

At operation 1610 (e.g., in step o), the system sends, in response to monitoring the first conversational dialogue, a first conversational challenge to the first sub-group questioning the first reasoning or evidence in support of the first assertion, viewpoint, position or claim. In some cases, the operations of this step refer to, or may be performed by, software components as described with reference to FIG. 2.

At operation 1615 (e.g., in step p), the system monitors the second conversational dialogue for a second assertion, viewpoint, position or claim supported by second reasoning or evidence. In some cases, the operations of this step refer to, or may be performed by, software components as described with reference to FIG. 2.

At operation 1620 (e.g., in step q), the system sends, in response to monitoring the second conversational dialogue, a second conversational challenge to the second sub-group questioning second reasoning or evidence in support of the second assertion, viewpoint, position or claim. In some cases, the operations of this step refer to, or may be performed by, software components as described with reference to FIG. 2.

At operation 1625 (e.g., in step r), the system monitors the third conversational dialogue for a third assertion, viewpoint, position or claim supported by third reasoning or evidence. In some cases, the operations of this step refer to, or may be performed by, software components as described with reference to FIG. 2.

At operation 1630 (e.g., in step s), the system sends, in response to monitoring the third conversational dialogue, a third conversational challenge to the third sub-group questioning third reasoning or evidence in support of the third assertion, viewpoint, position or claim. In some cases, the operations of this step refer to, or may be performed by, software components as described with reference to FIG. 2.

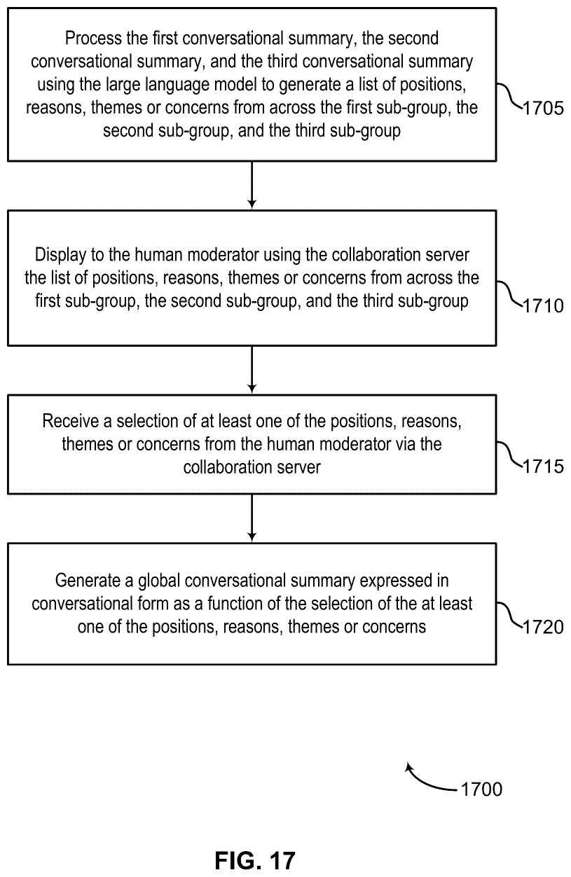

FIG. 17 shows an example of a method 1700 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1705 (e.g., in step n), the system processes the first conversational summary, the second conversational summary, and the third conversational summary using the large language model to generate a list of assertions, positions, reasons, themes or concerns from across the first sub-group, the second sub-group, and the third sub-group. In some cases, the operations of this step refer to, or may be performed by, software components as described with reference to FIG. 2.

At operation 1710 (e.g., in step o), the system displays to the human moderator using the collaboration server the list of assertions, positions, reasons, themes or concerns from across the first sub-group, the second sub-group, and the third sub-group. In some cases, the operations of this step refer to, or may be performed by, software components as described with reference to FIG. 2.

At operation 1715 (e.g., in step p), the system receives a selection of at least one of the assertions, positions, reasons, themes or concerns from the human moderator via the collaboration server. In some cases, the operations of this step refer to, or may be performed by, software components as described with reference to FIG. 2.

At operation 1720 (e.g., in step q), the system generates a global conversational summary expressed in conversational form as a function of the selection of the at least one of the assertions, positions, reasons, themes or concerns. In some cases, the operations of this step refer to, or may be performed by, software components as described with reference to FIG. 2.

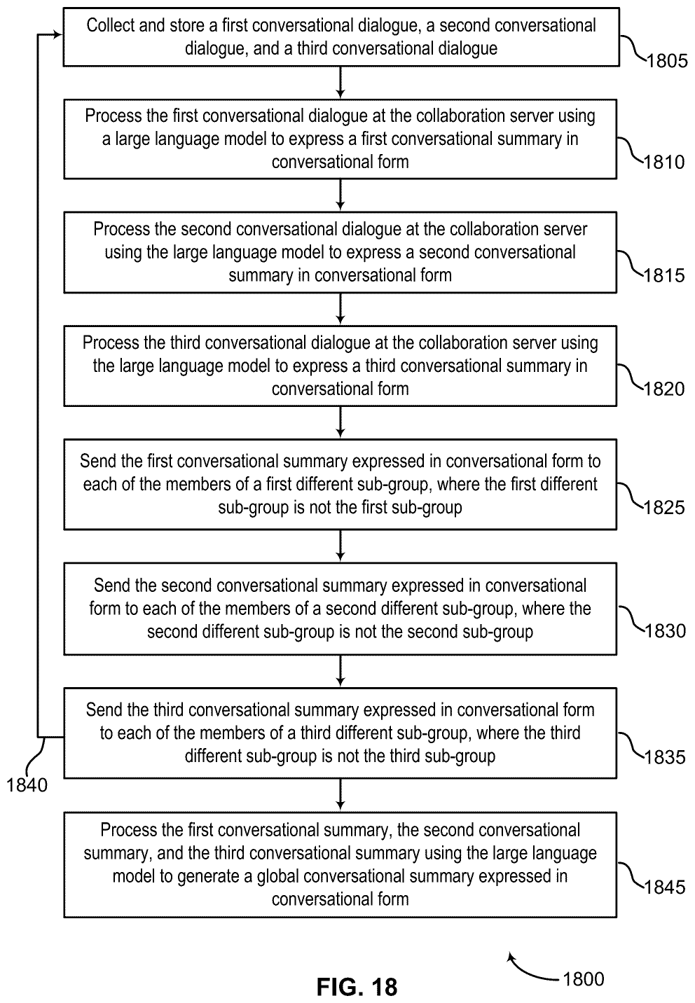

FIG. 18 shows an example of a method 1800 for computer mediated collaboration according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1805 (e.g., in steps d-f), the system collects and stores a first conversational dialogue from a first sub-group, a second conversational dialogue from a second sub-group, and a third conversational dialogue from a third sub-group, said first, second, and third sub-groups not being the same sub-groups. In some cases, the operations of this step refer to, or may be performed by, software components as described with reference to FIG. 2.

At operation 1810 (e.g., in step g), the system processes the first conversational dialogue at the collaboration server using a large language model to generate a first conversational summary. In some cases, the operations of this step refer to, or may be performed by, software components as described with reference to FIG. 2.

At operation 1815 (e.g., in step h), the system processes the second conversational dialogue at the collaboration server using the large language model to generate a second conversational summary. In some cases, the operations of this step refer to, or may be performed by, software components as described with reference to FIG. 2.

At operation 1820 (e.g., in step i), the system processes the third conversational dialogue at the collaboration server using the large language model to generate a third conversational summary. In some cases, the operations of this step refer to, or may be performed by, software components as described with reference to FIG. 2.

At operation 1825 (e.g., in step j), the system sends the first conversational summary to each of the members of a first different sub-group and expresses it to each member in conversational form via text or voice, where the first different sub-group is not the first sub-group. In some cases, the operations of this step refer to, or may be performed by, software components as described with reference to FIG. 2.

At operation 1830 (e.g., in step k), the system sends the second conversational summary to each of the members of a second different sub-group and expresses it to each member in conversational form via text or voice, where the second different sub-group is not the second sub-group. In some cases, the operations of this step refer to, or may be performed by, software components as described with reference to FIG. 2.

At operation 1835 (e.g., in step l), the system sends the third conversational summary to each of the members of a third different sub-group and expresses it to each member in conversational form via text or voice, where the third different sub-group is not the third sub-group. In some cases, the operations of this step refer to, or may be performed by, software components as described with reference to FIG. 2.

At operation 1840 (e.g., in step m), the system repeats operations 1805-1835 (e.g., steps (d) through (l)) at least one time. In some cases, the operations of this step refer to, or may be performed by, software components as described with reference to FIG. 2.

At operation 1845 (e.g., in step n), the system processes the first conversational summary, the second conversational summary, and the third conversational summary using the large language model to generate a global conversational summary. In many preferred embodiments, the global conversational summary is represented, at least in part, in conversational form. In many embodiments the system sends the global conversational summary to a plurality of members of the full population of members and expresses it to each member in conversational form via text or voice. In some embodiments, the plurality of members is the full population of members. In many embodiments the expression in conversational form is in the first person. In some cases, the operations of this step refer to, or may be performed by, software components as described with reference to FIG. 2.

It should be noted that in some embodiments of the present invention, some participants may communicate by text chat while other participants communicate by voice chat and other participants communicate by video chat or VR chat. In other words, the methods described herein can enable a combined environment in which participants communicate in real-time conversations through multiple modalities of text, voice, video, or VR. For example, a participant can communicate by text as input while receiving voice, video, or VR messages from other members as output. In addition, a participant can communicate by text as input while receiving conversational summaries from surrogate agents as voice, video, or VR output.

In such embodiments, each networked computing device includes appropriate input and output elements, such as one or more screen displays, haptic devices, cameras, microphones, speakers, LIDAR sensors, and the like, as appropriate to voice, video, and virtual reality (VR) communications.

Accordingly (e.g., based on the techniques described with reference to FIGS. 1-11, the operations described with reference to FIGS. 12-18, etc.), the present disclosure includes the following aspects.

Methods, apparatuses, non-transitory computer readable medium, and systems for computer mediated collaboration for distributed conversations is described. One or more aspects of the methods, apparatuses, non-transitory computer readable medium, and systems include providing a collaboration server running a collaboration application, the collaboration server in communication with the plurality of the networked computing devices, each computing device associated with one member of the population of human participants, the collaboration server defining a plurality of sub-groups of the population of human participants, the collaboration server comprising: providing a local chat application on each networked computing device, the local chat application configured for displaying a conversational prompt received from the collaboration server, and for enabling real-time chat communication with other members of a sub-group assigned the collaboration server, the real-time chat communication including sending chat input collected from the one member associated with the networked computing device to other members of the assigned sub-group; and enabling steps (e.g., steps or operations for computer mediated collaboration for distributed conversations) through communication between the collaboration application running on the collaboration server and the local chat applications running on each of the plurality of networked computing devices. The steps enabled through communication between the collaboration application and the local chat applications include: (a) sending the conversational prompt to the plurality of networked computing devices, the conversational prompt comprising a question, issue, or topic to be collaboratively discussed by the population of human participants, (b) presenting, substantially simultaneously, a representation of the conversational prompt to each member of the population of human participants on a display of the computing device associated with that member, (c) dividing the population of human participants into a first sub-group consisting of a first unique portion of the population, a second sub-group consisting second unique portion of the population, and a third sub-group consisting of a third unique portion of the population, wherein the first unique portion consists of a first plurality of members of the population of human participants, the second unique portion consists of a second plurality of members of the population of human participants and the third unique portion consists of a third plurality of members of the population of human participants, (d) collecting and storing a first conversational dialogue in a first memory portion at the collaboration server from members of the population of human participants in the first sub-group during an interval via a user interface on the computing device associated with each member of the population of human participants in the first sub-group, (e) collecting and storing a second conversational dialogue in a second memory portion at the collaboration server from members of the population of human participants in the second sub-group during the interval via a user interface on the computing device associated with each member of the population of human participants in the second sub-group, (f) collecting and storing a third conversational dialogue in a third memory portion at the collaboration server from members of the population of human participants in the third sub-group during the interval via a user interface on the computing device associated with each member of the population of human participants in the third sub-group, (g) processing the first conversational dialogue at the collaboration server using a large language model to identify and express a first conversational argument in conversational form, wherein the identifying of the first conversational argument comprises identifying at least one viewpoint, position or claim in the first conversational dialogue supported by evidence or reasoning, (h) processing the second conversational dialogue at the collaboration server using the large language model to identify and express a second conversational argument in conversational form, wherein the identifying of the second conversational argument comprises identifying at least one viewpoint, position or claim in the second conversational dialogue supported by evidence or reasoning, (i) processing the third conversational dialogue at the collaboration server using the large language model to identify and express a third conversational argument in conversational form, wherein the identifying of the third conversational argument comprises identifying at least one viewpoint, position or claim in the third conversational dialogue supported by evidence or reasoning, (j) sending the first conversational argument expressed in conversational form to each of the members of a first different sub-group, wherein the first different sub-group is not the first sub-group, (k) sending the second conversational argument expressed in conversational form to each of the members of a second different sub-group, wherein the second different sub-group is not the second sub-group, (l) sending the third conversational argument expressed in conversational form to each of the members of a third different sub-group, wherein the third different sub-group is not the third sub-group, and (m) repeating steps (d) through (l) at least one time.

Some examples of the methods, apparatuses, non-transitory computer readable medium, and systems described herein further include sending, in step (j), the first conversational argument expressed in conversational form to each of the members of a first different sub-group expressed in first person as if the first conversational argument were coming from a member of the first different sub-group of the population of human participants. Some examples further include sending, in step (k), the second conversational argument expressed in conversational form to each of the members of a second different sub-group expressed in first person as if the second conversational argument were coming from a member of the second different sub-group of the population of human participants. Some examples further include sending, in step (l), the third conversational argument expressed in conversational form to each of the members of a third different sub-group expressed in first person as if the third conversational argument were coming from a member of the third different sub-group of the population of human participants.

Some examples of the methods, apparatuses, non-transitory computer readable medium, and systems described herein further include processing, in step (n), the first conversational argument, the second conversational argument, and the third conversational argument using the large language model to generate a global conversational argument expressed in conversational form.

Some examples of the methods, apparatuses, non-transitory computer readable medium, and systems described herein further include sending, in step (o), the global conversational argument expressed in conversational form to each of the members of the first sub-group, the second sub-group, and the third sub-group.

In some aspects, a final global conversational argument is generated by weighting more recent ones of the global conversational arguments more heavily than less recent ones of the global conversational arguments.

In some aspects, the first conversational dialogue, the second conversational dialogue and the third conversational dialogue each comprise a set of ordered chat messages comprising text.

In some aspects, the first conversational dialogue, the second conversational dialogue and the third conversational dialogue each further comprise a respective member identifier for the member of the population of human participants who entered each chat message.

In some aspects, the first conversational dialogue, the second conversational dialogue and the third conversational dialogue each further comprises a respective timestamp identifier for a time of day when each chat message is entered.

In some aspects, the processing the first conversational dialogue in step (g) further comprises determining a respective response target indicator for each chat message entered by the first sub-group, wherein the respective response target indicator provides an indication of a prior chat message to which each chat message is the processing the second conversational responding; dialogue in step (h) further comprises determining a respective response target indicator for each chat message entered by the second sub-group, wherein the respective response target indicator provides an indication of a prior chat message to which each chat message is responding; and the processing the third conversational dialogue in step (i) further comprises determining a respective response target indicator for each chat message entered by the third sub-group, wherein the respective response target indicator provides an indication of a prior chat message to which each chat message is responding.

In some aspects, the processing the first conversational dialogue in step (g) further comprises determining a respective sentiment indicator for each chat message entered by the first sub-group, wherein the respective sentiment indicator provides an indication of whether each chat message is in agreement or disagreement with prior chat messages; the processing the second conversational dialogue in step (h) further comprises determining a respective sentiment indicator for each chat message entered by the second sub-group, wherein the respective sentiment indicator provides an indication of whether each chat message is in agreement or disagreement with prior chat messages; and the processing the third conversational dialogue in step (i) further comprises determining a respective sentiment indicator for each chat message entered by the third sub-group, wherein the respective sentiment indicator provides an indication of whether each chat message is in agreement or disagreement with prior chat messages.

In some aspects, the processing the first conversational dialogue in step (g) further comprises determining a respective conviction indicator for each chat message entered by the first sub-group, wherein the respective conviction indicator provides an indication of conviction for each chat message; the processing the second conversational dialogue in step (h) further comprises determining a respective conviction indicator for each chat message entered by the second sub-group, wherein the respective conviction indicator provides an indication of conviction for each chat message; and the processing the third conversational dialogue in step (i) further comprises determining a respective conviction indicator for each chat message entered by the third sub-group, wherein the respective conviction indicator provides an indication of conviction each chat message is in the expressions of the chat message.

In some aspects, the first unique portion of the population (i.e., a first sub-group) consists of no more than ten members of the population of human participants, the second unique portion consists of no more than ten members of the population of human participants, and the third unique portion consists of no more than ten members of the population of human participants.

In some aspects, the first conversational dialogue comprises chat messages comprising voice (i.e., real-time verbal content expressed during a conversation by a user 145 and captured by a microphone associated with their computing device 135.)

In some aspects, the voice includes words spoken, and at least one spoken language component selected from the group of spoken language components consisting of tone, pitch, rhythm, volume and pauses. In some embodiments, the verbal content is converted into textual content (by well-known speech to text methods) prior to transmission to the collaboration server 145.)

In some aspects, the first conversational dialogue comprises chat messages comprising video (i.e., real-time verbal content expressed during a conversation by a user 145 and captured by a camera and microphone associated with their computing device 135).

In some aspects, the video includes words spoken, and at least one language component selected from the group of language components consisting of tone, pitch, rhythm, volume, pauses, facial expressions, gestures, and body language.

In some aspects, the each of the repeating steps occurs after expiration of an interval.

In some aspects, the interval is a time interval.

In some aspects, the interval is a number of conversational interactions.

In some aspects, the first different sub-group is the second sub-group, and the second different sub-group is the third sub-group.

In some aspects, the first different sub-group is a first randomly selected sub-group, the second different sub-group is a second randomly selected sub-group, and the third different sub-group is a third randomly selected sub-group, wherein the first randomly selected sub-group, the second randomly selected sub-group and the third randomly selected sub-group are not the same sub-group.

Some examples of the methods, apparatuses, non-transitory computer readable medium, and systems described herein further include processing, in step (g), the first conversational dialogue at the collaboration server using the large language model to identify and express the first conversational argument in conversational form, wherein the identifying of the first conversational argument comprises identifying at least one viewpoint, position or claim in the first conversational dialogue supported by evidence or reasoning, wherein the first conversational argument is not identified in the first different sub-group. Some examples further include processing, in step (h), the second conversational dialogue at the collaboration server using the large language model to identify and express the second conversational argument in conversational form, wherein the identifying of the second conversational argument comprises identifying at least one viewpoint, position or claim in the second conversational dialogue supported by evidence or reasoning, wherein the second conversational argument is not identified in the second different sub-group. Some examples further include processing, in step (i), the third conversational dialogue at the collaboration server using the large language model to identify and express the third conversational argument in conversational form, wherein the identifying of the third conversational argument comprises identifying at least one viewpoint, position or claim in the third conversational dialogue supported by evidence or reasoning, wherein the third conversational argument is not identified in the third different sub-group.

One or more aspects of the methods, apparatuses, non-transitory computer readable medium, and systems described herein include sending, in step (a), the conversational prompt to the plurality of networked computing devices, the conversational prompt comprising a question, issue, or topic to be collaboratively discussed by the population of human participants; presenting, in step (b), substantially simultaneously, a representation of the conversational prompt to each member of the population of human participants on a display the of computing device associated with that member; dividing, in step (c), the population of human participants into a first sub-group consisting of a first unique portion of the population, a second sub-group consisting of a second unique portion of the population, and a third sub-group consisting of a third unique portion of the population, wherein the first unique portion consists of a first plurality of members of the population of human participants, the second unique portion consists of a second plurality of members of the population of human participants and the third unique portion consists of a third plurality of members of the population of human participants, comprising dividing the population of human participants as a function of user initial responses to the to the conversational prompt; collecting and storing, in step (d), a first conversational dialogue in a first memory portion at the collaboration server from members of the population of human participants in the first sub-group during an interval via a user interface on the computing device associated with each member of the population of human participants in the first sub-group; collecting and storing, in step (e), a second conversational dialogue in a second memory portion at the collaboration server from members of the population of human participants in the second sub-group during the interval via a user interface on the computing device associated with each member of the population of human participants in the second sub-group; collecting and storing, in step (f), a third conversational dialogue in a third memory portion at the collaboration server from members of the population of human participants in the third sub-group during the interval via a user interface on the computing device associated with each member of the population of human participants in the third sub-group; processing, in step (g), the first conversational dialogue at the collaboration server using a large language model to express a first conversational summary in conversational form; processing, in step (h), the second conversational dialogue at the collaboration server using the large language model to express a second conversational summary in conversational form; processing, in step (i), the third conversational dialogue at the collaboration server using the large language model to express a third conversational summary in conversational form; sending, in step (j), the first conversational summary expressed in conversational form to each of the members of a first different sub-group, wherein the first different sub-group is not the first sub-group; sending, in step (k), the second conversational summary expressed in conversational form to each of the members of a second different sub-group, wherein the second different sub-group is not the second sub-group; sending, in step (l), the third conversational summary expressed in conversational form to each of the members of a third different sub-group, wherein the third different sub-group is not the third sub-group; and repeating, in step (m), steps (d) through (l) at least one time.

Some examples of the methods, apparatuses, non-transitory computer readable medium, and systems described herein further include sending, in step (j), the first conversational summary expressed in conversational form to each of the members of a first different sub-group expressed in first person as if the first conversational summary were coming from an additional member (simulated) of the first different sub-group of the population of human participants. Some examples further include sending, in step (k), the second conversational summary expressed in conversational form to each of the members of a second different sub-group expressed in first person as if the second conversational summary were coming from an additional member (simulated) of the second different sub-group of the population of human participants. Some examples further include sending, in step (l), the third conversational summary expressed in conversational form to each of the members of a third different sub-group expressed in first person as if the third conversational summary were coming from an additional member (simulated) of the third different sub-group of the population of human participants.

Some examples of the methods, apparatuses, non-transitory computer readable medium, and systems described herein further include processing, in step (n), the first conversational summary, the second conversational summary, and the third conversational summary using the large language model to generate a global conversational summary expressed in conversational form.

Some examples of the methods, apparatuses, non-transitory computer readable medium, and systems described herein further include sending, in step (o), the global conversational summary expressed in conversational form to each of the members of the first sub-group, the second sub-group, and the third sub-group.

In some aspects, a final global conversational summary is generated by weighting more recent ones of the global conversational summaries more heavily than less recent ones of the global conversational summaries.

In some aspects, the dividing the population of human participants, in step (c), comprises: assessing the initial responses to determine the most supported user perspectives the dividing the population to distribute the most supported user perspectives amongst the first sub-group the second sub-group and the third sub-group.

Some examples of the methods, apparatuses, non-transitory computer readable medium, and systems described herein further include presenting, substantially simultaneously, in step (b), a representation of the conversational prompt to each member of the population of human participants on a display of the computing device associated with that member, wherein the presenting further comprises providing a set of alternatives, options or controls for initially responding to the conversational prompt.

In some aspects, the dividing the population of human participants, in step (c), comprises: assessing the initial responses to determine the most supported user perspectives the dividing the population to group users having the first most supported user perspective together in the first sub-group, users having the second most supported user perspective together in the second sub-group, and users having the third most supported user perspective together in the third sub-group.

One or more aspects of the methods, apparatuses, non-transitory computer readable medium, and systems described herein include monitoring, in step (n), the first conversational dialogue for a first viewpoint, position or claim not supported by first reasoning or evidence; sending, in step (o), in response to monitoring the first conversational dialogue, a first conversational question to the first sub-group requesting first reasoning or evidence in support of the first viewpoint, position or claim; monitoring, in step (p), the second conversational dialogue for a second viewpoint, position or claim not supported by second reasoning or evidence; sending, in step (q), in response to monitoring the second conversational dialogue, a second conversational question to the second sub-group requesting second reasoning or evidence in support of the second viewpoint, position or claim; monitoring, in step (r), the third conversational dialogue for a third viewpoint, position or claim not supported by third reasoning or evidence; and sending, in step(s), in response to monitoring the third conversational dialogue, a third conversational question to the third sub-group requesting third reasoning or evidence in support of the third viewpoint, position or claim.

One or more aspects of the methods, apparatuses, non-transitory computer readable medium, and systems described herein include monitoring, in step (n), the first conversational dialogue for a first viewpoint, position or claim supported by first reasoning or evidence; sending, in step (o), in response to monitoring the first conversational dialogue, a first conversational challenge to the first sub-group questioning the first reasoning or evidence in support of the first viewpoint, position or claim; monitoring, in step (p), the second conversational dialogue for a second viewpoint, position or claim supported by second reasoning or evidence; sending, in step (q), in response to monitoring the second conversational dialogue, a second conversational challenge to the second sub-group questioning second reasoning or evidence in support of the second viewpoint, position or claim; monitoring, in step (r), the third conversational dialogue for a third viewpoint, position or claim supported by third reasoning or evidence; and sending, in step(s), in response to monitoring the third conversational dialogue, a third conversational challenge to the third sub-group questioning third reasoning or evidence in support of the third viewpoint, position or claim.

Some examples of the methods, apparatuses, non-transitory computer readable medium, and systems described herein further include sending, in step (o), the first conversational challenge to the first sub-group questioning the first reasoning or evidence in support of the first viewpoint, position, or claim, wherein the questioning the first reasoning or evidence includes a viewpoint, position, or claim collected from the second different sub-group or the third different sub-group.

One or more aspects of the methods, apparatuses, non-transitory computer readable medium, and systems described herein include processing, in step (n), the first conversational summary, the second conversational summary, and the third conversational summary using the large language model to generate a list of positions, reasons, themes or concerns from across the first sub-group, the second sub-group, and the third sub-group; displaying, in step (o), to the human moderator using the collaboration server the list of positions, reasons, themes or concerns from across the first sub-group, the second sub-group, and the third sub-group; receiving, in step (p), a selection of at least one of the positions, reasons, themes or concerns from the human moderator via the collaboration server; and in generating, step (q), a global conversational summary expressed in conversational form as a function of the selection of the at least one of the positions, reasons, themes or concerns.

In some aspects, the providing the local moderation application on at least one networked computing device, the local moderation application configured to allow the human moderator to observe the first conversational dialogue, the second conversational and dialogue, the third conversational dialogue.

In some aspects, the providing the local moderation application on at least one networked computing device, the local moderation application configured to allow the human moderator to selectively and collectively send communications to members of the first sub-group, send communications to members of the second sub-group, and send communications to members of the third sub-group.

Some examples of the methods, apparatuses, non-transitory computer readable medium, and systems described herein further include sending, in step (r), the global conversational summary expressed in conversational form to each of the members of the first sub-group, the second sub-group, and the third sub-group.

One or more aspects of the methods, apparatuses, non-transitory computer readable medium, and systems described herein include processing, in step (g), the first conversational dialogue at the collaboration server using a large language model to express a first conversational summary in conversational form; processing, in step (h), the second conversational dialogue at the collaboration server using the large language model to express a second conversational summary in conversational form; processing, in step (i), the third conversational dialogue at the collaboration server using the large language model to express a third conversational summary in conversational form; sending, in step (j), the first conversational summary expressed in conversational form to each of the members of a first different sub-group, wherein the first different sub-group is not the first sub-group; sending, in step (k), the second conversational summary expressed in conversational form to each of the members of a second different sub-group, wherein the second different sub-group is not the second sub-group; sending, in step (l), the third conversational summary expressed in conversational form to each of the members of a third different sub-group, wherein the third different sub-group is not the third sub-group; repeating, in step (m), steps (d) through (l) at least one time; and processing, in step (n), the first conversational summary, the second conversational summary, and the third conversational summary using the large language model to generate a global conversational summary expressed in conversational form.

Some examples of the methods, apparatuses, non-transitory computer readable medium, and systems described herein further include processing, in step (n), the first conversational summary, the second conversational summary, and the third conversational y using the large language model to generate a first global conversational summary expressed in conversational form, wherein the first global conversational summary is tailored to the first sub-group, generate a second global conversational summary, wherein the second global conversational summary is tailored to the second sub-group, and generate a third global conversational summary, wherein the third global conversational summary is tailored to the third sub-group. Some examples further include sending, in step (o), the first global conversational summary expressed in conversational form to each of the members of the first sub-group, send the second global conversational summary expressed in conversational from to the each of the members of the second sub-group, and send the third global conversational summary expressed in conversational from to each of the members of the third sub-group.

Some examples of the methods, apparatuses, non-transitory computer readable medium, and systems described herein further include processing, in step (n), the first conversational summary, the second conversational summary, and the third conversational summary using the large language model to generate a first global conversational summary expressed in conversational form, wherein the first global conversational summary is tailored to the first sub-group by including a viewpoint, position, or claim not expressed in the first sub-group, generate a second global conversational summary, wherein the second global conversational summary is tailored to the second sub-group by including a viewpoint, position, or claim not expressed in the second sub-group, and generate a third global conversational summary, wherein the third global conversational summary is tailored to the third sub-group by including a viewpoint, position, or claim not expressed in the third sub-group.

Some examples of the methods, apparatuses, non-transitory computer readable medium, and systems described herein further include processing, in step (n), the first conversational summary, the second conversational summary, and the third conversational summary using the large language model to generate a first global conversational summary expressed in conversational form, wherein the first global conversational summary is tailored to the first sub-group by including a viewpoint, position, or claim not expressed in the first sub-group, wherein the viewpoint, position, or claim not expressed in the first sub-group is collected from the first different subgroup, wherein the second global conversational summary is tailored to the second sub-group by including a viewpoint, position, or claim not expressed in the second sub-group, wherein the viewpoint, position, or claim not expressed in the second sub-group is collected from the second different subgroup, wherein the third global conversational summary is tailored to the third sub-group by including a viewpoint, position, or claim not expressed in the third sub-group, wherein the viewpoint, position, or claim not expressed in the third sub-group is collected from the third different subgroup.

One or more aspects of the methods, apparatuses, non-transitory computer readable medium, and systems described herein include sending, in step (a), the conversational prompt to the plurality of networked computing devices, the conversational prompt comprising a question, issue, or topic to be collaboratively discussed by the population of human participants; presenting, in step (b), substantially simultaneously, a representation of the conversational prompt to each member of the population of human participants on a display of the computing device associated with that member; dividing, in step (c), the population of human participants into a first sub-group consisting of a first unique portion of the population, a second sub-group consisting of a second unique portion of the population, and a third sub-group consisting of a third unique portion of the population, wherein the first unique portion consists of a first plurality of members of the population of human participants, the second unique portion consists of a second plurality of members of the population of human participants and the third unique portion consists of a third plurality of members of the population of human participants; collecting and storing, in step (d), a first conversational dialogue in a first memory portion at the collaboration server from members of the population of human participants in the first sub-group during an interval via a user interface on the computing device associated with each member of the population of human participants in the first sub-group, wherein the first conversational dialogue comprises chat messages comprising a first segment of video including at least one member of the first sub-group; collecting and storing, in step (e), a second conversational dialogue in a second memory portion at the collaboration server from members of the population of human participants in the second sub-group during the interval via a user interface on the computing device associated with each member of the population of human participants in the second sub-group, wherein the first conversational dialogue comprises chat messages comprising a second segment of video including at least one member of the second sub-group; collecting and storing, in step (f), a third conversational dialogue in a third memory portion at the collaboration server from members of the population of human participants in the third sub-group during the interval via a user interface on the computing device associated with each member of the population of human participants in the third sub-group, wherein the first conversational dialogue comprises chat messages comprising a second segment of video including at least one member of the third sub-group; processing, in step (g), the first conversational dialogue at the collaboration server using a large language model to express a first conversational summary in conversational form; processing, in step (h), the second conversational dialogue at the collaboration server using the large language model to express a second conversational summary in conversational form; processing, in step (i), the third conversational dialogue at the collaboration server using the large language model to express a third conversational summary in conversational form; sending, in step (j), the first conversational summary expressed in conversational form to each of the members of a first different sub-group, wherein the first different sub-group is not the first sub-group; sending, in step (k), the second conversational summary expressed in conversational form to each of the members of a second different sub-group, wherein the second different sub-group is not the second sub-group; sending, in step (l), the third conversational summary expressed in conversational form to each of the members of a third different sub-group, wherein the third different sub-group is not the third sub-group; and repeating, in step (m), steps (d) through (l) at least one time.

Some examples of the methods, apparatuses, non-transitory computer readable medium, and systems described herein further include sending, in step (j), the first conversational summary expressed in conversational form to each of the members of a first different sub-group expressed in first person as if the first conversational summary were coming from an additional member (simulated) of the first different sub-group of the population of human participants. Some examples further include sending, in step (k), the second conversational summary expressed in conversational form to each of the members of a second different sub-group expressed in first person as if the second conversational summary were coming from an additional member (simulated) of the second different sub-group of the population of human participants. Some examples further include sending, in step (l), the third conversational summary expressed in conversational form to each of the members of a third different sub-group expressed in first person as if the third conversational summary were coming from an additional member (simulated) of the third different sub-group of the population of human participants.

Some examples of the methods, apparatuses, non-transitory computer readable medium, and systems described herein further include sending, in step (j), the first conversational summary expressed in conversational form to each of the members of a first different sub-group expressed in first person as if the first conversational summary were coming from an additional member (simulated) of the first different sub-group of the population of human participants, including sending the first conversational summary in a first video segment comprising a graphical character representation expressing the first conversational summary through movement and voice. Some examples further include sending, in step (k), the second conversational summary expressed in conversational form to each of the members of a second different sub-group expressed in first person as if the as if the second conversational summary were coming from an additional member (simulated) of the second different sub-group of the population of human participants, including sending the second conversational summary in a second video segment comprising a graphical character representation expressing the second conversational summary through movement and voice. Some examples further include sending, in step (l), the third conversational summary expressed in conversational form to each of the members of a third different sub-group expressed in first person as if the third conversational summary were coming from an additional member (simulated) of the third different sub-group of the population of human participants, including sending the second conversational summary in a second video segment comprising a graphical character representation expressing the second conversational summary through movement and voice.

Some examples of the methods, apparatuses, non-transitory computer readable medium, and systems described herein further include sending, in step (j), the first conversational summary expressed in conversational form to each of the members of a first additional different sub-group. Some examples further include sending, in step (k), the second conversational summary expressed in conversational form to each of the members of a second additional different sub-group. Some examples further include sending, in step (l), the third conversational summary expressed in conversational form to each of the members of a third additional different sub-group.

Some examples of the methods, apparatuses, non-transitory computer readable medium, and systems described herein further include processing, in step (g), the first conversational dialogue at the collaboration server using a large language model to express a first conversational summary in conversational form, wherein the first conversational summary includes a first graphical representation of a first artificial agent. Some examples further include processing, in step (h), the second conversational dialogue at the collaboration server using the large language model to express a second conversational summary in conversational form, wherein the second conversational summary includes a second graphical representation of a second artificial agent. Some examples in further include processing, step (i), the third conversational dialogue at the collaboration server using the large language model to express a third conversational summary in conversational form, wherein the third conversational summary includes a third graphical representation of a third artificial agent.

### Collective Superintelligence

One or more embodiments of the present disclosure provide systems and methods based on which a large population of users can hold a single unified conversation via a communication structure that divides the population into a plurality of small subgroups. The subgroups overlap based on assignment of an artificial agent (i.e., an AI agent) to each subgroup that expresses as natural first-person dialog.

In some cases, a conversational introduction can be used to enable subgroups to easily integrate the comments/insights expressed by the Surrogate within its group. For example, the Surrogate Agent within a room (i.e., chatroom or video conference room) can initially be introduced in the first person, telling the participants the name and function. In some examples, the surrogate agent may be introduced as “Hi my name is Sparky and I'm the Conversational I assigned to this room. There are currently 24 other rooms like this one. My job is to receive insights from those other rooms as they deliberate and tell you about them so you can consider their views during your deliberations. My job is also to pass your insights to other rooms so they can consider your views during their deliberations. This will make all of us smarter together.”

Additionally, the AI agents are Conversational Surrogate Agents (CSai) that are based on LLM and repeatedly observe the conservation of the associated subgroup, extract insights, assess numerical measure(s), store the observed insights and associated numerical measures and associated user, aggregate the numerical measures across unique insights, pass insights to other Surrogate Agents of other subgroups, receive insights of other subgroups from other Conversational Surrogates, express insights of other subgroups to the associated subgroup, and insights to the associated subgroup received from the Observer Agent. In some cases, the CSai may be configured to pass insights to Global Agent and receive insights from a Global Observer Agent.

According to one or more embodiments, the said insight may be passed as language, said insights may be passed along with said aggregated numerical measures of CONFIDENCE and/or CONVICTION and/or SCOPE. According to one or more embodiments, the said insights may include textual language representing the insights and numerical measures of the subgroup's CONVICTION and/or CONFIDENCE and/or SCOPE in said insights. The CSai expresses insights to the associated subgroup received from the Global Agent (in first person language).

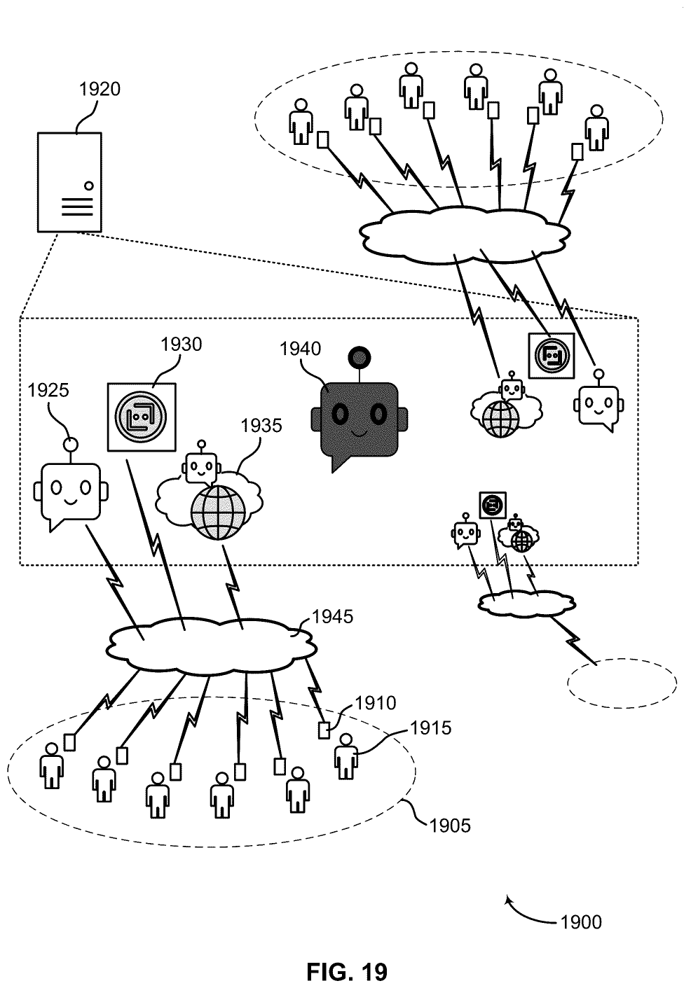

FIG. 19 shows an example of a system 1900 for real-time communication, conversation analysis, and insight extraction according to aspects of the present disclosure. In one aspect, system 1900 includes subgroups 1905 and central server 1920, where each subgroup 1905 includes computing devices 1910 (and corresponding participants or users 1915).

According to some aspects, central server 1920 is configured to coordinate asynchronous transmission and reception of insights among the AI agents based on predefined heuristics, wherein the heuristics determine which insights are to be transmitted from a subgroup, and which subgroups are to receive the transmitted insights. In some aspects, the central server 1920 is further configured to periodically update the predefined heuristics based on the aggregated responses from the feedback mechanism. In some aspects, the central server 1000 is further configured to generate reports or visualizations based on the aggregated insights and numerical measures from all subgroups. In some aspects, the central server 1920 is further configured to facilitate the exchange of insights between different subgroups based on the level of consensus identified from the aggregated insights.

According to some aspects, central server 1920 assigns a conversational surrogate agent (AI agent) to each subgroup. In some examples, central server 1920 coordinates asynchronous transmission and reception of insights among the subgroups using a central server 1920 based on predefined heuristics, where the heuristics determine which insights are to be transmitted from a subgroup, and which subgroups are to receive the transmitted insights. In some aspects, the central server 1920 is further configured to periodically update the predefined heuristics based on the aggregated responses from the feedback mechanism. In some aspects, the central server 1920 is further configured to generate reports or visualizations based on the aggregated insights and numerical measures from all subgroups. In some aspects, the central server 1920 is further configured to facilitate the exchange of insights between different subgroups based on the level of consensus identified from the aggregated insights.

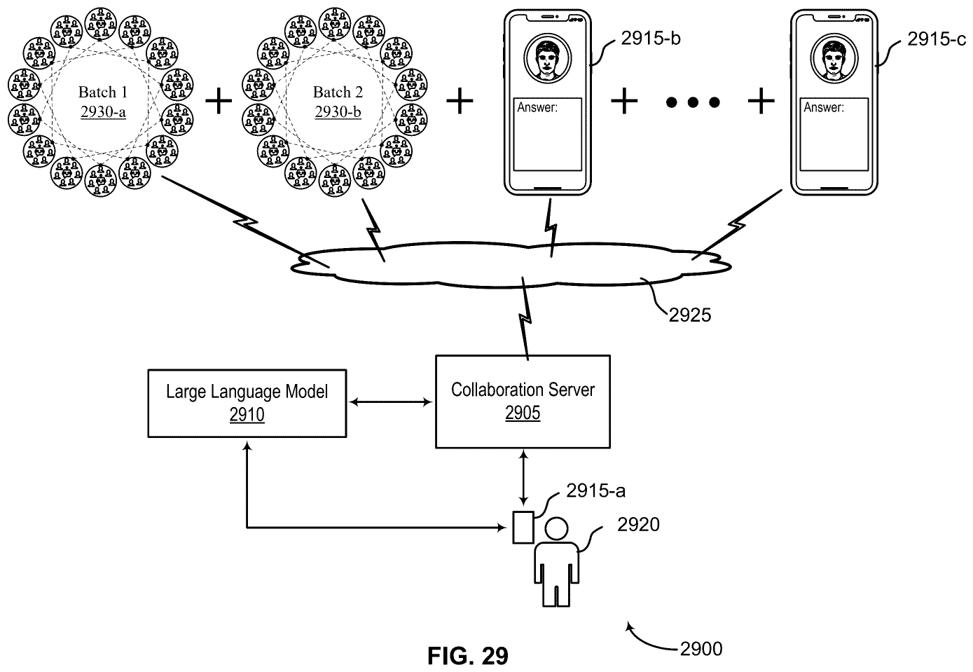

Central server 1920 is an example of, or includes aspects of, the corresponding element described with reference to FIGS. 11 and 29. In one aspect, central server 1920 includes (e.g., or implements) one or more conversational surrogate agent 1925. A conversational surrogate agent 1925 is an example of, or includes aspects of, the corresponding element described with reference to FIGS. 2, 5, 6, 8, 9, 11, and 20-24. In one aspect, conversational surrogate agent 1925 includes LLM-powered module 1930.

Subgroup 1905 is an example of, or includes aspects of, the corresponding element described with reference to FIGS. 3-6, 8, 9, and 20-24. Computing device 1910 is an example of, or includes aspects of, the corresponding element described with reference to FIG. 5. User 1915 is an example of, or includes aspects of, the corresponding element described with reference to FIGS. 1, 2, 4-6, 8, 9, and 20-24. Central server 1920 is an example of, or includes aspects of, the corresponding element described with reference to FIGS. 10 and 11.

One or more aspects of the systems and apparatuses described herein may include a plurality of networked computing devices 1910 associated with members of a population of participants (users 1915), and networked via a computer network 1945 and a central server 1920 in communication with the plurality of networked computing devices 1910, the central server 1920 dividing the population into a plurality of subgroups 1905 and enabling a conversational surrogate agent 1925 (CSai) associated with each subgroup 1905.

An apparatus, system (e.g., network architecture 1900), and method for large-scale conversational deliberation and amplified collective intelligence are described. One or more aspects of the apparatus, system, and method include a plurality of networked subgroups 1905 of users 1915, each subgroup 1905 configured for real-time conversational deliberation among a its members; conversational surrogate agent 1925 associated with each subgroup 1905, each configured to observe the real-time conversational deliberation among members of its subgroup 1905, pass insights to and receive insights from other conversational surrogate agents 1925 associated with other subgroups 1905, and conversationally express insights received from other subgroups 1905 to the members of its own subgroup 1905 as natural first person dialog; and a conversational contributor agent 1930 associated with each subgroup 1905, each configured to participate in local conversation of that subgroup 1905 by offering answers, insights, opinions, or factual information that is independently AI generated rather than being derived based on conversational content of human users 1915 in other subgroups 1905. In some instances the Conversational Contributor Agent expresses factual information that is derived at least in part from a defined set of documents and or data. In other instances, the Conversational Contributor Agent may express factual information that is derived by searching the internet or accessing other remote sources of information. In both cases where the Conversational Contributor Agent is provided with and/or remotely accesses sources of information when generating conversational content, we refer to that agent as a Scout Agent or Fact Agent.

Some examples of the apparatus, system, and method further include a global observer agent 1940 associated with a set of subgroups 1905, configured to receive insights from and pass insights to the conversational surrogate agents 1925 associated with each of the subgroups 1905 in its set of subgroups 1905.

Some examples of the apparatus, system (e.g., network architecture 1900), and method further include one or more scout agents 1935, each associated with a particular subgroup 1905 or set of subgroups 1905 and configured to search for and acquire factual information for use in the real-time conversational deliberation within that subgroup 1905 or among that set of subgroups 1905 and express that factual information conversationally to the members of that subgroup 1905 in real-time. In some aspects, the scout agent 1935 is configured to search the internet and/or a set of defined information sources to acquire factual information for use in the real-time conversational deliberation.

In some aspects, the real-time conversational deliberation is a text chat conversation. In some aspects, the real-time conversational deliberation is a teleconference or videoconference conversation.

In some aspects, the conversational contributor agent 1930 is configured with a unique persona profile. In some aspects, the unique persona profile includes demographic characteristics, psychographic characteristics, expertise, information, and/or values. In such instances where the Conversational Contributor Agent is configured to express conversational contributions from the perspective of a unique persona profile, we may refer to that agent as a Persona Agent.

In some aspects, the conversational surrogate agent 1925 is visually represented on the screens associated with each of one or more users 1915 as an animated avatar with facial expressions that correlated with its expressed first person conversational dialog.

In some aspects, the one or more conversational contributor agents 1930 are configured to offer factual information that is sourced by a scout agent 1935 in real-time. In some aspects, the conversational contributor agent 1930 is configured to offer insights, opinions, or factual information that is seeded with specific key phrases, talking points, statistics, stories, contexts, and other reference information or informational sources. In some aspects, the one or more conversational contributor agents 1930 are configured to participate in local conversation of that subgroup 1905 by offering answers, insights, opinions, or factual information that is generated using a large language model. In some aspects, the one or more conversational contributor agents 1930 are configured to participate in local conversation of that subgroup 1905 by offering answers, insights, opinions, or factual information that is generated using GPT Builder from Open AI.

Some examples of the apparatus, system, and method further include a conversational topic that is provided over an information network to one or more networked subgroups 1905, the one or more networked subgroups 1905 configured hold simultaneous conversational deliberations on the conversational topic during a synchronous time period.

Some examples of the apparatus, system, and method further include one or more other networked subgroups 1905 are configured to hold sequential conversational deliberations on the conversational topic during asynchronous time periods.

An apparatus, system (e.g., network architecture 1900), and method for large-scale conversational deliberation and amplified collective intelligence are described. One or more aspects of the apparatus, system, and method include a communication structure that divides a large population of users 1915 into one or more unique subgroups 1905, each configured for real-time conversational deliberation among its members; a conversational surrogate agent 1925 assigned to each subgroup 1905, each configured to observe real-time dialog among its members, distill salient insights, pass insights to one or more other subgroups 1905, and conversationally express insights received from other subgroups 1905 to members of its own subgroup 1905 as natural first person dialog; and one or more conversational contributor agents 1930 placed into one or more subgroups 1905 of humans, each configured to participate in local conversations of its subgroup 1905 independently of observations of other rooms, by suggesting answers or offering insights, opinions, and/or factual information that is primarily AI generated.

Some examples of the apparatus, system, and method further include including a global agent configured to send and receive insights with each of the one or more unique subgroups 1905.

An apparatus, system, and method for large-scale conversational deliberation and amplified collective intelligence are described. One or more aspects of the apparatus, system, and method include a communication structure that divides a large population of users 1915 into one or more unique subgroups 1905, each configured for real-time conversational deliberation among its members; a conversational surrogate agent 1925 assigned to each subgroup 1905, each configured to observe real-time conversational deliberation among its members, distill salient insights, pass insights to one or more other subgroups 1905, and conversationally express insights received from other subgroups 1905 to members of its own subgroup 1905 as natural first person dialog; and a scout agent 1935 assigned to subgroup 1905, each configured to search for and acquire factual information for use in the real-time conversational deliberation in that subgroup 1905 and express that factual information to the members of that subgroup 1905 in real-time.

Some examples of the apparatus, system, and method further include a global agent configured to send and receive insights with each of the one or more unique subgroups 1905.

Some examples of the apparatus, system, and method further include one or more conversational contributor agents 1930, each associated with a particular subgroup 1905 or set of subgroups 1905 and configured to participate in local conversation of its subgroup 1905 by offering answers, insights, opinions, or factual information that is entirely AI generated or generated by AI based in part on accessed sources of factual content.

In some aspects, the scout agent 1935 is configured to search the internet or other information sources to acquire factual information for use in the real-time conversational deliberation. For example, in some instances the Scout Agent 1935 may be provided with a curated set of factual information relevant to a conversational topic.

In some aspects, the conversational surrogate agent 1925 is configured to pass insights to other conversational surrogate agents 1925 associated with other subgroups 1905, the insights being passed as language, the insights being passed along with aggregated numerical measures of confidence and/or conviction and/or scope.

In some aspects, the conversational surrogate agent 1925 is configured to receive insights from other conversational surrogate agents 1925 associated with other subgroups 1905, the insights including textual language representing the insights and aggregated numerical measures of the other subgroups' 1905 conviction and/or confidence and/or scope in the insights.

In some aspects, the conversational surrogate agent 1925 is configured to express insights to its own subgroup 1905 received from conversational surrogate agents 1925 associated with other subgroups 1905, the strength of first-person language being modulated based at least in part upon the strength of received numerical measures.

Some examples of the apparatus, system, and method further include a conversational topic is provided over an information network to one or more networked subgroup 1905, the one or more networked subgroups 1905 configured hold simultaneous conversational deliberations on the conversational topic during a synchronous time period.

Some examples of the apparatus, system, and method further include one or more other networked subgroups 1905 are configured to hold sequential conversational deliberations on the conversational topic during asynchronous time periods.

In some aspects, the scout agent 1935 is configured to convey the acquired factual information to a conversational contributor agent 1930, configured to conversationally inject the factual information into the real-time conversational deliberation.

### Numerical Assessment

One or more embodiments of the present invention are configured to accelerate information transfer among subgroups 1905 to support faster and more effective convergence on optimized solutions. In some cases, an AI agent (e.g., Conversational Surrogate Agents 1925, CSai) extracts insights and assesses numerical measure(s) based on the observed insights, stores the numerical measures, and aggregates the numerical measures across unique insights. For example, the conversational surrogate agents 1925 may observe the conversation among the members of its subgroup 1905, distill and store content. In some cases, a conversational surrogate agent 1925 may extract insights from the observed subgroup conversation at intervals. The insights may include, for example (but not limited thereto), identifying proposed solutions to a current question, and/or proposed reasons in support or opposition to one or more said solutions.

Further, a conversational surrogate agent 1925 assesses numerical measure(s) of “conviction” and/or “confidence” associated with each unique insight that is observed within the conversation among the user 1915 of the corresponding subgroup 1905. The numerical assessments are associated with each solution and/or reason that is expressed by users 1915 of the subgroup 1905. Additionally, the numerical measures are associated with the user 1915 who expressed the insight (i.e., solution and/or reason). In some cases, the conversational surrogate agent 1925 stores the observed insights and associated numerical measures and associated users in a memory (database) by passing the data to one or more other computational processes.

According to an embodiment, the sentiment value of a user 1915 in an “answer choice” (i.e., in an idea or solution or other insight that a user is supporting or opposing in a conversational comment) represents the degree to which the user 1915 believes the answer choice is a good answer to the question or issue being deliberated. The sentiment is calculated and stored in real-time for each user 1915 in the full population of users 1915.

A user's sentiment in each answer choice may be computed based on a natural language processing system such as a large language model that is used to transform a batch of the user's dialog (i.e., language via entered text, or generated via voice to text) in-context (i.e., including another user's dialog messages that appear in the same time frame for context) into an estimation of the degree to which the user supports each answer choice. In some embodiments, a zero-centered scale is used, such as from −3 (strong negative support) to +3 (strong positive support), such that the center of the scale (no preference) is equivalent to not having mentioned the answer choice (or having expressed no preference for the answer choice).

In some cases, the sentiment assessment may be stored directly in the sentiment data structure associated with that user. For example, the storage may include overwriting the previous sentiment assessment with the new one. In some embodiments, the new measurement may be incorporated such that noise and the limited context window used over time is considered. In an embodiment, the sentiment of each user 1915 in a group is evaluated frequently in small batches of up to 10 messages at a time, and then a new sentiment data structure is calculated for each user in the group using natural language processing system. The new sentiment data structure may be applied to the user's existing sentiment data structure using heuristics.

In an embodiment, the heuristics apply a combination of rules. For example, the rules may include (but not limited thereto) applying smoothing by taking a weighted average of the new answer's sentiment and the existing answer's sentiment in case the answer already exists in the user's existing sentiment data structure, and/or increasing the existing sentiment value by some fraction of the new sentiment value in case the answer does not exist, and/or applying a decay to the existing sentiment value in case a previous answer is not mentioned.

In some cases, sentiment may be calculated at the user level, and averaged over the users in a subgroup 1905 and reported as the subgroup sentiment or averaged over users 1915 in a group (i.e., subgroup 1905 or chatroom) and reported as the average global sentiment. Accordingly, the mean subgroup sentiment for each insight that is surfaced (i.e., each answer surfaced, solution surfaced, and or justification or opposition for an answer or solution) can be updated in real-time or close to real-time. Similarly, the mean population sentiment for each insight that surfaces conversationally (i.e., each answer surfaced, solution surfaced, and or justification or opposition for an answer or solution) may be updated in real-time (or close to real-time).

Conviction refers to the fraction of positive sentiment directed each towards insight that is conversationally deliberated (i.e., each surfaced answer or solution or idea, and/or each surfaced justification in support or opposition of an answer or solution). Conviction may be calculated at the user level, based on the sentiment data structure. In some cases, in case someone had a +2 sentiment for Answer A, +1 sentiment for Answer B, and −2 sentiment for Answer C, the convictions may be the percentage of the overall sentiment (across the answers) that is directed at a particular answer: {Answer A: 67%, Answer B: 33%, Answer C: 0%}. A similar process may be used for justifications in support or opposition to an answer (i.e., the conviction in a justification for an answer is the percentage of overall sentiment (across justifications for the answer) that is directed at a particular justification.

In some cases, negative sentiment may be treated as 0 for the calculation of conviction since a user who opposes an idea has no conviction in the answer, and is not deemed to have negative conviction. Thus, conviction is a scale from 0 to 100% and indicates the fraction of positive support for an answer choice (or answer justification), and may not be modified by critics of an idea (i.e., people with negative sentiment for an idea). In some cases, conviction may be averaged over subgroups and reported as the subgroup conviction for each answer choice or averaged over the entire population and reported as the global conviction for each answer choice. In case of structures in which subgroups have different levels (i.e., subgroups of subgroups), conviction is computed for each level and the values are then used in heuristics associated with the level of the structure.

The exposure of an idea is calculated as the fraction of users that an idea has been presented to, as identified by a Natural Language processing tool or the sentiment data structure. For example, in a HyperChat with 10 subgroups of 5 users each, in case two groups mention Answer A, the exposure of the idea is approximately 20%, since only 20% of users are exposed to the idea in their subgroups. In case a message is passed that provides Answer A to a subgroup that had not mentioned the idea previously, the exposure is 30%, since 3 out of 10 subgroups may have seen the idea.

In some cases, exposure is calculated from the sentiment data structure and Conversational Surrogate message log based on tallying each chatroom in which a Conversational Surrogate has mentioned the idea or in which a user has directly mentioned the idea as tracked by the sentiment data structure. In other embodiments, a natural language processing tool examines the chat log of each chatroom directly to evaluate whether the idea has been mentioned. Accordingly, the number of users who may reasonably consider the idea are quantified.

The scope of an insight, also referred to as the engagement with the insight, is calculated as the fraction of users who mention or reference the insight (i.e., the answer or solution or idea) at least once, as identified by a Natural Language processing tool or the Sentiment data structure. Therefore, the degree to which an idea is being discussed by the group may be quantified. For example, in case 80% of the subgroup is exposed to an idea, and only 40% of the group has mentioned the idea, the idea may not include sufficient engagement within the subgroups (e.g., the idea may not get sufficient/desired traction within the subgroups).

In some embodiments, scope is calculated from the sentiment data structure by tallying the chatrooms in which a user has directly mentioned the idea as tracked by the Sentiment data structure. In some embodiments, a natural language processing tool examines the chat log of each chatroom directly to evaluate whether the idea has been mentioned and identify the user mentioning the idea.

According to one or more embodiments, the CSai aggregates the described numerical measures across unique insights expressed within the subgroup. For example, the conviction expressed and/or confidence is aggregated by computing over time the quantity and/or percentage of messages and/or unique users that expressed confidence and/or conviction in that particular insight. In some instances, the aggregation is scaled by the strength of the assessed confidence or conviction in each observation. In some embodiments, time is used as a factor, with a decay function in conviction and/or confidence as observed insights age versus newer insights observed from users. In some embodiments, the aggregated numerical measures include an indication of scope which is a percentage (or number) of users within the subgroup that have expressed support and/or have expressed opposition to a particular insight. Thus, a particular insight (i.e. the Yankees will win the world series) may be computed that may be associated with a confidence measure of +1.9 on a scale of −3 to +3. For example, the aggregation may be computed based on three users within a five-member subgroup that expressed sentiments related to the Yankees. In the example, the SCOPE of the confidence measure is 3/5 or 60%.

Accordingly, the conversational surrogate agent 1925 passes insights to other conversational surrogate agents 1925 associated with other subgroups 1905, said insight is passed as language, said insights is passed along with said aggregated numerical measures of confidence and/or conviction and/or scope. The strength of the first-person language (i.e. phrasing, emphasis, emotion) is modulated based at least in part upon on strength of received numerical measures (in relation to other insights received during the conversation).

### Facilitating Subgroup Communication

An embodiment of the present disclosure includes an architecture (e.g., a CSI architecture) configured to enable bidirectional flow of content into and out of subgroups at certain intervals based on elapsed time, elapsed conversational flow within subgroups, reaching threshold conviction, confidence, or scope levels within subgroups, and other measures.

For instance, in some embodiments, intelligent heuristics are used to pass insights from a first subgroup A to a second subgroup B among a large number of subgroups (for example, A through X) based on subgroup A having discussed with strong conviction and/or confidence in an insight (i.e., a solution or reason) that has not yet been surfaced (or been discussed to a threshold level) in subgroup B. The heuristic ensures that information propagates efficiently, giving preferential passage of insights surfaced in ‘first groups’ that have not yet been deliberated upon in ‘second groups’ at a meaningful level.

In some embodiments, a frequent and/or efficient information flow is performed to facilitate fast and/or smart population-wide deliberations. A form of valuable and accelerating bidirectional communication is enabling one subgroup to provide a response and/or feedback to insights that are obtained from a surrogate in another subgroup, the response selectively being passed to the originating subgroup.

In some aspects, the usage of the term “bidirectional” may imply that two groups (e.g., two subgroups 1905, two conversational surrogate agents 1925, etc.) may trade insights in either direction. However, in any of the described embodiments, insights (or any other communications or information sharing) may be relayed instead of, or in addition to, bidirectionally traded. For instance, a subgroup A may trade insights with B, B may trade insights with C, and C may trade insights with A.

In some cases, a fast solution may be to enable participants within a subgroup to provide simple expressions of appreciation and/or support for an insight from another subgroup that is expressed in the subgroup. For example, if a text, voice, or video insight from another subgroup is passed into a subgroup, the insight may be a text and/or audio for the members of the subgroup. In response, members may learn that a simple text response such as “Good Insight” will trigger the surrogate in the room to document and tally a favorable response. Additionally, or alternatively, in some cases, a single such response may not be enough to trigger feedback to the originating room. In some cases, a threshold metric can be used. According to an example, the threshold is a majority such that if a majority of participants within a subgroup respond to the injected insight with “Good Insight” or another similar phrase, the Conversational Surrogate in the chatroom can be configured to send a response message to the Surrogate that passed the insight, informing the surrogate that the insight was “well received” or “appreciated” by a majority of members of the subgroup.

An exemplary embodiment of the present disclosure considers a conversational swarm of 100 people broken into 20 subgroups of 5 people. For example, the number the subgroups may be referred to as SG1, SG2, . . . . SG20 and each of the 20 subgroups are conversationally deliberating possible solution to Water Scarcity in Arizona. In some examples, five people holding a deliberative real-time conversation in SG15 are collectively in favor of “investing in hydro-panels that harvest water from the air.” In some cases, the conversation surrogate of the group may pass the insight into another subgroup (e.g., SG12) along with numerical indications of conviction, confidence, and/or scope of support within the subgroup.

The Conversation Surrogate in SG12 expresses the insight to the members of SG12 as first-person dialog integrated into the conversational flow. In some examples, support within SG15 is very high, the the numerical Surrogate Agent is SG12 expresses the insight using strong language such as “Hello everyone, group 15 is in very strong favor of hydro-panels that extract water from the air. The primary reasons they've expressed is that it's cost effective compared to desalinization and low maintenance.”

For example, if a majority (at least 3 of 5) members of subgroup SG12 respond conversationally to the comment with “Good Insight”, “Useful Insight”, or a similar phrase, the Conversational Surrogate can be configured to send a message to the surrogate for SG15, indicating that members of SG12 think that was a useful insight. The message reported may indicate the strength of support, for example, indicating that 60% (or 3/5) of SG15 members found the insight useful. The strength of the first-person language fed back to SG15 (i.e., phrasing, emphasis, or emotion) can be modulated in part based on the strength of received numerical measures.

According to an embodiment, a shortcut can be implemented for enabling members of a subgroup to provide feedback to an insight passed in from another subgroup. In some cases, a graphical icon such as a “CLAP” symbol may be used. In some cases, the members of SG15 may click the CLAP icon in response to the insight being displayed visually or audibly within the local conversation. In case a majority of the users clap, a response message is triggered, e.g., a textual response such as “Good Insight” triggers. According to some embodiments, textual responses and clap icon clicks can be aggregated, giving users multiple alternate options for expressing support. According to some embodiments, users may only clap (or verbally support) a particular insight once. In some cases, the users may clap (or verbally support) multiple times. Accordingly, in some aspects, a quantifiable method and a clear threshold trigger is achieved. In some embodiments, a physical gesture by the user such as a thumbs-up gesture or a head-nod gesture may be detected by a camera of the computing device and used to trigger a numerical expression of support by that user for an expressed comment in the real-time conversation

The strength of the first-person language fed back to SG15 (i.e., phrasing, emphasis, or emotion) may be modulated in part based on the strength of the received numerical measures (e.g., in relation to other insights received during the conversation). For example, a user in a chatroom may be able to clap for a received insight. In some cases, if a majority of users in a room clap for a received insight, that gets reported back to the other room. “A majority in Room 3 liked your justification of Answer C.”

Conversational feedback pathway encourages members to more thoughtfully consider the insights from other subgroups. Moreover, participants are encouraged to come up with good insights in the respective subgroups that get passed to other subgroups and receive positive feedback. Additionally, the participants provide for a new channel of messaging which increases the frequency of messages passing between subgroups. The conversational feedback pathway provides analytical algorithms within the Central Server more information to discern levels of support for ideas and/or reasons being discussed across the population.

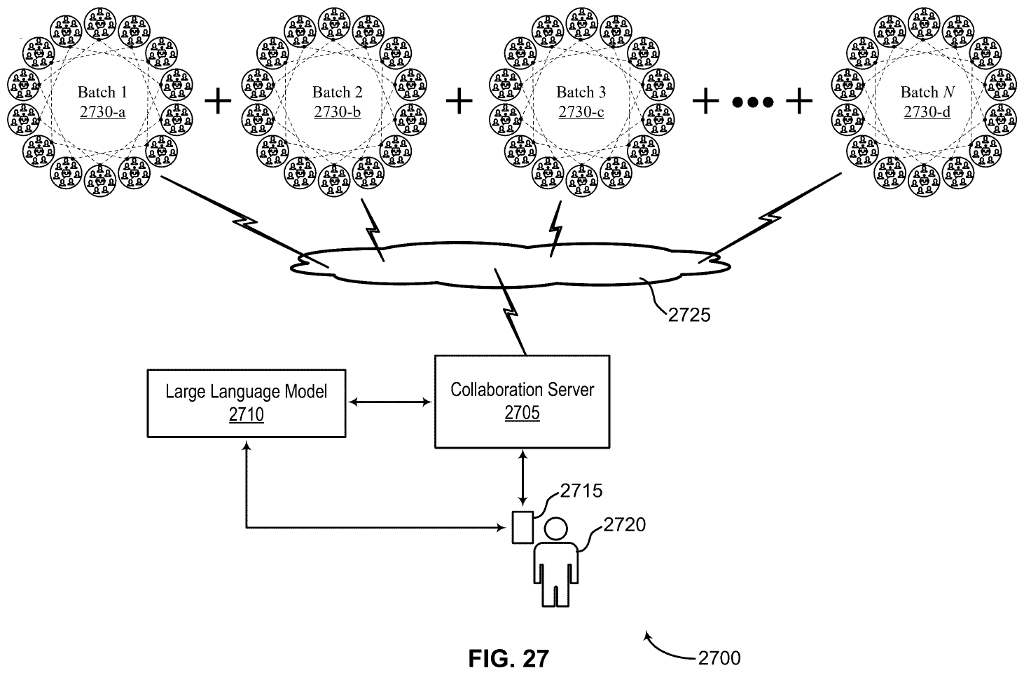

An embodiment of the present disclosure may be configured to enable moderator commands. In some cases, a moderator command provides for a human moderator or administrator to select between modes of operation when coordinating sessions among participants. For example, the human moderator may send a command such as “Set Participation Mode” to the central server (such as central server 1920 described with reference to FIG. 19) and assign a parameter, either synchronous, semi-synchronous, or asynchronous. Accordingly, the system may be configured into the semi-synchronous mode of operation. For example, in case of the semi-synchronous mode, the system may expect multiple groups of participants to engage through a series of batches, the first batch being the seed population (seed population as described with reference to FIGS. 27-29). After a seed population may have been conducted, the human moderator may continue coordinating sessions with additional batches of participants. Simultaneously, the human moderator may choose to end the process or may choose to enable the asynchronous mode in which additional participants may engage the system and convey additional ideas, insights, assertions, and reactions. Further details regarding each of the modes of operation are provided with reference to FIGS. 27-29.

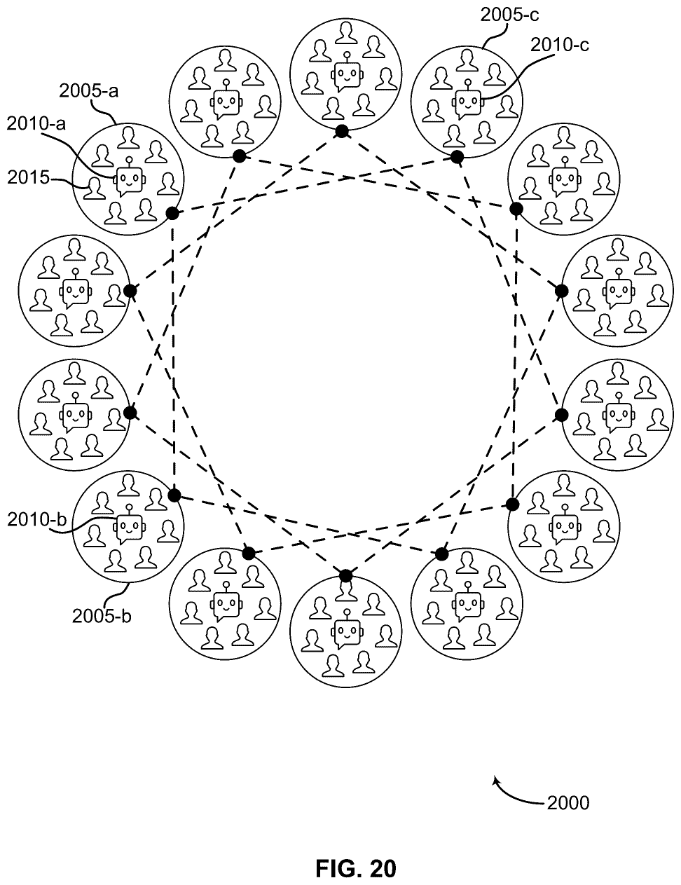

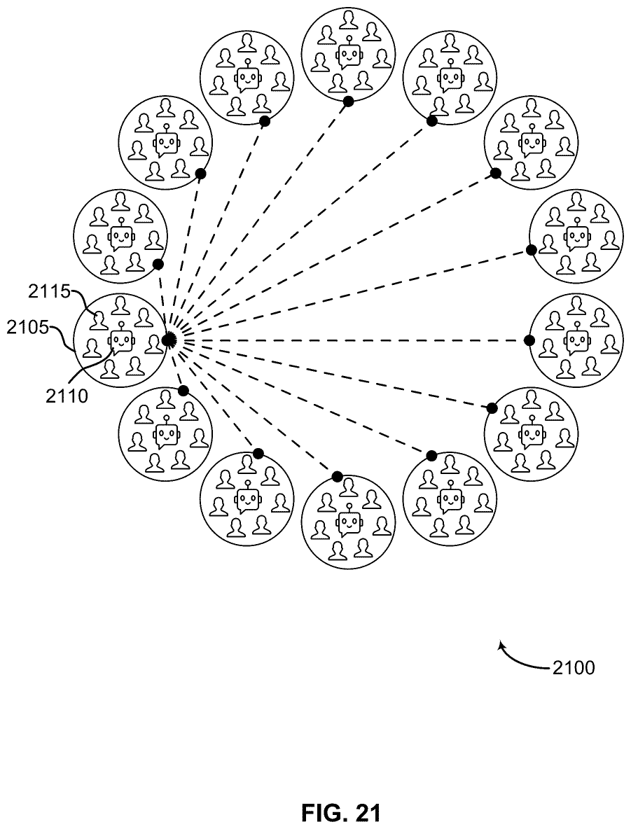

FIG. 20 shows an example of a network architecture 2000 according to aspects of the present disclosure. Network architecture 2000 is an example of, or includes aspects of, the corresponding element described with reference to FIGS. 21-24. In one aspect, network architecture 2000 includes subgroups 2005. In one aspect, each subgroup 2005 includes a conversational surrogate agent 2010 and one or more users 2015.

For instance, a population of real-time networked users (e.g., users 2015) can be configured into a unique architecture where the entire population is divided into a set of small subgroups 2005, such as sub-groups 2005-a, 2005-b, 2005-c, etc., sized for thoughtful conversational deliberation. For example, FIG. 20 shows a large group of 84 users that can be divided into 14 subgroups (such as subgroup 2005) of 6 users (such as users 2015) each.

Each subgroup 2005 (e.g., sub-groups 2005-a, 2005-b, 2005-c, etc.) is provided with a conversational surrogate agent 2010 (e.g., conversational surrogate agents 2010-a, 2010-b, 2010-c, etc.) that can pass and receive insights from one or more other subgroups 2005 (e.g., subgroups 2005-a, 2005-b, 2005-c, etc.). In some examples, each conversational surrogate agent 2010 can exchange insights with conversational surrogate agents 2010 in two other subgroups 2005. For example, referring to FIG. 20, conversational surrogate agent 2010-a may exchange insights of subgroup 2005-a with two other subgroups (i.e., subgroup 2005-b, via conversational surrogate agent 2010-b, and subgroup 2005-c, via conversational surrogate agent 2010-c, as indicated by the dotted lines).

Subgroup 2005 is an example of, or includes aspects of, the corresponding element described with reference to FIGS. 3-6, 8, 9, 19, and 21-24. Conversational surrogate agent 2010 is an example of, or includes aspects of, the corresponding element described with reference to FIGS. 2, 5, 6, 8, 9, 11, 19, and 21-24. User 2015 is an example of, or includes aspects of, the corresponding element described with reference to FIGS. 1, 2, 4-6, 8, 9, 19, and 21-24. FIG. 21 shows an example of a network architecture 2100 according to aspects of the present disclosure. In one aspect, network architecture 2100 includes subgroups 2105. In one aspect, each subgroup 2105 includes a conversational surrogate agent 2110 and one or more users 2115.

According to an example, each conversational surrogate agent 2110 can communicate with any one of the other surrogate agents (e.g., any conversational surrogate agent 2110 in any of the other subgroups 2105). Accordingly, the structure represents bi-directional connections the between a single subgroup 2105 and every other subgroup. In some cases, similar (or same) connections may be drawn for each of the other subgroups 2105. Referring to FIG. 21, only connections from one subgroup 2105 are shown for clarity.

Network architecture 2100 is an example of, or includes aspects of, the corresponding element described with reference to FIGS. 20, and 22-24. Subgroup 2105 is an example of, or includes aspects of, the corresponding element described with reference to FIGS. 3-6, 8, 9, 19, 20, and 22-24. Conversational surrogate agent 2110 is an example of, or includes aspects of, the corresponding element described with reference to FIGS. 2, 5, 6, 8, 9, 11, 19, 20, and 22-24. User 2115 is an example of, or includes aspects of, the corresponding element described with reference to FIGS. 1, 2, 4-6, 8, 9, 19, 20, and 22-24.

In case of a fully connected structure (such as that shown with reference to FIG. 21), message passing is based on (e.g., requires) an additional level of intelligence since passing insights from each subgroup 2105 to every other subgroup 2105 is a complex process. Accordingly, intelligent heuristics are used to organize message passing such that different aspects of conversational deliberation are facilitated.

In case of intelligent heuristics, each subgroup, such as subgroup 2105 (or chatroom) is assigned two flags (i.e., variables) that are associated with the Conversational Surrogate Agent, such as conversational surrogate agent 2110 for the room (CSai-n). In some cases, the flags may be a READY TO TRANSMIT flag and a READY TO RECEIVE flag.

READY TO TRANSMIT (RTT) may be a binary flag that is set to “0” when the CSai for the room is not ready to transmit insights to other rooms. In some cases, the CSai may not be ready to transmit insights if it transmitted insights (e.g., recently transmitted an insight) and is waiting for additional insights to be generated conversationally by the users of the subgroup. In some cases, the CSai may not be ready to transmit insights in case the session recently started and the conversation has not produced any meaningful insights in the subgroup. In some examples, a minimum transmission delay may not be expired. For example, the minimum transmission delay refers to a variable that is set to ensure that a subgroup does not transmit insights at a high frequency (i.e., at a frequency that exceeds a defined threshold) since a minimum conviction threshold has not been met. In some examples, the minimum conviction threshold refers to a variable that requires the conviction and/or confidence and/or scope among users of the subgroup with respect to a particular insight (i.e. a solution and/or reasons to support or dispute a solution) that exceeds a certain threshold.

According to an example, a subgroup may be discussing/debating the team that will win the Super Bowl and the conviction may be very low because each of the six users favor a different solution. In some cases, when support for a particular solution gains conviction over time (as the users of the group deliberate) the solution may exceed the minimum conviction threshold and thus put the CSai into a state of ready to transmit. For example, other requirements are assumed to be met such as the minimum interval delay.

In some cases, the minimum interval delay may not be a single value but a function of the conviction level supporting the top choice (e.g., most supported choice) being discussed in the subgroup and/or a function of the conversational content being exchanged among the participants in the subgroup. In some instances, a minimum conversational threshold is set which requires a minimum amount of conversational content (measured in terms of characters, words, messages, or informational content) that has been exchanged in the chatroom.

Accordingly, a conversational surrogate associated with a particular subgroup may have the READY TO TRANSMIT flag set to 0. The flag may transition to 1 when a sufficient amount of time has passed since it was set to 0 and/or a sufficient amount of conversational content has been exchanged among members of the subgroup since the flag was set to 0. In some examples, the flag may transition to 1 when at least one insight being discussed within the room has exceeded a threshold level of confidence, conviction, and/or scope as determined by the conversational content among group members (e.g., users), and/or when an integration over the amount of time, conversational content, and subgroup conviction exceeds a threshold value. However, embodiments are not limited thereto, and the flag may transition to 1 based on a combination of the described conditions.

READY TO RECEIVE (RTR) may be a binary flag that is set to “0” when the CSai for a chatroom is not ready to receive insights from other rooms. For example, the flag may be set to 0 because an insight may be recently received and the CSai is waiting for the members of the sub-group to consider and discuss the insight. In some cases, the session may have recently started and the subgroup may not have a chance to have sufficient internal discussion. In some cases, a minimum receive delay may not be expired, where the minimal receive delay refers to a variable that is set to ensure that a subgroup does not receive insights at a high frequency (i.e., at a frequency that exceeds a defined threshold). In some cases, a minimum conversational content threshold may not be met, where the minimum conversational content threshold refers to a minimum amount of content exchanged among the members of the subgroup since the last insight was received from outside the group. The minimum conversational content may be measured in characters, words, messages, or informational content that have been exchanged in the chatroom.

Accordingly, a conversational surrogate agent associated with a particular subgroup may have the READY TO RECEIVE flag set to 0. The flag may transition to 1 when a sufficient amount of time has passed since the flag has been set to 0 and/or a sufficient amount of conversational content has been exchanged among members of the subgroup since the flag has been set to 0.

In one or more embodiments of the present disclosure, each subgroup may be connected for bidirectional transmission of insights with a plurality of other subgroups. In some cases, a subgroup may be connected to a small number of neighbors which define a connection set that is available for possible insight exchange. In some cases, a subgroup can be connected to each of the other subgroups as potentials for information exchange. In some examples, the set of other subgroups that a single subgroup can exchange insights with is referred to as the connection set of the subgroup. In case of the fully connected models, the connection set for each of the subgroups is the other subgroups.

When a CSai associated with a subgroup transitions from ‘NOT READY TO TRANSMIT’ (i.e., RTT=0) to ‘READY TO TRANSMIT’ (i.e., RTT=1), a coordination process on the central server (such as central server 1920 as described with reference to FIG. 19) is triggered that identifies the insight being discussed within the particular subgroup that is the signal transmitted to another subgroup (or subgroups). Additionally, the coordination process identifies the other subgroup(s) that receives the signal that is transmitted. As used herein, the signal refers to a representation of the insight (i.e. a representation of an answer and/or reasons in support of an answer) along with optional numerical indicators that represent the strength of support for the insight within the subgroup (i.e., conviction, confidence, and/or scope measures associated with the insight within the subgroup).

In some cases, a simple heuristic may be defined to pick the insight (among a set of possible insights) that has the highest support within the subgroup (i.e. the highest confidence, and/or conviction and/or scope within that subgroup) to determine the insights that may be transmitted from the subgroup. In some cases, complex heuristics may use random selection among a set of the highest supported insights (e.g., insights with maximum support) in the chatroom. The complex heuristics is useful when subgroups discuss many insights during a short period of time, and when the subgroups have similar support levels. In some cases, random selection includes a memory so that the next time the subgroup transitions to ‘READY TO TRANSMIT’, an alternate insight may be selected (i.e., not the insight that is previously selected).

In some cases, the heuristic may be defined to consider the CONNECTION SET of possible subgroups that can be a target, and then consider only the subgroups within the CONNECTION SET that are currently in the ‘READY TO RECEIVE’ state (i.e., RTR=1) to determine the subgroup (or subgroups) that will receive the transmitted insight. Accordingly, the system defines a ‘READY TO RECEIVE CONNECTION SET’ for the moment in time. In case the set has more than one subgroup, the heuristic is defined further with a mechanism to select one or more subgroups to receive the insight. According to one or more embodiments, one subgroup may be chosen from the ‘READY TO RECEIVE CONNECTION SET’. According to one or more embodiments, a ‘number of receivers’ variable may be defined. For example, when the ‘number of receivers’ variable is set to 3, the heuristic may pick three subgroups from the READY TO RECEIVE CONNECTION SET (e.g., when larger than three subgroups exist).

A current heuristic is used that compares the insight that is ready to be sent, with the insights being discussed in each of the subgroups within the READY TO RECEIVE CONNECTION SET to identify subgroup(s) that are chosen from the READY TO RECEIVE CONNECTION SET. For example, a top priority for the heuristic is to select a subgroup(s) (in case allowed) that have not discussed the insight in question. In some examples, subgroups with 0 conviction, confidence, and/or scope for an insight. In case no such subgroups (or not enough subgroups) have 0 conviction, confidence, and/or scope for the insight (i.e., each subgroup may have discussed the insight at some level), then the heuristic selects the subgroup(s) with the lowest level of support for the INSIGHT which may include groups that have negative conviction or confidence (i.e., subgroups that may have considered and rejected the insight), which provides for the subgroup to potentially consider other arguments/reasons in favor of a previously rejected insight.

Accordingly, a subgroup that triggers to READY TO TRANSMIT may send the highest supported insight to one or more other subgroups that have not considered the insight and/or have considered the insight with the lowest current level of support (i.e., confidence, conviction, and/or scope). In some cases, the lowest support may be negative support.

In some cases, complex heuristics may use random selection among the READY TO RECEIVE CONNECTION SET, especially in case of multiple subgroups that have not discussed the insight in question and/or have similar support values. In some cases, selection includes a memory such that the next time the subgroup transitions to READY TO TRANSMIT, an alternate subgroup or subgroups may be selected as the recipient (i.e., subgroups different from previously selected subgroups).

In some cases, the conversational surrogate agent associated with each of the receiving subgroups transmits an insight (e.g., an insight that is selected and a subgroup or subgroups that is selected to receive that insight). Each of the Conversational Surrogate Agents may express the insight to the respective group as first person dialog which immediately enables the subgroups to transition from READY TO RECEIVE (RTR=1) back to (RTR=0) since the groups may be internally discussing insights for a period of time. In addition, the transmitting subgroup may transition from READY TO TRANSMIT (RTT=1) back to (RTT=0) until the threshold requirements are met.

The set of heuristics creates an organic flow of insights around the network structure. In addition, the system is preferably configured such that groups with higher level of support for the top insight among the users, transmit the insight at a higher frequency than subgroups that have low levels of support for the top insight. Accordingly, top ideas and/or answers and/or reasons that have strong conviction within subgroups are propagated more often than top ideas and/or answers and/or reasons in subgroups that are only mildly supported verses other ideas.

In an embodiment, the minimum transmission delay in a particular subgroup is modulated based on the strength of support for the strongest insight currently being discussed in the subgroup such that subgroups that have strong internal agreement for a particular insight may transmit more frequently to other subgroups than the strongest insight in subgroups where the insight may be heavily debated among a set of possible alternative insights.

In an embodiment, the READY TO TRANSMIT flag may be set dynamically using an integrate-and-fire model that amplifies insights that are minority opinions in the global group (i.e., that are assessed across the full population of individual participants). In some cases, the flag may transition to 1 based on an integral of the amount of time that has passed since the time was set to 0, and/or an integral of the amount of conversational content that may be exchanged among members of the subgroup since the flag is set to 0, and/or an integral of the confidence, conviction, and/or scope of the top insight being discussed having exceeded some threshold value within the chatroom as determined by the conversational content among users (or group members), and/or an integral of the degree to which the top insight is not the top insight found in most other chatrooms. In some cases, the top insights may be distributed globally (i.e., across the entire population of individual users) and “READY TO TRANSMIT” may be triggered (e.g., triggered faster) for groups supporting minority opinions. Accordingly, global minority positions may be amplified.

In addition, each subgroup may be configured with a means of responding to the insights that are received including by clapping or by arguing which provides feedback to the subgroup from which the insight originated. Thus, support for the insight is significantly impacted, potentially causing the insight to drop below the support of other insights (e.g., have low priority). The feedback loop enables complex interactions around the network of subgroups to emerge organically. In some examples, the emergent properties of the networked structure favor the elevation of the smartest and/or best supported insights which amplify the collective intelligence of the entire population.

### A Scalable Collaborative System

The present disclosure describes systems and methods for enabling collective superintelligence. Embodiments include HyperChat and/or Conversational Swarm Intelligence that are configured to support different forms of large-scale language-based communication (i.e., vocalized communication or transmitted via Brain-Computer-Interfaces (BCI)). In some cases, language-based communication includes human-to-human communication through BCI which may enable conversations by thinking language instead of explicitly typing or uttering language.

One or more embodiments of the present disclosure include an architecture of subgroups that is scalable to multiple users. For example, the architecture described with reference to the present disclosure may be scalable to hundreds or thousands of users. In some cases, a recursive structure may be used in which small groups of users are organized into deliberative subgroups (i.e., each with a surrogate agent), and/or small sets of subgroups are organized into subsets (i.e., each subset includes a global agent), and/or small sets of subsets are organized into larger subsets, etc. to enable (e.g., massively) scalable populations.

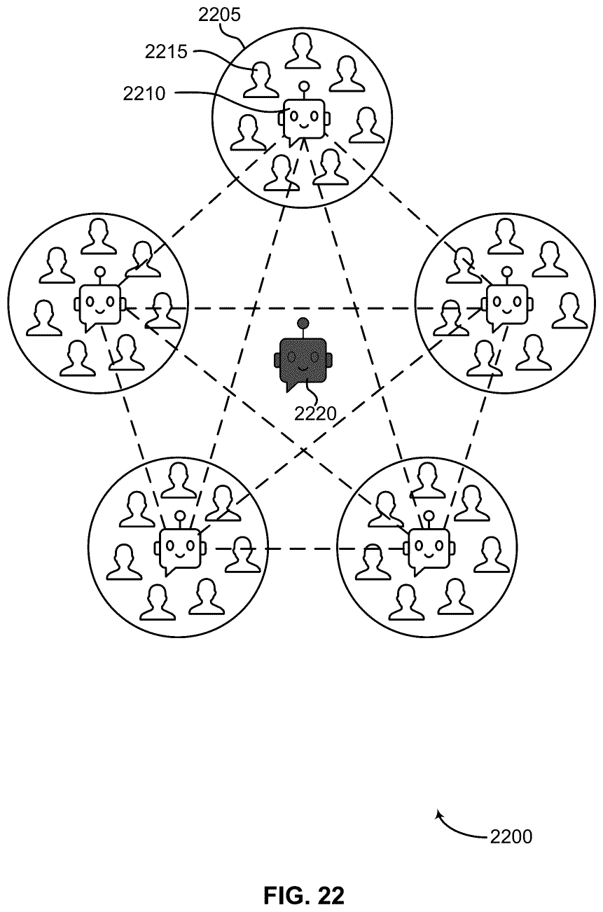

FIG. 22 shows an example of a network architecture 2200 according to aspects of the present disclosure. In one aspect, network architecture 2200 includes subgroups 2205 and observer agent 2220. In one aspect, each subgroup 2205 includes a conversational surrogate agent 2210 and one or more users 2215.

FIG. 22 shows an example network architecture 2200 according to aspects of the present disclosure. For instance, a network architecture 2200 shows a small population (e.g., 30)) of users 2215 divided into 5 subgroups 2205, where each subgroup 2205 includes (e.g., is populated with) a conversational surrogate agent 2210 that can pass or receive messages from any of the other conversational surrogate agents 2210. Moreover, observer agent 2220 (e.g., at the center) may send and receive insights with any of the conversational surrogate agents 2210. In some aspects, FIG. 22 shows an example of one set of five subgroups 2205. In some aspects, the network architecture 2200 shown in FIG. 22 may be referred to as ‘LEVEL 0’ subset architecture (e.g., the observer agent 2220 may be referred to as a LEVEL 0 observer agent 2220).

Network architecture 2200 is an example of, or includes aspects of, the corresponding element described with reference to FIGS. 20, 21, 23, and 24. Subgroup 2205 is an example of, or includes aspects of, the corresponding element described with reference to FIGS. 3-6, 8, 9, 19-21, 23, and 24. Conversational surrogate agent 2210 is an example of, or includes aspects of, the corresponding element described with reference to FIGS. 2, 5, 6, 8, 9, 11, 19-21, 23, and 24. User 2215 is an example of, or includes aspects of, the corresponding element described with reference to FIGS. 1, 2, 4-6, 8, 9, 19-21, 23, and 24. Observer agent 2220 is an example of, or includes aspects of, the corresponding element described with reference to FIGS. 5, 19, 23, and 24.

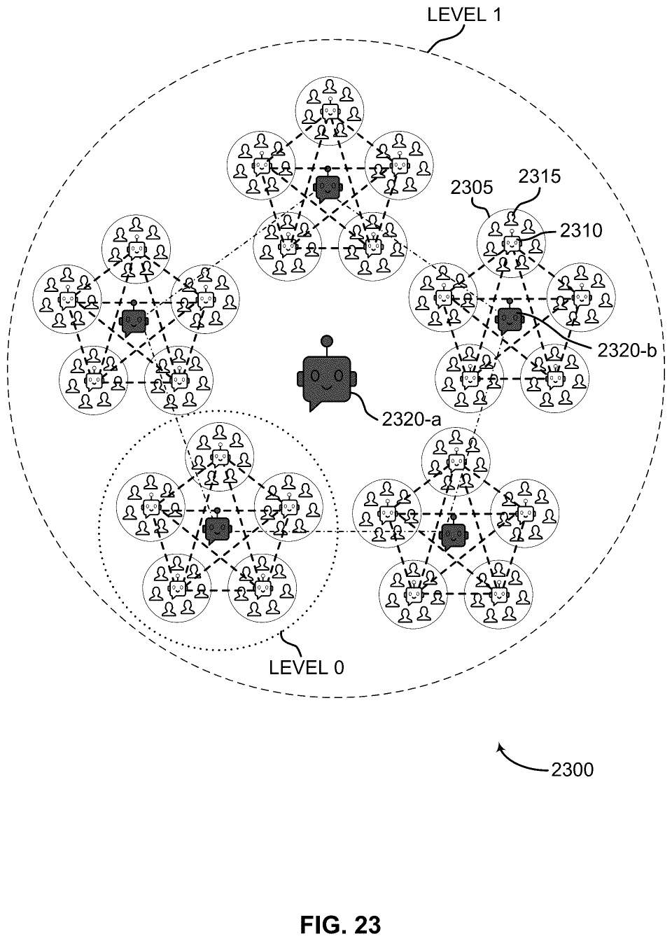

FIG. 23 shows an example of a network architecture 2300 according to aspects of the present disclosure. In one aspect, network architecture 2300 includes subgroups 2305 and observer agents 2320. In one aspect, each subgroup 2305 includes a conversational surrogate agent 2310 and one or more users 2315.

FIG. 23 shows an example network architecture 2300 according to aspects of the present disclosure. For instance, a network architecture 2300 shows an example structure of 150 users 2315 in five sets of five subgroups 2305 (e.g., or 25 total subgroups 2305) that are fully connected through bidirectional messaging among the observer agents 2320. In other words, each subgroup 2305 may have a corresponding conversational surrogate agent 2310, and each set of five subgroups 2305 (and the five corresponding conversational surrogate agents 2310) may have a corresponding observer agent 2320.

In some aspects, network architecture 2300 illustrates an example of what may be referred to as a LEVEL 1 subset (e.g., that includes five sets of LEVEL 0 subset network architectures, aspects of which are further described herein, for example, with reference to network architecture 2200 as described in FIG. 22). A higher-level observer agent 2320-a (e.g. a LEVEL 1 observer agent 2320-a) is enabled that communicates with the lower level observer agents 2320 (e.g. LEVEL 0 observer agents 2320-b), fully connected for passing insights in both directions. Moreover, each of the subset level observer agents 2320 (e.g. the LEVEL 0 observer agents 2320-b) are connected with each other for passing insights.

Network architecture 2300 is an example of, or includes aspects of, the corresponding element described with reference to FIGS. 20-22, and 24. Subgroup 2305 is an example of, or includes aspects of, the corresponding element described with reference to FIGS. 3-6, 8, 9, 19-22, and 24. Conversational surrogate agent 2310 is an example of, or includes aspects of, the corresponding element described with reference to FIGS. 2, 5, 6, 8, 9, 11, 19-22, and 24. User 2315 is an example of, or includes aspects of, the corresponding element described with reference to FIGS. 1, 2, 4-6, 8, 9, 19-22, and 24. Observer agent 2320 is an example of, or includes aspects of, the corresponding element described with reference to FIGS. 5, 19, 22, and 24.

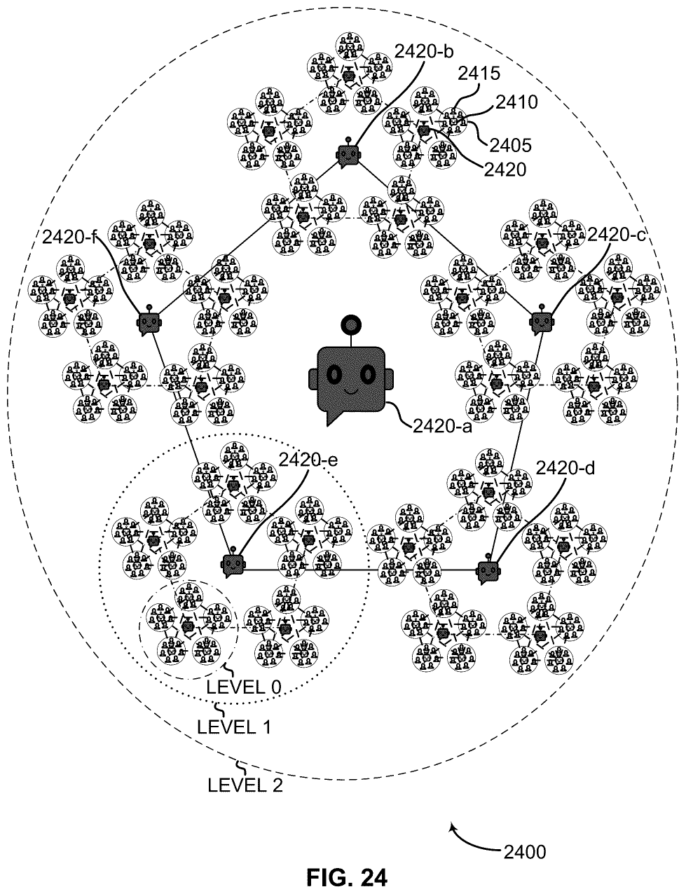

FIG. 24 shows an example of a network architecture 2400 according to aspects of the present disclosure. In one aspect, network architecture 2400 includes subgroups 2405 and observer agent 2420. In one aspect, each subgroup 2405 includes a conversational surrogate agent 2410 and one or more users 2415.

For instance, a network architecture 2400 shows an example structure of 750 users 2415. The users 2415 are in five Level 1 sets, where each level 1 set includes five level 0 sets, and each level 0 set includes five subgroups 2405. Therefore, all 125 subgroups 2415 are combined to form a higher-level of sets, resulting in 750 users being fully connected through bidirectional messaging among the observer agents 2420 within each set (within each set of five subgroups 2405). In some examples, network architecture 2400 illustrates an exemplary structure referred to as LEVEL 2 that includes five sets of LEVEL 1 network architectures (network architecture 2300 as described in FIG. 23). As described with reference to FIG. 23, each of the LEVEL 1 architecture includes five sets of LEVEL 0 network architectures (network architecture 2200 as described in FIG. 22).

For instance, a population of a large number of users 2415 may be fully connected through bidirectional messaging among global agents 2420 at the center of each subgroup 2405 (or subset). In the example network architecture 2400, users 2415 (e.g., 750 individuals) may be structured or organized into five sets of five subgroups 2405 fully connected through bidirectional messaging among the global agents 2420 at the center of each subgroup 2405. In addition, a higher-level global agent 2420-a is enabled that communicates with the subset level global agents (e.g., global agent 2420-b, global agent 2420-c, global agent 2420-d, global agent 2420-e, and global agent 2420-f), which are fully connected for passing insights in both directions. However, this is an example, and the number of subgroups, subsets, and global agents are not limited thereto.

In the example structure shown in FIG. 24 (i.e., network architecture 2400 with 750 participating users 2415), each individual user 2415 is placed in a subgroup of six users 2415 (e.g., which is well sized for real-time conversational deliberation). Each subgroup 2405 may include a conversational surrogate agent 2410 that monitors the subgroup 2405 and shares insights bidirectionally with other (e.g., similar) surrogate agents 2410 within each of five subgroups 2405. As described, the five subgroups 2405 (e.g., each of 30 users 2415) may be referred to as a LEVEL 1 SUBSET. Each LEVEL 1 SUBSET (e.g., of 150 people/users 2415) is given a global agent 2420 (e.g., global agent 2420-b, global agent 2420-c, global agent 2420-d, global agent 2420-e, and global agent 2420-f) that shares insights bidirectionally with similar observer agents 2420 (e.g., the other of global agent 2420-b, global agent 2420-c, global agent 2420-d, global agent 2420-e, and global agent 2420-f) within each of five LEVEL 1 SUBSETS. This creates a LEVEL 2 SUBSET (of 750 people/users 2415) of five LEVEL 1 SUBSETS. A LEVEL 2 observer agent 2420-a communicates with the five LEVEL 1 observer agents 2420 (i.e., global agent 2420-b, global agent 2420-c, global agent 2420-d, global agent 2420-e, and global agent 2420-f), enabling bidirectional insight passing.

Accordingly, in the example of FIG. 24, five subgroups 2405 may be referred to as LEVEL 1 SUBSETS. Each LEVEL 1 SUBSET (e.g., of 5 subgroups 2405 or 150 users 2415) is provided with an observer agent. Each LEVEL 1 observer agent shares insights bidirectionally with other LEVEL 1 observer agents within each of five LEVEL 1 SUBSETs. For instance, LEVEL 1 observer agent 2420-b communicates (e.g., shares insights bidirectionally) with other LEVEL 1 observer agents including observer agent 2420-c, observer agent 2420-d, observer agent 2420-e, and observer agent 2420-f. This creates a LEVEL 2 SUBSET (e.g., of 750 users 2415) of five LEVEL 1 SUBSETs. A LEVEL 2 global agent (global agent 2420-a) communicates with the five LEVEL 1 global agents (observer agent 2420-b, observer agent 2420-c, observer agent 2420-d, observer agent 2420-e, and observer agent 2420-f), enabling bidirectional insight passing.

Network architecture 2400 is an example of, or includes aspects of, the corresponding element described with reference to FIGS. 20-23. Subgroup 2405 is an example of, or includes aspects of, the corresponding element described with reference to FIGS. 3-6, 8, 9, and 19-23. Conversational surrogate agent 2410 is an example of, or includes aspects of, the corresponding element described with reference to FIGS. 2, 5, 6, 8, 9, 11, and 19-23. User 2415 is an example of, or includes aspects of, the corresponding element described with reference to FIGS. 1, 2, 4-6, 8, 9, and 19-23. Observer agent 2420 is an example of, or includes aspects of, the corresponding element described with reference to FIGS. 5, 19, 22, and 23.

The method may be extended to an even high number of users, thereby enabling exponential growth. For example, five of the structures (LEVEL 2 SUBSETs) described with reference to FIG. 24 may be connected as a LEVEL 3 SUBSET (enabling 3750 people to communicate and pass bidirectional insight in real-time) with a global agent at center of the structure. Similarly, another level may be added, i.e., a plurality of the structures of LEVEL 3 may be combined (as described with reference to FIGS. 23-24 to a LEVEL 4 SUBSET (of 18,750 people). Embodiments are not limited thereto, and the number of users may be exponentially increased by combining the subsets at each level.

In some cases, the transmission heuristics for chatrooms that are READY TO RECEIVE and READY TO TRANSMIT may be structured such that the CONNECTION SET available for each subgroup is defined by the SUBSETS at different levels. For example, the CONNECTION SET may refer to the other groups in the same LEVEL 1 SUBSET. Additionally, or alternatively, the CONNECTION SET may refer to the other subgroups in the same LEVEL 2 SUBSET. Similarly, the CONNECTION SET may refer to the other subgroups in the same LEVEL 3 SUBSET and LEVEL 4 SUBSET.

In some embodiments, the heuristics change over time such that at beginning a the of conversational deliberation, the CONNECTION SET is defined as a small set of other subgroups (for example, the LEVEL 1 subset described with reference to FIG. 24) but as the conversation continues, the CONNECTION SET is expanded to large sets of subgroups (e.g., the LEVEL 2 subset described with reference to FIG. 24). Additionally, the CONNECTION SET may be expanded to the LEVEL 3 subset and the LEVEL 4 subset.

According to some embodiments, an individual subgroup first transmits insights to one other subgroup at a time. In some cases, as the conversation continues over time, each individual subgroup may transmit to more than one subgroup upon trigger. In some embodiments, the number of subgroups that are selected to receive an insight (from the CONNECTION SET of possible subgroups) increases with strength of support (i.e., conviction, confidence, and or scope) in the insight of the subgroup.

### Hybrid Superintelligence

Embodiments of the present disclosure are configured to enable the use of one (or more) AI-powered conversational agents, called Conversational Contributor Agents (CCAs), that are placed into a plurality of the conversational subgroups of human users to further enhance and facilitate conversational deliberations among human groups. In preferred embodiments, these Conversational Contributor Agents are functionally different from the Surrogate Agents and/or Observer Agents that are also used in embodiments of this the disclosed system. The difference is that Surrogate Agents and Observer Agents generate conversational content based on observations of the human conversations within one or more subgroups. The Conversational Contributor Agents serve a different purpose. They engage in the local conversations independently of the conversational observations in other rooms (e.g., their role is NOT to share insights, opinions, and/or information that is derived from the ongoing human conversations in other rooms). Instead the role of Conversational Contributor Agents is to directly participate in the local conversation of their subgroup by offering insights, opinions, and/or factual information that is AI generate, for example by making API calls to a Large Language Model such as GPT4.

In some embodiments, the AI generated insights, opinions, and/or factual information are expressed by the CCA from the perspective of a human user with a specifically defined persona profile. In such instances the Conversational Contributor Agent (CCA) may be referred to herein as a Persona Agent. In other embodiments, the specific key phrases, talking points, statistics, stories, contexts and other reference information sources may be provided to each Conversational Contributor agent to seed that agent with specific information, positions, or perspectives to draw from when contributing conversational content. In some such embodiments the CCA agents may be created with specific information that is relevant to the conversation at hand. For example, if the human group is deliberating football games, the CCA may be created such that it has access to the latest statistics on a particular topic. In such embodiments, the CCA may be referred to as an Informational Agent or InfoBot. In some instances, the Informational Agent is configured to monitors the conversation and automatically share relevant factual information with the conversational subgroup it is associated with. In other instances, one or more participants can make a comment that directly asks for information, for example by asking the whole group or asking the Informational Agent directly for specific facts, data, or statistics on the topic at hand.

In many situations, the informational needs of the conversation may not be known in advance. To support these situations, some embodiments an AI Agent referred to herein as a Scout Agent or ScoutBot is created that can be assigned to a particular subgroup (or subgroups) and is enabled to search the internet or other information sources to acquire information that is useful in the deliberation based upon the ongoing conversational content in that group. In some instances, the Scout Agent is configured to monitors the conversation and automatically search for and share relevant factual information with the conversational subgroup it is associated with. In other instances, one or more participants can make a comment that directly asks for information, for example by wondering aloud in the group conversation or directly asking the Scout Agent to find specific facts, data, or statistics related to the topic at hand. As disclosed herein, a Scout Agent can be considered a specific type of Conversational Contributor Agent or it could work in coordination with one or more other Conversational Contributor Agents serving a subgroup or subgroups.

An embodiment of the present disclosure includes a conversational contributor agent that is configured to directly participate in the local conversation among the plurality of human participants. In some cases, the conversational contributor agent assigned to a local room may observe the interactions of the group of conversational participants.

According to exemplary an embodiment, the conversational contributor agent may include a text or voice-based chatbot via API calls to ChatGPT 4 or a similar large language model. In some cases, the conversational contributor agent may be configured to respond to the real-time ongoing conversation among the human participants at various intervals. For example, the conversational contributor agent may respond by either offering insights (i.e., conversational contributor agent may provide its own suggestion for answers and/or justification of the answers) and/or by offering support or opposition to answers expressed by the human participants in the subgroup.

According to an embodiment, the interval for injecting comments is defined by intelligent heuristics based on the elapsed time, quantity of elapsed dialog, speed and/or frequency of elapsed comments, quality of the intervening dialog, and/or number of the participants engaged in the local dialog. According to an embodiment, the heuristic may include a confidence measure for the AI Agent in the accuracy and/or supportability of a pending comment it plans to inject into the conversation with respect to human comments. In case the AI Agent determines that the accuracy and/or supportability of the pending injection of an insight into the conversation is substantially higher than the accuracy and/or supportability of the current human comments in the conversation, the determination may be used to reduce the time threshold, elapsed dialog threshold, speed and/or frequency threshold used to meter the timing and frequency of the Conversational Contributer Agent's contributions to the human conversation.

According to an embodiment, a conversational contributor agent may be assigned a unique persona profile via calls to a Large Language Model via API access, for example the ChatGPT API. In some cases, the persona profile may include a definition of the demographic characteristics, psychographic characteristics, expertise, information, and/or values. In some cases, the said characteristics of the personal profile may be desired for the conversational contributor agent in a particular application.

According to an example, in case the conversational deliberation is intended for use among large numbers of human constituents that may discuss a political policy issue, the persona profile defined for the conversational contributor agent may include a target age, gender, location of residence, income level, political leanings, and education level.

Accordingly, for example, a conversational contributor agent may be added to a local subgroup that may be intended to represent the views and/or knowledge of a 35-year-old man from New Jersey who is a democrat, middle class, and has a college education. Additionally, a similar conversation contributor agent may be placed in each subgroup (of the plurality of subgroups), thereby instigating certain types of conversation among each of the subgroups.

In some examples, a proportion of the local subgroups may be populated with a particularly configured persona (e.g., the 35-year-old man from New Jersey). In some examples, the remaining subgroups may be populated with one of a variety of conversational contributor agents designed to instigate conversation in various ways by representing different persona profiles. For example, a first set of 20% of the subgroups may be populated with the 35-year-old man from New Jersey. Additionally, a second set of 20% of the subgroups may be populated with a 55-year-old woman from West Virginia who is a republican. Accordingly, the hybrid structure may ensure emergence of diverse perspectives from different subgroups that may get transmitted between subgroups (e.g., transmitted between subgroups according to methods described with reference to at least FIGS. 21-23).

According to an embodiment, the persona profile includes a personality trait. For example, the persona profile may define a conversational contributor agent who may be pushy and aggressive which may cause the human participants to push back more against the agent than another agent that is defined as reserved and unsure.

According to an embodiment, the persona profile includes an expertise level. For example, the conversational contributor agent can be defined as an expert on climate change with a PhD from MIT which may drive the conversational contributions from the conversational contributor agent to include scientific and/or factually supported insights that relate to climate change and similar issues.

An embodiment of the present disclosure is configured to provide a conversational contributor agent with specific key phrases, talking points, statistics, stories, contexts, and other reference information or informational sources. However, embodiments are not limited thereto. In some cases, the conversational contributor agent receives the information on creation which enables seeding the conversational contributor agent's conversational interactions with a particular set of narratives that guide the agent's generative dialog.

According to an example, a first set of 20% of the subgroups may be populated with agents seeded with news articles and statistics that advocate for a particular position. In some examples, a second set (e.g., a different) 20% of subgroups may be populated with agents seeded with news articles and statistics that oppose or reject the same position. Accordingly, the method may be used for instigating a wide range of conversational reactions in a population as a means of assessing the support for or resistance to particular positions related to an issue at hand.

Therefore, embodiments of the present disclosure include systems and methods that are structured to assess each individual's reaction to the positions offered by other humans during a live conversation. In cases where conversational contributor agents are employed, the same methods are applied to assess the reactions to dialog contributed by the AI agents.

In some cases, a plurality of phrases, talking points, statistics, contexts, and other reference information may not be known when starting a conversation and creating the conversational contributor agents. In some cases, the conversation is a fluid process and may delve into issues and arguments that may not have been foreseen upon the creation of the conversational contributor agents. As such, additional reference information may be used in the conversation that may not currently be in possession of the human participants or the conversational contributor agents.

Therefore, embodiments of the present disclosure are configured to provide an additional AI agent (i.e., a scout agent). In some cases, the scout agent may be assigned to a particular subgroup. In some cases, the scout agent may be configured to monitor the conversation in the subgroup directly. In some cases, the scout agent may be configured to receive conversational summaries from a conversational observer agent assigned to the subgroup. Accordingly, an assessment is performed that identifies whether additional informational content on a particular issue may be helpful to the groupwise dialog in a particular subgroup or among a set of subgroups. In some cases, the scout agent may be configured to search the internet or other information sources and acquire the information for use in the deliberation in the subgroup (or a set of subgroups).

According to an exemplary embodiment of the present disclosure, a large human group may be debating the winner of a football game that is scheduled (e.g., for a Sunday). The participants may be sports fans that each bring substantial human knowledge, wisdom, and intuition to the conversation. For example, in advance of the discussion, a conversational contributor agent may be defined for each subgroup. In some examples, the conversational contributor agents may be created with specific information that is relevant (such as the latest statistics and standings for the NFL players and NFL teams as well as the latest Vegas odds for games on the Sunday). In some instances, such a conversational contributor agent may be referred to as an InfoBot.

In some cases, the conversation for a particular game may drift from the topic (e.g., take a unique turn). For example, the participants may discuss the unusually cold weather expected for the city of Green Bay where the game is being played. In some examples, as the participants discuss the different topic (e.g., the cold weather), the observer agent (such as observer agent 2320 described with reference to FIG. 23) may determine that a large percentage of participants believe the weather in Green Bay is an important factor that may influence the outcome of the game. As such, the weather may not be the statistical information that the conversational contributor agent may be pre-loaded with.

Therefore, embodiments of the present disclosure may be configured to determine that a scout agent may capture information about the latest weather forecast for Green Bay on the Sunday. The scout agent may convey the said information to the conversational contributor agent that is configured to conversationally inject the contextual information into the discussion in the subgroup. In other instances, the Conversational Contributor Agent is a Scout Agent in that it is configured to have the abilities of the scout agent to search for information as needed by the ongoing conversational deliberation among human participants.

By incorporating the conversational contributor agents to a plurality of subgroups, embodiments of the present disclosure provide a pathway for AI generated informational content (e.g., including factual content and/or factually supported opinions and/or suggestions) into the local conversation among small subgroups. For example, the informational content may become part of the debate among human users (i.e., in addition to being accepted).

In case the informational content is supported by the human users, the content may increase in group's confidence and/or conviction resulting in the content being propagated to one or more other subgroups. In case the informational content is rejected by the humans, the content may fail to acquire enough support, conviction, and/or confidence to propagate to other subgroups. Therefore, a powerful system is created in which AI generated informational comments, supported ideas, and/or supported opinions may surface. In some cases, the ideas presented conversationally to the subgroup(s) by the CCA are not accepted by the human users as valuable to the ongoing conversation as indicated by their reactions. In other cases, the ideas presented conversationally to the subgroup(s) by the CCA are accepted by the human users as valuable to the ongoing conversation as indicated by their reactions. In this way, the CCA agents do not excessively influence the ongoing discussion, but rather introduce ideas or information for consideration by participants in a similar way that other human participants introduce ideas or information. Accordingly, extreme comments, false comments, flawed comments, or otherwise erroneous information injected by CCA agents may be filtered out (i.e. rejected or attenuated) as a result of reactions of the human participants.

Additionally, competing AI generated views, ideas, and/or information may surface in multiple locations in the population structure at any given time because a different conversational contributor agent is placed in each of a plurality of subgroups. Accordingly, the bad AI generated ideas (e.g., based on human opposition) may be filtered and the good AI generated ideas (e.g., based on human support) may be amplified. Therefore, the human population may be the primary driver of the collective deliberation. In some cases, the informational ideas and/or opinions may be surfaced by the AI Agent which further enhances the intelligence of the system. In this way, a large-scale hybrid deliberation among large populations of human users and conversational contributor agents may significantly amplify the intelligence of the full system and potentially reach super-intelligent levels.

Additionally, the degree to which various information (e.g., in the form of statistics, stories, keywords, or other structures) may be accepted or rejected by subgroups or populations, or the degree to which the information may influence the beliefs of the subgroups or populations can be measured and reported because the informational dialog content expressed by each agent may be controlled and distributed between agents across many independent subgroups. The said control may be configured to identify and propagate insights that reflect the most convincing arguments or narratives, thereby helping the population converge on optimal solutions.

An embodiment of the present disclosure may be configured to assess the degree of impact of additional information sourced by scout agents in real-time. In some examples, a scout agent may source weather information for the Sunday and inject the information into different subgroups at different times during the deliberations. In some cases, the hybrid conversational system may be used to assess the impact that the weather forecast has on the direction of deliberations. Therefore, by providing a distributed architecture of the hybrid conversational system, embodiments of the present disclosure are able to inject weather information into a plurality of subgroups (e.g., dozens of subgroups). Accordingly, a large sample of events may be generated for which a statistically significant result may be computed that indicates the importance of the weather forecast on the predictive beliefs of the population of human participants.

The embodiments described here are in the context of a sporting event. However, embodiments of the present disclosure may not be limited thereto, and similar scout information may be sourced for more complex and significant deliberations such as political deliberations, policy deliberations, health and safety deliberations, and business deliberations. For example, a conversational contributor agent may be created that may contribute dialog according to specific persona profiles using GPT Builder from Open AI. Additionally, or alternatively, a conversational contributor agent may be created that may include pre-prompting other Large Language Models with profile information.

Embodiments of the present disclosure are configured to provide one or more individual users that may hold a real-time conversation. In some cases, the individual users may be referred to as interviewers that may hold an interview via text, voice, video, or VR chat with a personified collective intelligence. In some cases, the personified collective intelligence may comprise a large number of human participants (referred to herein as CI members). Embodiments of the present disclosure are configured to enable very large populations of human participants (e.g., thousands or tens of thousands of human users) to contribute in real-time, potentially enabling conversations with a Collective Superintelligence (CSI) that significantly exceeds the intellectual capabilities of individual members.

Real-Time Interactions with a Personified Collective

Embodiments of the present disclosure enable a large group of individuals to deliberate conversationally and converge on solutions that represent their collective views, perspectives, or insights. In some embodiments, the large group of individuals can communicate collectively through a personified entity that represent their collective intelligence. In some cases the personified collective entity is represented as an interactive avatar referred to herein as a “pluribus avatar” that looks and acts like a single human user. For example, embodiments of the present disclosure may enable one or more individual users to hold a real-time conversations with a personified collective entity that represents that large-scale deliberating population. In some cases, the users interacting with the personified collective entity may be referred to as interviewers that hold a real-time conversation (i.e., interview) via text, voice, video, or VR chat with a personified collective entity (also referred to herein as a personified collective intelligence) For example, the personified collective intelligence may comprise a large number of human participants referred to as CI members. One or more embodiments of the present disclosure may enable very large populations of human participants (e.g., thousands or tens of thousands) to contribute in real-time, potentially enabling conversations with a collective superintelligence (CSI) that significantly enhances the intellectual capabilities of individual participants.

In some embodiments the “interviewer” is a real-time collective intelligence comprised of a plurality of human participants that formulates questions to ask based on aggregated input derived from deliberative interactions among themselves using the methods disclosed herein. In such embodiments, the “interviewer” is a collective intelligence that holds a conversation with an “interviewee” which is also a collective intelligence, as described herein. In this way, the systems and methods described herein can be used to enable two large groups of human participants to be organized into two real-time collective intelligence entities and can hold a real-time group to group conversation. In some such embodiments, the two groups are entirely separate populations of human users. In other embodiments, the two groups can include members who are common to both.

As described herein, the personified collective intelligence agent (PCI agent or PCI) refers to an AI—that responds powered conversational agent conversationally to one or more dialog-based inquiries from the interviewer. In some cases, the conversational response of the PCI agent may be based on aggregated dialog-based input collected from a plurality of human participants in response to the participants being presented with a representation of the one or more dialog-based inquiries.

According to an embodiment, the PCI may be an AI-powered avatar with a visual facial representation in 2D or 3D that may be animated in real-time. In some examples, the PCI may output real-time dialog as computer-generated voice, complete with facial expressions and vocal inflections, where the dialog of the PCI may be driven (e.g., at least in part) by the output of a large language model.

In some cases, the PCI may be configured to respond to one or more inquiries from one or more interviewers via text, voice, video, or VR chat. For example, the PCI response may be generated based on the chat-based, voice-based, video-based, or Virtual Reality-based input collected from a plurality of real-time members in response to the participants being presented with a text, voice, video, or VR representation of the one or more inquiries.

As described herein, an interviewer may refer to one or more human participants that may be connected to the system via a one-to-many chat application. As described herein, CI Member(s) may refer to a plurality of human participants. For example, the CI members may refer to a group of 50, 500, or 5000 participants who are each connected to the system via a many-to-one chat application.

In some cases, a central server (herein referred to as a Collective Intelligence Server) may be configured to enable real-time interactions among human participants. In some examples, the human participants may include two different types of participants (i.e., interviewers and collective intelligence members). In some cases, each of the interviewers and the collective intelligence members may download the same Chat Application and may select among the one-to-many functionality or the many-to-one functionality based on the type of user the participant may log in as (e.g., an interviewer or a CI Member).

According to an embodiment, the Collective Intelligence Server may work in combination with the one-to-many chat applications running on the local computing devices of the interviewer(s) and the many-to-one chat applications running on the local computing devices of the plurality of CI Members.

According to an embodiment, a Personified Collective Intelligence agent may be an AI-powered avatar with a visual facial representation in 2D or 3D that may be animated in real-time. In some examples, the PCI may output real-time dialog as computer-generated voice, complete with facial expressions and vocal inflections, where the dialog of the PCI may be driven (e.g., at least in part) by the output of a large language model. In some cases, the PCI may be configured to respond to one or more inquiries from one or more interviewers via text, voice, video, or VR chat. For example, the PCI response may be generated based on the chat-based, voice-based, video-based, or Virtual Reality-based input collected from a plurality of real-time members in response to the participants (e.g., users 1915) being presented with a text, voice, video, or VR representation of the one or more inquiries.

In some cases, an interviewer refers to one or more human participants (e.g., users 1915 described with reference to FIG. 19) that may enter and send one or more inquiries to the system via a one-to-many chat application. In some cases, CI Member(s) may refer to a plurality of human participants (e.g., users 1915) that may be configured to provide a response to the received inquiries from the interviewer. For example, the CI members may refer to a group of 50, 500, or 5000 participants (e.g., users 1915) who are each connected to the system 1900 (e.g., server 1920) via a many-to-one chat application. In some cases, the one-to-many chat application and the many-to-one chat application may refer to the same software which may be configured to support one-to-many or many-to-one functionality. For example, the software may be configured based on user identity, i.e., based on the user logging in as an interviewer or as a participant (e.g., referred to herein as a collective intelligence member (CI Member)).

In some cases, the response sent from each many-to-one chat application may be entered in text form and may be sent to the collective intelligence server in text form. Additionally, or alternatively, the response may be entered as recorded voice and/or video and may be sent to the collective intelligence application as recorded voice and/or video. Additionally, or alternatively, the response may be captured as recorded voice and/or video, may be converted to text via a voice-to-text converter module, and then may be sent to the collective intelligence server in a text representation. In some examples, the response may be in the form of a VR representations that may include physical gestural information captured by camera and/or motion sensor devices on the user's hands, body, or head.

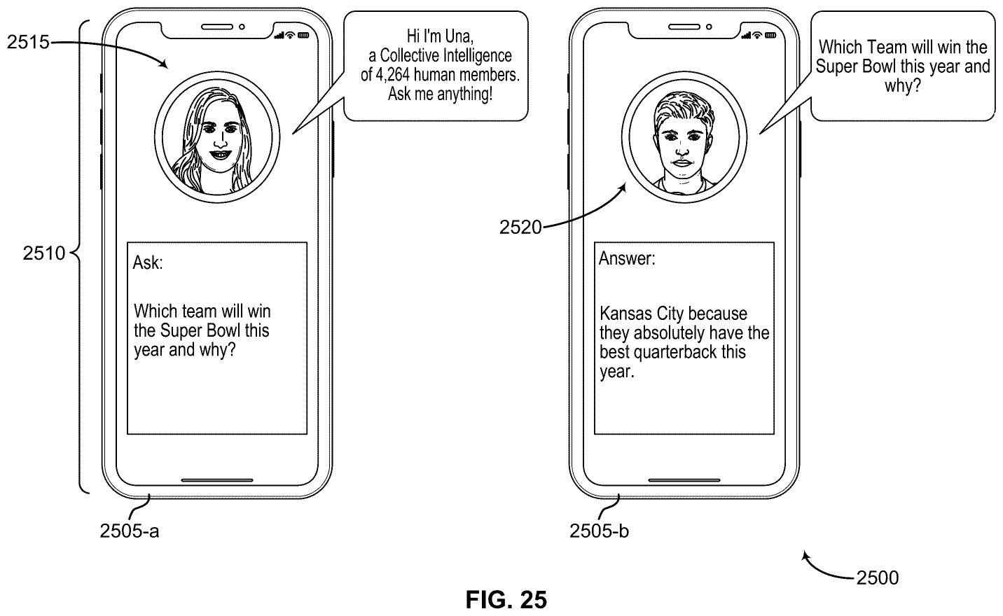

FIG. 25 shows an example of a system 2500 according to aspects of the present disclosure. In one aspect, system 2500 includes computing device (e.g., 2505-a or 2505-b) and user (e.g., a plurality of users). Computing device (i.e., 2505-a or 2505-b) is an example of, or includes aspects of, the corresponding element described with reference to FIGS. 1, 2, 19, 21, 27, and 29. User is an example of, or includes aspects of, the corresponding element described with reference to FIGS. 1-6, 8, 9, 19, 21-24, and 27-29.

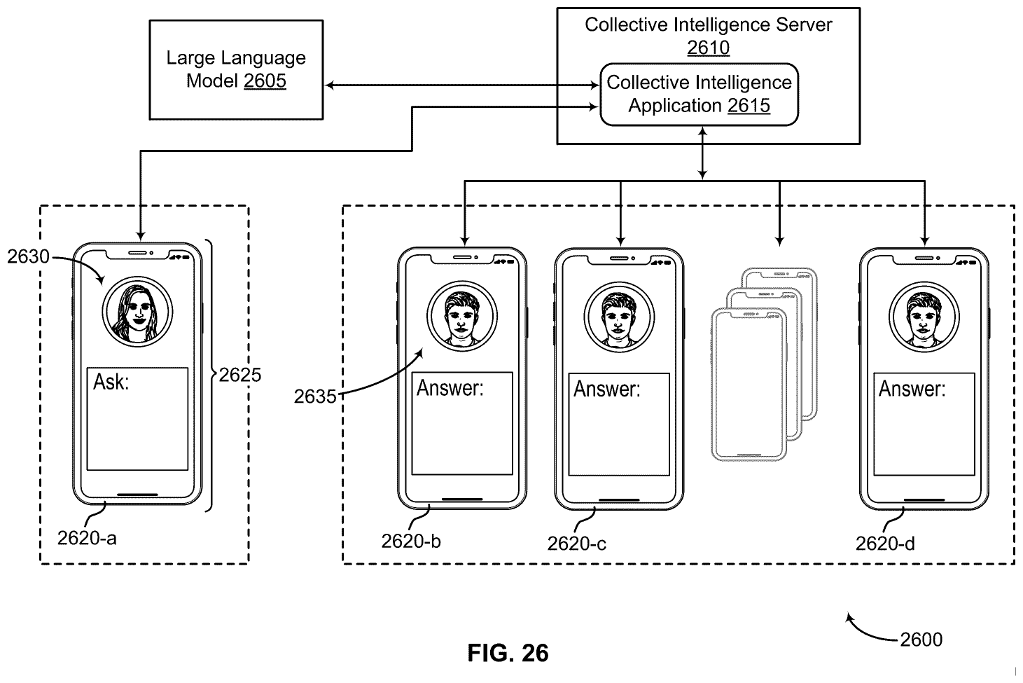

In one aspect, computing device 2505-a includes user interface 2510 and personified collective intelligence (PCI) agent 2515. In one aspect, computing device 2505-b includes user interface (e.g., such as user interface 2510) and likeness 2520 of the interviewer which may be a still image and streamed audio of the interviewing user, streamed audio and video of the interviewing user, or an animated AI-generated interviewing agent. User interface 2510 is an example of, or includes aspects of, the corresponding element described with reference to FIGS. 1-6, 8, 9, and 21. Personified collective intelligence agent 2515 is an example of, or includes aspects of, the corresponding element described with reference to FIGS. 19 and 26. likeness 2520 of the interviewer which may be a still image and streamed audio of the interviewing user, streamed audio and video of the interviewing user, or an animated AI-generated interviewing agent is an example of, or includes aspects of, the corresponding element described with reference to FIGS. 19 and 26.

FIG. 25 shows a personified collective intelligence agent 2515 that may enter (e.g., entered by interviewer(s)) and send (e.g., via computing device 2505-a) one or more inquiries to a collective intelligence server (as described with reference to FIGS. 19 and 26). In some cases, the PCI agent 2515 may perform a first-person conversation, i.e., implement a personified identity (e.g. as shown in 2515) of the collective intelligence. In some examples, the personified identity may be assigned a name—for example Una—and may respond conversationally to inquiries in the first-person voice of an entity named Una. For example, the PCI may be programmed for providing an introduction followed by asking for queries in the first person such as—“Hi, I'm Una, a Collective Intelligence of 4,264 human members. Ask me anything!”

In some cases, the one or more inquiries may be sent in a conversational form to the collective intelligence server (e.g., collective intelligence server described with reference to FIG. 25). In some cases, the collective intelligence server may receive and process the inquiry and route a representation of said inquiries to a plurality of human participants (e.g., for display via a many-to-one chat application). In some cases, the many-to-one chat application (e.g. on computing device 2505-b) may provide for each CI Member (e.g., user 2520) to enter a response (e.g., in a conversational form) in replay to one or more received inquiries.

According to an example, the inquiries may be received (e.g., and originate) from one or more Interviewer(s) (e.g., PCI agent 2515) and may be routed to the CI member (e.g., associated with user device 2505-b) by a collective intelligence server. In some examples, the collective intelligence server may receive the inquiries from the Interviewer (e.g., associated with user device 2505-a). In some cases, the collective intelligence server may process the inquiry and route a representation of said inquiries to a plurality of human participants in real-time (e.g., visually represented as a likeness 2520 of the interviewing user which could be a still image and streamed audio of the interviewing user, streamed audio and video of the interviewing user, or an animated AI-generated interviewing agent) for display on the many-to-one chat application (i.e., on user interface of computing device 2505-b) associated with the user logged in as CI member.

Referring again to FIG. 25, a user interface 2510 of the one-to-many application may run on the Local Computing Device (i.e., user device 2505-a) used by an interviewer. A PCI agent 2515 may appear on the user interface 2510 (e.g., screen) of the local computing device 2505-a as an animated avatar that may speak partially pre-planned introductory words (as shown with reference to FIG. 25).

Additionally, as shown in FIG. 25, the user (i.e., interviewer) of the local computing device 2505-a may then be given the opportunity to enter a question via text (e.g., as shown in FIG. 25) or by natural voice which may be converted to text via a speech-to-text module. As described, the question from the interviewer may be routed via the Collective Intelligence Server (as described with reference to FIG. 19) in real-time to the plurality of CI Members for display on the associated computing devices (e.g., computing device 2505-b).

In some cases, an example interface (e.g., screen) of the local computing device 2505-b of a CI member using a many-to-one instance of the chat application may be shown in FIG. 25. As shown on the CI member's interface, the interviewer may be represented visually as a streamed video or as an animated avatar, i.e., referred to herein as likeness 2520 of the interviewer which may be a still image and streamed audio of the interviewing user, streamed audio and video of the interviewing user, or an animated AI-generated interviewing agent. The video or avatar or likeness 2520 of the interviewer which may be a still image and streamed audio of the interviewing user, streamed audio and video of the interviewing user, or an animated AI-generated interviewing agent may be configured to verbally express to the user (i.e., the CI Member) the question that may be entered by the interviewer using PCI agent 2515.

For example, the question asked by the user of 2505-a via interface 2510 of computing device 2505-a may be “Which team will win the Super Bowl this year?”. The same question may appear as being asked by likeness 2520 of the interviewer which may be a still image and streamed audio of the interviewing user, streamed audio and video of the interviewing user, or an animated AI-generated interviewing agent of user device 2505-b associated with the CI member. Additionally, the CI member may be asked to enter an answer via text (as shown in FIG. 25) or by voice which may be converted to text via a speech-to-text module. For example, the response by the user of computing device 2505-b may be “Kansas City because they absolutely have the best quarterback this year”.

FIG. 26 shows an example of a system 2600 of an embodied large-scale personified collective intelligence according to aspects of the present disclosure.

System 2600 is an example of, or includes aspects of, the corresponding element described with reference to FIGS. 19 and 25. In one aspect, system 2600 includes large language model 2605, collective intelligence server 2610, computing device 2620, and user (e.g., a plurality of users).

Referring to FIG. 26, computing device 2620-a includes user interface 2625 and personified collective intelligence agent 2630. User interface 2625 is an example of, or includes aspects of, the corresponding element described with reference to FIGS. 1-6, 8, 9, and 25. Personified collective intelligence agent 2630 is an example of, or includes aspects of, the corresponding element described with reference to FIGS. 19 and 25.

As shown in FIG. 26, computing device (e.g., computing devices 2620-b, 2620-c, 2620-d, etc.) includes user interface and likeness 2635 of the interviewer which may be a still image and streamed audio of the interviewing user, streamed audio and video of the interviewing user, or an animated AI-generated interviewing agent. User interface is an example of, or includes aspects of, the corresponding element described with reference to FIGS. 1-6, 8, 9, and 25. Likeness 2635 of the interviewer which may be a still image and streamed audio of the interviewing user, streamed audio and video of the interviewing user, or an animated AI-generated interviewing agent is an example of, or includes aspects of, the corresponding element described with reference to FIG. 25.

One or more embodiments include an interviewer that may be a human participant logged in as an interviewer and connected to the system 2600 via a one-to-many chat application on user interface 2625 with a PCI agent 2630 on user device 2620-a. Additionally, CI Member(s) may refer to a plurality of users or human participants. For example, the CI members (e.g., users logged in as CI members) may refer to a group of 50, 500, or 5000 participants who are each connected to the system 2600 via a many-to-one chat application on user interface (e.g., user interface on user devices 2620-b, 2620-c, 2620-d, etc.) that includes an likeness 2635 of the interviewer which may be a still image and streamed audio of the interviewing user, streamed audio and video of the interviewing user, or an animated AI-generated interviewing agent.

In some cases, the many-to-one chat application may provide for each CI Member to enter a response (e.g., in a conversational form) in reply to one or more received inquiries. For example, the inquiries may be received (e.g., and originate) from one or more Interviewer(s) and may be routed to the CI member by a collective intelligence server 2610. Further details regarding the transmission of inquiries and responses between the Interviewer and the CI member are described with reference to FIGS. 19 and 25 and repeated description is omitted herein for brevity.

In some cases, the response (e.g., in text, voice, or video form) from each of a plurality of CI Member(s) may be routed to the conversational server 2610 for processing into an Aggregated Collective Intelligence Response. In some cases, the plurality of real-time responses from the plurality of CI Member(s) may be aggregated via calls to a Large Language Model (LLM) 2605 into a Collective Response in first person conversational form. Large language model 2605 is an example of, or includes aspects of, the corresponding element described with reference to FIGS. 1, 2, and 19.

In some examples, the collective intelligence server 2610 may receive the inquiries from the PCI agent 2630. In some cases, the collective intelligence server 2610 may process the inquiry and route a representation of said inquiries to a plurality of human participants using likeness 2635 of the interviewer which may be a still image and streamed audio of the interviewing user, streamed audio and video of the interviewing user, or an animated AI-generated interviewing agent on user device 2620-b, 2620-c, 2620-d, etc. In some cases, the Collective Intelligence Server 2610 may work in combination with the one-to-many chat applications running on the local computing devices (e.g., 2620-a) of the interviewer(s) and the many-to-one chat applications running on the local computing devices (e.g., 2620-b, 2620-c, 2620-d, etc.) of the plurality of CI Members. Collective intelligence server 2610 is an example of, or includes aspects of, the corresponding element described with reference to FIG. 19. In one aspect, collective intelligence server 2610 includes collective intelligence application 2615. In some examples, collective intelligence application 2615 may refer to the one-to-many chat application and/or the many-to-one chat application.

According to some examples, the one-to-many chat application may support text, voice, video, or VR chat on a computing device 2620-a depicting the PCI agent 2630. Additionally, in some examples, the many-to-one chat application may support text, voice, video, or VR chat on a computing device (e.g., computing devices 2620-b, 2620-c, 2620-d, etc.) depicting the likeness 2635 of the interviewer which may be a still image and streamed audio of the interviewing user, streamed audio and video of the interviewing user, or an animated AI-generated interviewing agent. Computing device (e.g., 2620-a, 2620-b, 2620-c, 2620-d) is an example of, or includes aspects of, the corresponding element described with reference to FIGS. 1, 2, 19, and 25.

Referring to FIG. 26, the interviewer may be configured to hold a conversational exchange with a real-time collective intelligence comprised of a plurality of users, said conversational exchange including at least one question or inquiry expressed by the interviewer via the user interface, collective intelligence server 2610, and likeness 2635 of the interviewer which may be a still image and streamed audio of the interviewing user, streamed audio and video of the interviewing user, or an animated AI-generated interviewing agent. In examples, same question appears on the screen of user devices 2620-b, 2620-c, 2620-d (e.g., appears as being asked by likeness 2635 of the interviewer which may be a still image and streamed audio of the interviewing user, streamed audio and video of the interviewing user, or an animated AI-generated interviewing agent) associated with each of the N members. Additionally, each of the N members may be asked to enter an answer via text (as shown in FIG. 26) or by voice which may be converted to text via a speech-to-text module.

In some cases, each of the responses from the CI Members may be routed in real-time to the Collective Intelligence server 2610 which may process the responses, generate a collective response, and send the collective response to the Local Computing Device 2620-a associated with the interviewer, depicting the PCI agent 2630. In some cases, the collective response may be verbally expressed in the first person language. For example, the collective response may be “Based on the Collective Intelligence of 4264 real-time human members, I believe that Kansas City is the most likely to win the Super Bowl because (i) they currently have the most reliable and talented quarterback, and (ii) they have a strong history of avoiding serious injuries for the key players.”

According to an embodiment, a Collective Intelligence server 2610 may run a Collective Intelligence Application 2615. In cases, some the Collective Intelligence application 2615 may communicate with the local computer(s) 2620-a of the one or more Interviewer(s). Additionally, the Collective Intelligence Application 2615 may communicate with the (N) local computers (e.g., 2620-b, 2620-c, 2620-d, etc.) of the (N) collective intelligence members. Additionally, the Collective Intelligence Application 2615 may communicate with one or more Large Language Models 2605 via API interactions (or embed the LLM within the associated code).

Referring to FIG. 26, the interviewer(s) (i.e., only the interviewer(s)) may see the Personified Collective Intelligence agent 2630. For example, the PCI agent 2630 may be seen as a text bot, voice bot, or visual avatar bot. Additionally, the large group of CI members each may see the interviewer either by viewing the real-time text chat of the interviewer or by viewing the real-time video stream or virtual avatar of the interviewer, via likeness 2635 of the interviewer which may be a still image and streamed audio of the interviewing user, streamed audio and video of the interviewing user, or an animated AI-generated interviewing agent.

According to one or more embodiments, the CI members may see a representation of the Personified Collective Intelligence (PCI) agent 2630 (in addition to the interviewer via likeness 2635 of the interviewer which may be a still image and streamed audio of the interviewing user, streamed audio and video of the interviewing user, or an animated AI-generated interviewing agent) on the local computing devices (e.g., 2620-b, 2620-c, 2620-d, etc.). As such, the CI members may see (and/or hear, when voice is enabled) the PCI responses as the responses emerge during the conversation. Accordingly, by enabling CI members to see a representation of the PCI agent, embodiments may enable follow-up questions from the interviewer that refer to a prior response from the PCI agent.

Accordingly, the interviewer may hold a real-time conversation with a personified collective intelligence (PCI) agent, ask questions and then follow up with additional questions, as the PCI (e.g., PCI agent 2630) responds in real-time. In some cases, when the CI Members may not be exposed to the PCI responses, the CI members may be confused about follow-up questions from the interviewer as the CI members may be uninformed of the conversational exchange between the PCI agent 2630 and the interviewer. Therefore, by providing conversational context to the CI Members based on displaying the PCI dialog to the CI members, embodiments may enable the complete population of CI members to hold a real-time conversation in first person form with the Interviewer(s).

Therefore, embodiments of the present disclosure may create a new form of real-time conversational communication from one to many where the number of members is very large. As such, individuals may be enabled to hold an interactive conversation with a Collective Superintelligence (CSI) that substantially exceeds the intellectual abilities of the individual CI members in various capacities.

### A Conversational Interaction Process

The present disclosure describes systems and methods that may enable one or more interviewers to ask questions to and hold a conversation with a real-time personified collective intelligence agent. For example, the interviewer may be a human participant. The response of the real-time personified collective intelligence agent may be based on the real-time responses of a plurality of collective intelligence (CI) members. In some cases, the plurality of CI members are organized into a set of subgroups for local conversational deliberation, each subgroup containing a surrogate agent that observes the local deliberation and passes insights to one or more other subgroups to enable a unified large-scale deliberation as described with respect to FIGS. 1-18. In some cases, a participant (e.g., human participant) refers to a user in the system. According to an embodiment, the users may log-in to the chat application (e.g., a one-to-many chat application or a many-to-one chat application) as an ‘Interviewer’ or ‘CI Member’.

In some examples, each interviewer participant may be enabled to use a One-to-Many Chat Application on a local computing device to send information to and receive information from a collective intelligence (CI) Server. In some cases, each CI Member may be enabled to use a Many-to-One chat application to send information to and receive information from the CI Server. According to an embodiment, the CI Server may work in combination with the one-to-many chat applications running on the local computing devices of the interviewer(s) and the many-to-one chat applications running on the local computing devices of the plurality of CI Members.

According to an embodiment, the CI server receives an inquiry from an interviewer via a local computing device and sends a representation of the received inquiry to the plurality of CI Members. Further, the plurality of CI members respond to the received inquiry and transmit the response to the CI server which stores the plurality of received responses. In some cases, the CI server may process the received responses (e.g., generate an aggregated response, rank the responses, etc.) and sends the processed response to the interviewer. In some cases, the plurality of CI members deliberate on the inquiry conversationally in local subgroups before the responses are aggregated, each subgroup containing a surrogate agent that observes the local deliberation and passes insights to one or more other subgroups to enable a unified large-scale deliberation as described with respect to FIGS. 1 to 18. Accordingly, embodiments of the present disclosure are able to perform a real-time collective superintelligence process which may combine the knowledge, wisdom, insight, and intuitions of a large-scale human population (e.g., thousands of people).

In some cases, the CI Server may receive an inquiry (e.g., in conversational form) from an interviewer via a local computing device. For example, the local computing device may be used by the interviewer, where the local computing device may run a one-to-many chat application. For example, the inquiry may be a question entered in text chat form, such as “Which team will win the super bowl this year and why?”. The inquiry may include the same conversational content, be expressed vocally, and may be captured by a microphone connected to the local computing device of the interviewer. In some examples, the vocal inquiry may be stored as a digitized audio signal and/or may be converted from an audio signal to a textual representation using a voice to text converter module.

In some cases, a representation of the inquiry entered into the one-to-many chat application on the local computing device of the interviewer may be sent over a communication channel and received by the CI Server. In some cases, the inquiry may be stored in a memory accessible to the CI Server along with relevant data (such as, time and date of the inquiry, a username, other identifier representative of the specific human participant, i.e., the interviewer asking the question). For example, the interviewer may be a human moderator.

According to an embodiment, the CI Server may send a representation of a received (e.g., inquiry in conversational form) to the plurality of CI Members. In some cases, the sending process may trigger the display of said inquiry on each of the computing devices of said plurality of CI Members via a local many-to-one chat application (e.g., at approximately the same time). In some examples, the local display of the inquiry may be a textual display of a text-based inquiry on a screen associated with the local computing device of the CI Member. In some examples, the local inquiry display may be an audio display of a verbally expressed conversational inquiry via speakers associated with the local computing device of the CI Member.

In some examples, the local inquiry display may include the display of a graphical avatar (e.g., likeness of the interviewer which may be a still image and streamed audio of the interviewing user, streamed audio and video of the interviewing user, or an animated AI-generated interviewing agent as described in FIGS. 25-26) that may appear and sound if as verbally expressing the conversational inquiry to the CI Member on the associated member's local computing device. In some cases, a likeness of the interviewer which may be a still image and streamed audio of the interviewing user, streamed audio and video of the interviewing user, or an animated AI-generated interviewing agent may be used which may ensure to the CI Member that the inquiry may have originated from a designated interviewer. In some cases, a local text-to-avatar converter module may be present on the local computing device as part of the local many-to-one chat application. For example, the local text-to-avatar converter module may receive a textual inquiry from the CI Server and display the inquiry as an audio/visual representation of an likeness of the interviewer which may be a still image and streamed audio of the interviewing user, streamed audio and video of the interviewing user, or an animated AI-generated interviewing agent verbally expressing the inquiry.

In some cases, each of the plurality of CI Members may be presented the same interviewer inquiry in visual and/or audio form on the local computing device (e.g., at approximately the same time).

In some cases, the human participants (e.g., CI members) may respond to the inquiry received from the interviewer. For example, the CI member may use a user interface of the associated computing device/user device to respond to the received inquiry. In some cases, the plurality of CI Members may enter a response to the inquiry into the local computing device, e.g., by typing the response as text, expressing the response verbally into a microphone, and/or expressing the response into a camera that may capture the facial expressions of the CI members.

For example, each computing device of the plurality of computing devices may be associated with one of a plurality of CI Members, where the responses entered by each of the CI Members in reply to the interviewer inquiry may be transmitted by the local computing device to the CI server.

In some cases, a representation of each response may then be sent from each local computing device to the CI Server, where the representation may be a text message in textual form entered by the CI Member. Additionally, or alternatively, the representation may be a verbally entered audio signal converted to text. Additionally, or alternatively, the representation of each response may include vocal inflection and/or facial expression information associated with the conversational content. In some cases, the CI Server may receive and store a plurality of responses (e.g., in conversational form) from the plurality of computing devices.

According to an embodiment, the CI Server may process the plurality of received and stored responses to determine a collective intelligence response. In some cases, the processing may include creating an aggregated text file that comprises a listing of the plurality of responses. For example, each response may be associated with a unique identifier linking the response to the CI member who may have provided the unique response (e.g., or the member computing device).

Therefore, the text file may include a listing, for example, of member names, where each member name may be associated with a text representation of the conversational response to the interview inquiry. In some cases, additional information may be associated with the response when the textual content of a member's response may be generated via voice to text conversion. For example, the additional information may refer to vocal inflection information linking emotional content to the complete response or specific portions of the response.

In some cases, additional information may be associated with the response when textual content of a member's response may be generated via video to text conversation. For example, the additional information may refer to facial expression information linking emotional content to the complete response or specific portions of the response. According to an embodiment, the text file may be sent from the CI Server (via one or more API calls) to a Large Language Model (such as, but not limited to ChatGPT or Gemini AI), wherein the API call may include a prompt that specifies the requested processing to be performed on the text file.

According to an embodiment, the requested processing may include a request for the LLM to identify the most supported response or responses among the plurality of responses within the text file. Additionally, the LLM may report the most supported response or one or more popular responses in conversational form. For example, the LLM may report—“When considering which team will win the Super Bowl this year and why, the most supported response among the plurality of responses was that Kansas City will win the Super Bowl because they currently have the most reliable and talented quarterback.”

Additionally, in some cases, the LLM request may report the most supported response or top few responses in first person conversational form. For example, the response may further be modified by the LLM such as—“When considering which team will win the Super Bowl this year and why, I believe that Kansas City is the team most likely to the Super Bowl because they currently have the most reliable and talented quarterback.”

In some cases, a pre-amble may be added to the conversational response to provide context for the Personified Collective Intelligence Agent. For example, the response from the LLM may be—“My name is Una and I am a collective intelligence currently comprised of 4264 real-time members. Based on the combined insights of these members, I believe that Kansas City is the team most likely to the Super Bowl because they currently have the most reliable and talented quarterback.”

In some cases, the processing step may be divided into a series of API calls the Large Language Model, where each API call may include performing further processing on the text file. As a first step, the LLM may identify each of the unique responses present by grouping duplicates within a threshold of similarity and reporting the number of duplicates for each unique response. Next, the LLM may report a reformulated version of the text file with answers grouped by duplication and rank ordered by number of duplications identified. In some cases, the answers may be reported such that the most supported answers may be placed/ranked first (e.g., based on number of duplications) and the least supported answers may be placed/ranked last (e.g., based on number of duplications). According to an embodiment, the ranking may be further processed based on consideration of sentiment data, such as textual sentiment, vocal inflection sentiment, or facial expression sentiment. In some cases, the sentiment data may weigh the rankings by sentiment strength and the number of duplications.

Additionally, as a second step, the LLM may be sent an updated version of the text file (with the prior grouping performed) and the LLM may identify each of the unique reasons (i.e., justifications) associated with each of the unique responses, while grouping duplicate reasons within a threshold of similarity and reporting the number of duplicates for each reason (i.e., justification). In some cases, the LLM may report a reformulated version of the text file. For example, the reported text file may include justifications (e.g., within each answer category) grouped by duplication and rank ordered by number of duplications. In some cases, the rank ordering of reasons may be weighted by sentiment data such as textual sentiment, vocal inflection sentiment, and/or facial expression sentiment.

Additionally, as a third step, the LLM may be sent an updated version of the text file i.e., including duplicate answers grouped and rank ordered based on the number of duplications, and within each answer category, the reasons grouped by duplication and rank ordered by the number of duplications. Additionally, the LLM may be prompted to identify the top answer along with the top reasons for the answer, e.g., the most supported answer and the corresponding reason. Additionally, or alternatively, the LLM may be prompted to identify a predetermined number (e.g., any specific number) of top answers, by rank, and a predetermined number (e.g., any number) of top reasons for each answer, by rank.

According to an embodiment, the answer output may be requested, in the first person and in conversational form, from the perspective of the Personified Collective Intelligence Agent. In some cases, the answer output may include the most supported (e.g., top two) answers, and the most supported (e.g., top two) reasons for each answer.

For example, when there are 4264 members who have responded to the interviewer's inquiry regarding winner of the Super Bowl and the associated reason, the response generated, in conversational form, may be—“My name is Una and I am a collective intelligence currently comprised of 4264 real-time human members. Based on the combined insights of these members, I believe that Kansas City is the most likely team to win the Super Bowl because (i) they currently have the most reliable and talented quarterback, and (ii) they have a strong history of avoiding serious injuries. If not Kansas City, my second most likely choice is Philadelphia because (i) they have the best all-around team, and (ii) they have the most to prove and may be the most aggressive.”

In some cases, the CI Server may send a conversational representation of the final answer output (referred to herein as a collective response) after receiving a final version of the processed set of responses from the Large Language Model. In some cases, the collective response may be sent to at least the local computing device of the interviewer such that the conversational representation of the collective response may be locally displayed to the interviewer in the form of text chat, audio chat, video chat, or VR chat via the one-to-many chat application on the interviewer's local computing device.

According to an embodiment, the local chat application may display text chat as if from a simulated user, for example named Una, that represents the Personified Collective Intelligence agent. For example, Una may appear to the user on a personal computer, laptop, or phone as an animated avatar that may speak vocally.

Referring again to the example in which 4264 members respond to an interviewer question regarding the winner of the Super Bowl and the associated reason, the collective response may appear in the text stream of chat messages as a personified message of the form: “UNA: I'm a collective intelligence currently comprised of 4264 real-time human members. Based on the combined insight of these members, I believe that Kansas City is the most likely to win the Super Bowl because (i) they currently have the most reliable and talented quarterback, and (ii) they have a strong history of avoiding serious injuries. If not Kansas City, my second most likely choice is Philadelphia because (i) they have the best all-around team, and (ii) they have the most to prove and may be the most aggressive.”

According to an embodiment, the Personified Collective Intelligence agent may refer to a chatbot that displays text messages on the local computer of the interviewer. Additionally, or alternatively, the Personified Collective Intelligence agent (PCI agent) may refer to an animated visual avatar with embodied facial features. In some cases, the PCI agent may be configured to express the text representation as a visually displayed face that speaks the text verbally as audio output with corresponding facial motions and expressions.

As described, the collective response, received as a textual representation generated by the LLM, may be converted to audio voice that appears to be coming from a visually displayed animated avatar using a text to voice converter module and/or text to avatar converter module disposed within the local chat application on the local computing device of the interviewer.

Accordingly, in some examples, the interviewer may ask a question regarding Super Bowl to a collective intelligence, e.g., comprising 4264 human members, who receive the inquiry at approximately the same time and respond to the inquiry at approximately the same time. In some examples, the 4264 human members may have the said responses aggregated by a large language model such that a Personified Collective Intelligence agent responds on behalf of each of the members in the first person. In some cases 4264 human members may be divided into a series of deliberative subgroups that are networked together using AI agents as described with respect to FIGS. 1 to 18. In some embodiments the 4264 members deliberate on the question by discussing conversationally within said networked deliberative subgroups, thereby amplifying their combined intelligence prior to reaching a final answer as described with respect to FIGS. 1 to 18.

For example, the PCI agent may express the most supported (e.g., strongest) aggregated views of the complete population. Considering the perspective of the interviewer, the process may resemble talking in real time to a Collective Superintelligence (CSI) that may combine the knowledge, wisdom, insight, and intuitions of a plurality of users (e.g., thousands of people), and respond instantly (e.g., as quickly and as naturally as talking to a single individual). According to an exemplary embodiment, the process may be used for small groups, for example 80 people, providing an interviewer (e.g., an employer) to capture the central insights from a large team of employees in real-time via conversational interaction.

One or more embodiments of the present disclosure provide systems and methods that may be configured to support a large population of users who communicate in different languages by performing real-time language translation. In some cases, a baseline language may be defined on the Collective Intelligence Server for a given session. Additionally, each user of a local computing device may configure the language for the associated computing device, where the associated computing device may report the language setting upon connecting to the Collective Intelligence Server.

In case the messages received from an Interviewer are not represented in the baseline language, the messages may be converted to the baseline language and stored in memory accessible to the Collective Intelligence Server. Next, the stored messages may be sent to each of the local computing devices in the language associated with the settings of the computing device using a translation module. In some cases, the translation module may be locally stored and translation may be performed on the local computing device. Similarly, a message sent by the Collective Intelligence Members to the Collective Intelligence Server may be converted into the baseline language and stored locally. In some cases, the Large Language Model may be highly equipped to process the baseline language, for example English.

In some cases, the content expressed by the personified collective intelligence may be generated by a Large Language Model that may be tasked with ingesting, analyzing, and aggregating a plurality of real-time conversational responses. For example, the plurality of real-time conversational responses may be obtained from the plurality of human participants and a collective response may be generated that represents the combined knowledge, wisdom, insights, and intuitions expressed within the plurality of real-time conversational responses from the plurality of real-time human participants. In some cases the plurality of human participants may be divided into a series of deliberative subgroups that are networked together using AI agents as described with respect to FIGS. 1 to 18. In some such embodiments the human participants deliberate among themselves by discussing conversationally within said networked deliberative subgroups prior to the Large Language Model ingesting, analyzing, and aggregating a plurality of real-time conversational responses.

In some cases, the analysis of the real-time conversational responses may include categorizing elements within responses as either answers to a posed question, or as reasons to support or reject a given answer. Additionally, the analysis may include grouping similar answers (within a certain threshold of similarity) thereby creating answer groupings that effectively have the same meaning. Additionally, the analysis may include grouping similar reasons within each answer grouping thereby creating reason groupings.

Additionally, the analysis may include ranking the support of the answer groupings from the most supported answer grouping (i.e., received the most support within the plurality of responses from the plurality of human participants) to least supported answer grouping (i.e., received the least support within the plurality of responses from the plurality of human participants). In some cases, the ranking may optionally weight the ranked items based on popularity. In some cases, the ranking may optionally weight the ranked items based on the assessment on a measure of expressed conviction within each response from each of the plurality of human participants.

Accordingly, a response with high expressed conviction may contribute more to the ranked support of an answer grouping than a response with low expressed conviction. In some cases, the conviction may be assessed based on the conversational language of the response. In some cases, the conviction level associated with a given response may be assessed based on vocal inflections and/or facial expressions of the human participant who expressed the response.

Additionally, the analysis of the real-time conversational responses may further include ranking the support of reason groupings that may be associated with each unique answer grouping. For example, the support of reason grouping may be ranked from the most supported reason grouping associated with the answer grouping to the least supported reason grouping associated with the answer grouping. In some cases, the ranking may optionally weight the ranked items based on popularity.

In some cases, the ranking may optionally weight the ranked items based on the assessment on a measure of expressed conviction within each reason response from each of the plurality of human participants. In some examples, a reason response with high expressed conviction may contribute more to the ranked popularity of a reason grouping (i.e., associated with a particular answer grouping) than a reason response with low expressed conviction. In some cases, the conviction may be assessed based on the language of the reason response. In some cases, the conviction level associated with a given response may be assessed based on vocal inflections and/or facial expressions of the human participant who expressed the reason response.

Accordingly, the plurality of real-time responses from a plurality of real-time human participants may be rapidly assessed to produce a ranked ordering of the answers given (e.g., by answer grouping). Additionally, the plurality of real-time responses from a plurality of real-time human participants may be assessed to produce a ranked ordering of the reason groupings for each answer grouping. In some cases, select items from the ranked ordering may be sent back to the Large Language Model (or identified through API calls).

In some cases, a request may be made to create a Collective Response (e.g., in conversational form) that represents the prevailing view of the large population of human members. For example, the Collective Response may include the ANSWER RESPONSES within the most highly ranked Answer Grouping and the most supported REASON RESPONSES within the most highly ranked Reason Grouping that is associated with the most highly ranked Answer Grouping.

Next, the Large Language Model may process language within the most supported Answer Grouping to produce a summary in conversational form that represents the answer (i.e., most supported Answer Grouping) in concise language, expressed in the first person. For example, the summary may be a conversational statement expressing a particular answer to the inquiry provided by the interviewer and distributed in real-time to the large population of members. The Large Language Model may process the language within a number (e.g., a predefined number) of the most supported groupings (for example, top two) associated with the most supported answer grouping and may be tasked with generating a summary in conversational form that may represent the reason groupings in concise language in the first person.

Therefore, the Large Language Model may produce a block of conversational first person. For example, the block of conversational dialog may express the most supported answer grouping in concise form and may express a number of (for example, a predefined number such as the top two) reasons describing the answer grouping as a strong answer to the inquiry.

In some cases, the block of conversational dialog may be sent to the computing device of one or more interviewer(s) running the one-to-many instance of the client application. The dialog may be expressed in text form as a first-person text chat from a personified text bot. In some cases, the dialog may be expressed in audio and visual form as spoken dialog that may appear to be spoken by a realistic animated avatar representative (i.e., referred to herein as a Personified Collective Intelligent (PCI) agent). Accordingly, the interviewer may ask a question via the PCI agent and rapidly receive an answer from the (e.g., animated) PCI agent that represents the collective intelligence of a large population in first person conversational form along with supporting reasons for the answer.

According to an embodiment, the Personified Collective Intelligence (PCI) agent may be displayed as text, audio, video, or avatar to the plurality of collective intelligence (CI) members. Therefore, the members may be made aware of the response from the collective intelligence which enables the interviewer to ask follow-up questions that refer to (directly or implied from) a prior response from the PCI, where the members may be contributing to the collective intelligence. Accordingly, an interviewer may hold a real-time conversation discussion with a personified collective intelligence, i.e., asking questions and then following up with additional questions, since the PCI agent may respond in real-time.

According to an embodiment, the large population of human participants may be divided into a set of small sub-populations. In some cases, real-time communication may be enabled among the sub-populations, providing for deliberation among small groups. Accordingly, by generating sub-populations of large a population of human participants, embodiments of the present disclosure may amplify the collective superintelligence.

According to an embodiment of the present disclosure, participants may take turns having the role of the interviewer. For example, a large group of people, such as 50 people, 500 people, or 5000 people (or more than 5000 people) may have a shared experience of participating as part of a real-time Personified Collective Intelligence that can answer questions in a coherent, conversational, first-person manner. In some examples, the large group of people may get a chance to ask questions to the PCI agent.

As described herein, a coherent conversation refers to a conversation in which the participants are able to effectively communicate and understand each other. In case of small groups, each CI Member may earn credits that may be used to ask questions. In some cases, said credits being earned as a result of participating in answering questions. Accordingly, for example, a person (e.g., A) may be one of 50 people participating and each of the 50 people may be earning credits while answering questions.

In some examples, the person (e.g., A) may earn enough credits to occasionally ask a question. In some examples, the credit economy may be configured based on the number of participants. For example, a 50-person population may earn credits at a rate such that each individual may earn the right to ask a question approximately after every 50 questions. In some examples, such as in case of large groups, such as with 5000 members, users may be given the right to ask a question by randomized lottery. According to an embodiment, a high number of answered questions may increase an individual's chances of being selected in the lottery to ask a question.

In some cases, the lottery for each question may be open (e.g., only open) to the participants that answer the last question. In some cases, the lottery may consider the number of questions answered over a prior period of time and weights the chances of each user winning the chance to ask a question based on the number of questions the user may have participated in answering during the said period of time. In some cases, a human moderator may be able to assign the question asking ability to a particular user at a particular time.

According to an embodiment, users may be incentivized to provide thoughtful answers that may represent the collective intelligence of the population. In some cases, the right to ask a question may be dependent at least in part on whether the user provides responses to a prior question. In some examples, users (e.g., only users) that provide responses in the top 20% of popular responses to the prior question may be provided credits that can be redeemed to ask a question. Additionally, or alternatively, users (e.g., only users) that provide responses in the top 20% of popular responses to the prior question may be considered in the lottery for asking a question. Accordingly, each participant may be incentivized to provide a thoughtful and reasonable answer.

The present disclosure describes systems and methods that enable very large groups of human users to form real-time collective intelligence (e.g., via an online method). In some cases, the real-time collective intelligence may be expressed verbally in the first person in the form of a Personified Collective Intelligence agent. In some cases, the facial expressions and/or vocal inflections that may be represented visually and aurally via the face and voice of the PCI, may be determined at least in part based on an emotional assessment and/or conviction assessment determined for each of a plurality of CI Members. For example, the emotional and conviction assessments may be based on the captured voice, captured facial expressions, and/or captured language content of the response.

According to an example, 4,264 members may reply to a question in real-time about predicting the winning team of the super bowl in a particular year. In some examples, the most supported answer may be Kansas City. In some examples, in case 2,345 of the members contribute to the choice Kansas City, an aggregation of emotional sentiment and/or conviction sentiment may be performed across the responses from the 2,345 members. In some examples, the aggregation may be used at least in part to determine the facial expressions and/or vocal inflections of the PCI agent when the agent (e.g., PCI agent) reports that Kansas City is the most likely winner.

For example, in case the aggregation shows low conviction, the PCI may be directed to express the answer with some uncertainty in the facial expressions and/or vocal inflections. Additionally, or alternatively, for example, in case the overall conviction and/or emotion is very strong in favor of Kansas City, the PCI agent may be directed to express the answer with significant certainty and/or enthusiasm on the face and in vocal inflections. Accordingly, a large population may direct the informational content of collective responses and the conviction and/or emotional enthusiasm (e.g., or lack thereof) to define the display of the informational content.

### Selectable Levels of Conversational Synchrony

The present disclosure describes systems and methods for enabling selectable modes of operation when building collective superintelligence through large-scale conversational deliberation while providing flexibility. Particularly, an embodiment of the present disclosure includes a selectable mode of operation. For example, embodiments include synchronous, semi-synchronous, and asynchronous modes of operation that relate to the relative timing of participation among the population of human contributors to the collective intelligence system.

An embodiment of the present disclosure includes a synchronous mode of operation configured to ensure participation of each of the human contributors to the collective intelligence at substantially the same time. For example, the collective intelligence system may function with each of the participants interacting at substantially the same time (e.g., 25 networked participants, 2500 networked participants, or 2 million networked participants). As used herein, the term ‘substantially’ refers to within the limits of human deliberations. For example, in case of a human meeting (i.e., in person or by zoom or chat room), participants may join late or leave early without changing the basic real-time dynamics of the conversation which may be referred to herein as the synchronous mode of operation.

Additionally, the tiered connection architecture (e.g., the architecture described with reference to FIGS. 23-24) enables extra flexibility in case of the synchronous implementation and the timing of joining of the participants since the lowest tier (e.g., Level 0 shown in FIG. 23 as including 5 subgroups of 6 participants each) is completely connected. Accordingly, a coherent real-time conversation may be performed even before other groups join the conversation in additional lowest tier groups (such as additional Level 0 groups). Therefore, in case of FIGS. 23-24, the lowest tier (Level 0) comprises a conversational unit of 30 participants.

In some cases, the participants begin conversation synchronously (e.g., as described with reference to FIGS. 22-24) with the 30 individuals. Subsequently, when another set of 30 individuals connect to the platform, the newly connected individuals may be added to the conversation as another lowest tier grouping (such as Level 0 described with reference to FIGS. 23-24). Similarly, as the participants joining increases over time, the participants may be added to the conversation by adding more groupings, e.g., based on the structure that progresses in size from FIG. 22 to FIG. 23 to FIG. 24. Further details regarding the conversation and the network structure are provided with reference to FIGS. 22-24. In some cases, the lowest tier may not be specifically 30 people, i.e., the lowest tier may be enough participants that are able to hold a meaningful deliberation. In some instances, the lowest tier can be as low as, e.g., 12 individuals or as large as hundreds of individuals. In some cases, the lowest tier may depend on the expected scale of the complete population.

Additionally, the structure shown with reference to FIGS. 22-24 may be (e.g., uniquely) flexible as a group may leave the conversation. For example, a group of participants that join first (e.g., at an earliest time) and form the first lowest tier in the structure may be ready to leave earliest. Therefore, the portion of the structure corresponding to the said group may be dissolved while other portions of the structure may continue to be active as participants engage in the conversation. In case of the synchronous mode, the conversation evolves in real-time. That is, the conversation may shift (e.g., shift a topic) as participants deliberate and debate, with emerging ideas and assertions being captured, assessed, and stored, while participants may join and leave over time.

Additionally, an embodiment of the present disclosure includes a semi-synchronous mode of operation configured to ensure human contributors' participation in a sequential series of batches. In some cases, each batch may be sized to reach a critical mass with respect to including a sufficient number of human participants that may challenge each other while building upon the ideas of each other and sharing ideas between some subgroups. In cases, implementation of a semi-synchronous mode of operation may include a seed population that starts the process followed by additional population(s) that may join over time (i.e., in batches).

For example, referring to FIG. 27, a first batch (such as Batch 1 2730-a shown in FIG. 27) may complete the conversation before a next batch joins. In some cases, there may be flexible levels of down-time between batches. For example, Batch 1 2730-a may join and hold a conversational deliberation with the emerging ideas and assertions being captured, assessed, and stored throughout the interactions (and associated in memory to the corresponding batch number). In some examples, the conversation may end and subsequently, a second batch of users may join, e.g., Batch 2 2730-b shown with reference to FIG. 27. Similar to Batch 1, Batch 2 may hold conversational deliberation on the same topic, the emerging ideas and assertions again being captured, assessed, and stored throughout the interactions, and added to the same database (such as the database corresponding to Batch 1 2730-a) for the deliberation (i.e., associated with the batch number). In some examples, at a subsequent time, an additional batch (such as Batch 3 2730-c up to Batch N 2730-d), may join and hold deliberations on the same topic.

Accordingly, each of the batches shown in FIG. 27 may be independent with respect to time, i.e., each batch (such as batch 2730-a, 2730-b, 2730-c, and 2730-d) may hold an independent conversation among the participants of the batch. In some cases, each of the batches of participants may be linked to a single unified conversation based on the central server (such as central server 1920 in FIG. 19). In some cases, the central server provides identical (or similar) prompts to the participants in each batch, directing the participants to deliberate on the same general topic. Additionally, the data stored from participants (i.e., the assertions, ideas, and insights captured, assessed, and stored from participants) during a previous batch may be used when injecting insights into conversational subgroups of subsequent batches. For example, the data stored from participants during Batch 1 2730-a may be used to inject insights into conversational subgroups of Batch 2 2730-b, Batch 3 2730-c, up to Batch N 2730-d.

Similarly, in some examples, the conversational insights that may be injected into subgroups of Batch N 2730-d may include insights from other subgroups, i.e., subgroups that may be currently engaged during Batch N and may additionally include insights from subgroups that participated previously in Batch 1 through Batch N−1. Accordingly, each of the groups may be linked into a unified conversation that may include real-time human deliberations among live participants. In some cases, the participants may challenge each other through active debate, enabling insights to propagate in real-time across a network of subgroups. Additionally, in some cases, each of the batches may include insights captured from prior batches, thereby providing for insights to propagate across time.

According to an embodiment, a batch size (i.e., a substantial sized batch) of real-time participants may be preferred since insights that propagate over time may be subject to sequential bias (e.g., early ideas may potentially have more weight than later ideas). In some cases, the collaboration server (such as collaboration server 2705 in FIG. 27) may be designed to propagate assertions, insights, and ideas forward through the sequence of batches (e.g., propagate over time) only when the assertions, insights, and ideas gain support independently in multiple subgroups in the same batch or in multiple subgroups across different batches. According to an embodiment, a threshold level may be set for the number of subgroups an idea, assertion, or insight must emerge independently within before being propagated across batches. According to an embodiment, conviction levels may be used to represent the strength of support for ideas, assertions, or insights and the number of subgroups in which the ideas, assertions, or insights emerged independently.

FIG. 27 shows an example of a network architecture 2700 according to aspects of the present disclosure. Network architecture 2700 is an example of, or includes aspects of, the corresponding element described with reference to FIGS. 1, 2, 19-24, 28, and 29. In one aspect, network architecture 2700 includes collaboration server 2705, LLM-powered module 2710, computing device 2715, user 2720, computer network 2725, and batch 2730.

For example, as described herein, a batch 2730 may generally refer to one or more of a first Batch 2730-a, a second Batch 2730-b, a third Batch 2730-c up to any number (e.g., N^{th}) Batch 2730-d (e.g., in the semi-synchronous structure shown in FIG. 27). In some cases, a value of the structure may be logistics which enables participants to engage at different times (i.e., reducing the requirement for each participant to engage the system at the same (or similar) time. Accordingly, for example, very large groups that span different time zones may easily and conveniently participate in a coherent real-time conversation.

In some cases, the logistics benefits may be enabled without losing the informational value of having participants react to other human participants, while revealing the strength of participant convictions through the conversational reactions. For example, a reaction may refer to expressions of agreement, disagreement or ambivalence to the comments of other human users. Accordingly, using a sufficiently large seed population (i.e., initial batch) and then sufficiently large next populations (i.e. next batches) may enable the logistics benefits without losing informational value.

For example, a collective intelligence system may be created that comprises 5000 human participants. In some examples, a seed population of 250 participants may be conducted in real-time to capture the ideas, sentiments, and conviction levels of the participants as the participants deliberate among themselves. The 250-participant group may be structured as 50 small groups of 5, interconnected as described with reference to FIGS. 22-24. Accordingly, the resulting dataset may include a large number of comments (e.g., assertions) made by the 250 participants that are quantified with respect to confidence and conviction and aggregated. Additionally, the population size may be sufficient to assess if ideas, assertions, or insights emerge independently in multiple subgroups (i.e., above a threshold level) as a metric for propagating to future batches. In some examples, future batches (such as Batch 2 2730-b, Batch 3 2730-c, up to Batch N 2730-d shown in FIG. 27) may not be as large as the seed batch (Batch 1 2730-a shown in FIG. 27).

According to an embodiment, when the seed session is complete (referred to as Batch 1 2730-a Session), an additional batch of the desired 5000 human participants may be run. Each of the additional batches (i.e., Batch 2 2730-b, Batch 3 2730-c, up to Batch N 2730-d) may be smaller than the initial 250 participant seed population (i.e., Batch 1) since the system may benefit from the data collected from the seed session (conducted by Batch 1 2730-a). For example, an additional batch of users (e.g., Batch 2 2730-b) may comprise 100 human participants interacting in real time.

In some cases, the new Batch 2 2730-b session may be conducted after the collective intelligence server (i.e., collaboration server 2705) has data from 100 participants (i.e., data from 20 groups of 5 participants, with the ideas, insights, and assertions quantified by individual and group conviction scores). The store of data from Batch 1 2730-a participants may be used during the real-time deliberation of Batch 2 2730-b participants. In some cases, a message passing method as described with reference to FIGS. 20-21 may be implemented. Additionally, the message passing may transmit ideas, insights, and assertions captured from subgroups in prior batches to subgroups in the current batch. In some cases, an idea, an assertion, or an insight may emerge independently in two or more batches to be propagated to subgroups in subsequent batches. In some cases, an idea, assertion, or insight may emerge independently in three or more batches to be propagated to subgroups in subsequent batches.

Collaboration server 2705 is an example of, or includes aspects of, the corresponding element described with reference to FIGS. 1 and 2. LLM-powered module 2710 is an example of, or includes aspects of, the corresponding element described with reference to FIGS. 1, 2, 26, and 29. In some aspects, an LLM-powered module 2710 may include, or refer to, a conversational contributor agent 1930. Computing device 2715 is an example of, or includes aspects of, the corresponding element described with reference to FIGS. 1, 2, 5, 19, 25, 26, and 29. User 2720 is an example of, or includes aspects of, the corresponding element described with reference to FIGS. 1, 2, 4-6, 8, 9, 19-26, 28, and 29. Computer network 2725 is an example of, or includes aspects of, the corresponding element described with reference to FIGS. 19 and 29. Batch 2730 is an example of, or includes aspects of, the corresponding element described with reference to FIG. 29. In some aspects, batches 2730 are each an example of, or includes aspects of, the example network architecture 2000 shown in FIG. 20.

Embodiments of the present disclosure are configured to enable large-scale conversational deliberations and perform the collective superintelligence process in (any of) the synchronous, semi-synchronous, or asynchronous modes of operation. One or more embodiments of the present disclosure include a Conversational Contributor Agent which enables a hybrid collective intelligence (HyCI) that combines human deliberation with input from AI agents. In some cases, the AI agents may be a Scout Agent and may add informational content (i.e., factual content) that may help the human participants deliberate more effectively, efficiently, and accurately.

That is, an additional AI agent, i.e., Scout Agents may be able to provide additional reference information to the subgroup in case the conversation drifts to a topic that may have not been foreseen at the beginning of the large-scale deliberative process. In some cases, the Scout Agent may be configured to use additional external resources (e.g., the Internet) to acquire information for use in the subgroup, e.g., the acquired information may be conversationally injected into the subgroup and used for deliberating the topic.

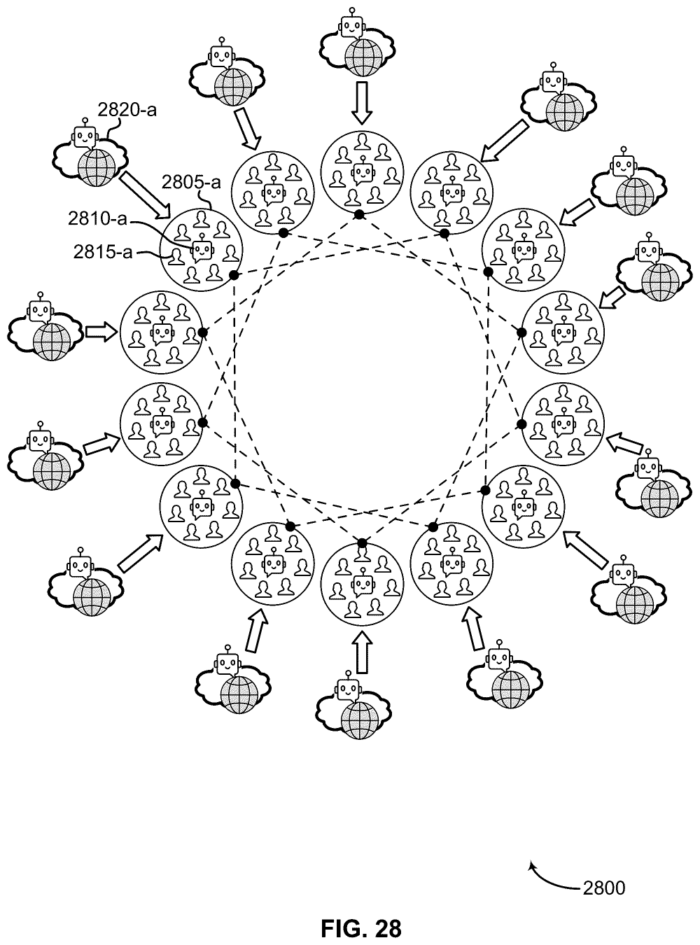

FIG. 28 shows an example of a network architecture 2800 according to aspects of the present disclosure. Network architecture 2800 is an example of, or includes aspects of, the corresponding element described with reference to FIGS. 1, 2, 19-24, 27, and 29. In one aspect, network architecture 2800 includes subgroup 2805. Subgroup 2805 is an example of, or includes aspects of, the corresponding element described with reference to FIGS. 3-6, 8, 9, and 19-24. In one aspect, subgroup 2805-a includes conversational surrogate agent 2810-a, user 2815-a, and scout agent 2820-a.

Referring to FIG. 28, the scout agent 2820-a (also referred to as scoutbots) may be designed to process the human conversation in real-time within subgroups and/or across different subgroups (such as subgroup 2805-a). In some cases, the scout agent 2820-a may assess when a factual information may be likely to help the subgroup 2805-a (or a collection of subgroups) make an effective decision. Additionally, the scout agent 2820-a may find the factual information on the internet or other from stored information sources and inject the information into one or more subgroups (such as subgroup 2805-a) as natural human dialog while ensuring the injection does not disrupt the conversational flow.

The scout agent 2820-a may be an AI agent that ensures that the human participants (such as 2815-a shown in FIG. 28) have the factual information needed as the participants debate and discuss critical issues to reach conclusions. Accordingly, the human collective intelligence remains in control of decisions, but are informed appropriately (i.e., in terms of content and time) with factual information needed. In some embodiments, the Scout Agent is configured to find and express information based on an automatic assessment of whether the information is likely to be helpful to the current conversational deliberation among human participants within its assigned subgroup. In some embodiments, the Scout Agent is configured to respond to direct queries expressed by human participants within the subgroup. For example, when deliberating the outcome of a presidential election, a participant could ask the ScoutBot for statistics about the percentage of young voters between 18 to 25 years ago. The Scoutbot can be configured to provide that information as a conversational response, either by accessing a curated data source or searching internet-based data sources.

Conversational surrogate agent 2810 is an example of, or includes aspects of, the corresponding element described with reference to FIGS. 2, 5, 6, 8, 9, 11, and 19-24. User 2815 is an example of, or includes aspects of, the corresponding element described with reference to FIGS. 1, 2, 4-6, 8, 9, 19-27, and 29. Scout agent 2820 is an example of, or includes aspects of, the corresponding element described with reference to FIG. 19.

Embodiments of the disclosure are configured to enable enhanced flexibility in terms of logistics. In some cases, an individual user may be enabled to engage the collective superintelligence system and provide ideas, insights, assertions, in response to the conversational prompt and in response to the ideas, insights, and assertions of other users. In case of the synchronous and semi-synchronous modes of operation, multiple participants interact with each other and with AI agents that represent the ideas, insights, and assertions of other users.

In case of an asynchronous mode, a human participant may interact with AI agents that represent the ideas, insights, and assertions of other users. An asynchronous mode of operation may be implemented using the conversational interview structure shown with reference to FIG. 26 in which an AI-powered avatar may interview one or more human participants to capture information.

According to an embodiment, a real-time seed population may be employed to capture authentic deliberative data from groups of human participants that may be debating and deliberating over a topic. In some cases, when the seed data is captured, a similar structure may be followed to the semi-synchronous mode. In some cases, individual participants (i.e., instead of batches) may engage the system and interact with an AI agent that is designed to represent the ideas, insights, and assertions that emerged from the authentic deliberation.

FIG. 29 shows an example of a network architecture 2900 according to aspects of the present disclosure. Network architecture 2900 is an example of, or includes aspects of, the corresponding element described with reference to FIGS. 1, 2, 19-24, 27, and 28. In one aspect, network architecture 2900 includes central server 2905, LLM-powered module 2910, computing device 2915, user 2920, computer network 2925, and batch 2930.

FIG. 29 shows a seed population that may be used to capture initial insights as Batch 1 2930-a, followed by a secondary population used to capture insights as Batch 2 2930-b. Subsequently, an asynchronous mode of operation is performed in which individual users interact directly with one or more AI agents (such as 2915-b and/or 2915-c) that are designed to represent the ideas, insights, and assertions of the collective intelligence (i.e., based on the database of information captured over time through Batch 1 2930-a, Batch 2 2930-b, and from any individual participants who may have joined the collective superintelligence system asynchronously before the current participant(s)). Accordingly, individual participants (such as human participants who engage computing device 2915-b and computing device 2915-c) may interact with the collective superintelligence system, first being posed with the conversational prompt and then being challenged by one or more AI agents (such as the AI agent or agents displayed on computing device 2915-b) that represent the views stored in the database (such as a memory in collaboration server 2905) captured from prior participants.

According to an embodiment, an individual human may be in conversation with two or more AI agents, wherein each of said AI agents may be designed to present the different prevailing views or minority views. In some cases, the views that may have been captured from prior participants are reflected in the database (i.e., memory in collaboration server 2905) that represents the views, insights, ideas, and assertions of the collective intelligence. For example, in case there are six different perspectives that may have emerged in response to the conversational prompt, as reflected in the database of insights and assertions, six different conversational agents may be deployed for real-time conversation with the individual human participant. Additionally, or alternatively, for example, a single AI agent, represented as a single avatar, may be deployed to represent each of the six different perspectives and may be designed to express the perspectives with conviction levels that match the levels stored in the collective intelligence database. Further details regarding conversational agents that represent specific views are provided with reference to FIGS. 25-26.

Central server 2905 is an example of, or includes aspects of, the corresponding element described with reference to FIGS. 10, 11, and 19. LLM-powered module 2910 is an example of, or includes aspects of, the corresponding element described with reference to FIGS. 1, 2, 26, and 27. Computing device 2915 is an example of, or includes aspects of, the corresponding element described with reference to FIGS. 1, 2, 5, 19, and 25-27. User 2920 is an example of, or includes aspects of, the corresponding element described with reference to FIGS. 1, 2, 4-6, 8, 9, and 19-28. Computer network 2925 is an example of, or includes aspects of, the corresponding element described with reference to FIGS. 19 and 27. Batch 2930 is an example of, or includes aspects of, the corresponding element described with reference to FIG. 27.

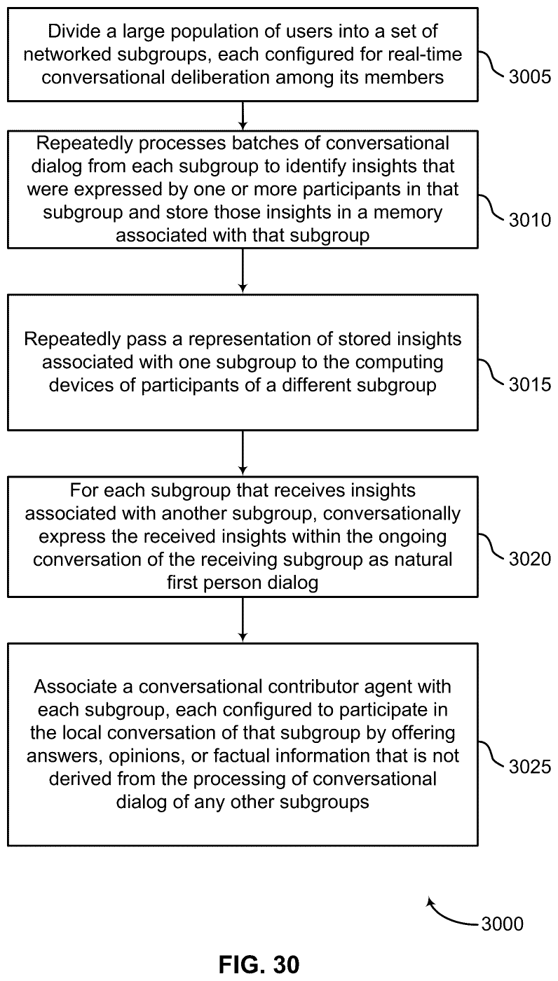

FIG. 30 shows an example of a method 3000 for communication systems according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 3005, the system divides a large population of users into a set of networked subgroups, each configured for real-time conversational deliberation among its members. In some cases, the operations of this step refer to, or may be performed by, a central server as described with reference to FIGS. 10, 11, 19, and 29. In some cases, the operations of this step refer to, or may be performed by, a subgroup as described with reference to FIGS. 3-6, 8, 9, 19-24, and 28. In some cases, the operations of this step refer to, or may be performed by, a network architecture as described with reference to FIGS. 1, 2, 19-24, and 27-29.

At operation 3010, the system repeatedly processes batches of conversational dialog from each subgroup to identify insights that were expressed by one or more participants in that subgroup and store those insights in a memory associated with that subgroup, e.g., in one variation, the system associates a conversational surrogate agent with each subgroup, each configured to observe the real-time conversational deliberation among members of its subgroup. In some cases, the operations of this step refer to, or may be performed by, a central server as described with reference to FIGS. 10, 11, 19, and 29. In some cases, the operations of this step refer to, or may be performed by, a conversational surrogate agent as described with reference to FIGS. 2, 5, 6, 8, 9, 11, 19-24, and 28.

In some aspects, the real-time conversational deliberation is a text chat conversation. In some aspects, the real-time conversational deliberation is a teleconference or videoconference conversation.

At operation 3015, the system repeatedly passes a representation of stored insights associated with one subgroup to the computing devices of participants of a different subgroup, e.g., in accordance with one variation, the system passes insights from the conversational surrogate agent of one subgroup to other conversational surrogate agents of other subgroups, and receiving insights from the other conversational surrogate agents of other subgroups. In some cases, the operations of this step refer to, or may be performed by, a conversational surrogate agent as described with reference to FIGS. 2, 5, 6, 8, 9, 11, 19-24, and 28.

At operation 3020, for each subgroup that receives insights associated with another subgroup, the system conversationally expresses insights received from other subgroups to the members of a subgroup as natural first person dialog using the conversational surrogate agent associated with that subgroup. In some cases, the operations of this step refer to, or may be performed by, a conversational surrogate agent as described with reference to FIGS. 2, 5, 6, 8, 9, 11, 19-24, and 28.

In some aspects, the conversational surrogate agent is visually represented on the screens associated with each of a plurality of users as an animated avatar with facial expressions that correlate with its expressed first person conversational dialog.

At operation 3025, the system associates a conversational contributor agent with each subgroup, each configured to participate in the local conversation of that subgroup by offering answers, opinions, or factual information that is not derived from the processing of conversational dialog of any other subgroups, e.g., in accordance with one variation, the system associates a conversational contributor agent with each subgroup, each configured to participate in local conversation of that subgroup by offering answers, insights, opinions, or factual information that is independently AI generated rather than being derived based on conversational content of human users in other subgroups. In some cases, the operations of this step refer to, or may be performed by, a conversational contributor agent as described with reference to FIGS. 1, 2, and 19.

In some aspects, the conversational contributor agent is configured with a unique persona profile. In some aspects, the unique persona profile includes demographic characteristics, psychographic characteristics, expertise, information, and/or values. In this way a Conversational Contributor Agent with an assigned persona profile can conversationally express answers, insights, opinions, or factual information from the first person perspective of a simulated human user of that persona profile.

In some aspects, the system includes a global observer agent associated with a set of subgroups, configured to receive insights from and pass insights to the conversational surrogate agents associated with each of the subgroups in its set of subgroups.

In some aspects, the system includes a plurality of scout agents, each associated with a particular subgroup or set of subgroups and configured to search for and acquire factual information for use in the real-time conversational deliberation within that subgroup or among that set of subgroups and express that factual information conversationally to the members of that subgroup in real-time. In some aspects, the scout agent is configured to search the internet and/or a set of defined information sources to acquire factual information for use in the real-time conversational deliberation.

In some aspects, the conversational contributor agent is configured to offer factual information that is sourced by a scout agent in real-time. In some aspects, the conversational contributor agent is configured to offer insights, opinions, or factual information that is seeded with specific key phrases, talking points, statistics, stories, contexts, and other reference information or informational sources or curated seta of documents or curated datasets.

In some aspects, the conversational contributor agent is configured to participate in local conversation of that subgroup by offering answers, insights, opinions, or factual information that is generated using a large language model. In some aspects, the conversational contributor agent is configured to participate in local conversation of that subgroup by offering answers, insights, opinions, or factual information that is generated in response to a query from a user in the subgroup.

In some aspects, the system includes (and provides) a conversational topic over an information network to a plurality of networked subgroups, the plurality of networked subgroups configured to hold simultaneous conversational deliberations on the conversational topic during a synchronous time period. In some aspects, the system configures a plurality of other networked subgroups to hold sequential conversational deliberations on the conversational topic during asynchronous time periods.

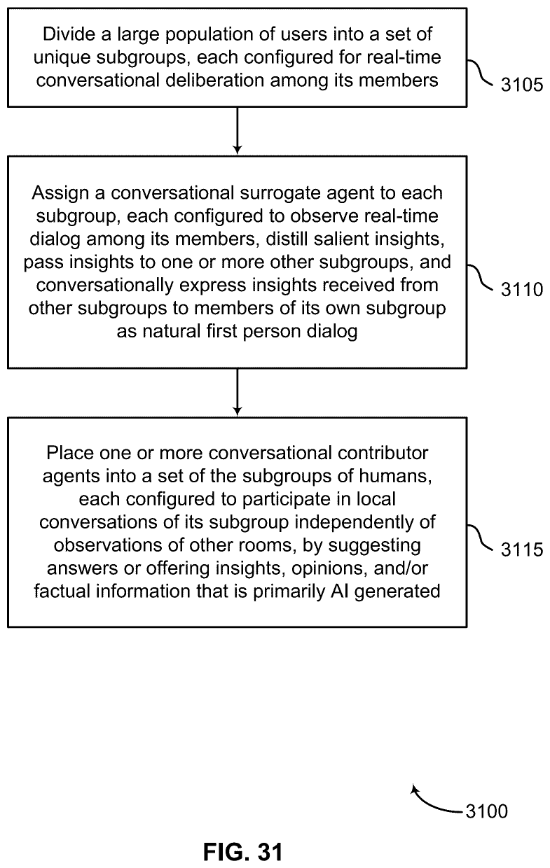

FIG. 31 shows an example of a method 3100 for communication systems according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 3105, the system divides a large population of users into a set of unique subgroups, each configured for real-time conversational deliberation among its members. In some cases, the operations of this step refer to, or may be performed by, a central server as described with reference to FIGS. 10, 11, 19, and 29. In some cases, the operations of this step refer to, or may be performed by, a subgroup as described with reference to FIGS. 3-6, 8, 9, 19-24, and 28. In some cases, the operations of this step refer to, or may be performed by, a network architecture as described with reference to FIGS. 1, 2, 19-24, and 27-29.

In some aspects, the real-time conversational deliberation is a text chat conversation. In some aspects, the real-time conversational deliberation is a teleconference or videoconference conversation.

At operation 3110, the system assigns a conversational surrogate agent to each subgroup, each configured to observe real-time dialog among its members, distill salient insights, pass insights to one or more other subgroups, and conversationally express insights received from other subgroups to members of its own subgroup as natural first person dialog. In some cases, the operations of this step refer to, or may be performed by, a central server as described with reference to FIGS. 10, 11, 19, and 29. In some cases, the operations of this step refer to, or may be performed by, a conversational surrogate agent as described with reference to FIGS. 2, 5, 6, 8, 9, 11, 19-24, and 28.

In some aspects, the conversational surrogate agent is visually represented on the screens associated with each of a plurality of users as an animated avatar with facial expressions that correlate with its expressed first person conversational dialog.

At operation 3115, the system places one or more conversational contributor agents into a set of the subgroups of humans, each configured to participate in local conversations of its subgroup independently of observations of other rooms, by conversationally suggesting answers or offering o insights, opinions, and/or factual information that is primarily AI generated. In some cases, the operations of this step refer to, or may be performed by, a conversational contributor agent as described with reference to FIGS. 1, 2, and 19.

In some aspects, the system includes a global observer agent associated with a set of subgroups, configured to receive insights from and pass insights to the conversational surrogate agents associated with each of the subgroups in its set of subgroups.

In some aspects, the system includes a plurality of scout agents, each associated with a particular subgroup or set of subgroups and configured to search for and acquire factual information for use in the real-time conversational deliberation within that subgroup or among that set of subgroups and express that factual information conversationally to members of that subgroup in real-time. In some aspects, the scout agent is configured to search the internet and/or a set of defined information sources to acquire factual information for use in the real-time conversational deliberation.

In some aspects, the one or more conversational contributor agents is configured with a unique persona profile. In some aspects, the unique persona profile includes demographic characteristics, psychographic characteristics, expertise, information, and/or values. In this way a Conversational Contributor Agent with an assigned persona profile can conversationally express answers, insights, opinions, or factual information from the first person perspective of a simulated human user of that persona profile.

In some aspects, the one or more conversational contributor agents is configured to offer factual information that is sourced by a scout agent in real-time. In some aspects, the one or more conversational contributor agents is configured to offer r insights, opinions, or factual information that is seeded with specific key phrases, talking points, statistics, stories, contexts, and other reference information or informational sources.

In some aspects, the one or more conversational contributor agents is configured to participate in a local conversation of that subgroup by conversationally offering answers, insights, opinions, or factual information that is generated using a large language model.

In some aspects, the one or more conversational contributor agents is configured to participate in local conversation of that subgroup by offering answers, insights, opinions, or factual information that is generated in response to a conversational request for information from a user in the subgroup.

In some aspects, the system includes (and provides) a conversational topic over an information network to a networked subgroups, the plurality of plurality of networked subgroups configured to hold simultaneous conversational deliberations on the conversational topic during a synchronous time period.

In some aspects, the system includes a plurality of other networked subgroups configured to hold sequential conversational deliberations on the conversational topic during asynchronous time periods.

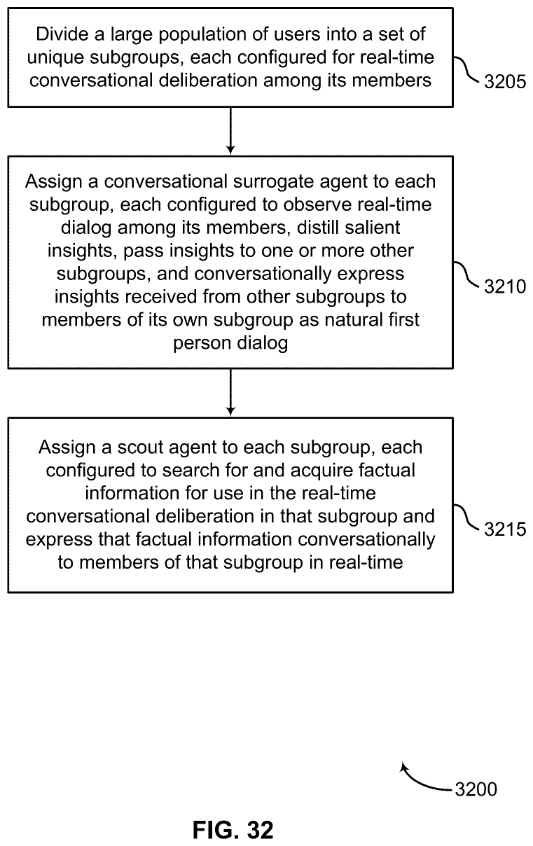

FIG. 32 shows an example of a method 3200 for communication systems according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 3205, the system divides a large population of users into a set of unique subgroups, each configured for real-time conversational deliberation among its members. In some cases, the operations of this step refer to, or may be performed by, a central server as described with reference to FIGS. 10, 11, 19, and 29. In some cases, the operations of this step refer to, or may be performed by, a subgroup as described with reference to FIGS. 3-6, 8, 9, 19-24, and 28. In some cases, the operations of this step refer to, or may be performed by, a network architecture as described with reference to FIGS. 1, 2, 19-24, and 27-29.

At operation 3210, the system assigns a conversational surrogate agent to each subgroup, each configured to observe real-time dialog among its members, distill salient insights, pass insights to one or more other subgroups, and conversationally express insights received other subgroups to members of its own subgroup as natural first person dialog. In some cases, the operations of this step refer to, or may be performed by, a conversational surrogate agent as described with reference to FIGS. 2, 5, 6, 8, 9, 11, 19-24, and 28. In some cases, the operations of this step refer to, or may be performed by, a central server as described with reference to FIGS. 10, 11, 19, and 29.

In some aspects, the real-time conversational deliberation is a text chat conversation. In some aspects, the real-time conversational deliberation is a teleconference or videoconference conversation.

At operation 3215, the system assigns a scout agent to each subgroup, each configured to search for and acquire factual information for use in the real-time conversational deliberation in that subgroup and express that factual information conversationally to members of that subgroup in real-time. In some cases, the operations of this step refer to, or may be performed by, a scout agent as described with reference to FIGS. 19 and 28. In some cases, the operations of this step refer to, or may be performed by, a subgroup as described with reference to FIGS. 3-6, 8, 9, 19-24, and 28.

In some aspects, the scout agent is configured to search the internet or other information sources to acquire factual information for use in the real-time conversational deliberation. In some aspects, the scout agent is configured to convey the acquired factual information to the conversational surrogate agents assigned to each subgroup, which is configured to conversationally inject that contextual information into the real-time conversational deliberation.

In some aspects, the system includes a global observer agent associated with a set of subgroups, configured to receive insights from and pass insights to the conversational surrogate agents associated with each of the subgroups in its set of subgroups.

In some aspects, the system includes a plurality of conversational contributor agents, each associated with a particular subgroup or set of subgroups and configured to participate in local conversation of its subgroup by offering answers, insights, opinions, or factual information that is entirely AI generated.

In some aspects, the conversational surrogate agent is visually represented on the screens associated with each of a plurality of users as an animated avatar with facial expressions that correlate with its expressed first-person conversational dialog.

In some aspects, the conversational surrogate agent is configured to pass insights to other conversational surrogate agents associated with the one or more other subgroups, the insights being passed as language, the insights being passed along with aggregated numerical measures of confidence and/or conviction and/or scope. In some aspects, the conversational surrogate agent is configured to receive insights from other conversational surrogates associated with other subgroups, the insights including textual language representing the insights and aggregated numerical measures of the other subgroups' conviction and/or confidence and/or scope in the insights. In some aspects, the conversational surrogate agent is configured to express insights to its own subgroup received from other conversational surrogate agents associated with other subgroups, strength of first-person language being modulated based at least in part upon the strength of received numerical measures.

In some aspects, the system includes a conversational topic is provided over an information network to a plurality of networked subgroups, the plurality of networked subgroups configured to hold simultaneous conversational deliberations on the conversational topic during a synchronous time period.

In some aspects, the system includes a plurality of other networked subgroups configured to hold sequential conversational deliberations on the conversational topic during asynchronous time periods.

FIG. 33 shows an example of a method 3300 for asynchronous conversational deliberation among a population of human participants according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 3305, the system provides a collaboration server connected to a memory containing a representation of conversational content that was previously captured from a set of prior human participants, the representation associated with each prior participant including at least one stored idea, insight, view, or assertion expressed by that prior participant and at least one associated numerical measure of sentiment, conviction, confidence, or support. In some cases, the operations of this step refer to, or may be performed by, a network architecture as described with reference to FIGS. 1, 2, 19-24, and 27-29. At operation 3310, the system runs an asynchronous conversation application on each of a set of networked computing devices, each computing device in communication with the collaboration server and each computing device associated with one of a set of new human participants. In some cases, the operations of this step refer to, or may be performed by, a computing device as described with reference to FIGS. 1, 2, 5, 19, 25-27, and 29.

At operation 3315, the system enables an asynchronous conversational process in which each of the set of new human participants engages in real-time dialog with a Conversational Surrogate Agent displayed by their associated computing device, each Conversational Surrogate Agent configured to express to at least one new participant, at least one stored idea, insight, view, or assertion associated with at least one prior participant. In some cases, the operations of this step refer to, or may be performed by, an asynchronous conversation application as described with reference to FIG. 2.

Accordingly, a method for asynchronous conversational deliberation among a population of human participants is described. One or more aspects of the method include providing a collaboration server connected to a memory containing a representation of conversational content that was previously captured from a plurality of prior human participants, the representation associated with each prior participant including at least one stored idea, insight, view, or assertion expressed by that prior participant and at least one associated numerical measure of sentiment, conviction, confidence, or support; running an asynchronous conversation application on each of a plurality of networked computing devices, each computing device in communication with the collaboration server and each computing device associated with one of a plurality of new human participants; and enabling an asynchronous conversational process in which each of the plurality of new human participants engages in real-time dialog with a Conversational Surrogate Agent displayed by their associated computing device, each Conversational Surrogate Agent configured to express to at least new participant, at least one stored idea, insight, view, or assertion associated with at least one prior participant.

In some aspects, the Conversational Surrogate Agent expresses dialog that is generated at least in part by a Large Language Model provided with at least one stored idea, insight, view, or assertion associated with at least one prior participant.

In some aspects, the Large Language Model is configured to generate the dialog used to express a stored idea, insight, view, or assertion based at least in part on the at least one stored numerical measure of sentiment, conviction, confidence, or support.

In some aspects, the Conversational Surrogate Agent expresses the dialog in the first person to the at least one new participant.

In some aspects, the at least one idea, insight, view, or assertion expressed to the at least one new participant is selected from a plurality of stored ideas, insights, views, or assertions by an intelligent heuristic process, the intelligent process configured to challenge the at least one new participant with conversational content that has not yet been discussed by the at least one new participant during the dialog.

In some aspects, the Conversational Surrogate Agent is configured to modulate its simulated emotion when expressing a stored idea, insight, view, or assertion based at least in part on a stored numerical measure of sentiment, conviction, confidence, or support.

In some aspects, the simulated emotion includes a vocal inflection. In some aspects, the simulated emotion includes facial expression.

In some aspects, a representation of conversational content from each of a plurality of the new participants is captured and stored in a memory accessible to the collaboration server, each representation including at least one idea, insight, view, or assertion and at least one associated numerical measure of sentiment, conviction, confidence, or support.

In some aspects, the at least one numerical measure of sentiment, conviction, confidence, or support is generated at least in part by a large language model that assesses dialog expressed by at least one of the plurality of new participants.

In some aspects, the at least one numerical measure of sentiment, conviction, confidence, or support is generated at least in part based on a facial expression or vocal inflection of the at least one new participant.

In some aspects, the Conversational Surrogate Agent is displayed as an animated avatar on the computing device. In some aspects, the at least one stored idea, insight, view, or assertion that is associated with at least one prior participant is an aggregation across a plurality of prior participants and represents a collective intelligence.

In some aspects, the aggregation is a weighted aggregation based at least on part on a plurality of stored numerical measures of sentiment, conviction, confidence, or support.

In some aspects, the asynchronous conversation process enables a selected plurality of new participants to communicate through real-time dialog with each other while also engaging in dialog the same Conversational Surrogate Agent.

In some aspects, the representation of conversational content associated with each of a plurality of prior participants references at least one solution to a problem presented to each participant and at least one reason in support or opposition of the solution.

In some aspects, the asynchronous conversational process is configured to enable at least one new participant to engage in real-time dialog with a plurality of different Conversational Surrogate Agents on their associated computing device, each of the different Conversational Surrogate Agents configured to conversationally represent a different perspective stored within the memory and associated with different prior human participants.

In some aspects, each of the plurality of different Conversational Surrogate Agents is represented by a different animated graphical avatar on the associated computing device.

In some aspects, each of the Conversational Surrogate Agents is also configured to express conversationally to at least one new participant, at least one stored idea, insight, view, or assertion captured and stored from at least one other new participant.

In some aspects, the plurality of networked computing devices running an asynchronous conversation application are not all connected to the collaboration server at the same time.

Additionally, an apparatus for asynchronous conversational deliberation among a population of human participants is described. One or more aspects of the apparatus include a collaboration server connected to a memory, the memory containing a representation of conversational content previously captured from a plurality of prior human participants, the representation associated with each prior participant including at least one stored idea, insight, view, or assertion expressed by that prior participant and at least one associated numerical measure of sentiment, conviction, confidence, or support; a plurality of networked computing devices, each computing device in communication with the collaboration server and associated with one of a plurality of new human participants, each computing device running an asynchronous conversation application; and a plurality of Conversational Surrogate Agents, each displayed by an associated computing device, each Conversational Surrogate Agent configured to engage in real-time dialog with at least one new human participant and to express at least one stored idea, insight, view, or assertion associated with at least one prior participant.

In some aspects, the collaboration server is further configured to periodically update the representation of conversational content based on new inputs from the plurality of new human participants.

In some aspects, each Conversational Surrogate Agent is further configured to adapt its dialog based on the real-time sentiment, conviction, confidence, or support expressed by the new human participant.

In some aspects, the asynchronous conversation application includes a user interface that displays a summary of the most relevant stored ideas, insights, views, or assertions to the new human participant.

In some aspects, the collaboration server is further configured to analyze the conversational content to identify emerging trends or consensus among the human participants.

In some aspects, the memory further contains metadata associated with each stored idea, insight, view, or assertion, the metadata including the time of capture and an identification of the prior participant.

In some aspects, the collaboration server is further configured to facilitate the exchange of conversational content between different subgroups of new human participants.

In some aspects, each Conversational Surrogate Agent is further configured to provide contextual information or statistical information related to the stored ideas, insights, views, or assertions.

In some aspects, the collaboration server is further configured to generate reports or visualizations based on aggregated conversational content and the associated numerical measures of sentiment, conviction, confidence, or support.

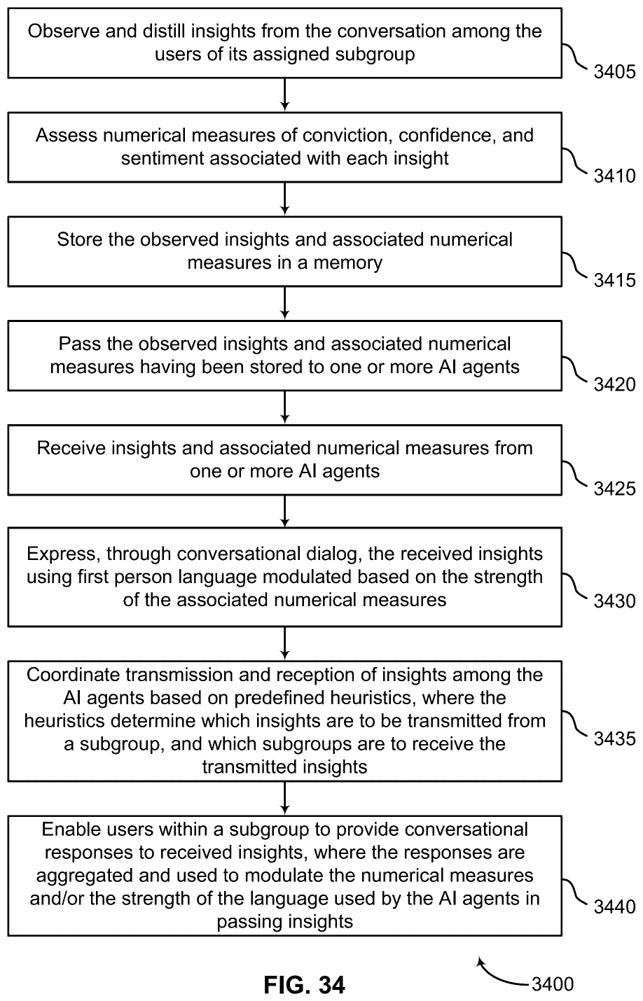

FIG. 34 shows an example of a method 3400 for facilitating collective superintelligence among a large population of networked users according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 3405, the system observes and distills insights from the conversation among the users of its assigned subgroup. In some cases, the operations of this step refer to, or may be performed by, a conversational surrogate agent as described with reference to FIGS. 2, 5, 6, 8, 9, 11, 19-24, and 28.

At operation 3410, the system assesses numerical measures of conviction, confidence, and sentiment associated with each insight. In some cases, the operations of this step refer to, or may be performed by, a conversational surrogate agent as described with reference to FIGS. 2, 5, 6, 8, 9, 11, 19-24, and 28.

At operation 3415, the system stores the observed insights and associated numerical measures in a memory. In some cases, the operations of this step refer to, or may be performed by, a conversational surrogate agent as described with reference to FIGS. 2, 5, 6, 8, 9, 11, 19-24, and 28.

At operation 3420, the system passes the observed insights and associated numerical measures having been stored to one or more AI agents. In some cases, the operations of this step refer to, or may be performed by, a conversational surrogate agent as described with reference to FIGS. 2, 5, 6, 8, 9, 11, 19-24, and 28.

At operation 3425, the system receives insights and associated numerical measures from one or more AI agents. In some cases, the operations of this step refer to, or may be performed by, a conversational surrogate agent as described with reference to FIGS. 2, 5, 6, 8, 9, 11, 19-24, and 28.

At operation 3430, the system expresses, through conversational dialog, the received insights using first-person language modulated based on the strength of the associated numerical measures. In some the cases, operations of this step refer to, or may be performed by, a conversational surrogate agent as described with reference to FIGS. 2, 5, 6, 8, 9, 11, 19-24, and 28.

At operation 3435, the system Coordinates transmission and reception of insights among the AI agents based on predefined heuristics, where the heuristics determine which insights are to be transmitted from a subgroup, and which subgroups are to receive the transmitted insights. In some cases, the operations of this step refer to, or may be performed by, a central server as described with reference to FIGS. 10, 11, 19, and 29.

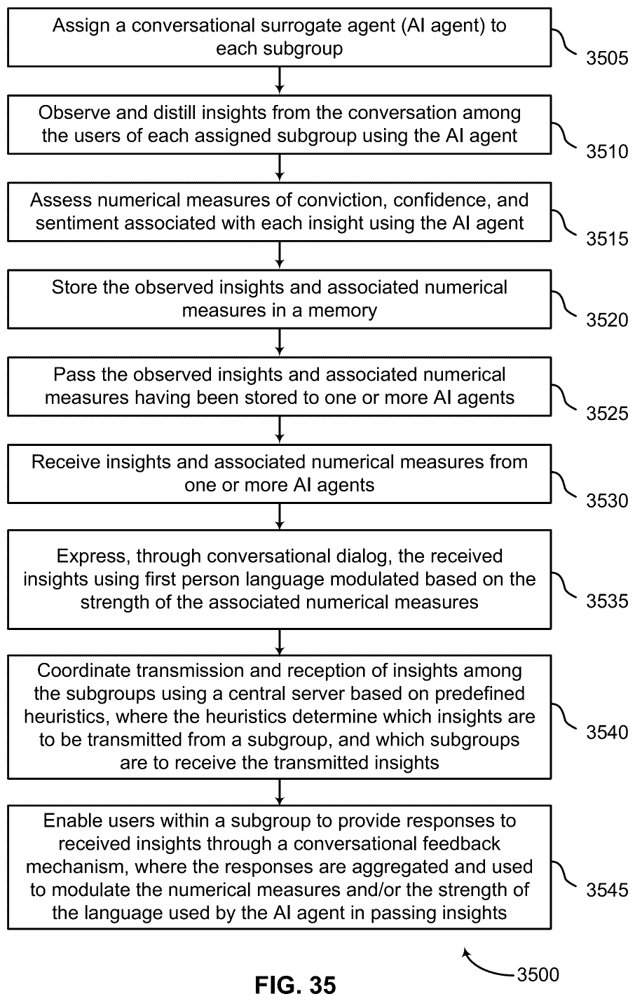

At operation 3440, the system enables users within a subgroup to provide conversational responses to received insights, where the responses are aggregated and used to modulate the numerical measures and/or the strength of the language used by the AI agents in passing insights. In some cases, the operations of this step refer to, or may be performed by, a feedback mechanism as described with reference to FIG. 35.

Accordingly, an apparatus for facilitating collective superintelligence among a large population of networked users each belonging to at least one of a plurality of subgroups is described. One or more aspects of the apparatus include a conversational surrogate agent (AI agent) assigned to each subgroup, wherein the AI agent is configured to: observe and distill insights from the conversation among the users of its assigned subgroup, assess numerical measures of conviction, confidence, and sentiment associated with each insight, store the observed insights and associated numerical measures in a memory, pass the observed insights and associated numerical measures having been stored to another AI agent, receive insights and associated numerical measures from the other AI agent, express, through conversational dialog, received insights from the other AI agents assigned subgroup using first-person language modulated based on the strength of the numerical measures; a central server configured to coordinate asynchronous transmission and reception of insights among the AI agents based on predefined heuristics, wherein the heuristics determine which insights are to be transmitted from a subgroup, and which subgroups are to receive the transmitted insights; and a feedback mechanism enabling users within a subgroup to provide conversational responses to received insights, wherein the responses are aggregated and used to modulate the strength of the language used by the AI agents in passing insights.

In some aspects, the central server is further configured to periodically update the predefined heuristics based on the aggregated responses from the feedback mechanism.

In some aspects, each AI agent is further configured to adapt its dialog based on real-time sentiment analysis of the users' responses within its assigned subgroup.

In some aspects, the memory storing the observed insights and associated numerical measures includes metadata indicating the time of capture and an identification of the user who provided the insight.

In some aspects, the central server is further configured to generate reports or visualizations based on the aggregated insights and numerical measures from all subgroups.

In some aspects, each networked computing device includes a user interface that displays a summary of the most relevant insights and associated numerical measures to the users within the subgroup.

In some aspects, the feedback mechanism includes a feature that allows users to rate the relevance or usefulness of the received insights.

In some aspects, each AI agent is further configured to provide contextual information or statistical information related to the observed insights.

In some aspects, the central server is further configured to facilitate the exchange of insights between different subgroups based on the level of consensus identified from the aggregated insights.

In some aspects, each AI Agent is further configured to express received insights using multimedia elements such as text, audio, and video to enhance user engagement.

In some aspects, a plurality of the subgroups are engaged asynchronously over sequential time periods.

FIG. 35 shows an example of a method 3500 for facilitating collective superintelligence among a large population of networked users according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 3505, the system assigns a conversational surrogate agent (AI agent) to each subgroup. In some cases, the operations of this step refer to, or may be performed by, a central server as described with reference to FIGS. 10, 11, 19, and 29.

At operation 3510, the system observes and distills insights from the conversation among the users of each assigned subgroup using the AI agent. In some cases, the operations of this step refer to, or may be performed by, a conversational surrogate agent as described with reference to FIGS. 2, 5, 6, 8, 9, 11, 19-24, and 28.

At operation 3515, the system assesses numerical measures of conviction, confidence, and sentiment associated with each insight using the AI agent. In some cases, the operations of this step refer to, or may be performed by, a conversational surrogate agent as described with reference to FIGS. 2, 5, 6, 8, 9, 11, 19-24, and 28.

At operation 3520, the system stores the observed insights and associated numerical measures in a memory. In some cases, the operations of this step refer to, or may be performed by, a conversational surrogate agent as described with reference to FIGS. 2, 5, 6, 8, 9, 11, 19-24, and 28.

At operation 3525, the system passes the observed insights and associated numerical measures having been stored to one or more AI agents. In some cases, the operations of this step refer to, or may be performed by, a conversational surrogate agent as described with reference to FIGS. 2, 5, 6, 8, 9, 11, 19-24, and 28.

At operation 3530, the system receives insights and associated numerical measures from one or more AI agents. In some cases, the operations of this step refer to, or may be performed by, a conversational surrogate agent as described with reference to FIGS. 2, 5, 6, 8, 9, 11, 19-24, and 28.

At operation 3535, the system expresses, through conversational dialog, the received insights using first-person language modulated based on the strength of the numerical measures. In some cases, the operations of this step refer to, or may be performed by, a conversational surrogate agent as described with reference to FIGS. 2, 5, 6, 8, 9, 11, 19-24, and 28.

At operation 3540, the system coordinates transmission and reception of insights among the subgroups using a central server based on predefined heuristics, where the heuristics determine which insights are to be transmitted from a subgroup, and which subgroups are to receive the transmitted insights. In some cases, the operations of this step refer to, or may be performed by, a central server as described with reference to FIGS. 10, 11, 19, and 29.

At operation 3545, the system enables users within a subgroup to provide responses to received insights through a conversational feedback mechanism, where the responses are aggregated and used to modulate the numerical measures and/or the strength of the language used by the AI agent in passing insights. In some cases, the operations of this step refer to, or may be performed by, a feedback mechanism as described with reference to FIG. 34.

Accordingly, a method for facilitating collective superintelligence among a large population of networked users each belonging to at least one of a plurality of subgroups is described. One or more aspects of the method include assigning a conversational surrogate agent (AI agent) to each subgroup; observing and distilling insights from the conversation among the users of each assigned subgroup using the AI agent; assessing numerical measures of conviction, confidence, and sentiment associated with each insight using the AI agent; storing the observed insights and associated numerical measures in a memory;

passing the observed insights and associated numerical measures having been stored to another AI agent; receiving insights and associated numerical measures from the other AI agent; expressing, through conversational dialog, received insights from the other AI agent's assigned subgroup using first-person language modulated based on the strength of numerical the measures; coordinating asynchronous transmission and reception of insights among the subgroups using a central server based on predefined heuristics, wherein the heuristics determine which insights are to be transmitted from a subgroup, and which subgroups are to receive the transmitted insights; and enabling users within a subgroup to provide responses to received insights through a conversational feedback mechanism, wherein the responses are aggregated and used to modulate the strength of the language used by the AI agent in passing insights.

In some aspects, the central server is further configured to periodically update the predefined heuristics based on the aggregated responses from feedback mechanism.

In some aspects, each AI Agent is further configured to adapt its dialog based on real-time sentiment analysis of the users' responses within its assigned subgroup.

In some aspects, the memory storing the observed insights and associated numerical measures includes metadata indicating the time of capture and an identification of the user who provided the insight.

In some aspects, the central server is further configured to generate reports or visualizations based on the aggregated insights and numerical measures from all subgroups.

In some aspects, each networked computing device includes a user interface that displays a summary of the most relevant insights and associated numerical measures to the users within the subgroup.

In some aspects, the feedback mechanism includes a feature that allows users to rate the relevance or usefulness of the received insights.

In some aspects, each AI agent is further configured to provide contextual information or statistical information related to the observed insights.

In some aspects, the central server is further configured to facilitate the exchange of insights between different subgroups based on the level of consensus identified from the aggregated insights.

In some aspects, a plurality of the subgroups are engaged asynchronously over sequential time periods.

In some aspects, the feedback mechanism includes a feature that allows users to bookmark or save specific insights for future reference.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While only a few embodiments of the disclosure have been shown and described, it will be obvious to those skilled in the art that many changes and modifications may be made thereunto without departing from the spirit and scope of the disclosure as described in the following claims.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (Saas), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein. While the invention herein disclosed has been described by means of specific embodiments, examples and applications thereof, numerous modifications and variations could be made thereto by those skilled in the art without departing from the scope of the invention set forth in the claims.

What is claimed is:

1. An AI-facilitated method for asynchronous conversational deliberation among a population of human participants, the method comprising:
providing a collaboration server connected to a memory containing a representation of conversational content that was previously captured from a plurality of prior human participants, the representation associated with each prior participant including at least one stored idea, insight, view, or assertion expressed by that prior participant and at least one associated numerical measure of sentiment, conviction, confidence, or support;
running an asynchronous conversation application on each of a plurality of networked computing devices, each computing device in communication with the collaboration server and each computing device associated with one of a plurality of new human participants; and
enabling an asynchronous conversational process in which each of the plurality of new human participants engages in real-time dialog with a Conversational Surrogate Agent displayed by their associated computing device, each Conversational Surrogate Agent configured to express to at least one new participant, at least one stored idea, insight, view, or assertion associated with at least one prior participant.

2. The AI-facilitated method of claim 1 wherein the Conversational Surrogate Agent expresses dialog that is generated at least in part by a Large Language Model provided with at least one stored idea, insight, view, or assertion associated with at least one prior participant.

3. The AI-facilitated method of claim 2 wherein the Large Language Model is configured to generate the dialog used to express a stored idea, insight, view, or assertion based at least in part on said at least one stored numerical measure of sentiment, conviction, confidence, or support.

4. The AI-facilitated method of claim 1 wherein the Conversational Surrogate Agent expresses said dialog in the first person to said at least one new participant.

5. The AI-facilitated method of claim 1 wherein the at least one idea, insight, view, or assertion expressed to said at least one new participant is selected from a plurality of stored ideas, insights, views, or assertions by an intelligent heuristic process, said intelligent process configured to challenge said at least one new participant with conversational content that has not yet been discussed by said at least one new participant during said dialog.

6. The AI-facilitated method of claim 1 wherein the Conversational Surrogate Agent is configured to modulate its simulated emotion when expressing a stored idea, insight, view, or assertion based at least in part on a stored numerical measure of sentiment, conviction, confidence, or support.

7. The AI-facilitated method of claim 6 wherein said simulated emotion includes a vocal inflection.

8. The AI-facilitated method of claim 6 wherein said simulated emotion includes facial expression.

9. The AI-facilitated method of claim 1 wherein a representation of conversational content from each of a plurality of said new participants is captured and stored in a memory accessible to said collaboration server, each representation including at least one idea, insight, view, or assertion and at least one associated numerical measure of sentiment, conviction, confidence, or support.

10. The AI-facilitated method of claim 9 wherein said at least one numerical measure of sentiment, conviction, confidence, or support is generated at least in part by a large language model that assesses dialog expressed by at least one of the plurality of new participants.

11. The AI-facilitated method of claim 10 wherein said at least one numerical measure of sentiment, conviction, confidence, or support is generated at least in part based on a facial expression or vocal inflection of said at least one new participant.

12. The AI-facilitated method of claim 1 wherein the Conversational Surrogate Agent is displayed as an animated avatar on said computing device.

13. The AI-facilitated method of claim 1 wherein said at least one stored idea, insight, view, or assertion that is associated with at least one prior participant is an aggregation across a plurality of prior participants and represents a collective intelligence.

14. The AI-facilitated method of claim 13 wherein said aggregation is a weighted aggregation based at least on part on a plurality of stored numerical measures of sentiment, conviction, confidence, or support.

15. The AI-facilitated method of claim 1 wherein said asynchronous conversation process enables a selected plurality of new participants to communicate through real-time dialog with each other while also engaging in dialog with the same Conversational Surrogate Agent.

16. The AI-facilitated method of claim 1 wherein the representation of conversational content associated with each of a plurality of prior participants references at least one solution to a problem presented to each participant and at least one reason in support or opposition of said solution.

17. The AI-facilitated method of claim 1 wherein the asynchronous conversational process is configured to enable at least one new participant to engage in real-time dialog with a plurality of different Conversational Surrogate Agents on their associated computing device, each of said different Conversational Surrogate Agents configured to conversationally represent a different perspective stored within said memory and associated with different prior human participants.

18. The AI-facilitated method of claim 17 wherein each of said plurality of different Conversational Surrogate Agents is represented by a different animated graphical avatar on said associated computing device.

19. The AI-facilitated method of claim 1 wherein each of said Conversational Surrogate Agents is also configured to express conversationally to at least one new participant, at least one stored idea, insight, view, or assertion captured and stored from at least one other new participant.

20. The AI-facilitated method of claim 1 wherein the plurality of networked computing devices running an asynchronous conversation application are not all connected to said collaboration server at the same time.

21. A system for asynchronous conversational deliberation among a population of human participants, the system comprising:
a collaboration server connected to a memory, the memory containing a representation of conversational content previously captured from a plurality of prior human participants, the representation associated with each prior participant including at least one stored idea, insight, view, or assertion expressed by that prior participant and at least one associated numerical measure of sentiment, conviction, confidence, or support;
a plurality of networked computing devices, each computing device in communication with the collaboration server and associated with one of a plurality of new human participants, each computing device running an asynchronous conversation application; and
a plurality of Conversational Surrogate Agents, each displayed by an associated computing device, each Conversational Surrogate Agent configured to engage in real-time dialog with at least one new human participant and to express at least one stored idea, insight, view, or assertion associated with at least one prior participant.

22. The system of claim 21, wherein the collaboration server is further configured to periodically update the representation of conversational content based on new inputs from the plurality of new human participants.

23. The system of claim 21, wherein each Conversational Surrogate Agent is further configured to adapt its dialog based on the real-time sentiment, conviction, confidence, or support expressed by the new human participant.

24. The system of claim 21, wherein the asynchronous conversation application includes a user interface that displays a summary of the most relevant stored ideas, insights, views, or assertions to the new human participant.

25. The system of claim 21, wherein the collaboration server is further configured to analyze the conversational content to identify emerging trends or consensus among the human participants.

26. The system of claim 21, wherein the memory further contains metadata associated with each stored idea, insight, view, or assertion, the metadata including the time of capture and an identification of the prior participant.

27. The system of claim 21, wherein the collaboration server is further configured to facilitate the exchange of conversational content between different subgroups of new human participants.

28. The system of claim 21, wherein each Conversational Surrogate Agent is further configured to provide contextual information or statistical information related to the stored ideas, insights, views, or assertions.

29. The system of claim 21, wherein the collaboration server is further configured to generate reports or visualizations based on aggregated conversational content and the associated numerical measures of sentiment, conviction, confidence, or support.

30. A system for facilitating collective superintelligence among a large population of networked users each belonging to at least one of a plurality of subgroups, each subgroup consisting of a small number of users, the system comprising:
a conversational surrogate agent (AI agent) assigned to each subgroup, wherein the AI agent is configured to:
observe and distill insights from the conversation among the users of its assigned subgroup;
assess numerical measures of conviction, confidence, and sentiment associated with each insight;
store the observed insights and associated numerical measures in a memory;
pass the observed insights and associated numerical measures having been stored to another AI agent;
receive insights and associated numerical measures from the other AI agent;
express, through conversational dialog, received insights from the other AI agents assigned subgroup using first-person language modulated based on the strength of the numerical measures;
a central server configured to coordinate asynchronous transmission and reception of insights among the AI agents based on predefined heuristics, wherein the heuristics determine which insights are to be transmitted from a subgroup, and which subgroups are to receive the transmitted insights; and
a feedback mechanism enabling users within a subgroup to provide conversational responses to received insights, wherein the responses are aggregated and used to modulate the strength of the language used by the AI agents in passing insights.

31. The system of claim 30, wherein a plurality of said subgroups are engaged asynchronously over sequential time periods.

32. The system of claim 30, wherein the central server is further configured to periodically update the predefined heuristics based on the aggregated responses from the feedback mechanism.

33. The system of claim 30, wherein each AI agent is further configured to adapt its dialog based on real-time sentiment analysis of the users' responses within its assigned subgroup.

34. The system of claim 30, wherein the memory storing the observed insights and associated numerical measures includes metadata indicating the time of capture and an identification of the user who provided the insight.

35. The system of claim 30, wherein the central server is further configured to generate reports or visualizations based on the aggregated insights and numerical measures from all subgroups.

36. The system of claim 30, wherein each networked computing device includes a user interface that displays a summary of the most relevant insights and associated numerical measures to the users within the subgroup.

37. The system of claim 30, wherein the feedback mechanism includes a feature that allows users to rate the relevance or usefulness of the received insights.

38. The system of claim 30, wherein each AI agent is further configured to provide contextual information or statistical information related to the observed insights.

39. The system of claim 30, wherein the central server is further configured to facilitate the exchange of insights between different subgroups based on the level of consensus identified from the aggregated insights.

40. The system of claim 30, wherein each AI Agent is further configured to express received insights using multimedia elements such as text, audio, and video to enhance user engagement.

41. A method for facilitating collective superintelligence among a large population of networked users each belonging to at least one of a plurality of subgroups, each subgroup consisting of a small number of users, the method comprising:
assigning a conversational surrogate agent (AI agent) to each subgroup;
observing and distilling insights from the conversation among the users of each assigned subgroup using the AI agent;
assessing numerical measures of conviction, confidence, and sentiment associated with each insight using the AI agent;
storing the observed insights and associated numerical measures in a memory;
passing the observed insights and associated numerical measures having been stored to another AI agent;
receiving insights and associated numerical measures from the other AI agent;
expressing, through conversational dialog, received insights from the other AI agent's assigned based on the aggregated insights and numerical measures from all subgroups.

46. The method of claim 41, wherein each networked computing device includes a user interface that displays a summary of the most relevant insights and associated numerical measures to the users within the subgroup.

47. The method of claim 41, wherein the feedback mechanism includes a feature that allows users to rate the relevance or usefulness of the received insights.

48. The method of claim 41, wherein each AI agent is further configured to provide contextual information or statistical information related to the observed insights.

49. The method of claim 41, wherein the central server is further configured to facilitate the exchange of insights between different subgroups based on the level of consensus identified from the aggregated insights.

50. The method of claim 41 wherein a plurality of said subgroups are engaged asynchronously over sequential time periods.
